(19) United States
(12) Patent Application Publication
(10) Pub. No.: US 2010/0269049 A1
(43) Pub. Date: Oct. 21, 2010

(54) SYSTEM AND METHOD FOR MANAGING EVENTS IN A MULTIPLE SCHEDULE ENVIRONMENT

(76) Inventor: REGEN FEARON, DALLAS, TX (US)

Correspondence Address: HOWISON & ARNOTT, L.L.P, P.O. BOX 741715, DALLAS, TX, 75374-1715, US

(21) Appl. No.: 12/578,308

(22) Filed: Oct. 13, 2009

Related U.S. Application Data
(60) Provisional application No. 61/104,988, filed on Oct. 13, 2008.

(51) Int. Cl. G06F 3/048; G06F 3/01

(52) U.S. Cl. 715/744; 715/772; 715/752; 715/810

(57) ABSTRACT

Provided are a system and method for managing events in a multiple schedule environment. In one example, the method includes receiving a user selection identifying an event that is to be scheduled, wherein the user selection identifies the event from a plurality of pre-defined event types. User data is received identifying at least a date and a time corresponding to the event. A message for a recipient is created that includes the time and date inserted into pre-defined text corresponding to the event type. The message is sent to the recipient. A determination is made as to whether a reply has been received from the recipient and whether the reply is affirmative or negative. A status of the event is updated based on the step of determining and a designated individual is notified of the status.

### CROSS-REFERENCE TO RELATED APPLICATIONS

This application claims the benefit of U.S. provisional application for patent Ser. No. 61/104,988, filed Oct. 13, 2008, and entitled COMPUTER SOFTWARE FOR TIME MANAGEMENT (Atty. Dkt. No. MOSI-29,113), the specification of which is incorporated herein by reference in its entirety.

### TECHNICAL FIELD

This application is related to event management and, more particularly, to managing events in a multiple schedule environment.

### BACKGROUND

Individuals in modern society typically have busy schedules. Keeping track of various dates, times, and other event information can be time consuming and frustrating. Furthermore, missing appointments or other events can be stressful and, in some cases, damaging to the individual's career. Some individuals rely on business-type planning aids, but these may provide little or no flexibility and may be too generic to work in all situations. Accordingly, improvements in planning aids are needed.

### SUMMARY

In one embodiment, a method for managing events in a multiple schedule environment is provided. The method comprises receiving, by a computing device, a user selection identifying an event that is to be scheduled, wherein the user selection identifies the event from a plurality of pre-defined event types; opening, by the computing device, the event as an entry in a schedule; receiving, by the computing device, user data identifying at least a date and a time corresponding to the event; creating, by the computing device, a message for a recipient, wherein the message includes the time and date inserted into pre-defined text corresponding to the event type; sending, by the computing device, the message to the recipient; determining, by the computing device, whether a reply has been received from the recipient; determining, by the computing device, whether the reply is affirmative or negative if the reply has been received; updating, by the computing device, a status of the event based on the steps of determining; and notifying, by the computing device, a designated individual of the status.

In another embodiment, a computing device is provided. The computing device comprises a network interface; a processor coupled to the network interface; a memory coupled to the processor; and a plurality of instructions stored in the memory for execution by the processor, the instructions including instructions for: receiving user data identifying at least a date and a time corresponding to an event; retrieving a preformatted message from the memory, wherein the message is retrieved from a plurality of preformatted messages based on an event type of the event; retrieving an address of a recipient for the message from the memory, wherein the recipient is selected based on one of a user selection and a recipient list associated with the event type; inserting the time, date, and address into the message; sending the message to the recipient via the network interface; determining whether a reply has been received from the recipient; updating a status of the event based on the step of determining; and notifying, by the computing device, a designated individual of the status.

In still another embodiment, a computing device for managing events in a multiple schedule environment is provided. The computing devices comprises means for receiving a user selection identifying an event that is to be scheduled, wherein the user selection identifies the event from a plurality of pre-defined event types; means for opening the event as an entry in a schedule; means for receiving user data identifying at least a date and a time corresponding to the event; means for creating a message for a recipient, wherein the message includes the time and date inserted into pre-defined text corresponding to the event type; means for sending the message to the recipient; means for determining whether a reply has been received from the recipient; means for determining whether the reply is affirmative or negative if the reply has been received; means for updating a status of the event based on the steps of determining; and means for notifying a designated individual of the status.

### BRIEF DESCRIPTION OF THE DRAWINGS

For a more complete understanding, reference is now made to the following description taken in conjunction with the accompanying Drawings in which:

FIG. 1 is a diagram of the MOS high-level architecture;

FIG. 2 illustrates a diagram of a MOS logical solution;

FIG. 3 is a diagram of a logical solution;

FIG. 4 illustrates a timeline of the functional specification project Gantt chart;

FIG. 5 illustrates a solution concept diagram for MOS;

FIG. 6 illustrates a proposed MOS application architecture;

FIG. 7 illustrates an MS SQL server database architecture;

FIG. 8 illustrates loading MS Outlook add-in;

FIG. 9 illustrates unloading MS Outlook add-in;

FIG. 10 illustrates an MOS database schema;

FIG. 11 illustrates an MOS domain model diagram;

FIG. 12 illustrates an activity diagram for user creation of a MOS card;

FIG. 13 illustrates an activity diagram for system management of sitter appointments;

FIG. 14 illustrates an activity diagram for system management of charity appointments;

FIG. 15 illustrates an activity diagram for system management of driver appointments;

FIG. 16 illustrates an activity diagram for creating a custom appointment;

FIG. 17 illustrates an activity diagram for running an organization/team genie;

FIG. 18 illustrates an activity diagram for running a school year setup form;

FIG. 19 illustrates an activity diagram for running an initial setup genie;

FIG. 20 illustrates an activity diagram for creating a custom calendar;

FIG. 21 illustrates an activity diagram for printing a custom calendar;

FIG. 22 illustrates an exemplary screen display for creating an adult appointment;

FIG. 23 illustrates an exemplary screen display of an adult appointment start form;

FIG. 24 illustrates an exemplary screen display of a create appointment materials tab;

FIG. 25 illustrates an exemplary screen display of a create appointment sitter tab;

FIG. 26 illustrates an exemplary screen display of a create appointment reservation tab;

FIG. 27 illustrates an exemplary screen display of a create appointment RSVP tab;

FIG. 28 illustrates an exemplary screen display of a create appointment reminder tab;

FIG. 29 illustrates an exemplary screen display of a create child appointment start form;

FIG. 30 illustrates an exemplary screen of a create appointment materials tab;

FIG. 31 illustrates an exemplary screen display of a create appointment driver tab;

FIG. 32 illustrates an exemplary screen display of a create appointment reservation tab;

FIG. 33 illustrates an exemplary screen display of a create appointment RSVP tab;

FIG. 34 illustrates an exemplary screen display of a create appointment notification tab;

FIG. 35 illustrates an exemplary screen display of a create appointment reminder tab;

FIG. 36 illustrates an exemplary screen display of a create appointment for a charity event tab;

FIG. 37 illustrates an exemplary screen display for creating a service call appointment;

FIG. 38 illustrates an exemplary screen display for creating a calendar settings tab;

FIG. 39 illustrates an exemplary screen display for creating a child calendar;

FIG. 40 illustrates an exemplary screen display for creating a employee calendar;

FIG. 41 illustrates an exemplary screen display of calendar settings;

FIG. 42 illustrates an exemplary screen display of a calendar schedule tab;

FIG. 43 illustrates an exemplary screen display of a print calendar selection;

FIG. 44 illustrates an exemplary screen display for printing selection details;

FIG. 45 illustrates an exemplary screen display for further printing a calendar selection;

FIG. 46 illustrates an exemplary screen display for further printing a calendar selection;

FIG. 47 illustrates an exemplary screen display for further printing a calendar selection;

FIG. 48 illustrates an exemplary screen display to delete a calendar;

FIG. 49 illustrates an exemplary screen display for creating a dashboard;

FIG. 50 illustrates an exemplary screen view of a dashboard;

FIG. 51 illustrates an exemplary screen display for customizing a dashboard;

FIG. 52 illustrates an exemplary screen display for deleting a dashboard;

FIG. 53 illustrates an exemplary screen display for creating a folder;

FIG. 54 illustrates an exemplary screen display for deleting a folder;

FIG. 55 illustrates an exemplary screen display run during the initial setup genie;

FIG. 56 illustrates an exemplary screen display of an organization/team setup genie—details tab;

FIG. 57 illustrates an exemplary screen display of a coaches/leader form—organization/team genie;

FIG. 58 illustrates an exemplary screen display of an organization/team setup genie—roster tab;

FIG. 59 illustrates an exemplary screen display of an organization/team setup genie—schedule tab;

FIG. 60 illustrates an exemplary screen display of an organization/team setup genie—materials tab;

FIG. 61 illustrates an exemplary screen display of an organization/team setup genie—Share/Publish tab;

FIG. 62 illustrates an exemplary screen display of genie options—organization/team setup genie;

FIG. 63 illustrates an exemplary screen display of an organization/team genie complete;

FIG. 64 illustrates an exemplary screen display of an edit existing organization/team genie—coaches/leaders tab;

FIG. 65 illustrates an exemplary screen display of an edit existing organization/team genie—roster tab;

FIG. 66 illustrates an exemplary screen display of an edit existing organization/team genie—schedule tab;

FIG. 67 illustrates an exemplary screen display of an edit existing organization/team genie—materials tab;

FIG. 68 illustrates an exemplary screen display of an edit existing organization/team genie—Publish/Share tab;

FIG. 69 illustrates an exemplary screen display of an edit existing organization/team genie—genie options tab;

FIG. 70 illustrates an exemplary screen display of an edit existing organization/team genie—genie status tab;

FIG. 71 illustrates the delete already completed genie;

FIG. 72 illustrates an exemplary screen display of a family card—primary;

FIG. 73 illustrates an exemplary screen display of a family card—edit partner;

FIG. 74 illustrates an exemplary screen display of a family card—children;

FIG. 75 illustrates an exemplary screen display of a family card—second home;

FIG. 76 illustrates an exemplary screen display of a create business card;

FIG. 77 illustrates an exemplary screen display of a delete MOS card;

FIG. 78 illustrates an exemplary screen display of a split MOS card;

FIG. 79 illustrates an exemplary screen display of a family card—quick view;

FIG. 80 illustrates an exemplary screen display of a merge contacts;

FIG. 81 illustrates an exemplary screen display of an import contacts;

FIG. 82 illustrates an exemplary screen display of an errand task;

FIG. 83 illustrates an exemplary screen display of a call task;

FIG. 84 illustrates an exemplary screen display of a correspondence task;

FIG. 85 illustrates an exemplary screen display of a set task preferences;

FIG. 86 illustrates an exemplary screen display of a school details tab—school year template;

FIG. 87 illustrates an exemplary screen display of a school details tab—school year template;

FIG. 88 illustrates an exemplary screen display of a school calendar—school year template;

FIG. 89 illustrates an exemplary screen display of a grade/class calendar—school year template;

FIG. 90 illustrates an exemplary screen display of a class roster—school year template;

FIG. 91 illustrates an exemplary screen display of a school rotation schedule form;

FIG. 92 illustrates an exemplary screen display of an publish/share—school year template;

FIG. 93 illustrates an exemplary screen display of a quick entry genie—calendar;

FIG. 94 illustrates an exemplary screen display of a quick entry genie—example table;

FIG. 95 illustrates an exemplary screen display of a quick entry—list of contacts;

FIG. 96 illustrates an exemplary screen display of a quick entry—list of contacts template;

FIG. 97 illustrates an exemplary screen display of a school year share/publish form;

FIG. 98 illustrates an exemplary screen display for setting MOS preferences;

FIG. 99 illustrates an exemplary screen display of MOS menus;

FIG. 100 illustrates an exemplary screen shot of Outlook—showing GIT Tool Bar;

FIG. 101 illustrates an exemplary screen shot of opening appointment screen;

FIG. 102 illustrates an exemplary screen shot of a reminder sent when information entered for appointment is incomplete;

FIG. 103 illustrates an exemplary screen shot of an Email from GIT about needed information;

FIG. 104 illustrates an exemplary screen shot of a Service Appointment—Entry with notes;

FIG. 105 illustrates an exemplary screen shot of a Service Appointment—Entry ;

FIG. 106 illustrates an exemplary screen shot of a Family Card—starting data entry;

FIG. 107 illustrates an exemplary screen shot of a Family Card—Edit Screen;

FIG. 108 illustrates an exemplary screen shot of a Family Care—Edit Screen—primary contact;

FIG. 109 illustrates an exemplary screen shot of a Family Card—Edit Screen—Children's information;

FIG. 110 illustrates an exemplary screen shot of a Family Card—Edit Screen—different family;

FIG. 111 illustrates an exemplary screen shot of a Family Card—Quick Entry;

FIG. 112 illustrates an exemplary screen shot of an Appointment Screen;

FIG. 113 illustrates an exemplary screen shot of an Appointment as it appears on Outlook Calendar;

FIG. 114 illustrates an exemplary screen shot of Contacts Quick Entry;

FIG. 115 illustrates an exemplary screen shot of Contacts Quick list entry;

FIG. 116 illustrates an exemplary screen shot of New Contacts added via quick entry;

FIG. 117 illustrates an exemplary screen shot of an Appointments Quick Entry;

FIG. 118 illustrates an exemplary screen shot of a Charity Event Entry and further illustrates an exemplary screen shot of the same screen that appears when you double click on the entry on the Outlook calendar;

FIG. 119 illustrates an exemplary screen shot of an Event Entry shown on Outlook Calendar;

FIG. 120 illustrates an exemplary screen shot of New B/G Club Charity Event—multiple people received invitations;

FIG. 121 illustrates an exemplary screen shot of B/G Club Charity Event—shows on Tuesday on calendar;

FIG. 122 illustrates an exemplary screen shot of a Charity Event with notes;

FIG. 123 illustrates an exemplary screen shot of a Charity Event with one response;

FIG. 124 illustrates an exemplary screen shot of a Reminder that Charity Event table is not yet filled;

FIG. 125 illustrates an exemplary screen shot of B/G Club Charity Event Response from GIT about B/G Club Event;

FIG. 126 illustrates an exemplary screen shot of Fake Charity Even with prepaid table;

FIG. 127 illustrates an exemplary screen shot of Fake Charity Even with prepaid table—response (decline);

FIG. 128 illustrates an exemplary screen shot of Fake Charity Even with prepaid table—response (decline)—as it showed on guest's computer;

FIG. 129 illustrates an exemplary screen shot of B/G Club Charity Event Response from guest—invitation went out when the event was created, saved, and closed;

FIG. 130 illustrates an exemplary screen shot of a Business Card Entry;

FIG. 131 illustrates an exemplary screen shot of a Card accessed from Contacts list;

FIG. 132 illustrates an exemplary screen shot of a Business Card Entry with notes and additional Business Type;

FIG. 133 illustrates an exemplary screen shot of a Business Card—another view;

FIG. 134 illustrates an exemplary screen shot of Business Card Contacts with two cards;

FIG. 135 illustrates an exemplary screen shot of Business Contacts—multiple entries—shows in alpha order by contact;

FIG. 136 illustrates an exemplary screen shot of a Business Card—with notes;

FIG. 137 illustrates an exemplary screen shot of a Business Card with added employees;

FIG. 138 illustrates an exemplary screen shot of GIT—Business Cards with a zipcode search;

FIG. 139 illustrates an exemplary screen shot of a GIT—Family Card;

FIG. 140 illustrates an exemplary screen shot of GIT—Card style—selected zipcodes;

FIG. 141 illustrates an exemplary screen shot of a Service Appointment—landscape;

FIG. 142 illustrates an exemplary screen shot of a Child's Appointment—football game;

FIG. 143 illustrates an exemplary screen shot of a Child Appointment;

FIG. 144 illustrates an exemplary screen shot of a Child Appointment—dentist;

FIG. 145 illustrates an exemplary screen shot of a Child Appointment—Materials;

FIG. 146 illustrates an exemplary screen shot of a Child Appointment—Carpool;

FIG. 147 illustrates an exemplary screen shot of a Child Appointment—RSVP;

FIG. 148 illustrates an exemplary screen shot of a Child Appointment—Notification;

FIG. 149 illustrates an exemplary screen shot of a Child Appointment—Reminder;

FIG. 150 illustrates an exemplary screen shot of an Adult Appointment—Materials and reminder;

FIG. 151 illustrates an exemplary screen shot of an Adult Appointment with sitter information;

FIG. 152 illustrates an exemplary screen shot of an Adult Appointment—Response from sitter to automatically generated sitter request;

FIG. 153 illustrates an exemplary screen shot of an Adult Appointment—Automatic email from GIT—sitter is unavailable;

FIG. 154 illustrates an exemplary screen shot of an Adult Appointment—Reservation information;

FIG. 155 illustrates an exemplary screen shot of an Adult Appointment—RSVP;

FIG. 156 illustrates an exemplary screen shot of an Adult Appointment—Reminder Tab;

FIG. 157 illustrates an embodiment of a computer system with which various aspects of the present disclosure may be implemented; and

FIG. 158 illustrates an embodiment of a mobile device with which various aspects of the present disclosure may be implemented.

### DETAILED DESCRIPTION

Referring now to the drawings, wherein like reference numbers are used herein to designate like elements throughout, the various views and embodiments of a system and method for managing events in a multiple schedule environment are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

PVD

Business Opportunity

Mom's Office Suite (MOS) would like to introduce into the marketplace a suite of personal management tools for upper-income Moms to automate, coordinate and simplify her job as a Mom. The MOS solution will enable Mom to use her time and talents to be more creative, meaningfully productive and available to her family by providing a suite of tools to assist Mom in effectively and efficiently accomplish the many facets of her job as a Mom. MOS will extend, customize, and integrate existing solutions unlocking the versatility and flexibility of those tools for Moms. MOS will make the job of being a busy Mom more efficient, effective, time saving, and less stressful.

MOS is for women who manage multiple people, houses and projects and need and want to operate more professionally so they can use their time and talents in a more rewarding manner—on their families and/or on meaningful work or projects. The first step in this process is a proof-of-concept or beta application to validate the value of the core set of MOS features and capabilities.

Background

Today's Mom is a mother, wife, and businesswomen, she manages multiples homes, multiple employees, household finances, investments, insurance and other business functions for the family, and often are, themselves, employed. Moms are bombarded every day with an innumerable number of tasks, activities, to-dos, calls, responsibilities, and interruptions. A typical day for Mom includes appointment scheduling, carpools, meetings, contractors, managing payroll, planning the office party and dealing with the stained drapes in a home 3,000 miles away. More generally Mom's typically charged with managing a wide range of activities including:
Multiple Households—with landscaping, pets, housekeeping, taxes, and other household tasks
Family—kids and spouse or partner, plus parents and in-laws
Business—paid work plus family businesses (including legal, insurance, payroll, investments, and accounting, among others)
Community—volunteer work at school, church, charitable organizations plus managing the family philanthropy
Friends—birthdays, occasions, food/hospital visit for sick friends, or entertaining

Like many Moms, the MOS team started with a search for a family personal management solution. What we found was a patchwork of solutions (websites, programs, phones, and computers, for example) Moms could use to manage her wide-ranging daily “routine”. The MOS team found that while well-known applications such as Microsoft Outlook or Apple iCal/Address Book can be used to accomplish some of Mom's responsibilities and activities, these tools fail to meet Mom's specific needs. First, such applications were typically geared toward the business user, which detracted from their usefulness for Mom. These applications also use business jargon such as “meeting request” and “business card” in their descriptions, creating a dichotomy where personal users must adapt these business terms and processes in order to manage their family routine. Further, appointments, contacts and tasks were generic or at best business-specific, and many of the common sequences of steps associated with managing Mom's daily routine using appointments, contacts, tasks and the like had to be done manually. For example, contacts were defined by job title and company name instead of family name. Finally, their print view differs from their screen view, a confusing approach for many users who are used to the screen view for most tasks and/or visual learners who would be unfamiliar with the differing print view.

Other applications attempt to bridge this gap by marketing themselves as life or family or organization organizers in an effort to fulfill the role of a family-oriented personal management solution. Products such as AirSet, Cozi, Famundo, and others fall into this realm. While these applications are geared towards home and family use, they are too general in three senses: they attempt to work for all family users (mothers, fathers, children, parents, and others), still utilizing generic labels such as “appointment” and “task” and do not lend themselves to the specific routine tasks and responsibilities of a busy Mom. Printing and contact features are no different from business-oriented applications.

Current solutions are missing several key features and capabilities which make them incapable of providing a rich and complete experience for today's Moms. They do not utilize the tools Moms already have and use, instead requiring them to learn new controls and new systems. Further, many of these solutions do not leverage Mom's current behaviors or habits as these solutions require Moms to switch tools, change her behavior, or learn something new, which can lead to slow or no adoption, missed opportunities/synergies, and ultimately to head-on competition with larger personal information manager companies. One concept behind MOS is to start with the tools Moms and families already use and extend or customize them for Moms.

Many of today's solutions are primarily web-centric Internet or Internet-only applications that over time, at best, have evolved to include synchronization with the tools Moms already use as an afterthought, something their customers may have told them they had to add. While some solutions are Internet ideas that appeared to “back into” a desktop solution, instead of a desktop application which worked out to a broader online solution. MOS aims to leverage proven business technologies and processes to re-engineer and automate Mom's daily life.

None of today's solutions simplify, coordinate or automate the Mom's routine. MOS's intention is to bring the power of common business automation tools out of the enterprise world and into the home, just as cell phones evolved from exclusive business tools to everyday consumer essentials.

The market is full of a patchwork of “point-solutions”—applications which cover only a sliver of Mom's daily life. These generally fail Moms in the following ways:
They do not use Mom's vernacular
They are not tailored to Mom's specific needs or requirement
They do not simplify, coordinate or automate Mom's many routines
They do not “talk” to one-another; solutions and information are disjointed
They are difficult to use and navigate
They require Mom to change her behavior, learn a new tool, or abandon her existing tools
They require substantial technical and time barriers to be overcome
They do not unlock the power of the tools Moms already have and use
They are Internet or web-centric in nature

What sets MOS apart is that the solution is “Mom-centric.” The terminology used and the processes (Mom's routine) supported will reflect Mom's viewpoint; furthermore, appointments, to-do items, contacts and tasks will resemble most closely what a Mom's approach is. Moreover, because there are a large variety of appointments and tasks Moms need to schedule, there will be a variety of custom/Mom-specific appointments, contacts and tasks along with automation for the common steps associated with these appointments, contacts and tasks. A Family Card will enable Mom's to view the context of family with all individuals in the family together in one place. Finally, the print view will enables Mom's to use custom print styles to quickly and cleanly print Mom's calendar, tasks, contacts and the like for use on the go, to share with others or simply to hang on the fridge, giving the application an across-the-board consistency others lack.

Project Vision Statement

MOS will provide an effective personal management tool for busy Moms that is extremely user-friendly and integrates seamlessly with both the tools Moms use today and her unique style and interests. MOS is built by a Mom for other Moms, and it unlocks the hidden potential of the software Moms already own to simplify and automate her daily routines. Metaphorically, it provides Mom with a clone or a virtual digital assistant. It fundamentally supports Mom's need to simplify, coordinate, and automate the routine and the mundane in her life.

The Mom's Office Suite enables Mom to use her time and talents to do the following:
Effectively and efficiently accomplish the many facets of her job as a Mom
Simplify, coordinate and automate as many mundane sequences of steps as possible
Manage multiple people, houses and projects
Be more available to her family
Bring order to the chaos of her daily routine

Opportunity Statements

Custom Appointment

Personal information management software such as Outlook and Thunderbird allow for creation of appointments that are very generic in nature and by design, allowing for a topic, location, and timeframe, and other miscellaneous information. While this is fine for businesses and light information management, MOS will provide more sophisticated and customized appointments for Moms.

One means to do so is to customize, extend and enhance existing Outlook appointments to make them work for Moms by capturing the additional information she needs to manage these appointments and their related tasks and contacts wherein MOS automates routine tasks, activities, emails and the like associated with these custom appointments.

Dashboard

The main entry point for the office suite will consist of a “dashboard”, similar to the “Today” screen in Microsoft Outlook. This entry point will allow the Mom to manage her calendar, tasks, contacts, emails and documents in her filing cabinet from a single screen (views). From here, clicking on specific sections will allow her to view details of the calendar, task, contacts, email or documents. <Please add text to capture concept that folders/project also have their own dashboards giving Mom's a quick control panel/HQ to manage the various “roles” in her life—Den Leader, Soccer Mom, Board Director, etc.>

Family Card

In a business setting, contacts are stored as electronic business cards and adhere to standard file formats such as vCard. Such contact information may include the person's name, email address, phone number, etc., but very little relevant metadata for Mom. Adding metadata as an extension to the vCards format would allow familial relationships to be input and then searched for. Family cards bring to the forefront how Mom views and interacts with her contacts/address book. Thus the address book shifts from focus on an individual to focus on families, with individuals now being members of a family and linked via their relationships to the family card.

This will enable Mom's to view and interact with contacts the way she views and interacts with other families in her daily routine and provide Moms with an “at-a-glance” view of the entire family enabling her to centrally maintain family information.

Genies

Moms are constantly creating and managing complex series interrelated appointments, contacts, emails and tasks to support her many responsibilities and daily activities (e.g. managing her daughter's sports team, or the school carpool). The problem today is that this series of information must be independently/individually entered and managed forcing Mom's to spend a great deal of time entering and re-entering the same information, remembering what tasks she has completed, finding documents and contacts related to the project and the like.

Genies provide a quick, intuitive and centralized way for Mom's to initially setup and manage this interrelated information as well as automate many of the background activities (for example, schedule reminders or publish team calendars) associated with these projects.

Moms will be guided through a series of steps, which will enable MOS to simplify and automate these projects.

Custom Print Styles

In modern business office suites that provide similar office-centric capabilities, the print view often differs from the monitor view due to the content of the screen, the layout of the monitor versus the paper, and other technical and aesthetic traits. For regular users of the application, with these printouts being supplementary, these differing views can be jarring. Providing a printout of the screen that closely matches the layout and content of the page will provide for a stronger consistency for the user as well as provide a more enjoyable, user-friendly experience. Moreover, a print view that captures the data from the current screen view in a clear, readable format will improve the intended functionality of printing. This will enable Mom's to print calendar, tasks and contacts in a more user-friendly way, making it easier for Mom's to read, understand and share.

In some embodiments, the print may be matched to the screen. In other embodiments, the calendar may be printed without altering how Outlook displays calendars on the desktop. In still other embodiments, the data may be exported into XML and then style sheets, etc. may be used to format and print the calendars for Moms (all in the background, Mom would not see this).

Easy Entry of Data

Related to these, a simple method to quickly enter and/or import calendars, lists of appointments, tasks, and contacts that adhere to standard file formats such as vCard or ICS/VCS. The goal is to enable Mom's to quick enter large amounts of data such a school, team and carpool schedules using quick entry tables, file imports, screen scrape or copy and paste from emails or the web.

Glossary of Terms

The Table 1 identifies and defines the terms used throughout this document.

TABLE 1

| Term | Type | Definition |
|---|---|---|
| Mom | Entity | The female head of household and the target |
| | | demographic and administrator of MOS |
| Partner | Entity | Mom's spouse, a secondary head of household, |
| | | and a secondary administrator and user of MOS |
| Child | Entity | The offspring of Mom and a tertiary user of MOS |
| Staff | Entity | The regular or infrequent employees of Mom |
| Appointment | Term | In MOS, appointments are scheduled meetings |
| | | that customized and trigger other events, such |
| | | as emails or text messages to one or more |
| | | recipients, appointment reminders, or sequences |
| | | of steps |
| Family Card | Term | The MOS composite contact, that contains |
| | | family members and their relationships to one another |
| Dashboards | Term | Like Outlook's “Today” screen, the MOS |
| | | dashboard will be the entry point, displaying |
| | | Mom's filing cabinet, email, documents, |
| | | calendar, to-do list, and contacts. Dashboards |
| | | include Mom's top-level dashboard which |
| | | gives her a bird's eye view of all of her |
| | | projects, children and roles that she performs. |
| | | Each project, child and/or role will also have a |
| | | dashboard which enables Mom to quickly focus |
| | | in on the project specific tasks. |
| | | In some embodiments, this may be two |
| | | definitions - Mom dashboard, project/folder |
| | | dashboard. |
| Filing Cabinet | Term | Part of the dashboard entry screen of MOS, |
| | | contains the list of folders into which emails, |
| | | appointments, tasks, contacts and other |
| | | documents may be placed |
| Calendar | Term | A graphical representation of appointments for |
| | | people and projects. MOS will utilize existing |
| | | calendar functionality and display them within |
| | | the dashboard's filing cabinet; calendars |
| | | contain folders |
| Folder | Term | A graphical representation of a directory or |
| | | bucket into which emails, tasks, contacts, |
| | | calendars, and documents may be placed. |
| WYSIWYG | Acronym | “What you see is what you get”; in MOS, |
| | | custom printing involves printing to paper the |
| | | view on the screen for calendars and tasks. |
| | | This may involve having Outlook look like the |
| | | way you want to print, or another mechanism |
| | | may be provided, such as a print preview and |
| | | printing mechanism “outside” the traditional |
| | | Outlook print concept or having the print styles |
| | | print what Mom's want/need - whether or not it |
| | | matches the Outlook calendar displayed on the |
| | | desktop. |
| Quick Entry Table | Term | A tabular data entry component comprised of |
| | | columns for data members and rows for |
| | | separate entries |
| Composite Form | Term | The summary of a template, with each tab |
| | | corresponding to a template form |
| Genie | Term | The step-by-step set of forms that walks a Mom |
| | | through the creation of a project such as a |
| | | carpool or team and include the business logic |
| | | that completes the automated sequence of steps |
| | | when a Mom completes the required information |

Project Goals and Objectives

Goals are high-level statements that characterize the high-level requirements for the solution. These goals translate into more granular and measurable terms that serve as requirements. Ultimately, these goals will act as the basis for demonstrating success of the overall project.

The end results achieved by meeting these objectives would enable Mom to spend more time with her family, permit her to be more effective and efficient in her responsibilities, add to the ease of Use of MOS, and allow Mom to get more done, with fewer errors, in less time.

Technical Business Goals

TABLE 2

| Objectives | Business Goals | Critical Success Factors |
|---|---|---|
| BG.1 | Create custom child, adult, | Build specific scenarios for each |
| | delivery, and staff appointments | appointment type and a rules set |
| | that handle administrative task | that handles the automated |
| | work such as sending emails or | features. |
| | text messages, creating tasks at | |
| | preset times, and other behind-the-scenes | |
| | efforts. | |
| BG.2 | Create dashboards to allow Mom | Design a user-friendly interface |
| | to view her filing cabinet, email | for the dashboard screens, similar |
| | inbox, her day/week/month/year | to Microsoft Outlook's Today |
| | calendar view, contacts, | screen. |
| | documents and tasks. | |
| BG.3 | Provide a WYSIWYG print | Use standard libraries to capture |
| | functionality for appointments, | full screen views of the current |
| | tasks, calendar views, contacts, | module for printing. |
| | and dashboard views to allow | Design a user-friendly print |
| | greater visibility of them. | preview and printing mechanism |
| | | that prints what Mom's want to |
| | | see. |
| BG.4 | Create a family card contact that | Utilize metadata to correlate |
| | enables Mom's to quickly create, | immediate members of a family |
| | edit, find and view a family's | together and to a family. |
| | contact information in a single | And/or |
| | place/view (card). | Design a family card that |
| | | provides Mom's an at a glance |
| | | view of a family's contact |
| | | information. |
| BG.5 | Leverage existing user interface so | Ensuring the user interface |
| | that additional content has a | adequately supports new features |
| | consistent style | and enhancements and can be |
| | | utilized for new features and |
| | | enhancements. |

Technical Business Goal Assumptions
Microsoft Outlook 2007 with a custom add-in is an acceptable means to develop the beta for MOS.
Adequate data model design must be done to verify advanced business goals are possible.
The user interface paradigm will support the new features that are planned.

Technical User Goals

TABLE 3

| Objectives | User Goals | Critical Success Factors |
|---|---|---|
| UG.1 | Simplify appointment, | Utilize Genies to enable users to |
| | contact, task and | create each extend appointment |
| | project <school, carpool, | easily. |
| | etc.> creation with limited | |
| | keystrokes and mouse | |
| | clicks. | |
| UG.2 | Display multiple concurrent | Extend existing appointment |
| | appointments in a readable | conflict resolution functionality |
| | customized calendar view. | to display a readable customized |
| | | view. |

Technical User Goal Assumptions
Microsoft Outlooks calendar view is sufficiently extendable to display a customized view of the appointments.
Adequate focus group testing from MOS will be available to validate usability of the user interface.

Technical Operational Goals

TABLE 4

| Ob- | | |
|---|---|---|
| jectives | Operational Goals | Critical Success Factors |
| OG.1 | Extend the contact storage to | Embrace existing standards for |
| | accommodate “family cards” | contacts and include metadata to |
| | where individual members are | relate contacts to a family. |
| | viewed as a unit. This may | |
| | also include extending | |
| | appointments, calendars | |
| | and tasks. | |
| OG.2 | Automate common activities | Embed templates and events for |
| | associated with appointments, | each appointment, to-do item, |
| | calendars, projects, contacts, | and task, to be triggered upon |
| | emails, and tasks. | event creation, modification, and |
| | | deletion. |

Technical Operational Goal Assumptions
Microsoft's contact formats can make use of metadata to associate members of a family together in a family card. This may also include appointments, calendars and tasks.

Technical System Goals

TABLE 5

| Ob- | | |
|---|---|---|
| jectives | Technical Goals | Critical Success Factors |
| TG.1 | Develop add-in with an eye to | Design and develop add-in in a |
| | a long-term goal of a large- | modular way to make effective |
| | scale deployment that may not | use of previously written |
| | make use of Microsoft | components. |
| | Outlook and associated | |
| | add-ins. | |
| TG.2 | Leverage existing personal | Make use of Microsoft Outlook |
| | information management | 2007's existing capabilities and |
| | applications to use shared | use an add-in to add existing |
| | functionality. | functionality where appropriate. |
| TG.3 | Support Mom's environment | Provide support for Microsoft |
| | and operating systems. | Windows XP SP2 and Vista SP1 |
| | | operating systems and Microsoft |
| | | Outlook 2007. |

Technical System Goal Assumptions
Design of add-in will lend itself to a modular means of deployment.
Microsoft Windows XP SP2 or Vista SP1 and Microsoft Outlook 2007 and are installed for all users

General Business Goals
Market & Technology feasibility and viability
   Prove or disprove the value added by MOS
   Prove core market viability and technology feasibility of core features
   Create a demonstrable solution/product for Moms, investors, and partners
Product for Mom's by Mom's
   Involve Mom's early and often
   Information and a user experience that is tailored/targeted to Mom's vernacular, with her specific needs/requirements
   An intuitive interface and

General User Goals
Spend more time with family, friends and personal goals
   Be a more effective Mom, wife, business professional
   Automate & coordinate the routine & background activities
Be a more efficient Mom, wife, business professional
   Reduce the need for repetitive data entry or duplicate data in multiple places
   Eliminate non-value added steps, activities, etc.

General Technical Goals
Scalable
Reliable
Portable
Leverage software that Mom's already have, such as Outlook or Windows Calendar
Cost effective
Open standard whenever possible
Component based—plug-in-play architecture where possible
Support Mom's environment
   Microsoft Windows
      Microsoft Outlook 2003/2007
      Windows XP/Vista
      Internet Explorer 7+
   Apple
      Entourage 2008
      Mac OS X
      Safari
   High-speed Internet connection
   Mobile
      Smartphone/PocketPC/WindowsMobile
      iPhone

Future Release Considerations

The following items may not be requirements for the first release of the project. However, they may be requirements for future releases and represent the direction the application may take. These should be kept in mind during the concept, design and development process.

Build from the Ground Up

Using the add-in tools provided by Microsoft, it is simple to add extra functionality to Microsoft Outlook 2007 in a short period of time. However, one of the limitations of Outlook includes being restricted by its look and feel, working with its inherent functionality and data storage, and being locked into a single implementation. Additionally, this version of Outlook requires users to have Microsoft Office 2007, which is a for-pay software suite and currently has limited market penetration compared to its predecessors (which will soon be obsolete). An application built from the ground up may utilize a full range of usability and look and feel, while maintaining free range of what functionality to include and drop, and having the freedom to deploy to one or many environments.

Mac OS Implementation

Microsoft Outlook 2007 currently runs on the Microsoft Windows Operating System, currently the majority of home computers on the market today. While the Apple Mac OS operating system is the second largest on the market, its user base is increasing. Developing MOS for the Mac OS platform would allow the system to make use of new built-in functionality only available for Mac users.

Internet Access

A desktop application like Microsoft Outlook 2007 has access to many features only available to the local deployment environment, which for most users include only that physical computer. Developing a web application with the same, or limited, set of functionality, will allow users to access content even when away from their personal computers, enhancing their overall experience. Additionally, using dynamic web parts such as gadgets powered by Google may allow for additional customization and modularization.

Mobile Access

In the last five years, cell phone dissemination has largely saturated the market, and smartphones running Palm OS, Windows Mobile, and iPhone Mac OS are commonplace. Almost all are capable of running the Java ME Virtual Machine, and high-speed wireless networks such as UMDA, EVDO, and WiMAX allow users to access full internet content. Developing a mobile client for MOS would allow Moms to sync with their full application while still remaining connected for contacts, appointments, and email access.

Sharing

While Moms may have the ability to create a template or print style, they may also desire the ability to share those creations with others. Allowing the export of templates or print styles to file and later import would allow Moms to share them with others.

Advertising

While in the beta phase, advertising revenue will not be collected. When MOS goes into wide release, the ability to display and track advertisement views and clicks would simplify administration-side revenue collecting.

Billing Management

While in the beta phase, customer revenue in the form of one-time or monthly billing will not be collected or managed. When MOS goes into wide release, the ability to easily handle billing on a monthly or license basis would simplify administration-side revenue collecting.

Content Management

While the personal information management capacity of MOS will allow Moms to free up their time with automated routines replacing their manual equivalent, an all-in-one solution which encompasses other realms of daily activity, such as blog post publishing, instant messaging, and other content management activities, would allow Moms to use one tool for many applications currently requiring separate tools. Additionally, content management may be handled by a desktop or web application version of MOS.

Mom's Office Suite—Back Office

Business analytics, Hosting, Customer Support, Member Management, Customer relationship management, Security, Data management

Third Party Integration

ePrize, Google Analytics, Google Adsense, SMS/Text messaging,

Google Gadget

Mom's Office Suite Web Site

Customer Support,

Additional Personal Information Management Capabilities

Email, calendar items, and task lists are the most common and necessary personal information management staples. Extended information management capabilities geared toward the target audience of Mom's could include but are not limited to financial administration, employee tracking, travel planning, and shopping list organization.

Business/Small Business
Business accounting/financial administration
Employee scheduling & management
Employee time & attendance
Employee payroll
Rental property management
Supplier management

Miscellaneous
Map/location
Carpool routing Genie
Multiple households
Pets
Message boards
Chat
Wiki boards
File/Photo Albums
Blogs/Journals
Office Applications
Polls/Surveys

User Profiles

Mom

Definition: This user is the administrator for MOS and the targeted user. She likely has a spouse or significant other, has children and other relatives (parents, in-laws) whom she coordinates with on a regular basis. She is likely active at her employment and likely engaged in politics, school, her community, charity functions, holiday events, and other activities. For family and household events for the purposes of MOS, she coordinates with others in a primary role to schedule events, staff, deliveries, and other common “Mom” tasks.

Benefit: MOS will allow Moms to complete tasks with very few, easy-to-follow steps. Custom printing will give Mom a hard-copy reproduction of the electronic view they are familiar with in MOS. Genies will allow Moms to create specific arrangements (rather than a generic appointment) on a variety of events applicable to Moms, and automate tasks associated with these arrangements. The MOS dashboard will allow busy Moms to get a view of their current day or week “at a glance”, including their email, to-do list, and appointments.

Partner

Definition: This has some administrative function ability with MOS. He likely shares children and other relatives (parents, in-laws) with whom he coordinates with on a regular basis alongside Mom. Similar to Mom, he is likely active at his employment and likely engaged in politics, school, his community, charity functions, holiday events, and other activities. For family and household events for the purposes of MOS, he coordinates with Mom through MOS in a secondary role to schedule events, staff, deliveries, and other common “Mom” tasks.

Benefit: MOS will allow Partner's appointments to be assigned by Mom, and automate tasks associated with these arrangements. Some light administrative functions will allow Partners to create appointments and to-do items. Custom printing will give Partners a hard-copy reproduction of the electronic view they are familiar with in MOS. The MOS dashboard will allow Partners to get a read-only view of the current day or week “at a glance”, to-do lists and appointments. The Partner's calendar permits the export of Partner-specific events and information for ease of importation into a work or other calendar system.

Child

Definition: This user has some very light administrative ability with MOS. This user coordinates with Mom on a regular, sometimes daily, basis to accomplish tasks. Children are likely active in school and extracurricular activities, including daily education, music or dance events, sports practice and competitions, doctor or dental appointments, church, and other activities. For family and household events for the purposes of MOS, children coordinate with Mom through MOS in a tertiary role to accept appointments, receive emails, and have their availability visible by Mom for schedule coordination.

Benefit: MOS will allow an immediate family member to be assigned tasks, appointments, and emails by Mom, and automate tasks associated with these arrangements. MOS will allow immediate family members to create appointments and to-do items, pending Mom's approval. Custom printing will give immediate family member a hard-copy reproduction of the electronic view they are familiar with in MOS. Child-specific calendars allow the export of calendar data for import into other calendaring systems, if desired. The MOS dashboard will allow family members to get a read-only view of the current day or week “at a glance”, to-do lists and appointments.

Staff

Definition: These users are varied and can be full-time staff, part-time staff, or occasional employees. Staff members may include maintenance employees such as housekeeping or gardening, or occasional work such as landscaping or babysitting. Staff members have additional data to track, such as arrival and departure schedule, planned activity, payment timeline, and special or expected needs. For the purposes of MOS, he or she coordinates with Mom through MOS in a tertiary, read-only role to accept scheduled events, receive emails, and limited view functionality.

Benefit: MOS will allow a staff member to be assigned tasks, appointments, and emails by Mom, and automate tasks associated with these arrangements. Additionally, MOS will allow all staff members to communicate with Mom through the same channel, allowing Mom to use one tool to manage disparate employees.

Proposed Business Processes and Usage Scenarios

For MOS, there are five groups of related usage scenarios. The first are the administrative activities required to create custom appointments for a variety of Mom-specific events. The second group includes the personal information management features through a user-friendly dashboard. The third group involves customized “family cards” modeled after electronic business cards that contain metadata familial relationships for easy searching of relatives and importing existing contact and calendar information from existing formats, including standards such as vCard, proprietary formats like Microsoft's ICS, or tabular data from well-defined CVS files. The fourth group includes custom WYSIWYG printing functionality of custom appointments, tasks, contacts, and dashboard. The fifth group includes custom Genies or macros which ease the process of calendar or contact data entry into the system. Additionally, a group of system scenarios are identified.

The high-level user scenarios documented below are not meant to be comprehensive use cases, but serve to document the usage scenarios from which a subset will become detailed use cases in the functional specification.

Custom Personal Information Management Scenarios
Appointment Scenarios
Create, read, update, and delete a child appointment
Create, read, update, and delete a adult appointment
Create, read, update, and delete a staff appointment
Create, read, update, and delete a delivery appointment
Import appointments

Genie Scenarios
Create, read, update, and delete a carpool genie
Create, read, update, and delete a correspondence genie
Create, read, update, and delete an emergency genie
Create, read, update, and delete an entertaining genie
Create, read, update, and delete a staff management genie
Create, read, update, and delete a finance management genie
Create, read, update, and delete a house management genie
Create, read, update, and delete a medical and dental appointment genie
Create, read, update, and delete an school year and rotation genie
Create, read, update, and delete a second home and household genie
Create, read, update, and delete a shopping genie
Create, read, update, and delete a team or organization season or year genie
Create, read, update, and delete a travel genie
Create, read, update, and delete a yard genie

Task Scenarios
Create, read, update, and delete a errand task
Create, read, update, and delete a call task
Create, read, update, and delete a correspondence task
Create, read, update, and delete other tasks
Sort task list
View task list
Set task style
Set task sort options
Set task placement

Dashboard Scenarios
View email filing cabinet, inbox, calendar, to-do list, and contact list
View email from inbox or other folders via Outlook email focus
View Mom's or others' calendar-specific events via Outlook calendar focus
View detailed to-do tasks and notes via Outlook's tasks focus
View detailed family cards via Outlook's contact focus
Customize Dashboard
Create, read, update and delete project dashboards

Contacts Scenarios

Import Scenarios
Import existing contacts from vCard files
Import existing contacts from well-known CSV or Excel spreadsheet files
Import existing calendar items from proprietary ICS files

Custom Contact Scenarios
Create, read, update, and delete a family card
Add members to a family card
Add custom fields to a member in a family card

Custom Print Scenarios
Print custom appointments: adult, child, delivery, staff
Print dashboard
Print custom tasks: call, correspondence, errand
Print customize calendar view
Print custom contacts: family card
Create calendar events and contact lists for the creation of a group activity

Other Scenarios
Refer a friend
Recover lost password

Solution Concept

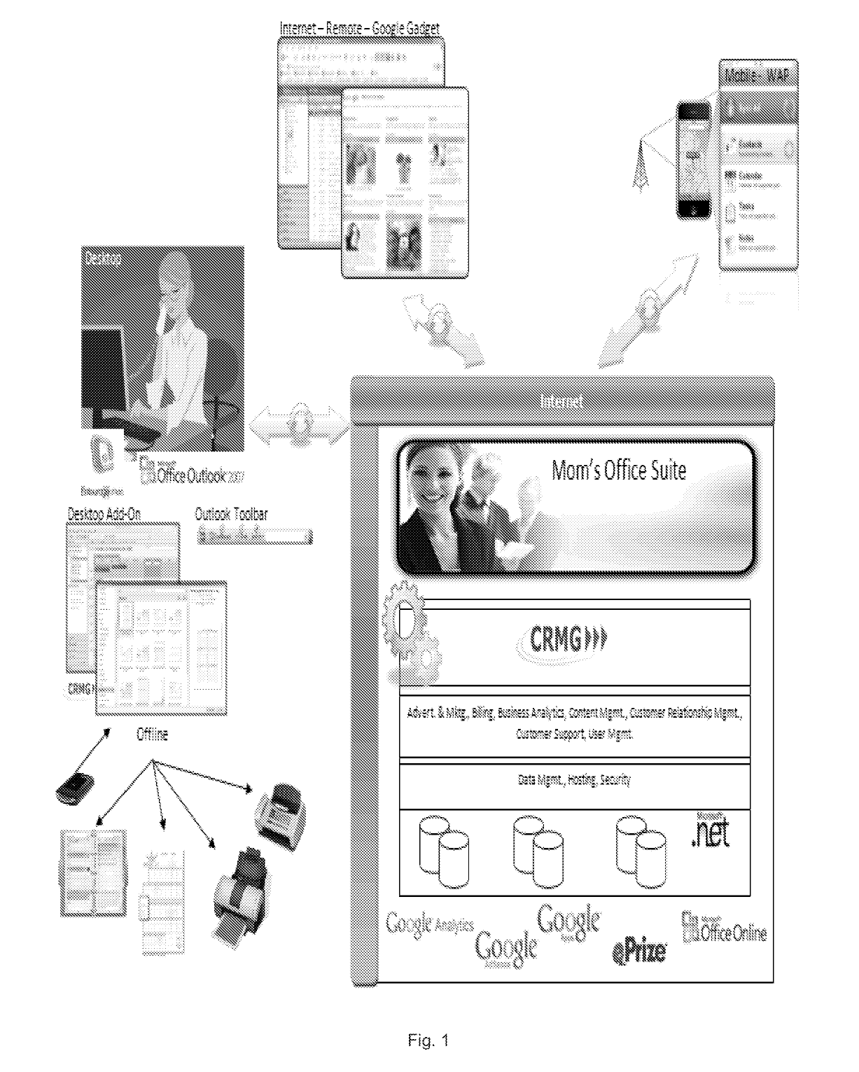

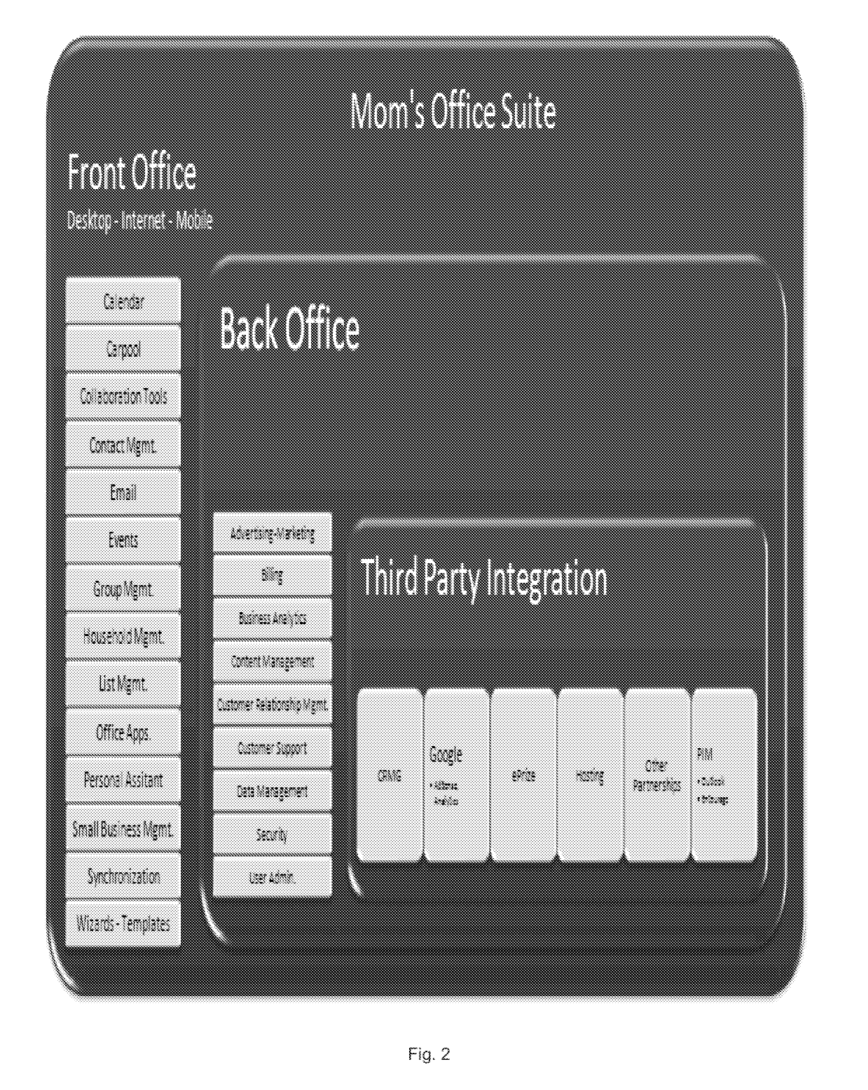

FIGS. 1 and 2 illustrate diagrams depicting the structure and functions of the proposed Mom's Office Suite architecture, illustrating the components, tools and technologies of the proposed suite and their relationship to each other after all the initiatives are complete.

MOS Outlook Add-In Conceptual Logical Solution Diagram

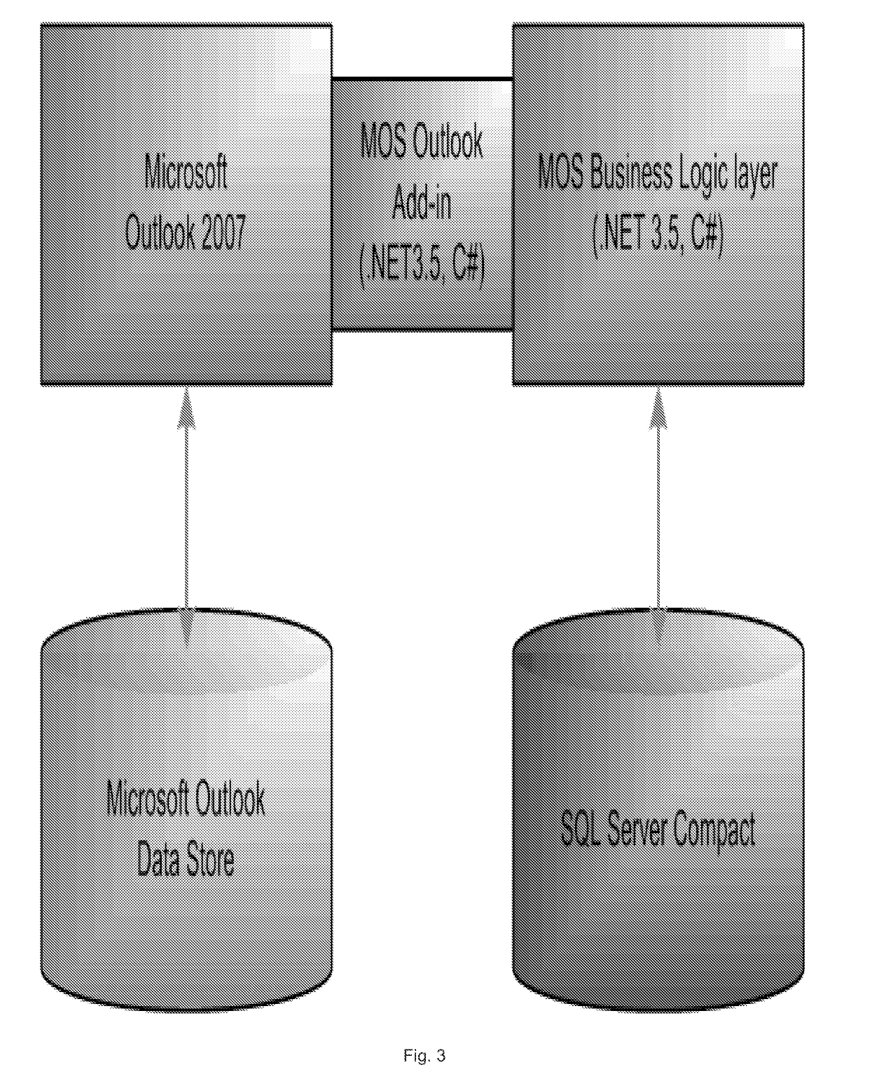

FIG. 3 displays the proposed MOS system. Microsoft Outlook 2007 is the proposed application into which a developed add-in application will be installed. This add-in will capitalize on Outlook's look and feel and will contain additional screens and Genies for custom workflows and dashboard. The add-in shall reference libraries that will contain the business logic for MOS, which will make use of a lightweight embeddable data store for information storage. Care will be taken to make the system architecture upwards compatible and swappable, keeping the add-in layer and data layer separate from the MOS business logic.

List of Proposed Features

The following list of proposed MOS features was generated from interviews with MOS staff or provided in the original MOS Requirements.

TABLE 6

| Feature Category | Features | Feature Description |
|---|---|---|
| Custom | New child appointment | Moms can create a new custom |
| Appointment | | appointment for a child (from |
| | | the proposed child scenarios) |
| | | using new streamlined Genies |
| | | and custom forms. |
| Custom | New adult appointment | Moms can create a new custom |
| Appointment | | appointment for an adult (from |
| | | the proposed adult scenarios) |
| | | using Genies and custom forms. |
| Custom | New staff appointment | Moms can create a new custom |
| Appointment | | appointment for a staff (from the |
| | | proposed staff scenarios) using |
| | | Genies and custom forms. |
| Custom | New delivery appointment | Moms can create a new custom |
| Appointment | | appointment for a delivery (from |
| | | the proposed delivery scenarios) |
| | | using Genies and custom forms. |
| Custom Tasking | New custom task | Moms can create a new task |
| | | (from the proposed task |
| | | scenarios) using Genies and custom |
| | | forms. |
| Custom Genie or | Automated sequence of steps | Moms may create, edit, or delete |
| Macro | | appointments, emails, or tasks |
| | | which trigger the system to |
| | | execute events. |
| Contacts | New family card | People will be associated with |
| | | families in a family card, similar to a |
| | | company card. |
| Contacts | New family member | Moms can create new members |
| | | and associate them with existing |
| | | families. |
| Contacts | Import contact | Moms can import existing |
| | | contacts from other known |
| | | sources and create new family |
| | | cards from them or add them to |
| | | existing families, |
| Contacts | Link contact | After a contact has been created |
| | | or imported, it can be linked to a |
| | | family card. |
| Dashboard | Dashboard | Mom can customized the view |
| | | of her email, calendar, and tasks on one |
| | | view. |
| Print Styles | Appointment printing | The custom appointment print |
| | | view will match its screen view. |
| Print Styles | Task printing | Printing a task offers a different |
| | | view from the screen view. |
| | | Custom task printing allows a |
| | | task to be printed in a |
| | | WYSIWYG manner. |
| Print Styles | Calendar printing | Printing a calendar offers a |
| | | different view from the screen |
| | | view. Custom calendar printing |
| | | allows a calendar to be printed |
| | | in a WYSIWYG manner. |
| Print Styles | Contact printing | Printing a contact offers a |
| | | different view from the contact |
| | | view. Custom contact printing |
| | | allows a contact to be printed in |
| | | a WYSIWYG manner, and with |
| | | additional relevant data for |
| | | family relationships. |
| Print Styles | Custom Printing | Custom printing allows for |
| | | configurable printing of different |
| | | components of MOS, such as |
| | | calendar and to-do list, in one |
| | | view. |

Risk Management

All goals have some level of risk attached to them. Below is a list of potential risks with a potential non-negligible level associated with it, and their mitigation plans. By identifying potential risks early, they may be diminished and possibly averted.

TABLE 7

| Goal | Associated Risk | Level | Plan for Mitigation |
|---|---|---|---|
| BG.1 | Custom appointments could be | Low | Focus groups will be utilized to |
| | confusing for Moms new to the | | validate the user-friendliness of |
| | system. | | the design prior to development. |
| BG.2 | The dashboard may not display | Medium | Assign technical minimum |
| | all components (email, | | specifications for screen size |
| | calendar, task list, etc.) for users | | with the expectation that the |
| | with smaller screens. | | target audience may have larger |
| | | | screen dimensions. |
| BG.4 | Relationships within a family | Medium | Limit family cards to an |
| | card may be difficult to | | immediate family unit and allow |
| | propagate for extended families | | contacts to belong to multiple family |
| | (e.g., a husband's brother's | | cards. |
| | wife's cousin). | | |
| BG.5 | The user interface required of a | Medium | Work closely with the president |
| | Microsoft Outlook 2007 Add-in | | of MOS and Mom focus groups |
| | may prevent some desired user | | to design wireframes and |
| | interface capabilities. | | horizontal prototypes to get the |
| | | | interface as close as possible to |
| | | | the desired result. |
| OG.1 | Microsoft Outlook 2007 may | Low | Utilize the separate data storage |
| | utilize its contact, task, | | as a mechanism to store metadata |
| | appointment, and calendar data | | about contacts. |
| | store in a way inconsistent with | | |
| | established standards, | | |
| | disallowing extension. | | |
| UG.1 | Microsoft Outlook 2007 may | Medium | Extensive research will be |
| | not provide a fully aesthetic | | conducted during the design |
| | experience for users in time for | | phase of the functional |
| | the beta deployment. | | specification. Additionally, a |
| | | | notice that the beta is geared |
| | | | toward testing functionality will |
| | | | be given. |
| TG.3 | Some Moms may not have an | Medium | Establish a means for using |
| | environment that includes | | VMWare or similar |
| | Microsoft Outlook 2007 or | | virtualization software for |
| | Windows XP/Vista. | | running Windows XP or Vista |
| | | | with Outlook installed. |

Additionally, long-term risks unassociated with goals will be mitigated using an iterative approach, with key milestones to determine the next phase of the overall program. At the completion of the FSD, a go/no-go decision will be made to determine the viability of beta development. If beta development is commenced, at the completion of that phase, a go/no-go decision for the initiation of a second development phase is warranted.

Next Steps

Next Phases

The next four phases for this effort should be:
Use case development as part of the functional specification
Design and planning as part of the functional specification
High-level user interface design with storyboard and mockups
Construction, stabilization and deployment as part of the development

Once this document is finalized, Denim Group will provide documentation for the next three phases as part of a functional specification document. This document will also include an estimate for the construction, stabilization and deployment phase.

Based on goals from MOS, efforts will be made to release an initial version of the application by the middle of June. This will give MOS time to conduct testing internally and with focus groups and release the proof-of-concept application prior to the summer. Additional phases can be initiated after that date.

Approximate Functional Specification Timeline

The timeline for the next steps are delineated below:
Use Case and Requirements Gathering
Technology Proof-of-Concept and System Design
High-Level User Interface Design
Functional Specification Document Composition
Functional Specification Document Delivery

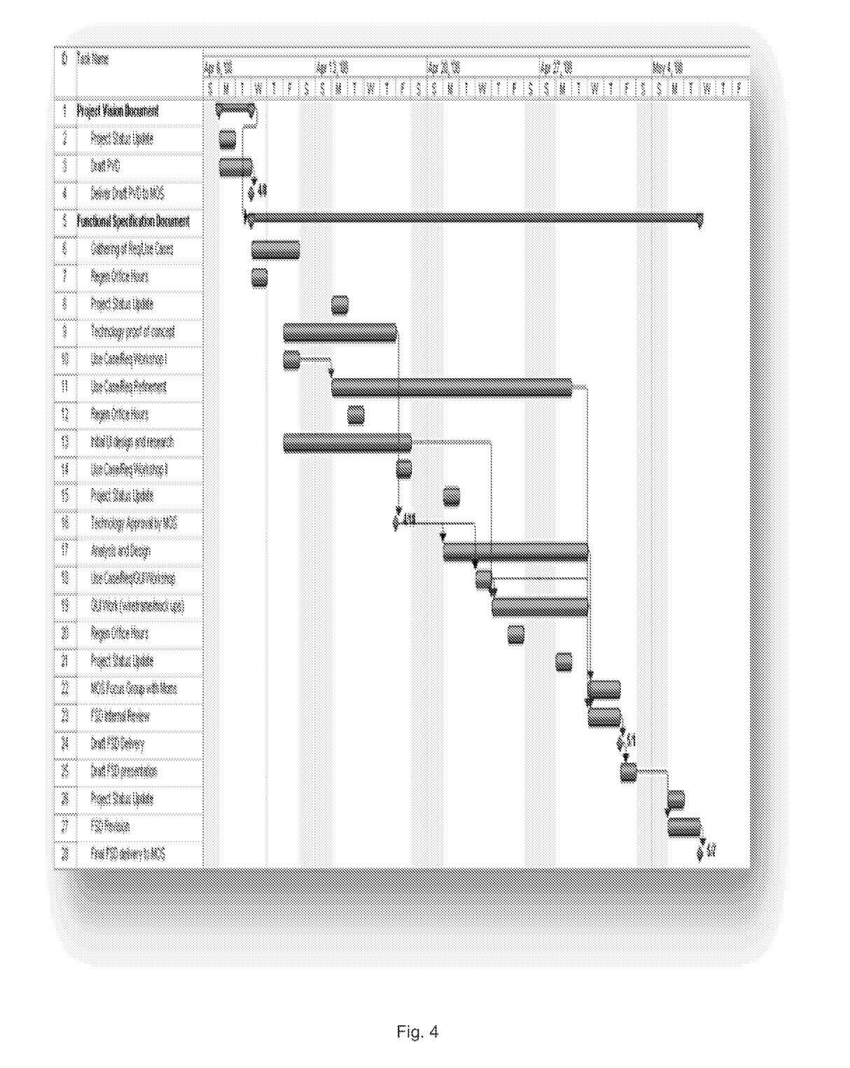

FIG. 4 further outlines the timeline as a detailed Gantt chart of approximate milestones.

Beta Development and Testing

Should Denim Group's bid be selected for the development and testing phase of MOS, the following high-level, sequential timeline is expected.

Development of MOS

Quality Assurance Testing on MOS

Delivery of MOS

MOS Beta Testing (handled by MOS)

Focus Group Feedback (gathered by MOS)

Evaluation and Determination of Future Version

FSD

Project Overview

Mom's Office Suite (MOS) is going to introduce into the marketplace a suite of personal management tools for upper-income Moms to automate, coordinate and simplify her job as a Mom. The MOS solution will enable Mom to use her time and talents to be more creative, meaningfully productive and available to her family by providing a suite of tools to assist her in effectively and efficiently accomplishing the many facets of her job.

MOS is for women who manage multiple people, houses and projects and need and want to operate more professionally so they can use their time and talents in a more rewarding manner—on their families and/or on meaningful work or projects. The first step in this process is a proof-of-concept or beta application to validate the value of the core set of MOS features and capabilities.

Opportunity Statements

Custom Appointment

Personal information management software such as Outlook and Thunderbird allow for creation of appointments that are very generic in nature and by design, allowing for a topic, location, and timeframe, and other miscellaneous information. While this is fine for businesses and light information management, MOS will provide more sophisticated and customized appointments for Moms.

Dashboards

The main entry point for the office suite will consist of a “dashboard”, similar to the “Today” screen in Microsoft Outlook. This entry point will allow the Mom to manage her calendar, tasks, contacts, emails and documents in her filing cabinet from a single screen (view). From here, clicking on specific sections will allow her to view details of the calendar, task, contacts, email or documents. Multiple dashboards may exist, containing related calendars and folders.

MOS Card

In a business setting, contacts are stored as electronic business cards and adhere to standard file formats such as vCard. Such contact information may include the person's name, email address, phone number, and other data, but very little relevant metadata for Mom. Adding metadata as an extension to the vCards format will allow familial relationships to be input and then searched for. MOS cards bring to the forefront how Mom views and interacts with her contacts/address book. Thus the address book shifts from focus on an individual to focus on families, with individuals now being members of a family and linked via their relationships to the MOS card.

Genies

Many current applications do not handle scenarios beyond individual appointments and tasks. Larger tasks, such as setting up a team or organization, or creating information for a school year, require many manual tasks that seem automatable. These genies, then, allow Mom to create and manage a complex set of interrelated appointments, contacts, emails and tasks to support her many responsibilities and daily activities. These genies will also provide a quick, intuitive and centralized way for Moms to set up and manage this information as well as automate many of the background activities (for example, schedule reminders or publish team calendars) associated with these projects. Moms will be guided through a series of steps, which will enable MOS to simplify and automate these projects.

Custom Print Styles

In modern business office suites that provide similar office-centric capabilities, the print view often differs from the monitor view due to the content of the screen, the layout of the monitor versus the paper, and other technical and aesthetic traits. For regular users of the application, with these printouts being supplementary, these differing views can be jarring. Providing a printout of the screen that closely matches the layout and content of the page will provide for a stronger consistency for the user as well as provide a more enjoyable, user-friendly experience. Moreover, a print view that captures the data from the current screen view in a clear, readable format will improve the intended functionality of printing. This will enable Moms to print calendar, tasks and contacts in a more user-friendly way, making it easier for Moms to read, understand and share.

Easy Entry of Data

Related to these statements, a simple method to quickly enter and/or import calendars, lists of appointments, tasks, and contacts that adhere to standard file formats such as vCard or ICS/VCS. The goal is to enable Moms to quickly enter large amounts of data such as a school, team and carpool schedule using “quick entry” tables, implementable as a table or grid view.

Project Vision Statement

Develop the MOS system to create a personal information management solution that is more user-friendly than existing current alternatives, and geared toward the busy mother, rather than a general purpose family or business application, in accordance with the requirements of MOS.

Audience

The audience for this application is women who manage multiple people (such as children, other family members, and employees), houses and projects who need or want to operate more professionally so they can use their time and talents in a more rewarding manner—on their families and/or on meaningful work or projects.

Mom is the administrator for MOS and the targeted user. She may have a spouse or significant other, children and other relatives (parents, in-laws) whom she coordinates with on a regular basis. She is potentially active at her employment and likely engaged in politics, school, her community, charity functions, holiday events, and other activities. For family and household events for the purposes of MOS, she coordinates with others in a primary role to schedule events, staff, deliveries, and other common “Mom” tasks.

MOS will allow Moms to complete tasks with very few, easy-to-follow steps. Custom printing will give Mom a hard-copy reproduction of the electronic view they are familiar with in MOS. Genies will allow Moms to create specific arrangements (rather than a generic appointment) on a variety of events applicable to Moms, and automate tasks associated with these arrangements. The MOS dashboard will allow busy Moms to get a view of their current day or week “at a glance”, including their email, files, tasks, and appointments.

Glossary

Function

The glossary identifies and defines the terms used throughout this document.

Solution Concept

The application is comprised of two parts. The host application will be Microsoft Outlook 2007, and is the proposed application into which a developed add-in application will be installed. This add-in will capitalize on Outlook's look and feel and will contain additional screens and Genies for custom workflows and dashboards. The add-in shall reference libraries that will contain the business logic for MOS, which will make use of a lightweight embeddable data store for information storage. Care will be taken to make the system architecture upwards compatible and swappable, keeping the add-in layer and data layer separate from the MOS business logic.

Software Solution Concept Diagram

Software Solution Concept Diagram Details

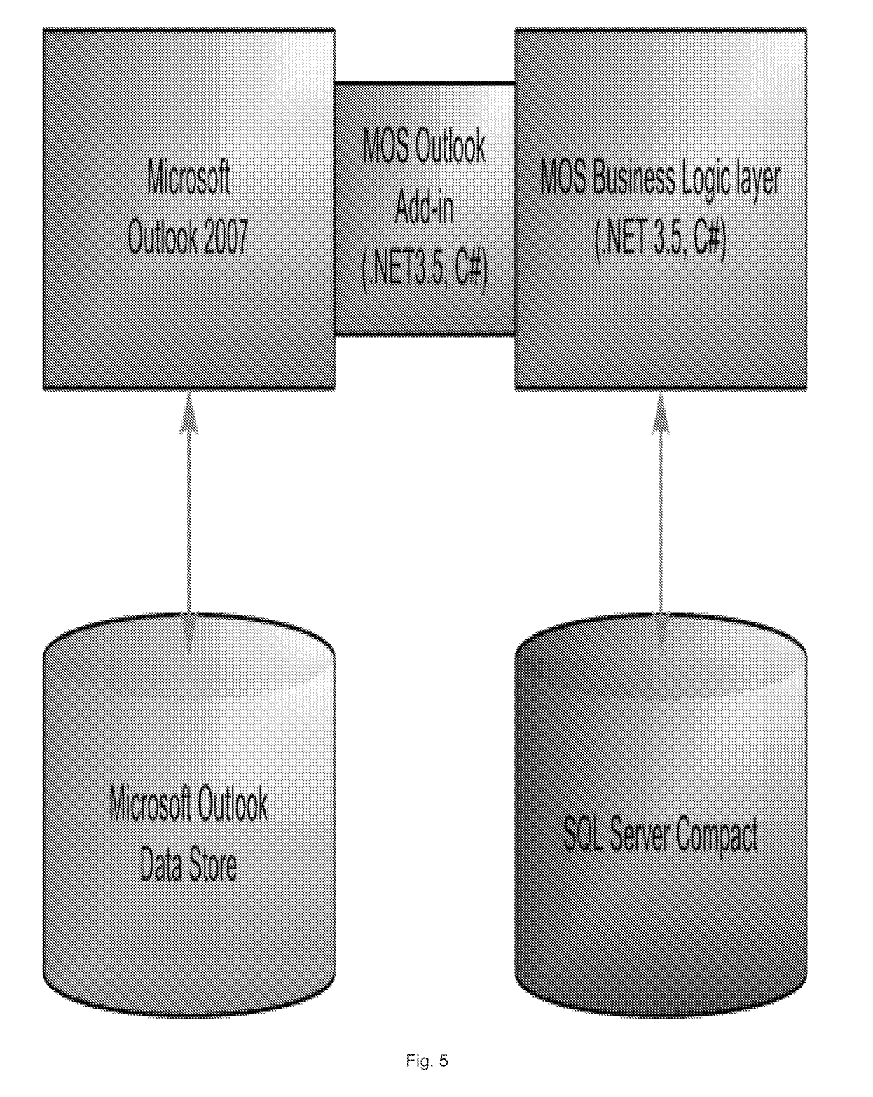

From FIG. 5, the existing Microsoft Outlook data store will continue to exist and be made use of by the MOS add-in. This data store will continue to contain Outlook-created and imported tasks, calendars, contacts, and emails. MOS-specific information, such as genies, custom appointments, and MOS cards, will make use of the data store when appropriate and use its own database for MOS-specific backend logic and metadata.

The business logic layer will be written in C# using the .NET 3.5 framework. The data layer will communicate with SQL Server Compact using LINQ-to-SQL and the ADO.NET framework.

Proposed Architecture

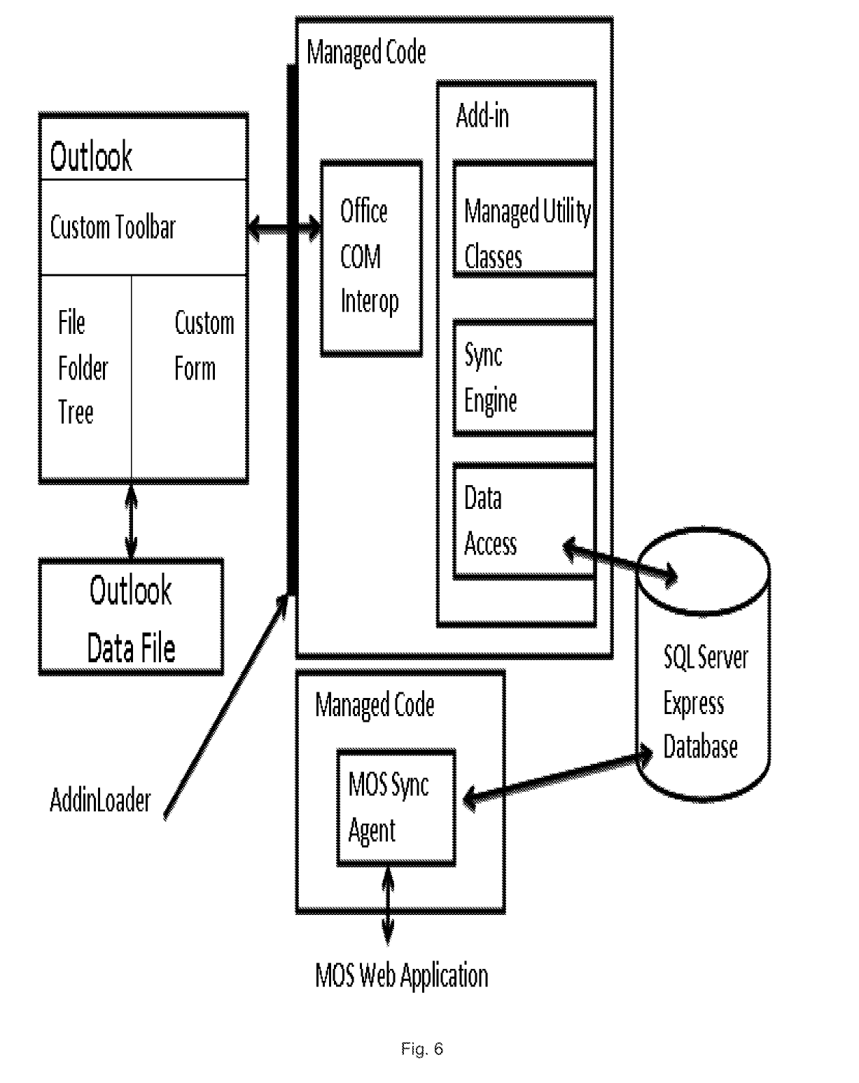

The architecture of the MOS application as an Outlook Add-in with SQL Server as an external data store is depicted in FIG. 6.

Advantages of Outlook Add-In

Microsoft Outlook is actually a PIM (Personal Information Manager), but it is essentially the standard in business today for individual email, contact and scheduling management. Microsoft Outlook falls a bit short on providing the advanced functions such as required in MOS. An easy solution would be to build an Outlook Add-in that can fill the gap in the functionalities that Outlook can offer against the MOS requirements.
Outlook integration: An add-in is actually built into Outlook and utilizes the powerful functions already present.
Outlook Data Store: Having all the information available within Outlook would be very useful.
Popularity of Outlook: Outlook is very popular and most people already have a good level of familiarity with it and the concepts, making training times for MOS Outlook Add-in shorter. This also makes acceptance of the add-in higher since the users feel like they already know the program concepts.
Integrated email features: Having access to MOS and email through the same program, Outlook, makes users more efficient and can make record management and storage a more centralized process.

Advantages to Using MS SQL Server

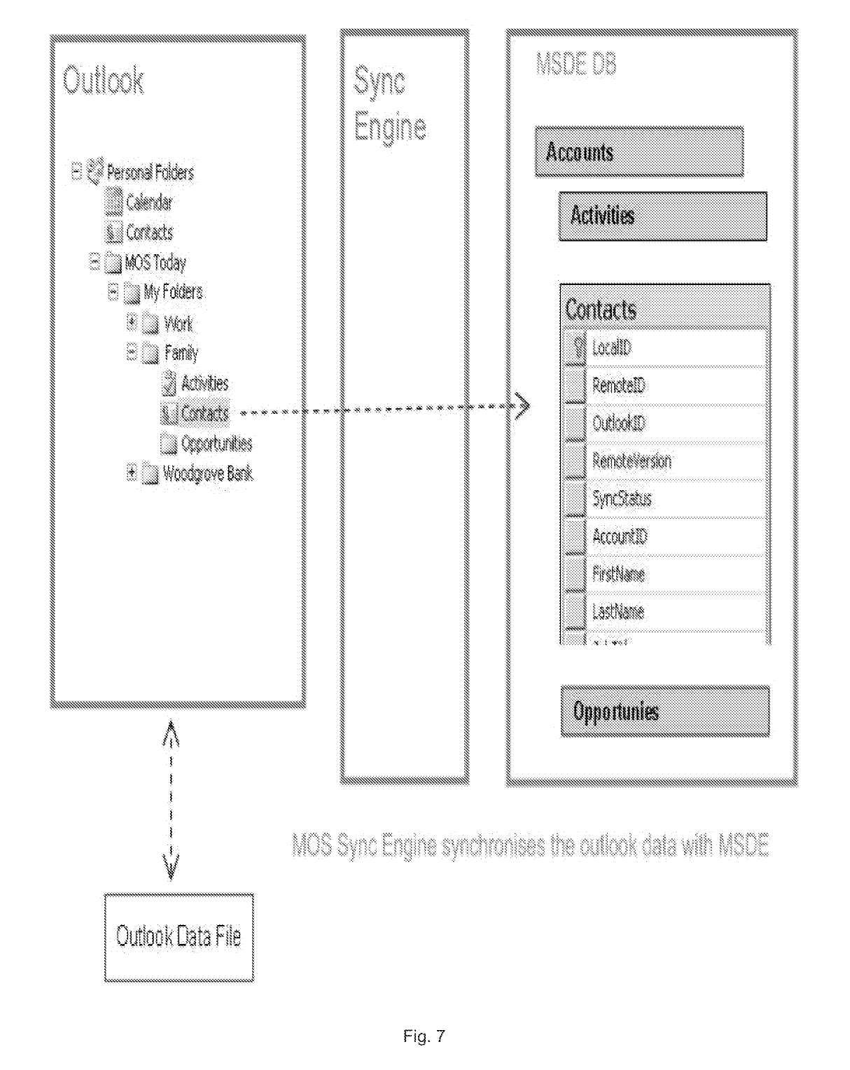

Storing all the data in Outlook Data Store can create storage issues as the Outlook profile has a storage size limit. However, storing the unique data in a separate but linked database can provide more data storage capacity and improve the product feature scalability. The architecture diagram using MS SQL Server as the database as depicted in FIG. 7.

Project Requirements

1.0 Architecture Requirements

TABLE 8

| Req. No | Definition |
|---|---|
| 1.1. | The application shall be a Microsoft Outlook add-in targeting |
| | Microsoft Outlook 2007. |
| 1.2. | The application shall be written in C# using the Microsoft |
| | .NET 3.5 framework. |
| 1.3. | The application shall communicate with the MOS database |
| | running on Microsoft SQL Server Compact 3.5 using LINQ-to- |
| | SQL and the Microsoft ADO.NET framework. |
| 1.4. | The application shall interoperate with the existing Outlook |
| | functionality to send emails and meeting requests. |
| 1.5. | The application shall interoperate with the existing Outlook |
| | functionality to add appointments, contacts and tasks to |
| | Mom's dashboards, folders, and calendars. |
| 1.6. | The application shall interoperate with the existing Outlook |
| | functionality to add contacts to Mom's contact list. |
| 1.7. | The application shall reference icon and graphics images |
| | at compile-time. |
| 1.8. | The application shall reference data field display labels at |
| | compile-time, enabling displayed fields labels to be revised |
| | without changing coded values or database fields. |

2.0 Users and Roles Requirements

TABLE 9

| Req. | |
|---|---|
| No | Definition |
| 2.1. | The application shall utilize Microsoft Outlook 2007 authentication |
| | and authorization mechanisms to authenticate and authorize users. |
| 2.2. | The application shall define read/write permissions to calendars |
| | based upon calendar type. |
| 2.3. | The application shall contain the following roles for calendar: |
| | primary, partner, child or senior, special occasions, employee, |
| | residence, or other (project). |

3.0 Data Store Requirements

TABLE 10

| Req. | |
|---|---|
| No | Definition |
| 3.1. | The application shall store configuration settings in its |
| | app.config file. |
| 3.2. | The application shall utilize the existing Microsoft Outlook |
| | data store for contacts, appointments, emails, and tasks. |
| 3.3. | The application shall utilize its database for extra MOS |
| | metadata and application data store. |
| 3.4. | The application shall create, read, update, and delete records |
| | for user-specific content in the database. |
| 3.5. | The application shall use parameterized SQL statements or |
| | language integrated queries to create, read, update, and delete |
| | records in the database. |
| 3.6. | The application shall store message templates for emails, |
| | appointments, and tasks in the database. |
| 3.7. | The application shall store labels for contact, appointment, |
| | tasks, and genie fields in the database. |
| 3.8. | The application shall store virtual folder locations for all items |
| | in the database. |

4.0 Dashboard Requirements

TABLE 11

| Req. No | Definition |
|---|---|
| 4.1. | The application shall allow for visibility of a mailbox, inbox, filing |
| | cabinet, calendar, and task list, dependent on the selection of a dashboard. |
| 4.2. | The application shall allow Mom to create one or more dashboards. |
| 4.3. | The application shall allow Mom to customize the dashboard's color and |
| | name. |
| 4.4. | The application shall allow Mom to select which order to view a |
| | dashboard's contents. |
| 4.5. | The application shall allow Mom to select how calendars in the dashboard |
| | may be viewed-from day, week, month, list, or range-and on which day |
| | to start. |
| 4.6. | The application shall allow Mom to sort tasks in the dashboard by title, type, |
| | folder, dashboard, category, or deadline. |
| 4.7. | The application shall allow Mom to delete a Mom-created dashboard. |
| 4.8. | The application shall disallow Mom from deleting the default dashboard. |
| 4.9. | The application shall disallow Mom from creating a dashboard within |
| | another dashboard or folder. |
| 4.10. | The application shall allow Mom to move items from one folder/dashboard to |
| | another using drag-and-drop movements or deletion. |
| 4.11. | The application shall change the dashboard view based on a selected folder |
| | or dashboard. |
| 4.12. | The application shall change the color of calendar appointments and tasks |
| | to match the folder or dashboard color they are “filed” in. |
| 4.13. | A finite number of Dashboard templates/layout options vs. completely |
| | customizable (Beta). |

5.0 Appointment Requirements

TABLE 12

| Req. No | Definition |
|---|---|
| 5.1. | The application shall allow Mom to create custom appointments. |
| 5.2. | The application shall allow Mom to input appointment details about |
| | materials, drivers, RSVP, notifications, reminders, sitters, reservations, and |
| | charity events. |
| 5.3. | The application shall allow Mom to choose whether the attendee's |
| | attendance is required, optional, or an FYI (“let's discuss”) when the |
| | appointment is assigned to another calendar. |
| 5.4. | The application shall require Mom to complete the Driver tab when the |
| | appointment is assigned to a child or senior calendar. |
| 5.5. | The application shall require Mom to complete the Notification tab if |
| | school notification is selected in the Details tab. |
| 5.6. | The application shall send reminder emails to Mom at a configurable time |
| | before the scheduled appointment if a driver has yet to be scheduled. |
| 5.7. | The application shall add an RSVP to Mom's task list if an RSVP is not |
| | selected as completed in the RSVP tab for appointments requiring an RSVP. |
| 5.8. | The application shall add a task assignment to each person assigned a |
| | material in the Materials tab. |
| 5.9. | The application shall assign appointments to each primary calendar, |
| | secondary calendar, and optional attendee listed in the Details tab. |
| 5.10. | The application shall assign appointments to each driver entered in the |
| | Driver tab. |
| 5.11. | The application shall deliver a notification email for each recipient listed in the |
| | Notifications tab. |
| 5.12. | The application shall assign a task for each recipient to be printed or |
| | phoned in the Notifications tab. |
| 5.13. | The application shall deliver a reminder email for each recipient listed in |
| | the Reminder tab. |
| 5.14. | The application shall deliver the sitter request and handle acceptances or |
| | declinations of each sitter. |
| 5.15. | The application shall deliver the driver request and handle acceptances or |
| | declinations of each driver. |
| 5.16. | The application shall send an email notification if every sitter declines. |
| 5.17. | The application shall send an email notification if either driver declines. |
| 5.18. | The application shall deliver the charity event request and handle |
| | acceptances or declinations of each potential attendee. |
| 5.19. | The application shall send an email notification of the accept/decline status |
| | of each charity event potential attendee to Mom at a configurable time |
| | prior to the event. |
| 5.20. | The application shall send an email notification to Mom if fewer potential |
| | attendees accept than are seats at the charity event. |
| 5.21. | The application shall add a task assignment to the person to handle the |
| | reservations listed in the Reservation tab. |
| 5.22. | The application shall send an email reminder to Mom if the task is not |
| | completed within a configurable timeframe. |
| 5.23. | The application shall send an email notification to Mom if a reservation |
| | cannot be completed. |
| 5.24. | The application shall allow Mom to delete a custom appointment. |
| 5.25. | The application shall color (‘mark’) appointments to match the calendar(s) |
| | and/or dashboard(s) the appointment is ‘filed’ in. |
| 5.26. | The application shall customize the background color or icons of each |
| | calendar in the calendar view. |
| 5.27. | The application shall allow Mom's to install and turn on/off (“enable”) |
| | appointment tabs independently and individually. |

6.0 Calendar Requirements

TABLE 13

| Req. No | Definition |
|---|---|
| 6.1. | The application shall allow Mom to create one or more calendars. |
| 6.2. | The application shall allow Mom to assign one or more calendars to a |
| | dashboard. |
| 6.3. | The application shall allow Mom to move a calendar into another calendar |
| | or folder. |
| 6.4. | The application shall allow Mom to give a calendar a name, type, and |
| | color. |
| 6.5. | The application shall enable staff hours and compensation tabs when the |
| | calendar is of type staff. |
| 6.6. | The application shall allow Mom to input a staff member's schedule into a |
| | staff calendar. |
| 6.7. | The application shall assign appointments to each staff calendar based on the |
| | schedule of the staff member's schedule. |
| 6.8. | The application shall store staff hire information. |
| 6.9. | The application shall allow a calendar to be printed. |
| 6.10. | The application shall allow customization of appointment information, |
| | displaying location, drivers, phone numbers, notes, and work or vacation hours. |
| 6.11. | The application shall allow the task list to be printed with the calendar, in |
| | either top-down or left-right order. |
| 6.12. | The application shall allow Mom to delete a calendar. |

7.0 Filing Cabinet Requirements

TABLE 14

| Req. No | Definition |
|---|---|
| 7.1. | The application shall have one filing cabinet. |
| 7.2. | The application shall allow Mom to create a folder and assign |
| | it to a filing cabinet. |
| 7.3. | The application shall allow Mom to select a color and |
| | keywords to a folder. |
| 7.4. | The application shall apply the tagged keywords against the |
| | from and subject fields of each email in the inbox. |
| 7.5. | The application shall apply the tagged keywords against the |
| | names of each contact in the contact list. |
| 7.6. | The application shall allow Mom to move folders from one |
| | folder or dashboard to another. |
| 7.7. | The application shall allow Mom to delete a folder. |
| 7.8. | The application shall allow Mom to move an email, task, file, |
| | or contact to a folder. |
| 7.9. | The application shall allow Mom to view emails, tasks, files, or |
| | contacts as a list using a filter. |

8.0 MOS Card Requirements

TABLE 15

| Req. No | Definition |
|---|---|
| 8.1. | The application shall allow Mom to create a family card. |
| 8.2. | The application shall allow Mom to create a business card. |
| 8.3. | The application shall allow a contact to be added to a family card. |
| 8.4. | The application shall allow a MOS card to be convertible between family |
| | and business cards. |
| 8.5. | The application shall allow a MOS card to be converted to a regular |
| | Outlook contact. |
| 8.6. | The application shall allow a contact to be converted to a MOS card. |
| 8.7. | The application shall link primary and secondary contacts in a family card. |
| 8.8. | The application shall link assistants to any primary and secondary contact in a |
| | family card. |
| 8.9. | The application shall link zero or more children to the primary and |
| | secondary contact of a family card. |
| 8.10. | The application shall link primary and secondary homes to the primary and |
| | secondary contacts of a family card. |
| 8.11. | The application shall allow Mom to print a MOS card. |
| 8.12. | The application shall allow Mom to split a family card. |
| 8.13. | The application shall allow Mom to delete a MOS card. |
| 8.14. | The application shall color (‘mark’) a MOS card to match the calendar(s) |
| | and/or dashboard(s) the appointment is ‘filed’ in. |

9.0 Task Requirements

TABLE 16

| Req. No | Definition |
|---|---|
| 9.1. | The application shall allow Mom to create an errand task. |
| 9.2. | The application shall allow Mom to create a call task. |
| 9.3. | The application shall allow Mom to create a correspondence |
| | task. |
| 9.4. | The application shall allow Mom to create an “other” task. |
| 9.5. | The application shall allow Mom to set task font preferences for |
| | errand, call, and correspondence tasks. |
| 9.6. | The application shall send a reminder email to Mom if the task |
| | is not completed if the email reminder MOS preference is set. |
| 9.7. | The application shall color (‘mark’) a Task to match the |
| | calendar(s) and/or dashboard(s) the appointment is ‘filed’ in. |

10.0 Setup and Helper Genie Requirements

TABLE 17

| Req. No | Definition |
|---|---|
| 10.1. | The application shall walk Mom through Initial Setup. |
| 10.2. | The application shall reformat Outlook contacts into MOS cards. |
| 10.3. | The application shall allow Mom to quickly enter calendar |
| | appointments. |
| 10.4. | The application shall allow Mom to quickly enter MOS cards. |

11.0 School Year Setup

TABLE 18

| Req. No | Definition |
|---|---|
| 11.1. | The application shall allow Mom to set up a school year. |
| 11.2. | The application shall allow Mom to enter school information for the year. |
| 11.3. | The application shall create a business card for the school. |
| 11.4. | The application shall allow Mom to assign a child to the school as primary |
| | calendar. |
| 11.5. | The application shall allow Mom to enter school calendar data into the |
| | School Year form. |
| 11.6. | The application shall add the school calendar data as appointments to the |
| | calendar of primary and secondary calendars entered. |
| 11.7. | The application shall allow Mom to enter the contact information of the |
| | child's advisor, room mom, classmates, and classmates' parents to the |
| | School Year form. |
| 11.8. | The application shall create a email distribution list for the child's |
| | calls/room. |
| 11.9. | The application shall create a MOS card for the advisor, room mom, and |
| | classmates using their contact information. |
| 11.10. | The application shall track the rotation day of the school based on the day |
| | start date and number of days in the rotation and place the rotation day on |
| | the appropriate dates on designated calendars. |
| 11.11. | The application shall allow Mom to enter school activities to the School Year |
| | form. |
| 11.12. | The application shall add the activity to each calendar as an appointment to the |
| | assigned calendars. |
| 11.13. | The application shall allow for sharing and publishing of the school year |
| | and grade level information. |
| 11.14. | The application shall deliver one email per School Year Setup form to each |
| | recipient. |
| 11.15. | The application shall allow Mom to set School Year Setup form options. |
| 11.16. | The application shall place the School Year in the appropriate Dashboard |
| | or Folder. |

12.0 Organization/Team Genie Requirements

TABLE 19

| Req. No | Definition |
|---|---|
| 12.1. | The application shall allow Mom to setup an Organization/Team. |
| 12.2. | The application shall allow Mom to assign one or more children to the |
| | Organization/Team as primary calendar. |
| 12.3. | The application shall allow Mom to assign a name, dashboard, and color to the |
| | organization. |
| 12.4. | The application shall allow Mom to enter the contact information of the |
| | team's coach/leader, assistant coach/leader, teammates, and teammates' |
| | parents to the Organization/Team genie. |
| 12.5. | The application shall create a MOS card for the coach/leader, assistant |
| | coach/leader, and teammates using their contact information. |
| 12.6. | The application shall create an email distribution list for the |
| | organization/team. |
| 12.7. | The application shall add the team schedule to each calendar as an |
| | appointment to the assigned calendars. |
| 12.8. | The application shall add a task assignment to each person assigned a |
| | material in the Materials tab. |
| 12.9. | The application shall deliver a reminder email for each recipient listed in |
| | the Reminder tab. |
| 12.10. | The application shall allow Mom to share or publish the |
| | Organization/Team roster, schedules, and assignments. |
| 12.11. | The application shall allow Mom to delete an Organization/Team genie. |
| 12.12. | The application shall deliver one email per Organization/Team genie to |
| | each recipient. |
| 12.13. | The application shall allow Mom to set Organization/Team genie options. |
| 12.14. | The application shall create a Dashboard or Folder for the Organization |
| | Team. |

13.0 Carpool Genie Requirements

TABLE 20

| Req. No | Definition |
|---|---|
| 13.1. | The application shall allow Mom to create a carpool. |
| 13.2. | The application shall allow Mom to name and set dates for |
| | carpooling. |
| 13.3. | The application shall assign carpool events given an input roster. |
| 13.4. | The application shall allow Mom to assign drivers for the |
| | carpool. |
| 13.5. | The application shall deliver a reminder email for each driver |
| | listed. |
| 13.6. | The application shall add the carpool schedule to each calendar |
| | as an appointment to the assigned calendars. |
| 13.7. | The application shall allow Mom to delete a Carpool genie. |
| 13.8. | The application shall deliver one email per Carpool genie to each |
| | recipient. |
| 13.9. | The application shall allow Mom to set Carpool genie options. |
| 13.10. | The application shall create a Dashboard or Folder for the |
| | Carpool. |
| 13.11. | The application shall create an email distribution list for the |
| | Carpool roster. |

14.0 Messaging Requirements

TABLE 21

| Req. No | Definition |
|---|---|
| 14.1. | The application shall deliver one email per genie or custom |
| | appointment to each recipient. |
| 14.2. | The application shall store email and appointment templates |
| | in the database. |
| 14.3. | The application shall send email to Mom for tasks as reminders |
| | in Custom Appointments and Genies. |
| 14.4. | The application shall accept meeting request responses for |
| | drivers, sitters, charity events, and carpools. |
| 14.5. | The application shall send email reminders at a configurable |
| | time in advance of the event. |
| 14.6. | The application shall send all emails and appointments with a |
| | standard MOS footer. |

15.0 Custom Print Styles

TABLE 22

| Req. No | Definition |
|---|---|
| 15.1. | The application shall extend the built-in Outlook printing |
| | capabilities by providing additional options. |
| 15.2. | The application shall provide a WYSIWYG view of the calendar |
| | and task list selected for printing. |
| 15.3. | Configurable labels for custom fields/columns. |

16.0 Easy Entry of Data

TABLE 23

| Req. No | Definition |
|---|---|
| 16.1. | Quick entry tables will be developed to enable Mom's to |
| | quickly enter series/lists of dates or contacts which upon |
| | completion of entry of the list will be created into individual |
| | dates or contacts. |
| 16.2. | Quick Entry tables will contain required, optional and custom |
| | fields. MOS will ensure at least the required fields are completed |
| | in each table and enable Mom to edit and/or add data fields |
| | (columns). |
| 16.3. | Configurable labels for custom fields/columns. |

17.0 Security

TABLE 24

| Req. No | Definition |
|---|---|
| 17.1. | MOS Solution will bypass all Outlook security restrictions |
| | and will integrate with Outlook in a Seamless and |
| | transparent manner. |
| 17.2. | Mom will never see the standard Outlook security prompt |
| | (“Another program is trying to access the data stored in Outlook. |
| | Do you want to allow this?”). |

Minimum Technical Specifications—Table 25

TABLE 25

| Req. | | |
|---|---|---|
| No | Category | Definition |
| T.1. | Infrastructure | Desktop application |
| T.2. | Screen Size | 1024 × 768 |
| T.3. | Deployment | Application: |
| | Platforms | Microsoft Outlook 2007 |
| | | .NET 3.5 Framework |
| | | Database Server |
| | | SQL Server Compact 3.5 |
| | | Client Machine: |
| | | Microsoft Windows XP |
| | | Microsoft Windows Vista |
| T.4. | User | Authentication and authorization will be managed |
| | Authentication | by Microsoft Outlook 2007 and the Windows |
| | | Operating System. |
| T.5. | Event Logging | Errors and events will be logged to the event log |
| | | or database. |
| T.6. | Integration | Add-in code will be written in C# using the |
| | | Microsoft .NET framework. Data Access code |
| | | will be written in C# using LINQ-to-SQL and the |
| | | ADO.NET framework. |

Application Approach

Microsoft Outlook Add-In

The business logic of MOS will be contained within a Microsoft Outlook Add-in. Developing MOS as an add-in allows for the common functionality of Microsoft Outlook to be extended to give it the extra capabilities that meet the requirements of MOS.

The creation of new MOS business logic requires modifications to the existing Microsoft Outlook Presentation Layer. MOS's forms will be implemented using Outlook Forms. Outlook Forms may be created in a number of implementations:
Add a new page to an existing form
Add a new form region to an existing form
Append to an existing form
Replace the default page of a form
Replace the entire existing form

These existing forms can be any of the standard message classes (appointment, contact, distribution list, journal entry, mail message, post, RSS, or task) or can be a custom message class. The Outlook Form can implement multiple of these (for example, a meeting request could be featured both on New Appointment and New Message), and have access to all of the features that each form region has available.

The largest advantage to implementing MOS as a Microsoft Outlook Add-in is in utilizing the resources that Microsoft Outlook provides. To this end, MOS will utilize the business functionality of Microsoft Outlook (email, appointment creation, calendars) as the building blocks for MOS's custom appointments and genies. Moreover, MOS will capitalize on modules and services that Microsoft Outlook provides, including its forms, reminders, contacts, and recurrence patterns.

Install

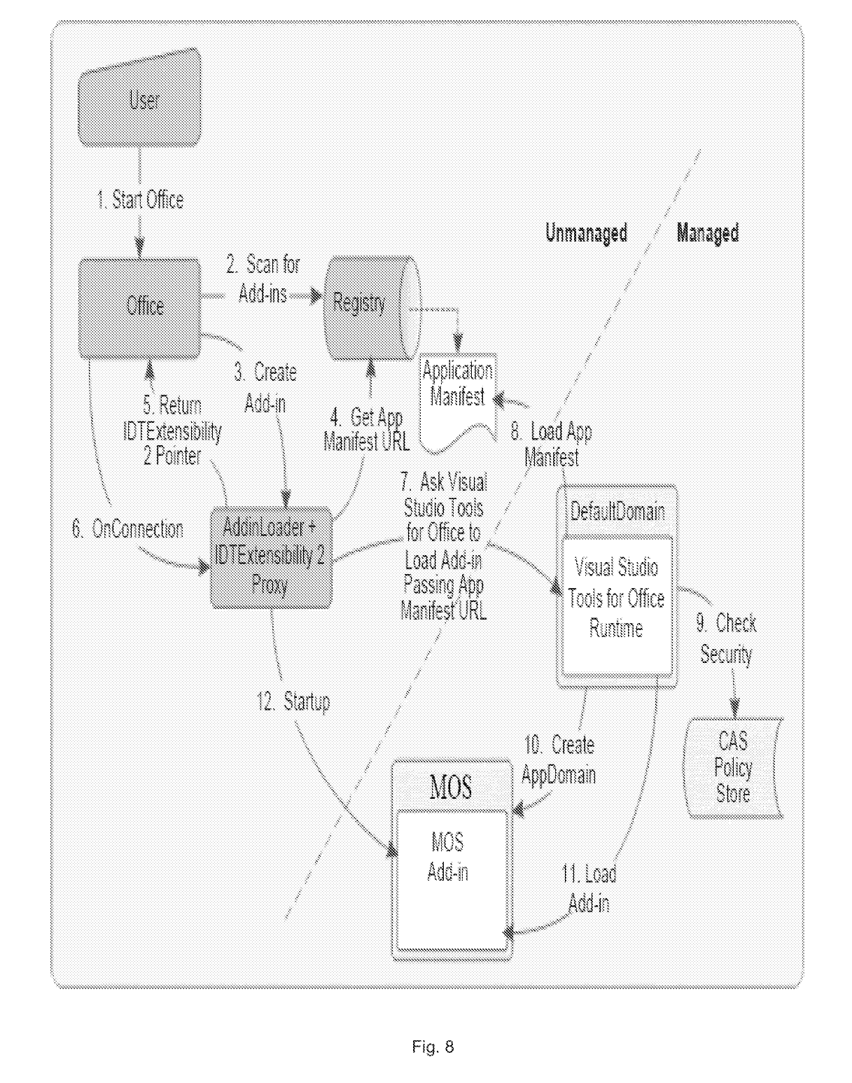

Functionality for creating an installer for a Microsoft Outlook 2007 Add-in is a standard part of Microsoft's libraries and Visual Studio 2008 and can be seen in FIG. 8. Publishing the add-in creates a setup executable which, when run, prompts the user to install the module as an Outlook add-in. The user is guided through the process to completion. Microsoft's .NET 3.5 Framework will be installed as part of the installation process.

MOS will utilize a third-party installation packaged (Wise Installer or Install Shield) for product deployment in all phases of development.

Uninstall

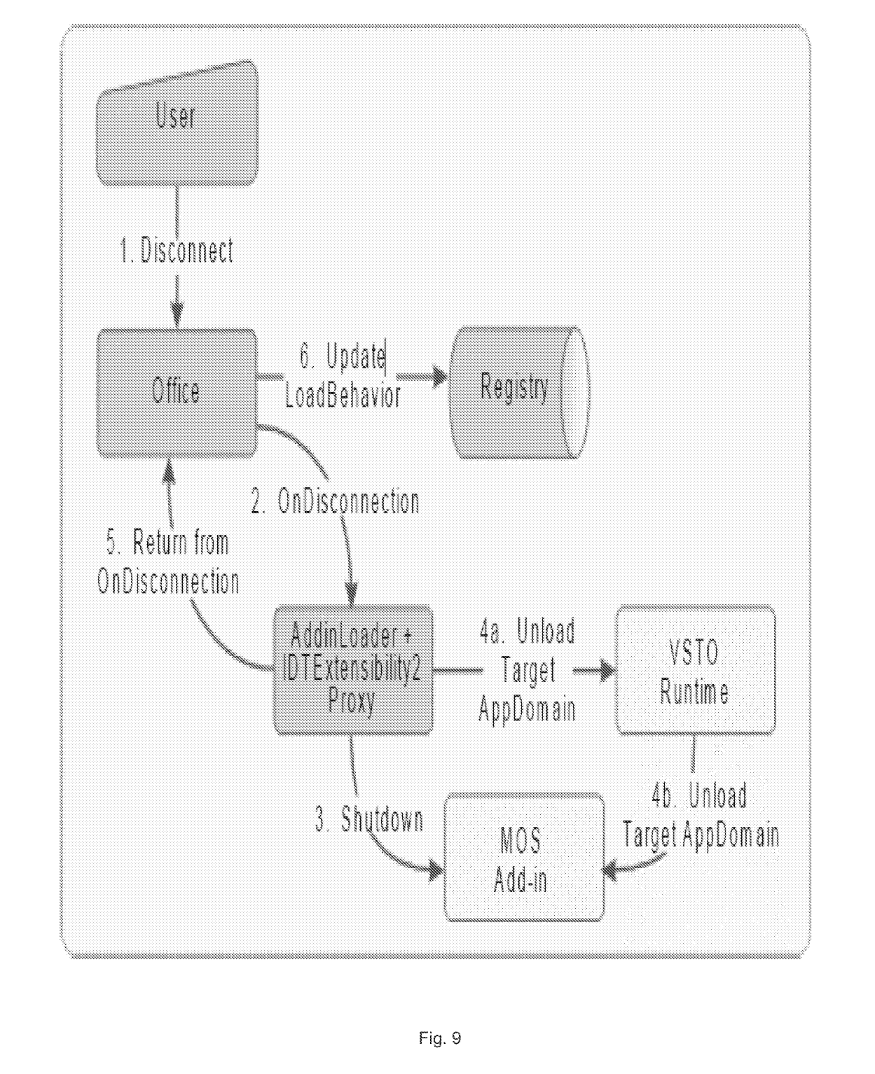

The uninstall of MOS will be a two-step process. In the Trust Center, the MOS add-in can be turned off or removed and can be seen in FIG. 9. To complete the removal of the add-in, the removal process must continue through Add/Remove Programs, where the add-in is listed as its own program, not under the Microsoft Outlook Add-Ins section of Add/Remove. Without taking this step after removing the add-in from Outlook, errors may be exhibited when accessing certain elements of Outlook.

Custom Appointments

Custom appointments will be created as a form with tabs for more detailed information on the appointment, captured in the Details, Materials, Driver, RSVP, Notification, Reminder, Sitter, Reservation, and Charity Event tabs.

The user will be shown the appointment creation process as a series of steps, although Mom may skip steps by clicking on a specific tab, and may save her process at any time for later completion. After each step, validation of the custom appointment will occur to validate the input data. Once the appointment has been completed, MOS will use existing Outlook functionality to deliver emails, add contacts, send meeting requests, assign tasks, and set appointments.

MOS Cards

Contacts will be uniquely identified using session and permanent IDs within the local Outlook data store. Their links to one another will be contained within the database, referencing the contacts' session and permanent IDs. MOS cards will contain one or more contacts linked relationally. Merging or splitting contacts will be a matter of linking or unlinking the contacts structure within the database. Creating a MOS card will create contacts and attach them in the same manner.

Genies

Custom genies are step-by-step processes to walk Mom through otherwise complicated manual procedures. Genies for setting up organizations and teams and carpools will enable Mom to easily and automatically manage traditionally manual approaches.

Mom will be walked through each genie as a series of steps, although Moms may skip steps by clicking on a specific tab during the edit of existing genies. Mom may save her process at any time for later completion. After each step, validation of the current screen will occur to validate the input data. Once the genie has been completed, MOS will use existing Outlook functionality to deliver emails, add contacts, send meeting requests, assign tasks, set appointments, create documents and folders, and other processes as part of the genie's logic.

Dashboard

Displaying Mailbox and Calendar

Mom will be provided with an at-a-glance view of all her mail, calendars, dashboards, contacts, files, genies, MOS card and tasks similar to the Outlook Today.

Filing Cabinet

The filing cabinet will contain dashboards, and those dashboards in turn will contain folders and calendars. Folders may contain other folders, and each folder will have built-in filters for viewing contacts, emails, tasks, files, and appointments. Dashboards will reside at the top-level and cannot be contained within other dashboards or folders. Selecting a dashboard in the fining cabinet will replace the current view of the today screen with the selected dashboard's view. By default, one dashboard will be installed with the add-in and cannot be deleted.

Because many copies of the same file (such as an email, attachment, or a contact) may be placed in different folders, the filing cabinet will display the items within as they appear but internally store these items as references rather than physical copies. Contacts, tasks, and the like have pre-assigned locations by Outlook that will remain the same. For emails and their attachments, MOS will store them into a central repository, and will reference them when selected in the filing cabinet. This repository will be stored on the local file system and may be backed up by standard backup software. One thing of note: there is no relationship between the filing cabinet and Outlook categories, so a user is free to use pre-existing Outlook categories without fear of modifying MOS behavior.

Outlook Functionality

Email

Sending email using Microsoft Outlook is straightforward. MOS will create a Mail Message object using the appropriate message template and with its recipients listed. The email will then be sent using the email server and the credentials provided by Outlook.

Meeting Request

For the process of sending a meeting request, MOS will use the Appointment Outlook Form with its recipients listed and status set to “Meeting”. Saving the current Appointment item will create a new appointment and send requests to the list of recipients if the appointment has the appropriate meeting status set.

Appointments

Appointments are treated similarly to meeting requests in Outlook, with the status set to “Appointment” and no recipients listed. Similar to the meeting request, saving the current Appointment item will create a new appointment to the specified calendar.

Contacts

MOS will extend the concept of the contact into Family and Business cards, with extra content and metadata stored in the MOS database. For business cards, the extra information associated with the card will be small and contained as fields within the MOS database. For MOS cards, the number of fields will be much larger, and the metadata to link contacts together will be activated.

Tasks

MOS will create a task with assigned colors using the Outlook Task Item type. By default, there are 25 color categories built into Outlook, which can be named and utilized when creating a task. A task can use as many of these as desired, including the defaults such as “Red Category.” MOS will assign subjects and attach content to a task, as well as deadlines and date/time reminders. Tasks may be assigned to any calendar in MOS.

Calendars

MOS will use the existing calendar functionality for appointment, meeting requests, and availability, and attach extra metadata about the calendar in the MOS database for later use. Creating a default outlook calendar and adding appointments to it through the Outlook Calendar type is straightforward.

Database Schema

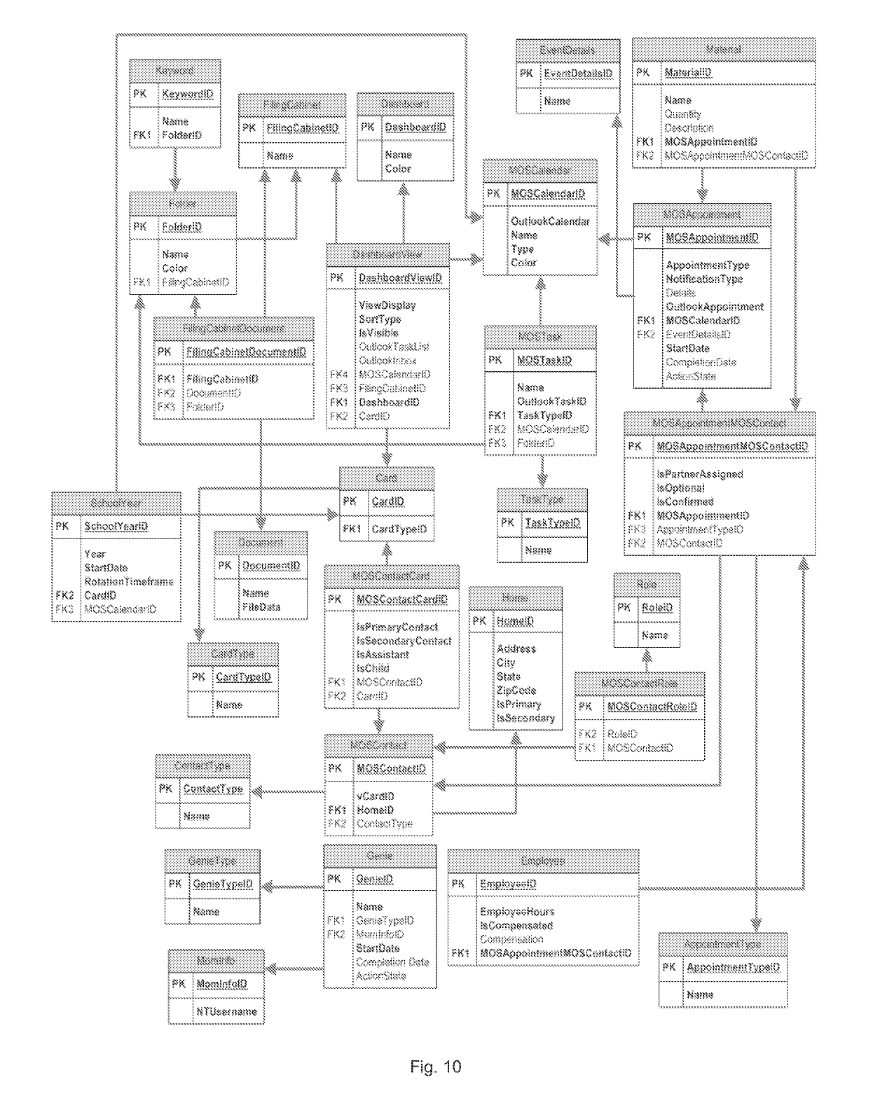

The database schema shows tables and their relationships in the system database. Options (such as preferences, options, and settings) may be stored in a configuration file. FIG. 10 shows the database schema for MOS. Additional data used by Outlook can be found at the MSDN Office Developer Center at http://msdn.microsoft.com/en-us/library/bb176619.aspx .

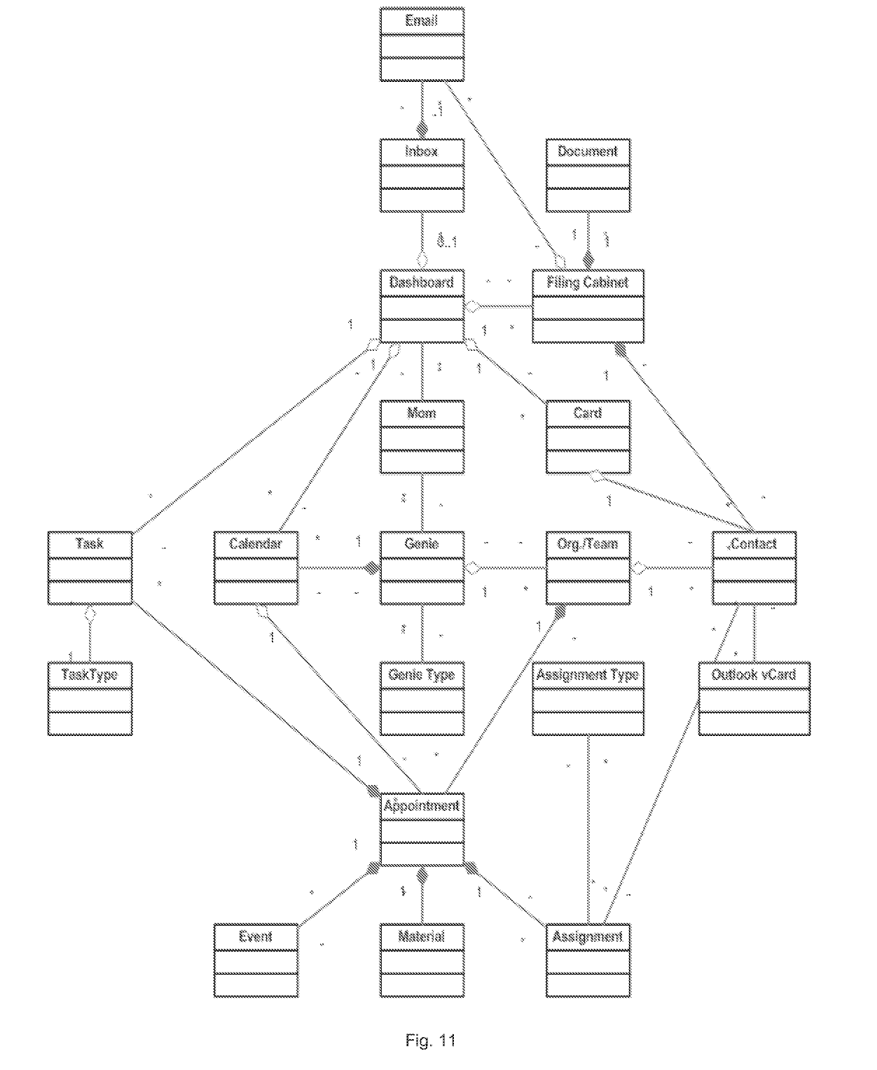

A domain model is a conceptual model that tells about the key entities involved in the system and their relationships. The purpose of a domain model is to clarify key system concepts and to familiarize the reader with the vocabulary of the system. FIG. 11 shows the domain model diagram.

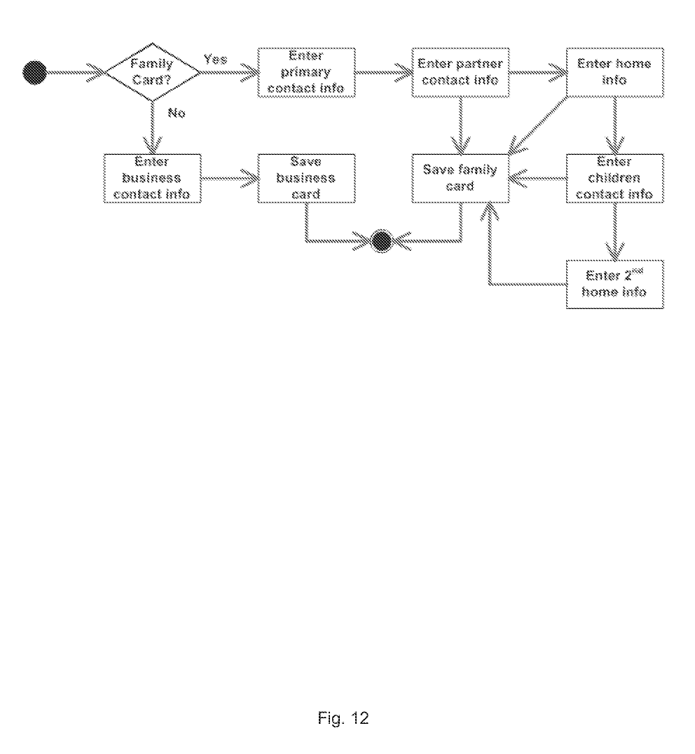

Activity diagrams are used to determine the user flow with the system. They help to guide the user through the typical use of the system. The diagrams below illustrate a few typical operations of the system. FIG. 12 displays the activity diagram for user creation of a MOS card.

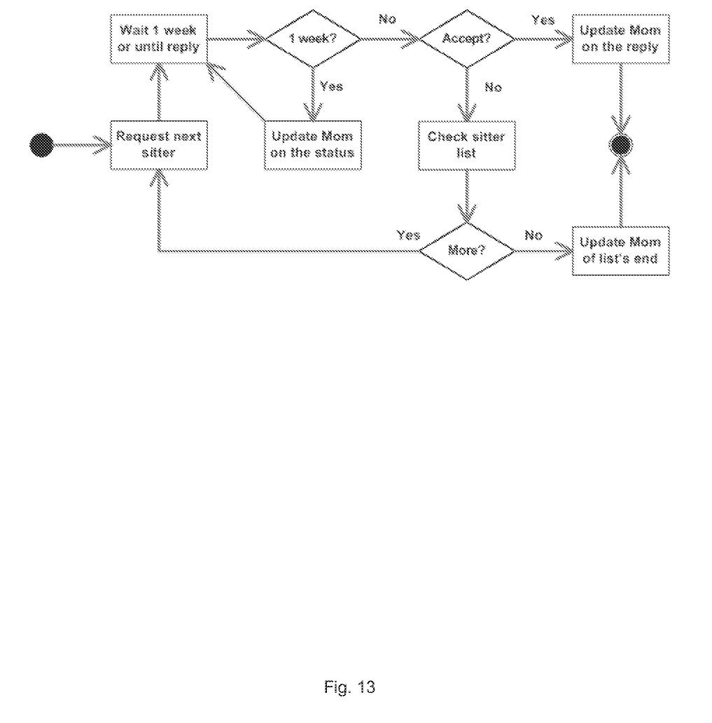

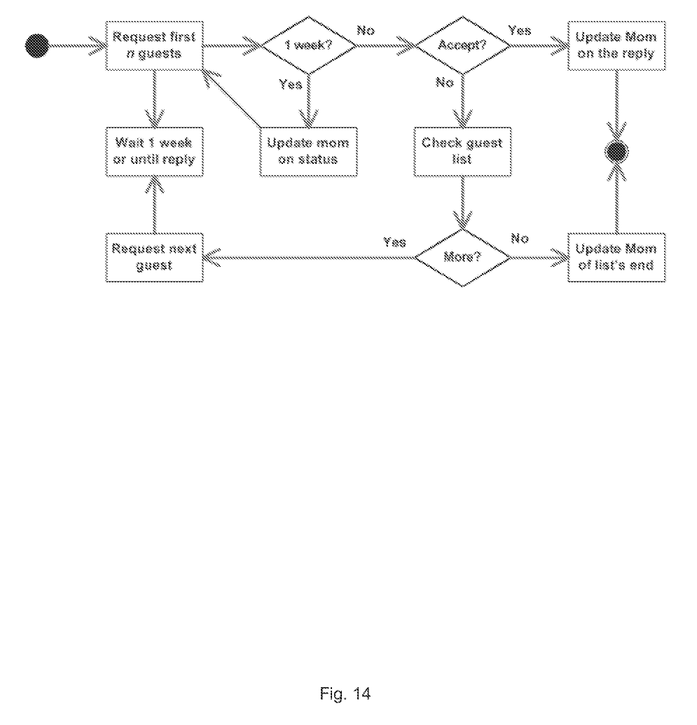

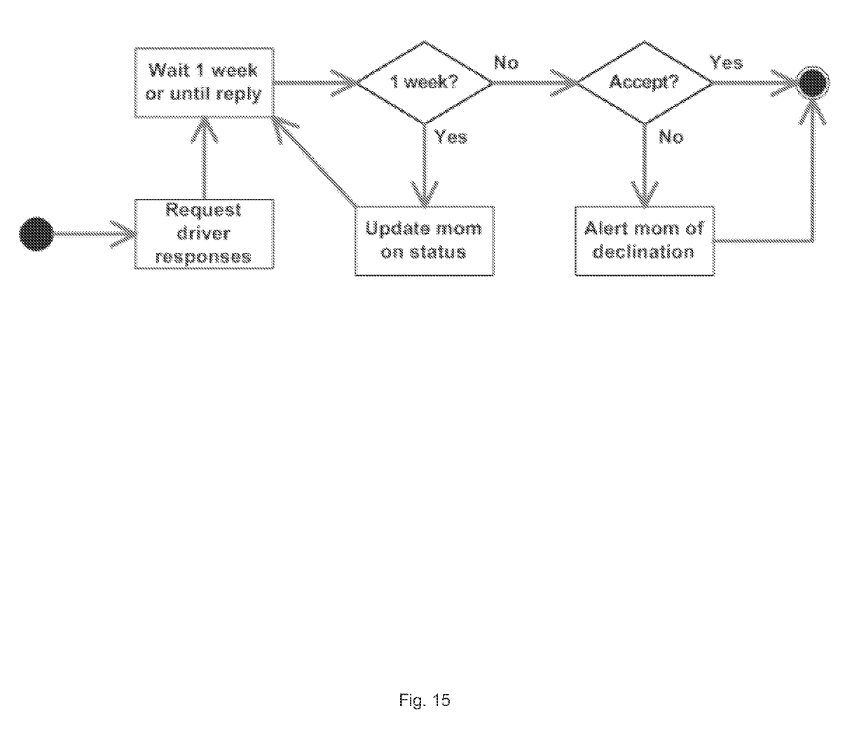

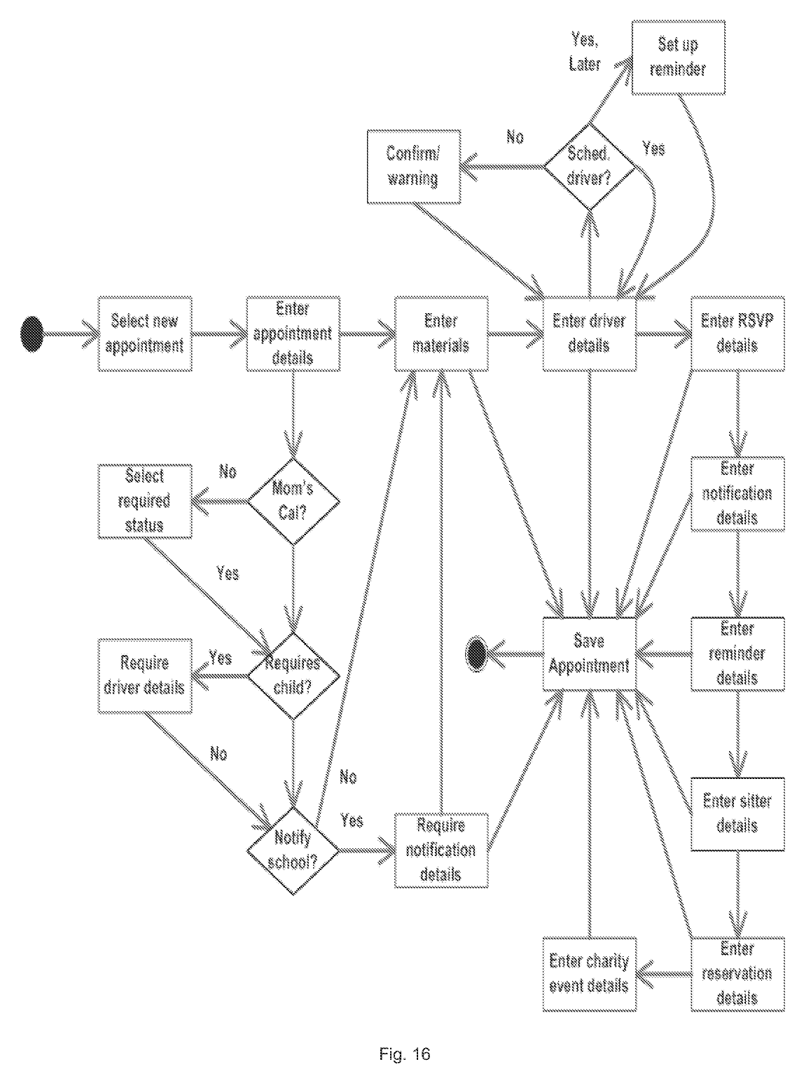

FIG. 13 shows the activity diagram for system management of sitter appointments, FIG. 14 displays the activity diagram for system management of charity appointments, and FIG. 15 shows the activity diagram for system management of driver appointments, all with the configurable time frame set to the default time of one week for example purposes. FIG. 16 shows the activity diagram for creating a custom appointment.

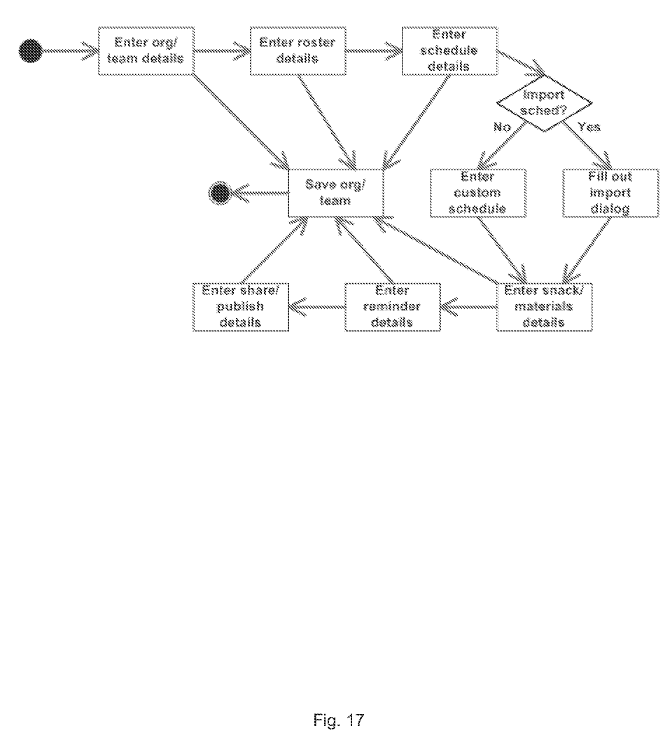

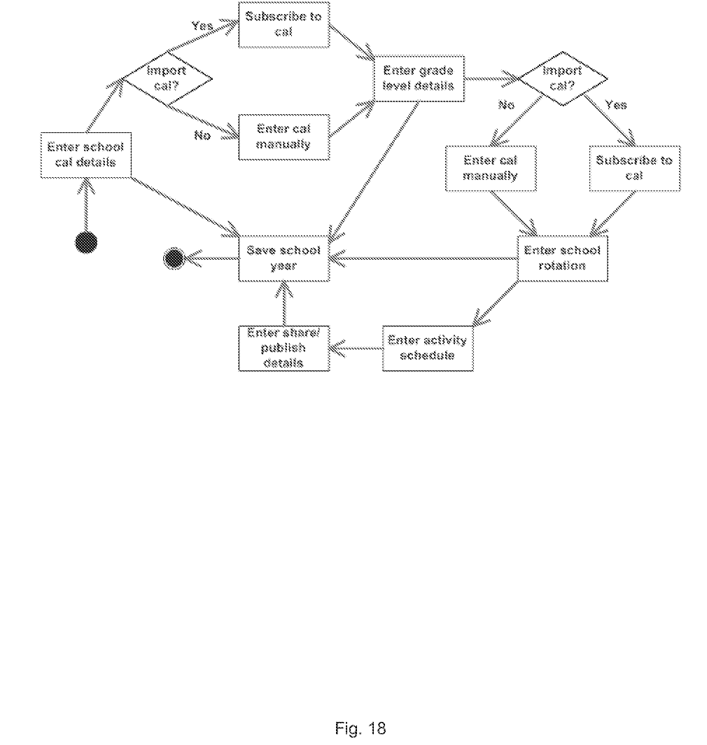

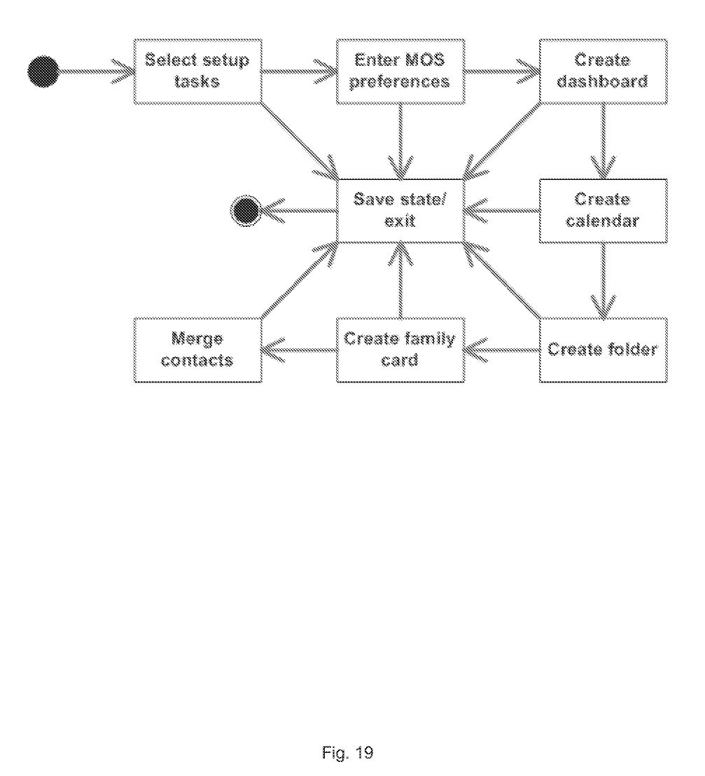

FIG. 17 displays the activity diagram for running an organization/team genie, FIG. 18 presents the activity diagram for running a school year setup form, and FIG. 19 shows the activity diagram for running the initial setup genie.

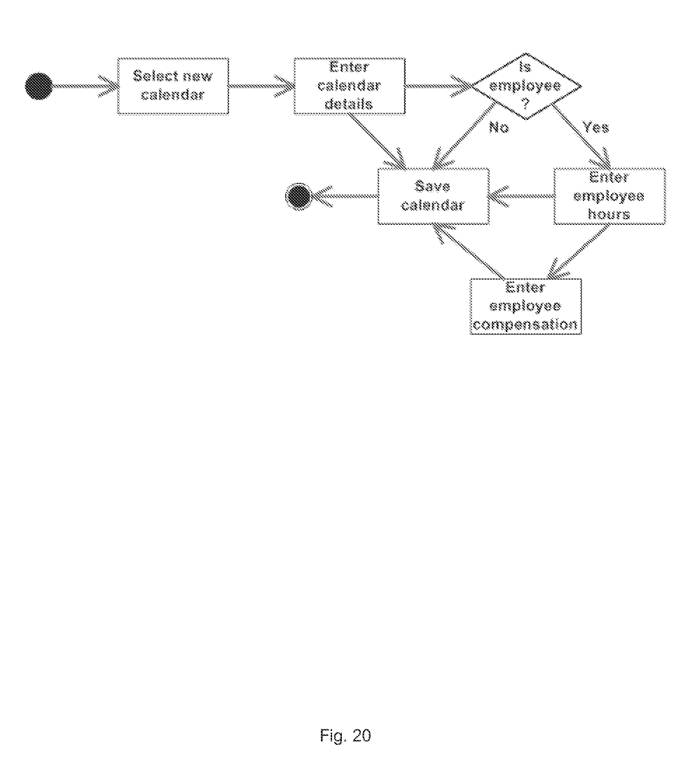

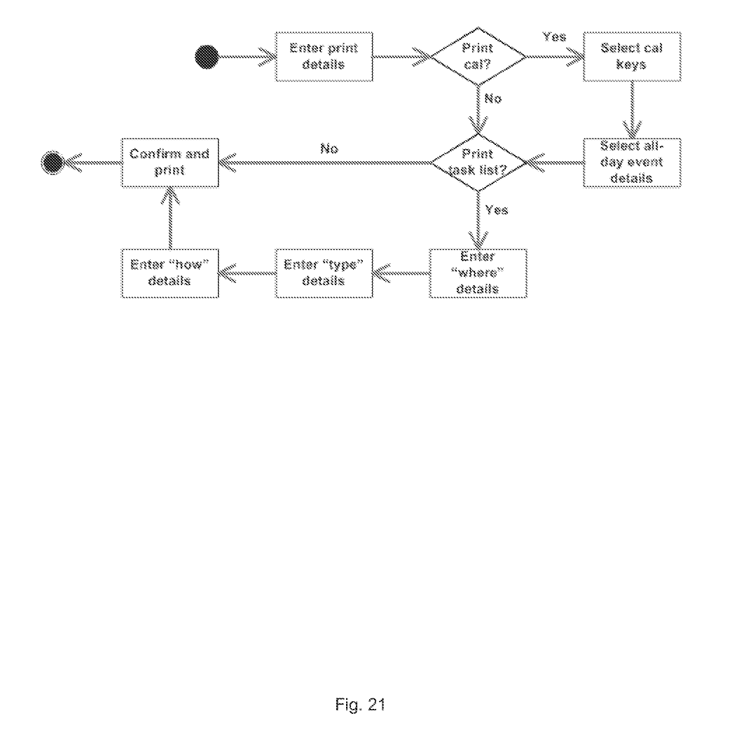

Finally, FIG. 20 presents the activity diagram for creating a custom calendar, while FIG. 21 displays the activity diagram for printing a custom calendar.

Use Cases

Use cases are steps that illustrate expected use of the system. Users and the tasks they will undertake are represented in each use case. Each task is then expanded and further described in the use case narratives.

The following use cases are captured in “MOS Use Case Specification v1.13”, dated May 16, 2008.

TABLE 26
Appointment Use Cases

| ID | Use Case Name |
|---|---|
| A 1.0 | Create Appointment |
| A 1.1 | Complete Appointment Details Tab |
| A 1.2 | Complete Appointment Materials Tab |
| A 1.3 | Complete Appointment Driver Tab |
| A 1.4 | Complete Appointment RSVP Tab |
| A 1.5 | Complete Appointment Notification Tab |
| A 1.6 | Complete Appointment Reminder Tab |
| A 1.7 | Complete Appointment Sitter Tab |
| A 1.8 | Complete Appointment Reservations Tab |
| A 1.9 | Complete Appointment Charity Event Tab |
| A 2.0 | Create Service Call |

TABLE 27
Calendar Use Cases

| ID | Use Case Name |
|---|---|
| C 1.0 | Create Calendar |
| C 1.1 | Complete Calendar Details Tab |
| C 1.2 | Complete Calendar Employee(s) Hours |
| C 2.0 | Print Calendar |
| C 3.0 | Delete Calendar |

TABLE 28
Dashboard and Filing Cabinet Use Cases

| ID | Use Case Name |
|---|---|
| D 1.0 | Create Dashboard |
| D 2.0 | Set Dashboard Preferences |
| D 3.0 | Delete a Dashboard |
| F 1.0 | Create Folder |
| F 2.0 | Move Folder |
| F 3.0 | Delete a Folder |
| F 4.0 | Move Item to Folder |

TABLE 29
Genies

| ID | Use Case Name |
|---|---|
| G 1.0 | Run Intial Setup |
| G2.0 | Run Organization/Team Setup Genie |
| G2.1 | Complete Details Form |
| G2.2 | Complete Roster Form |
| G2.3 | Complete Schedule Form |
| G2.4 | Complete Snack/Materials Schedule Form |
| G2.5 | Complete Share/Publish Form |
| G2.6 | Complete Genie Options Form |
| G3.0 | Edit Existing Genie |
| G4.0 | Delete Already Completed Genie |
| G? | Run Setup Carpool Genie |
| G ?.1 | Complete Carpool Details Form |

TABLE 30
Templates

| ID | Use Case Name |
|---|---|
| TP1.0 | Run School Year Set Up Form |
| TP1.1 | Complete All School Calendar Form |
| TP1.2 | Complete Grade Level/Child Specific Calendar Form |
| TP1.3 | Complete School Rotation Schedule Form |
| TP1.4 | Complete School Activity Schedule Form |
| TP1.5 | Complete Share/Publish Form |
| TP2.0 | Enter a List of Appointments - Quick Entry |
| TP3.0 | Enter a List of Contacts - Quick Entry |

TABLE 31
MOS Card

| ID | Use Case Name |
|---|---|
| FC 1.0 | Create MOS Card |
| FC 1.1 | Create Family Card |
| FC 1.1.1 | Add Partner To Family Card |
| FC 1.1.2 | Add Home Information to Family Card |
| FC 1.1.3 | Add Children to Family Card |
| FC 1.1.4 | Add Second Home Information to Family Card |
| FC 1.2 | Create Business Card |
| FC 2.0 | Print MOS Card |
| FC 3.0 | Delete MOS Card |
| FC 4.0 | Split Family Card |
| FC 5.0 | View Family Card - Quick View |
| FC6.0 | Create Family Cards by Merging Contacts |
| FC7.0 | Import Contacts into Family Card Format |

TABLE 32
Task Use Cases

| ID | Use Case Name |
|---|---|
| T 1.0 | Create Errand Task |
| T 2.0 | Create Call Task |
| T 3.0 | Create Correspondence Task |
| T 5.0 | Set Task Preferences |

TABLE 33
Utility Use Cases

| ID | Use Case Name |
|---|---|
| U 1.0 | Change MOS Preferences/Options |
| U 2.0 | Uninstall MOS |

Mom's Office Suite Overview

Mom's Office Suite (MOS) provides an effective personal management tool for busy Moms that is extremely user-friendly and integrates seamlessly with both the tools Moms use today and her unique style and interests. MOS is built by a Mom for other Moms, and it unlocks the hidden potential of the software Moms already own to simplify and automate her daily routines. Metaphorically, it provides Mom with a clone or a virtual digital assistant. It fundamentally supports Mom's need to simplify, coordinate, and automate the routine and the mundane in her life.

The Mom's Office Suite enables Mom to use her time and talents to do the following:
Effectively and efficiently accomplish the many facets of her job as a Mom
Simplify, coordinate and automate as many mundane sequences of steps as possible
Manage multiple people, houses and projects
Be more available to her family
Bring order to the chaos of her daily routine

What sets MOS apart is that the solution is “Mom-centric.” The terminology used and the processes (Mom's routine) supported will reflect Mom's viewpoint; furthermore, appointments, email, Calendars, contacts and tasks will resemble most closely what a Mom's approach is. Moreover, because there are a large variety of appointments and tasks Moms need to schedule, there will be a variety of custom/Mom-specific appointments, contacts and tasks along with automation for the common steps associated with these appointments, contacts and tasks. A Family Card will enable Mom's to view the context of family with all individuals in the family together in one place. Finally, the print view will enables Mom's to use custom print styles to quickly and cleanly print Mom's Calendar, tasks, contacts and the like for use on the go, to share with others or simply to hang on the fridge, giving the application an across-the-board consistency others lack.

The MOS Add-in for MS Outlook Add-In comprises a series of custom Microsoft Outlook forms, pages, print styles, rules, utilities and Genies that automate, coordinate and simplify Mom's life.

Actor List
Mom
Family
   Spouse
   Children
   Parents
   Extended family
Client/Customer
Friends
   Teammates
   Classmates
Community
   Charities
   Church
   Other
Employee(s)/Employee
   Nanny
   Housekeeping
   Landscaper
   Service Technician
Household
Pets

Glossary of Terms

Table 34 identifies and defines the terms used throughout this document.

| Term | Definition |
|---|---|
| Appointment | Scheduled meetings that customized and trigger other events, such as |
| | emails or text messages to one or more recipients, appointment reminders, |
| | or sequences of steps. |
| | An entry onto one or more Calendars for an event which happens |
| | one or more times. |
| | An appointment is associated with one Calendar (primary). |
| | Appointments can be listed on multiple Calendars but if multiple |
| | Calendars are viewed simultaneously, the appointment displays only |
| | on the primary Calendar to which it has been assigned. |
| Action Queue | A collection of actions, events, tasks, messages or other items stored in a |
| | single location during the creation of MOS contacts, appointments, and the |
| | like. Actions are ‘processed’ (acted upon) periodically or whenever a Mom |
| | completes the associated genie, appointment, contact or calendar. |
| Calendar | A graphical representation of appointments for people and projects. MOS |
| | will utilize existing Calendar functionality and display them within the |
| | Dashboard's filing cabinet; Calendars contain folders. |
| | Calendars are stored inside/on a Dashboard |
| | Each individual, project and residence can have a separate Calendar |
| | Calendars are identified by a color (might be same as Dashboard in |
| | which it resides) |
| Child | The offspring of Mom and a tertiary user of MOS. |
| Contact | The name of an individual and his/her data stored in another database. |
| Composite Form | The summary of a template, with each tab corresponding to a template |
| | form. |
| Dashboards | Similar to Outlook's “Today” screen, the MOS Dashboard will be the entry |
| | point, displaying Mom's filing cabinet, email, documents, Calendar, to-do |
| | list, and contacts. Dashboards include Mom's top-level Dashboard which |
| | gives her a bird's eye view of all of her projects, children and roles that she |
| | performs. Each project, child and/or role will also have a Dashboard which |
| | enables Mom to quickly focus in on the project specific tasks. |
| | Highest Level of Organizational Structure (like a Hanging File) |
| | Single View of File Cabinet, Calendar, Email InBox, Tasks, Family |
| | Cards |
| | Mom's Dashboard is the Primary and Default to which MOS opens |
| | Multiple Dashboards can be created |
| | May have a color associated |
| Family Card | The MOS composite contact, which contains family members and their |
| | relationships to one another. |
| | Family Cards and Business Cards can be sorted by any field within |
| | them and data can be retrieved about an individual or a complete |
| | family. |
| | Information about each individual, company or residence is specific |
| | to that individual but is also related to the other members of the |
| | family. |
| | Individuals within a Family Card can be identified with one or more |
| | folders (projects). |
| Filing Cabinet | Part of the Dashboard entry screen of MOS, contains the list of folders into |
| | which emails, appointments, tasks, contacts and other documents may be |
| | placed. |
| | The area on Mom's Dashboard where all information is stored in an |
| | organized fashion like folders within a literal file cabinet. The File Cabinet |
| | has this hierarchical structure: |
| | Dashboard |
| | Calendar or Folder |
| | Sub-folder |
| Folder | A graphical representation of a directory or bucket into which emails, tasks, |
| | contacts, Calendars, and documents may be placed. |
| | Folders reside inside a Dashboard |
| | Folders are used for organization and sorting of data and family |
| | cards. |
| | Folders are actually virtual folders which can contain Calendars, |
| | Emails, Documents, Data and Lists |
| | Folders can be listed/organized “under” a Calendar or a Calendar |
| | can be filed in a folder. |
| | Folders can have subfolders within them. |
| Form | A customized Microsoft Outlook form or page used to capture |
| | data/information from Mom regarding a specific appointment, calendar, |
| | contact or the like. |
| Genie | The step-by-step set of forms that walk a Mom through the creation of a |
| | project such as a carpool or team and include the business logic that |
| | completes the automated sequence of steps when a Mom completes the |
| | required information. Genie is a combination of one or more templates for |
| | data entry which is structured in a question and answer format for easy |
| | entry and a series of actions/steps which the MOS system will automatically |
| | do for the Mom when the Genie is activated. |
| List | A collection of individual, business and/or family contact information. |
| | Lists can be kept on a Dashboard or in a Folder. Lists are more user |
| | friendly was of referring to contact folders. |
| Mom | The female head of household and the target demographic and |
| | administrator of MOS |
| MOS Cards | The name of MOS contact database which is a collection of Family or |
| | Business Cards which contain all information about all individual members |
| | of a family or company/business. |
| Partner | Mom's spouse, a secondary head of household, and a secondary |
| | administrator and user of MOS |
| Tag | A tag is a label which causes the tagged item (typically an incoming email) |
| | to change to a color which is associated with a folder (project). |
| Task | An item (call, errand, correspondence, other) reminder to do which is |
| | placed in a list. A list of tasks can be sorted and displayed in a variety of |
| | ways. |
| Template | Template is a form which prompts the Mom to enter data. A template can |
| | be part of a Genie or a standalone tool to prompt the Mom to enter specific |
| | data for some other use (i.e. to create a medical release form). |
| Employee(s) | The regular or infrequent employees of Mom |
| WYSIWYG | “What you see is what you get”; in MOS, custom printing involves printing |
| | to paper the view on the screen for Calendars and tasks |
| Quick Entry Table | A tabular data entry component comprised of columns for data members |
| | and rows for separate entries |

Master Use Case List

Only details of the Use Cases not provided natively in Microsoft Outlook 2007 will be detailed as part of this Use Case Specification document. All use cases with assigned use case numbers, with a release of 1.0 (or earlier) and marked complete are to be included in the Beta/Release 1.0.

TABLE 35
Appointment Use Cases

| | | | Use | Wire- | |
|---|---|---|---|---|---|
| | | Fu- | Case | frame | Out- |
| | Rel. | ture | Com- | Com- | look |
| Use Case | 1 | Rel. | plete | plete | [symbol] |
| Create Appointment (UA1.0) | • | • | • | | |
| Create Service Call (UA2.0) | • | • | • | | |
| Edit an Appointment(UA1.0) | • | • | — | — | |
| Delete an Appointment | • | • | — | — | • |
| Export/Import Appointment | • | • | — | — | • |
| Filter/Sort Appointment | • | • | — | — | • |
| Print an Appointment | • | • | — | — | • |
| Search for an Appointment | • | • | — | — | • |
| Synchronize Appointment | • | • | — | — | • |
| View Appointment (UC1.0) | • | • | — | — | • |

TABLE 36
Calendar Use Cases

| | | | Use | Wire- | |
|---|---|---|---|---|---|
| | | Fu- | Case | frame | Out- |
| | Rel. | ture | Com- | Com- | look |
| Use Case | 1 | Rel. | plete | plete | [symbol] |
| Create Calendar (UC C1.0) | • | • | • | | |
| Edit Calendar (UC C1.0) | • | • | • | | |
| Delete Calendar (UC C3.0) | • | • | • | | |
| Print Calendar (UC C2.0) | • | • | • | | |
| Publish/Subscribe Calendar | • | • | — | — | • |
| Send Calendar | • | • | — | — | • |
| Search Calendar | • | • | — | — | • |
| View Calendar | • | • | — | — | • |

TABLE 37
Dashboard Use Cases

| | | | Use | Wire- | |
|---|---|---|---|---|---|
| | | Fu- | Case | frame | Out- |
| | Rel. | ture | Com- | Com- | look |
| Use Case | 1 | Rel. | plete | plete | [symbol] |
| Create Dashboard (UC D1.0) | • | • | • | | |
| Dashboard of Dashboards | | • | | | |
| Delete Dashboard (UC D3.0) | • | • | • | | |
| Edit Dashbooard (UC D1.0) | • | • | • | | |
| Print Dashboard | • | • | | | |
| Set Dashboard Preferences | • | • | • | | |
| (UC D2.0) | | | | | |
| View Dashboard | • | • | • | • | |

TABLE 38
Folder Use Cases

| | | | Use | Wire- | |
|---|---|---|---|---|---|
| | | Fu- | Case | frame | Out- |
| | Rel. | ture | Com- | Com- | look |
| Use Case | 1 | Rel. | plete | plete | [symbol] |
| Create Folder (UC F1.0) | • | • | • | | |
| Delete Folder (UC F3.0) | • | • | • | | |
| Move Folder (UC F2.0) | • | • | • | | |
| Move Item to Folder (UC F4.0) | • | • | • | | |

TABLE 39
Genie Use Cases

| | | | Use | Wire- | |
|---|---|---|---|---|---|
| | | Fu- | Case | frame | Out- |
| | Rel. | ture | Com- | Com- | look |
| Use Case | 1 | Rel. | plete | plete | [symbol] |
| Arrival at Second Residence | | • | | | |
| Create Carpool | | • | • | | |
| Edit Carpool | | • | • | | |
| Delete Carpool | | • | • | | |
| Create Carpool - Auto | | • | | | |
| Routing/Schedule | | | | | |
| Initial Setup (UC G1.0) | • | • | • | | |
| Emergency Call List | | • | | | |
| Host a Meeting | | • | • | | |
| Hot a Meeting at Another Residence | | • | • | | |
| Menu Planner | | • | | | |
| Medical Planner | | • | | | |
| Create Organization/Team | • | • | • | • | |
| (UC G2.0) | | | | | |
| Edit Qrganization/Team (UC G3.0) | • | • | • | • | |
| Delete Organization/Team | • | • | • | | |
| (UC G4.0) | | | | | |
| Party Planner | | • | | | |
| Shopping List | | • | | | |
| Travel Plan | | • | | | |

TABLE 40
MOS Card Use Cases

| | | | Use | Wire- | |
|---|---|---|---|---|---|
| | | Fu- | Case | frame | Out- |
| | Rel. | ture | Com- | Com- | look |
| Use Case | 1 | Rel. | plete | plete | [symbol] |
| Create Business Card (UC FC1.2) | • | • | • | | |
| Create Family Card (UC FC1.1) | • | • | • | • | |
| Create MOS Card (UC FC1.0) | • | • | • | | |
| Delete MOS Card (UC FC3.0) | • | • | • | | |
| Print MOS Card (UC FC2.0) | • | • | • | | |
| Split Family Card (UC FC4.0) | • | • | • | | |
| View Family Card (UC FC5.0) | • | • | | | • |
| Create Family Cards by | • | • | • | • | • |
| Merging Contacts (UC FC6.0) | | | | | |
| Import Contacts into Family | • | • | • | | |
| Cards (UC G4.0) | | | | | |
| Filter/Sort MOS Card | • | • | • | • | • |
| Import/Export Contacts | • | • | — | — | • |
| Search MOS Card | • | • | — | — | • |
| Synchronize MOS Card | • | • | — | — | • |
| View MOS Card (UC FC1.1, | • | • | • | | |
| UC FC1.2) | | | | | |

TABLE 41
Task Use Cases

| | | | Use | Wire- | |
|---|---|---|---|---|---|
| | | Fu- | Case | frame | Out- |
| | Rel. | ture | Com- | Com- | look |
| Use Case | 1 | Rel. | plete | plete | [symbol] |
| Create Call (UC T2.0) | • | • | • | • | |
| Create Errand (UC T1.0) | • | • | • | • | |
| Create Correspondence (UC T3.0) | • | • | • | • | |
| Edit Task (UC T1.0, T2.0, T3.0) | • | • | • | | |
| Delete Task | • | • | — | — | • |
| Delegate/Assign Task | • | • | — | — | • |
| Filter/Sort Task | • | • | — | — | • |
| Print Task | • | • | — | — | • |
| View Task (UC T1.0, T2.0. T3.0) | • | • | — | — | • |
| Task Preferences (UC T5.0) | • | • | • | | |

TABLE 42
Template Use Cases

| | | | Use | Wire- | |
|---|---|---|---|---|---|
| | | Fu- | Case | frame | Out- |
| | Rel. | ture | Com- | Com- | look |
| Use Case | 1 | Rel. | plete | plete | [symbol] |
| Start New School Year (UC TP1.0) | • | • | • | | |
| Edit School Year (UC TP1.0) | • | • | • | | |
| Delete School Year | • | • | | | |
| Enter a List of Appointments - | • | • | • | | |
| Quick Entry (UC TP2.0) | | | | | |
| Enter a List of Contacts - Quick | • | • | • | | |
| Entry (UC TP3.0) | | | | | |

TABLE 43
Utility Use Cases

| | | | Use | Wire- | |
|---|---|---|---|---|---|
| | | Fu- | Case | frame | Out- |
| | Rel. | ture | Com- | Com- | look |
| Use Case | 1 | Rel. | plete | plete | [symbol] |
| Uninstall Mom's Office Suite | • | • | • | | |
| (UC U1.0) | | | | | |
| Mom's Office Suite Preferences | • | • | • | | |
| (UC U2.0) | | | | | |
| Synchronize | | • | | | |

Prioritized Feature List

The following Table 44 is a prioritized list (highest to lowest) of MOS capabilities.

| Feature | Use Case(s) | Notes |
|---|---|---|
| Family Cards | UC FC1.0-UC | |
| | FC3.0, UC | |
| | FC5.0-UC | |
| | FC 6.0 | |
| Calendar | UC C1.0-3.0 | |
| Quick Entry of Lists | UC T2.0-T3.0 | |
| School Year Setup | UC T1.0 | |
| Custom Appointments | UC A1.0-2.0 | Tab priority (high-to low): |
| | | Materials, Driver, Sitter, |
| | | Charity Event, |
| | | Notification, Reminder, |
| | | RSVP, Reservation |
| Dashboards & Folders | UC D1.0-3.0, | |
| | UC F1.0-4.0 | |
| Organization/Team Setup | UC G3.0-5.0 | |
| Tasks | UC T1.0-4.0 | |

Notes:
The installation, initial setup (UC G1.0) and other utility and/or system use cases (UC G1.0) will need to be supported and updated after each new feature is added/released.
All use cases with assigned use case numbers, with a release of 1.0 (or earlier) and marked complete are to be included in the Beta/Release 1.0.

Future Use Cases—Use Case Parking Lot

Use Cases listed below will be included in future releases of the Mom's Office Suite.
Appointment
   Find/determine best appointment time
   Incomplete appointment use case
Business/Small Business
   Business accounting/financial administration
   Employee scheduling & management
   Employee time & attendance
   Employee payroll
   Rental property management
   Supplier management
Carpool
   Quick Data Entry of Existing Carpool Schedule
   Auto-route/Auto-schedule MOS takes data on activity schedule, children and drivers to create a schedule
Dashboard
   Dashboard of Dashboards
Emergency
   Create an Emergency Call List
Employee(s)
   Track hours worked and/or time off
   Create reports for IRS and other filings
   Create a Medical Release From for caregivers of your children
Entertaining
   Plan a party
      Plan a Party In your home
      Plan a Part At alternate location
Financial
   Create a budget
   Create an Insurance Master List/Chart
   Create a Charitable Giving Plan
House/Residence
   Create a Building or Remodeling Check List
   Create a Call List for Residence
   Arrange for arrival/departure to/from Residence (lake house, etc.)
   Create a Yard Care Schedule
Meal Planning and Shopping
   Plan weekly menus and their related grocery lists
   Create a master shopping list for multiple stores (Target, Costco, Sam's, etc.)
Medical
   Track medical visits, medications for insurance reporting
   Create Medical summary (if Mom will enter results from each appointment onto the Calendar, she would have a medical history record)
   Create a Medical Release From for caregivers of your children
Meeting
   Plan a meeting
   Coordinate between Calendars to find a meeting/appointment time (i.e. doctor appt)
Miscellaneous
   Collaboration tools
      Message boards
      Chat
      Wiki boards
      File/Photo Albums
      Blogs/Journals
      Office Applications
      Polls/Surveys
   Mom create and share their own templates, genies, custom forms
   Map/location
   Pets
   Where is? (am I, family, my children, my spouse, assistant, employee)
   What's next? (for me, spouse, children, etc)
   Enable Mom's to create, publish and share templates, custom forms, business rules/logic.
MOS Cards
   Promote non-member to family.
Quick Data Entry (enter a list of Calendar, appointment, contact, tasks)
   Quick Entry Data Genie—Using Screen Scrape
   Run Quick Entry Data Genie—Using Scanner
System
   Advertising management
   Billing
   Business Analytics
   Content Management
   Customer Relationship Management
   Customer Support
   Data Management
   Training
   Third-Party integration
   Security
Travel
   Template to plan a trip (help you think through trip and what you need for it)
   Create Notes for caregivers/house sitters for while you are on a trip
   Template for letter for minor to travel with single parent or non-relative
Synchronization
   Google Calendar
   Synchronization error handling
Utilities
   Transfer Account
      Import from another personal information management tool.
   Refer a Friend
   Lost Password
   Import
      Calendar from another Calendar MOS
      Tasks from another Calendar MOS
Build/compile time customization
   User-friendly ability to change the ‘visual’ labels for the fields and the icons/graphics (e.g. Dad's office suite)
   User-friendly ability to change the email, correspondence and other system messages
Backups
   How are we going to handle backups—with Mom's data spanning across her PST and the SQL db?
   Most backup utilities will ‘pick-up’ the PST file for backup, I think most will not backup the SQL database?
Customize data entry forms?
   Do we want to enable Mom's to create/customize their own rosters, carpool, etc.—fields
   For example in the organization/team setup on the quick entry table for the roster Moms could add or not add 2^{nd} parent, 2^{nd} phone, etc. or we could have a set number pre-named fields that Moms use as needed.
   If we allow them to ‘add/delete some of the columns in the quick entry table it may allow Mom's to tailor the application to what they want to see/capture—but this would require a different way of handling/storing the data on the backend. Specifically we likely store the roster as XML in the database vs. fixed data fields?
   Obviously some of the fields would be required and un-editable if we went this route in order to ensure MOS has the basic information it needs to perform its functions.

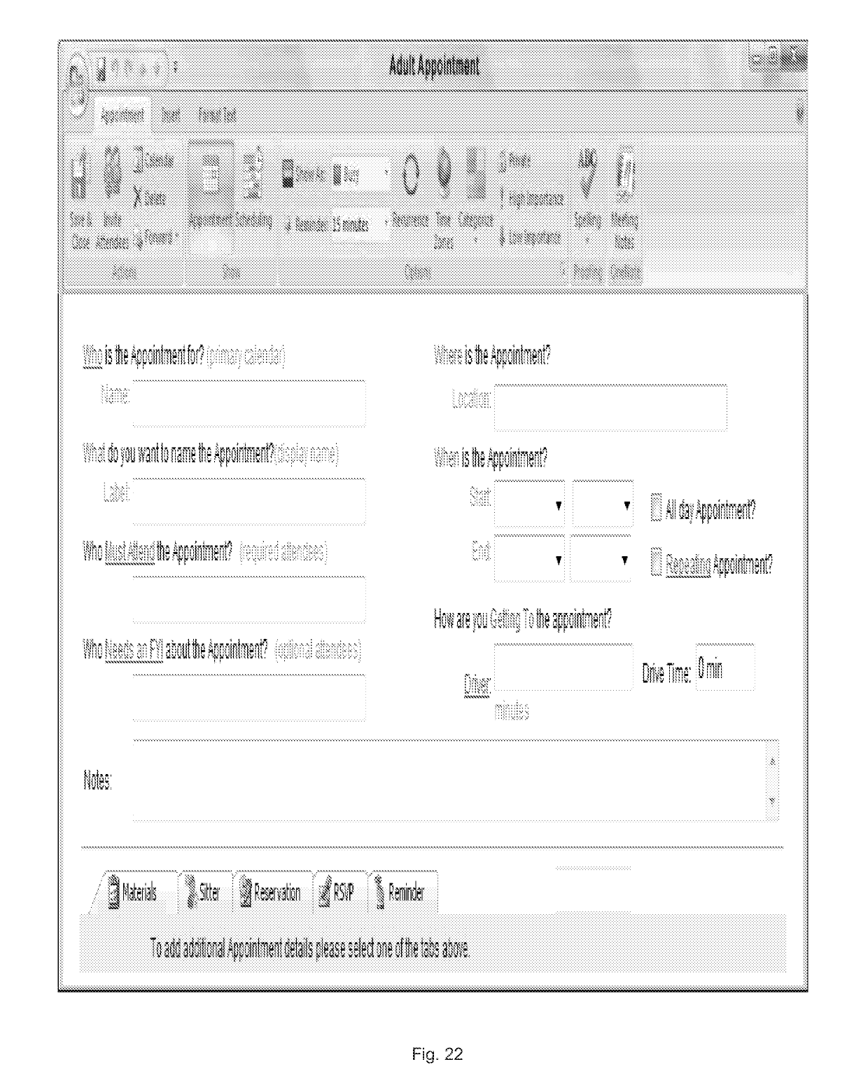

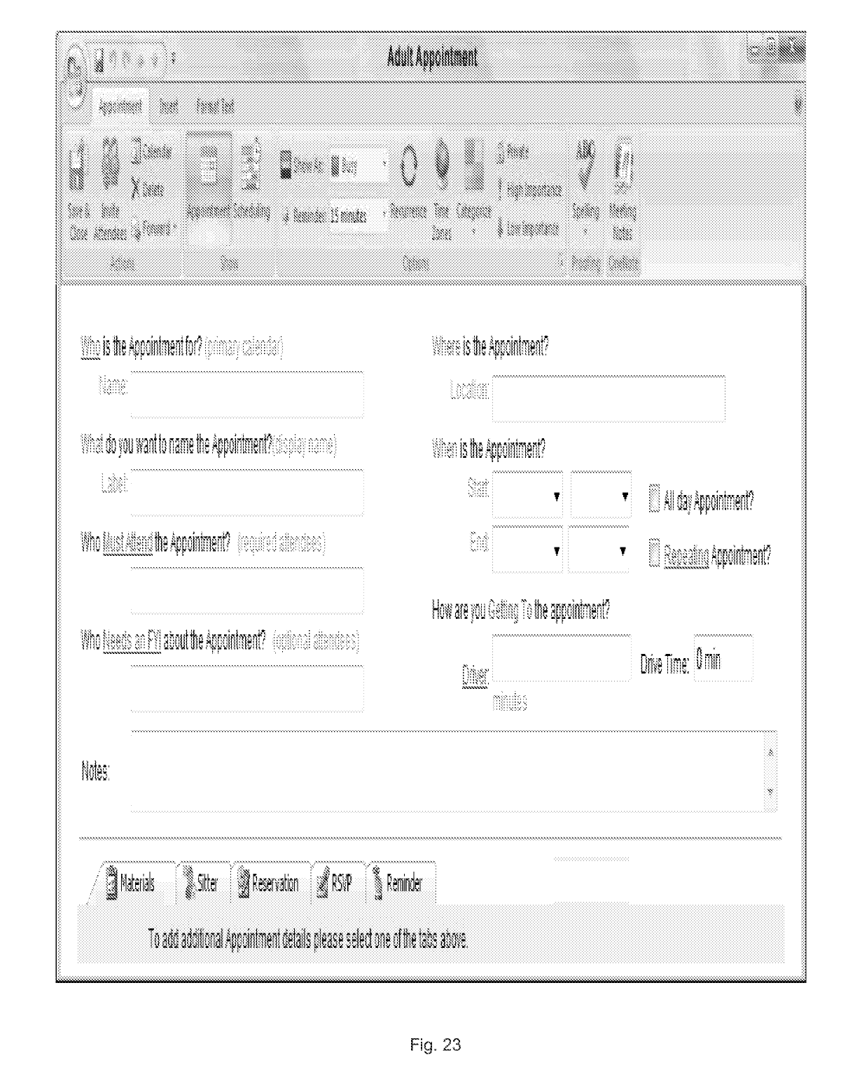

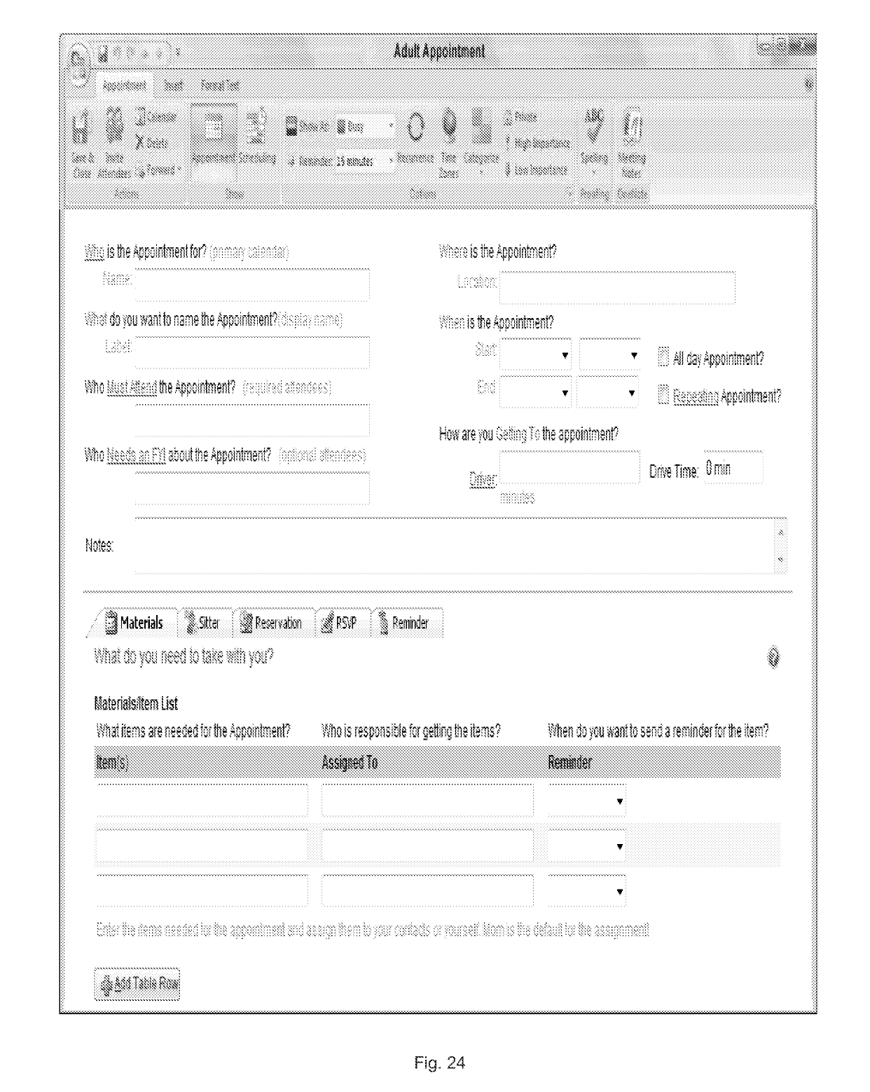

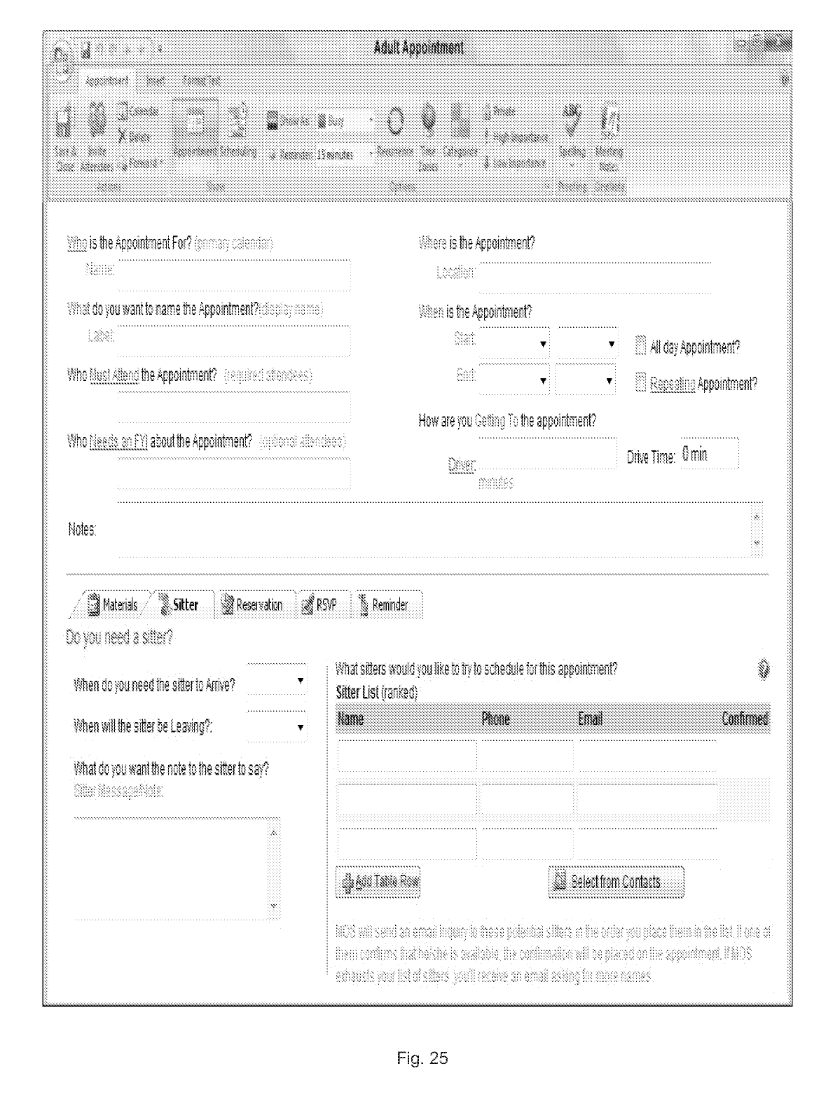

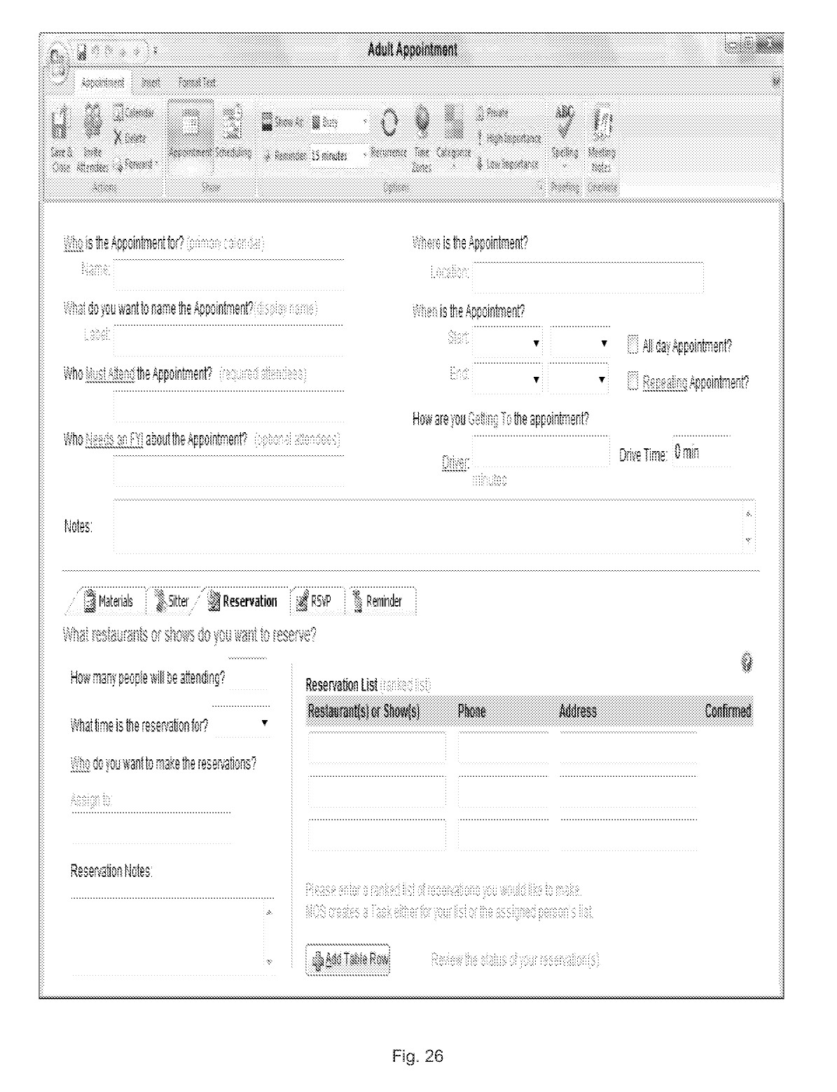

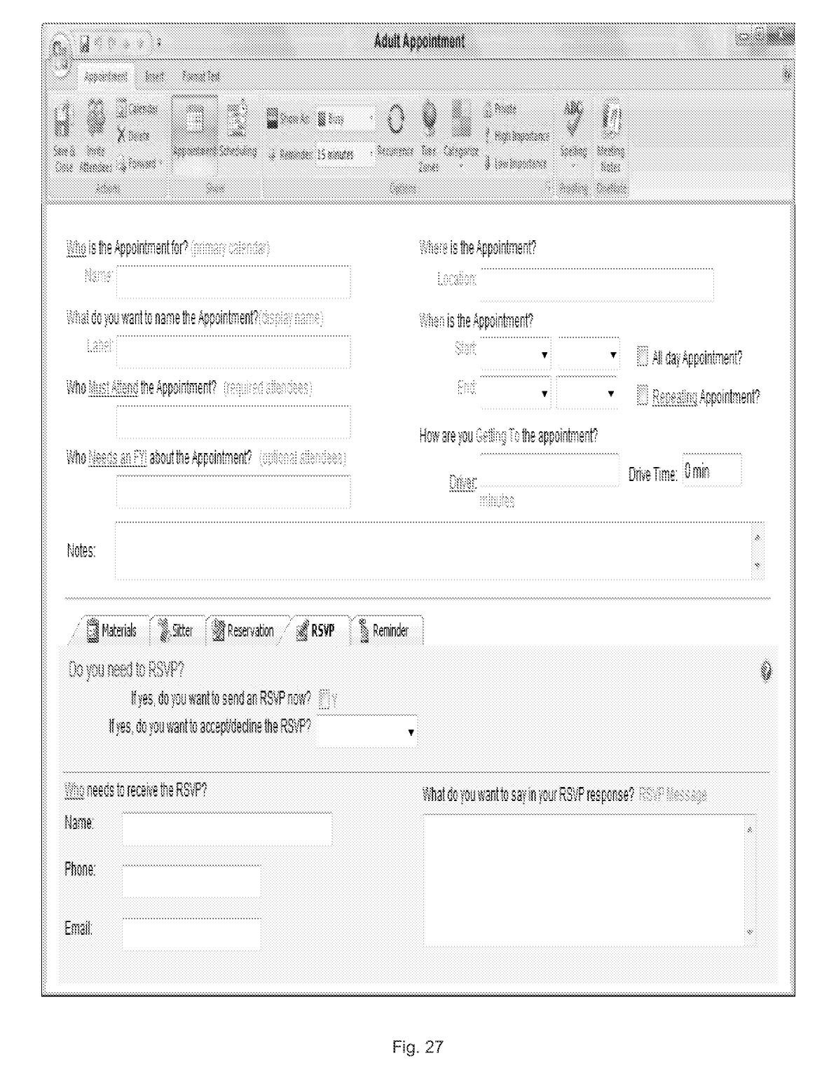

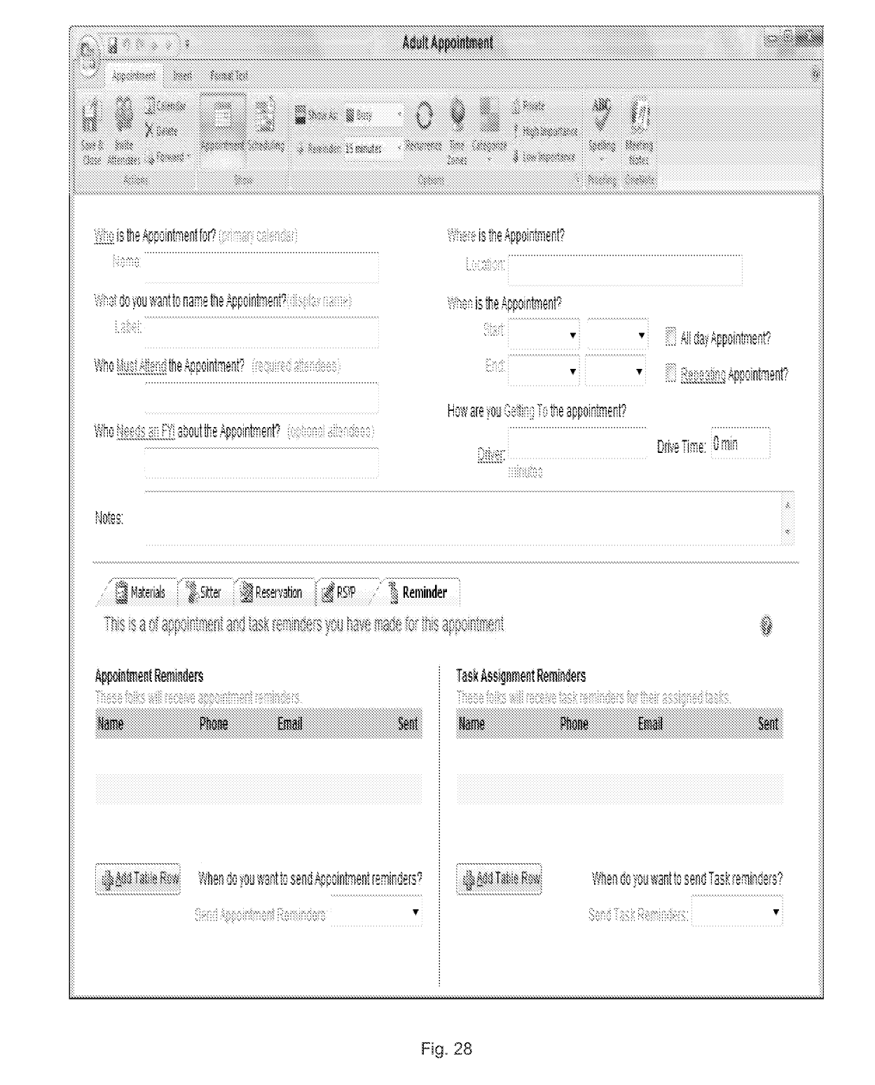

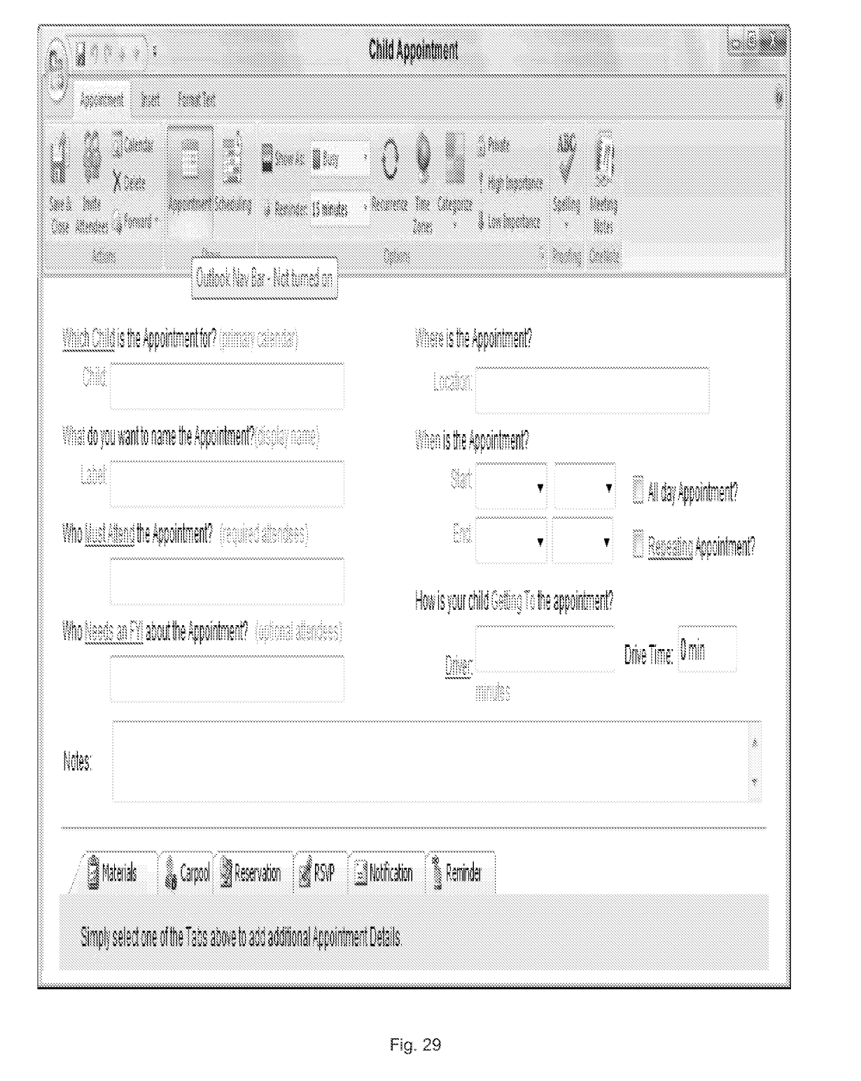

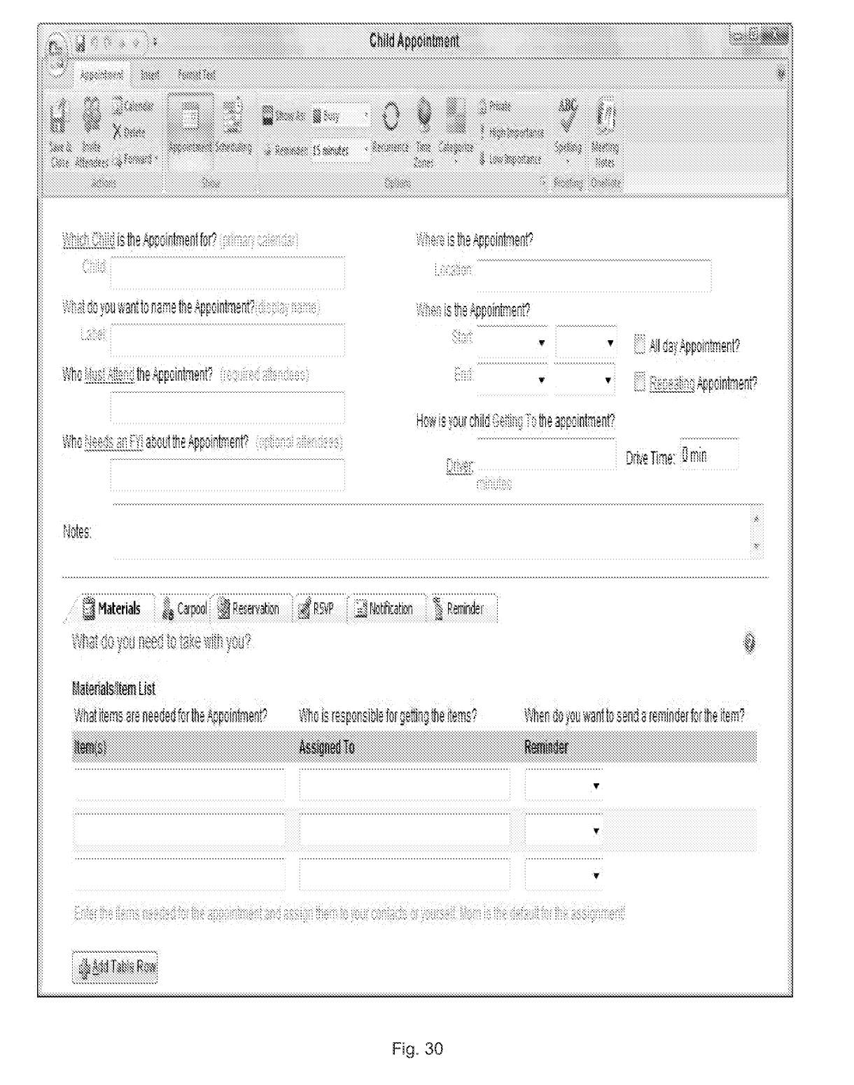

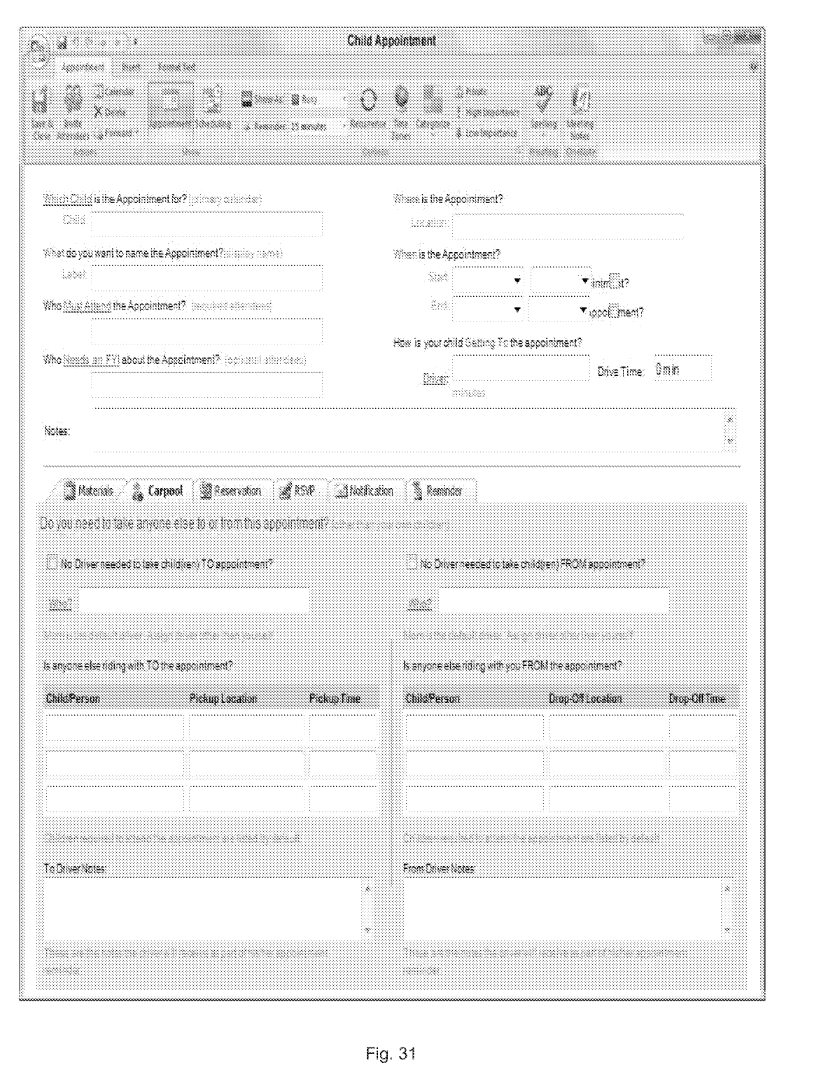

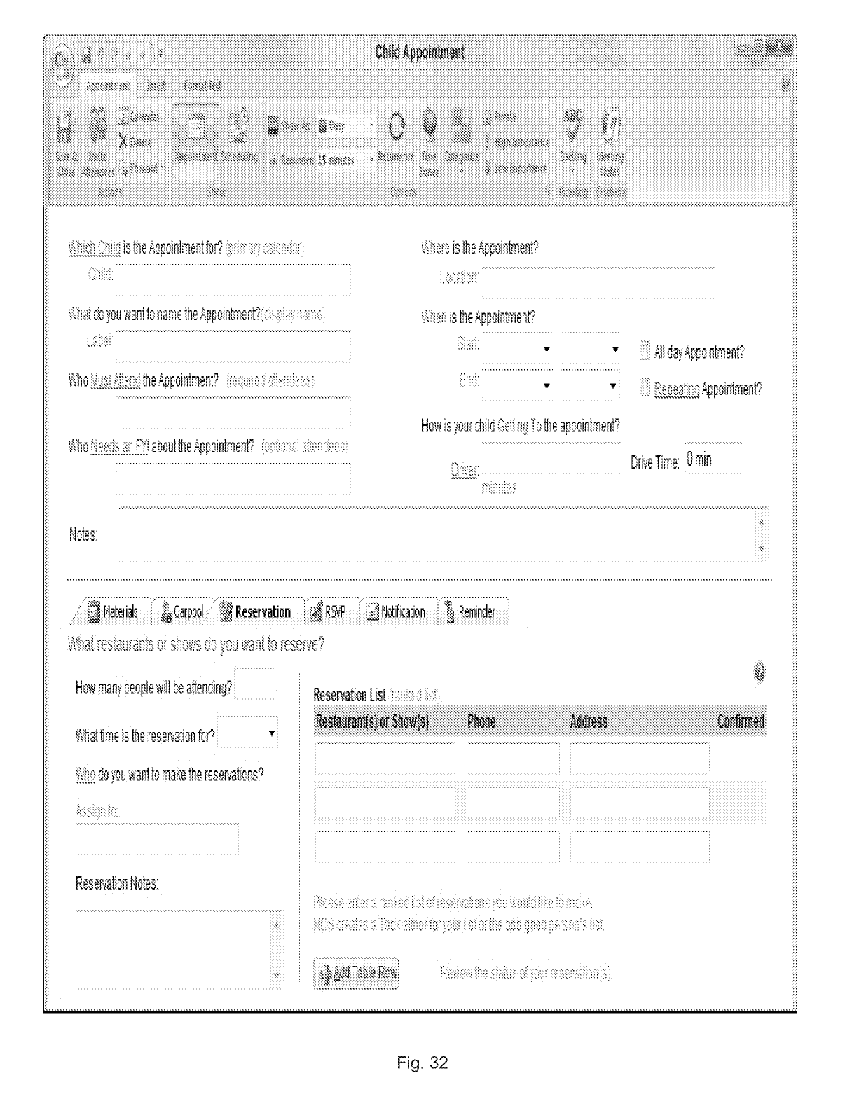

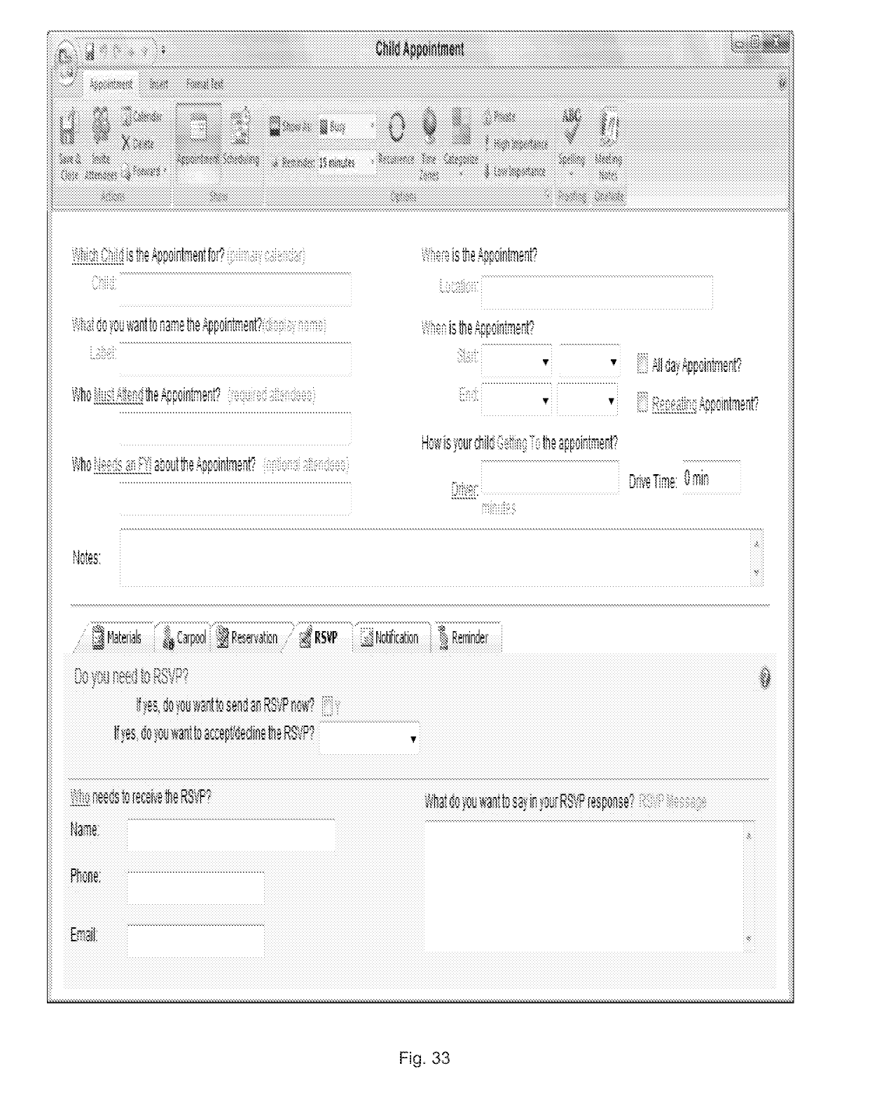

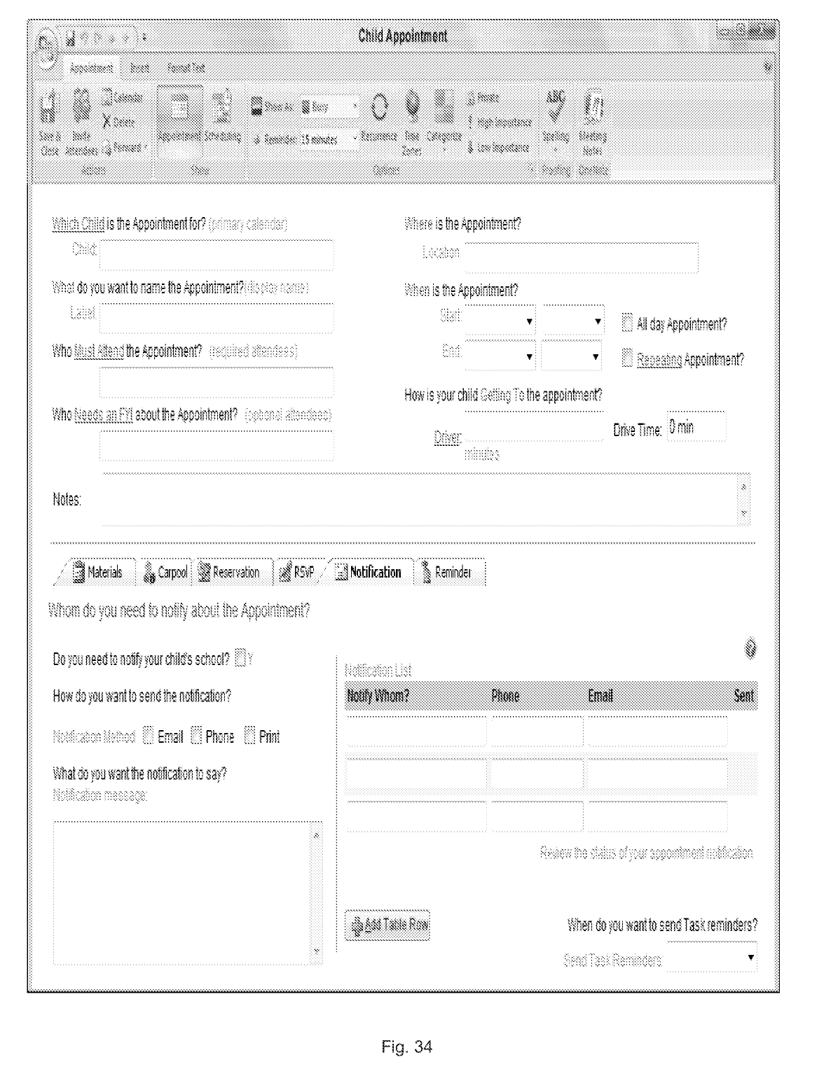

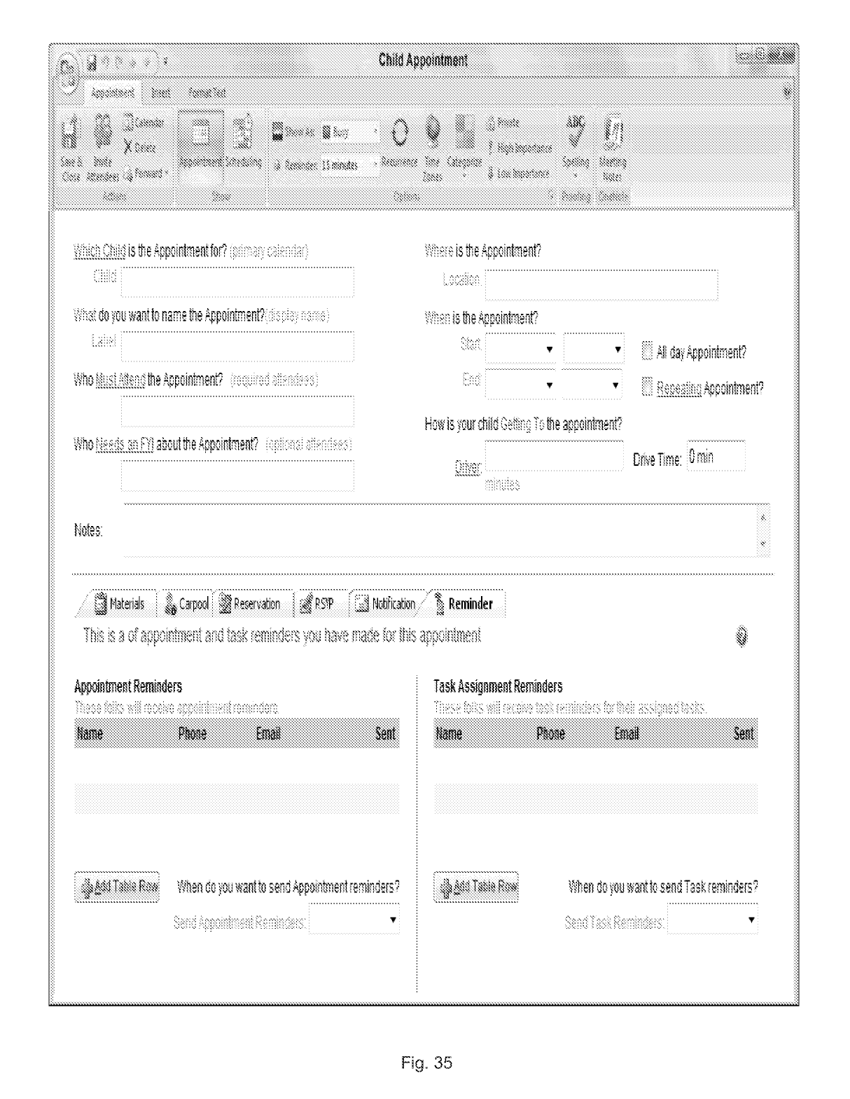

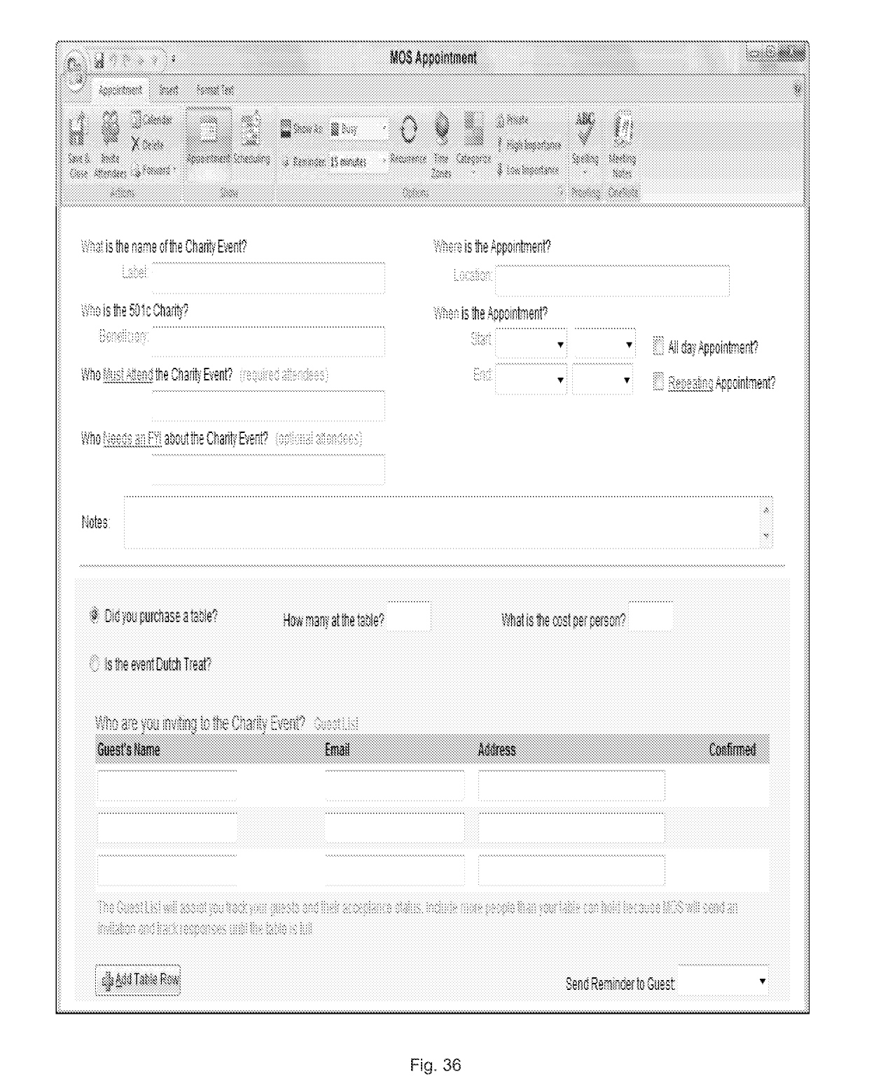

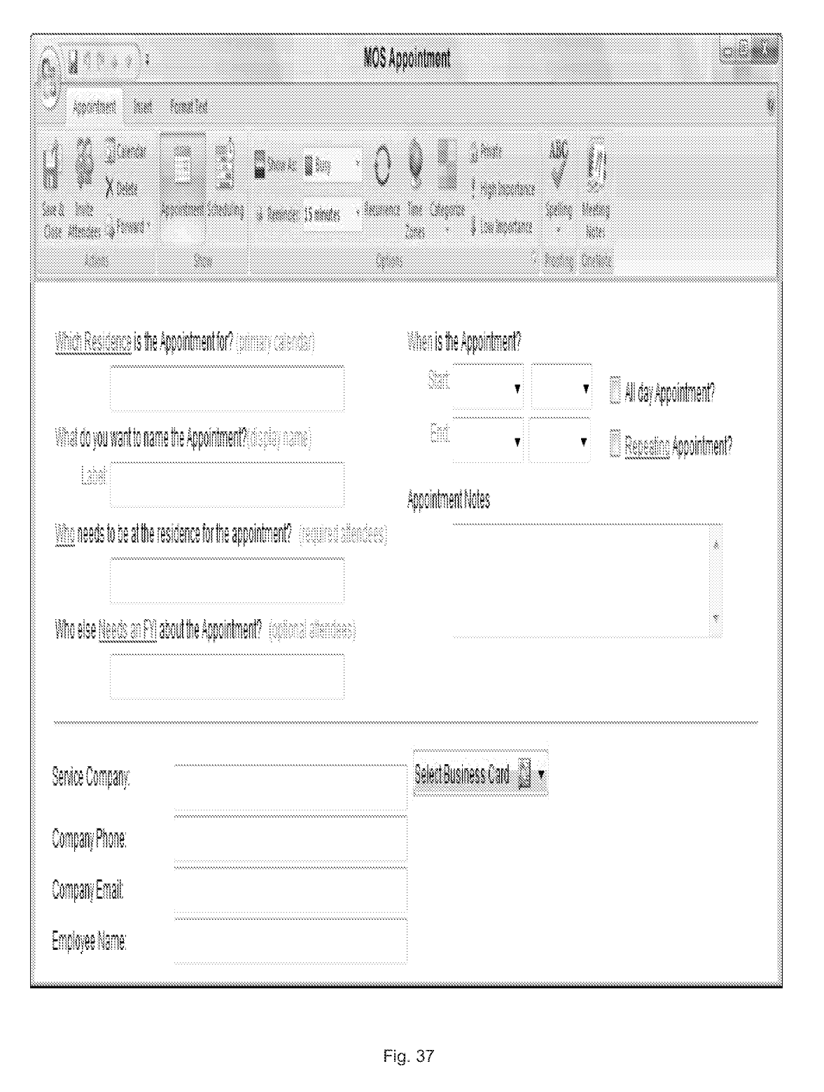

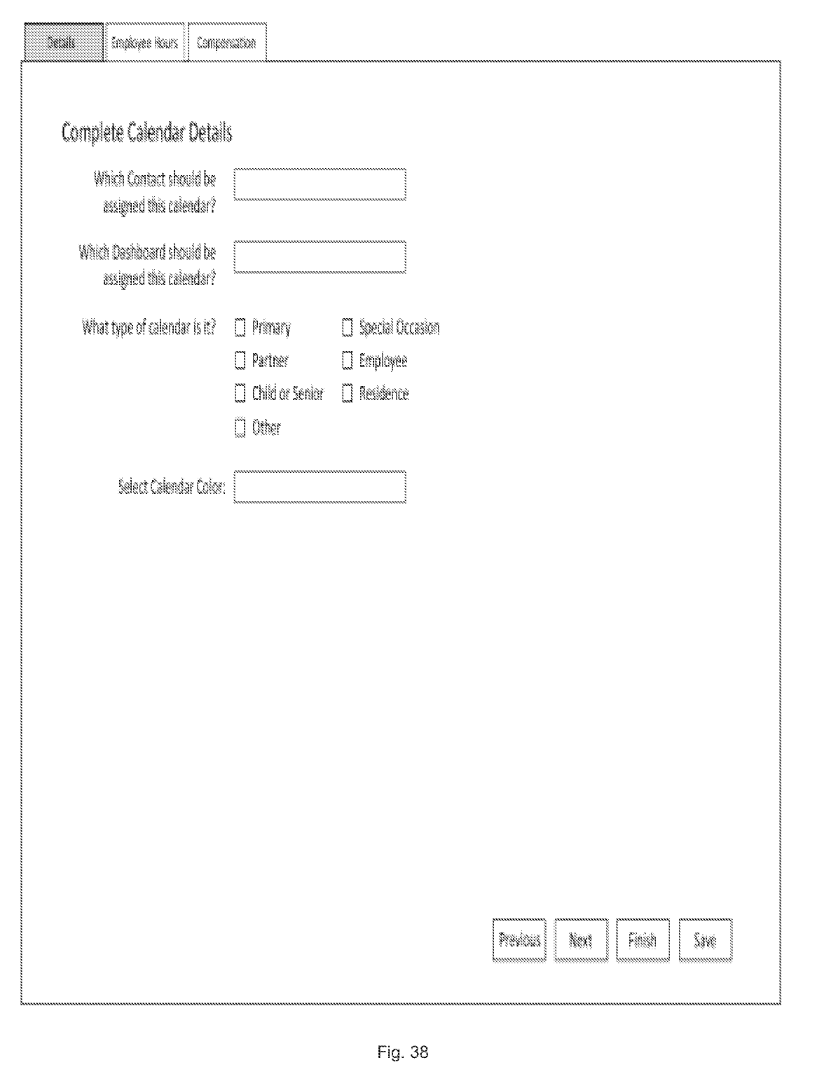

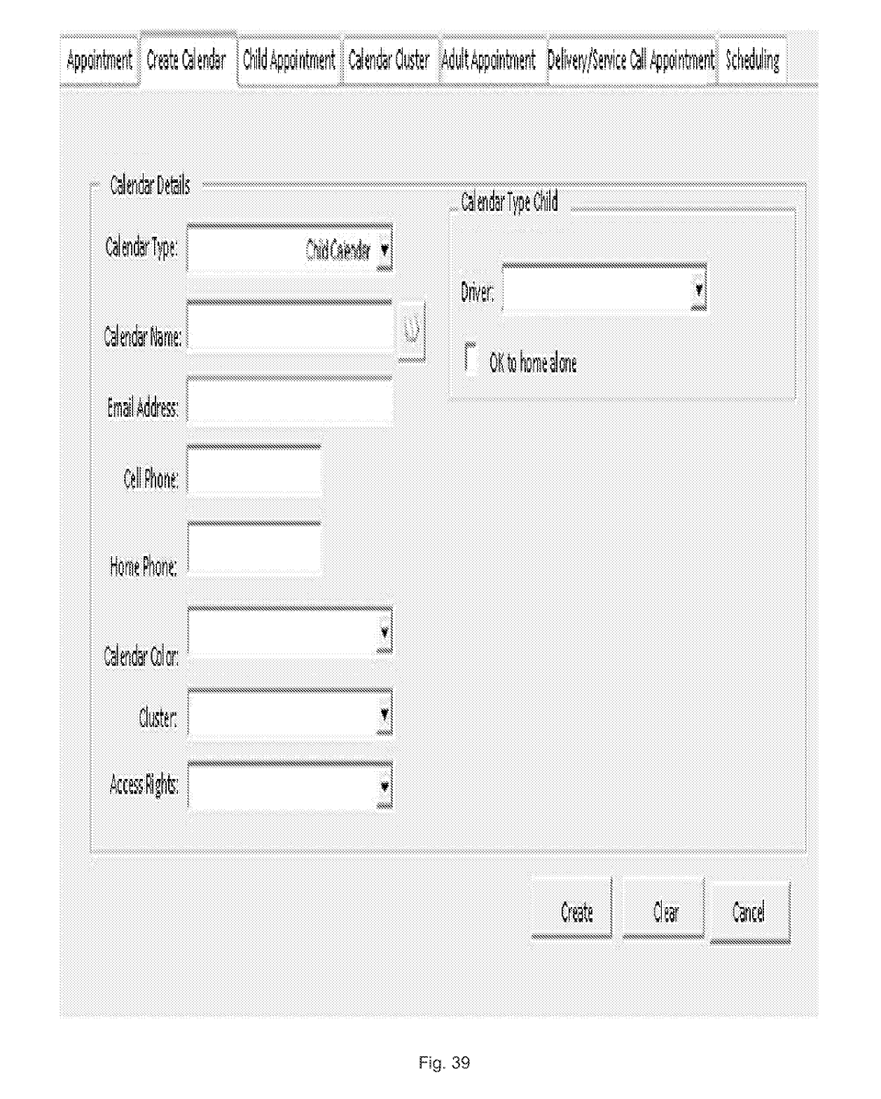

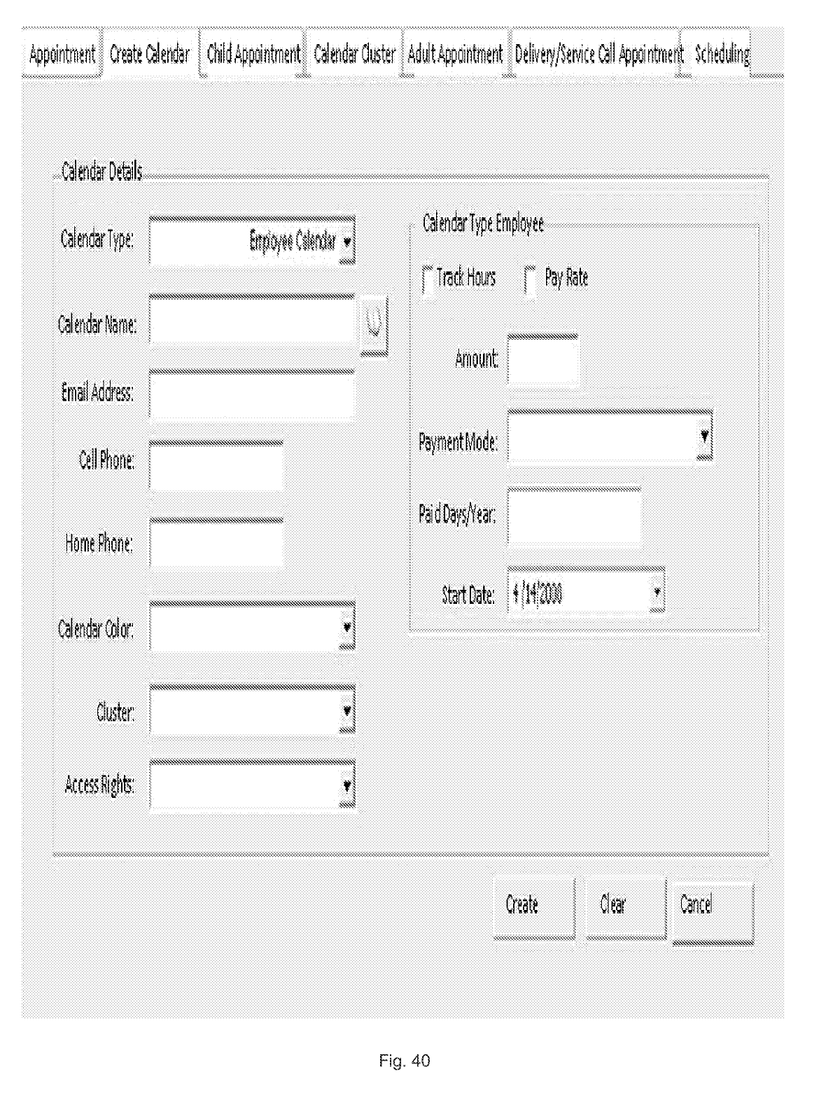

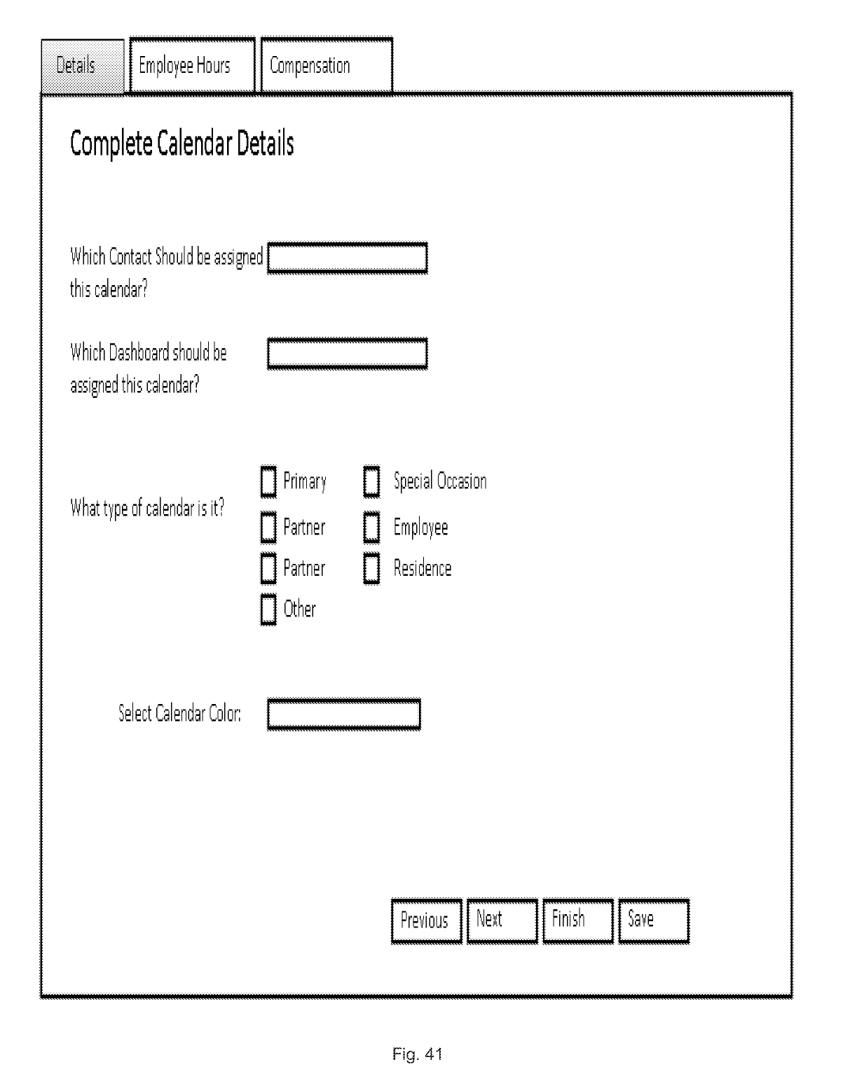

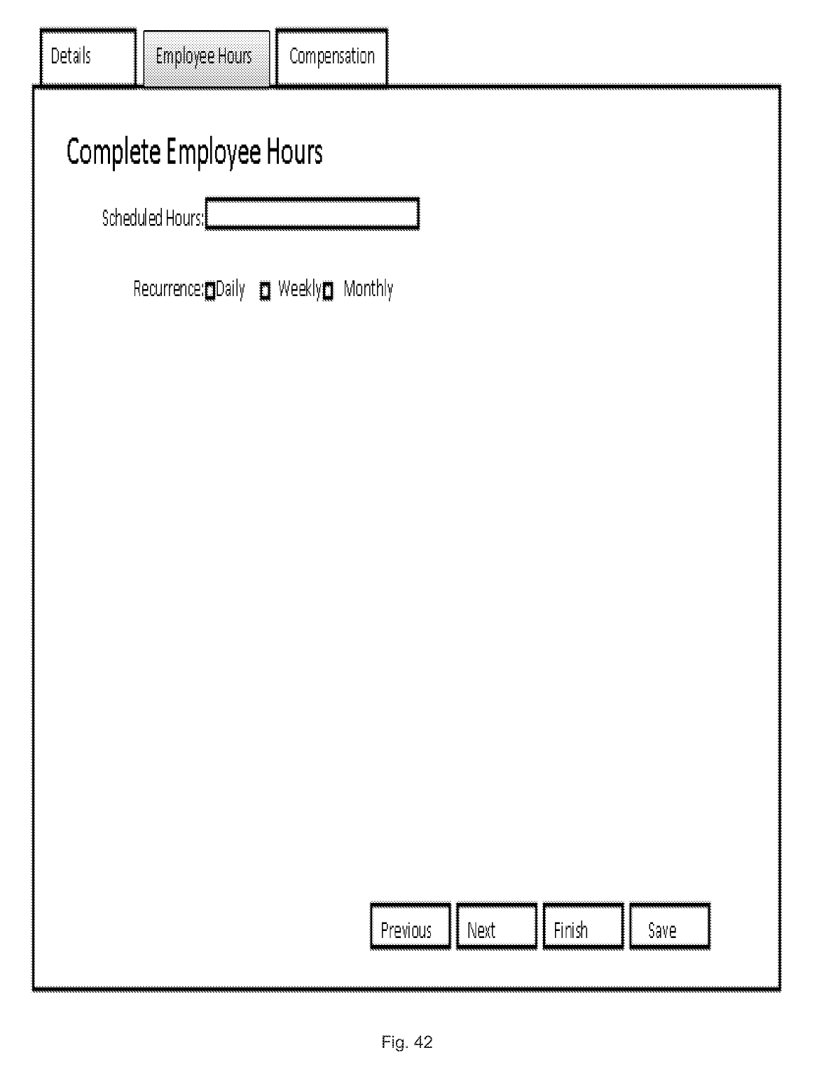

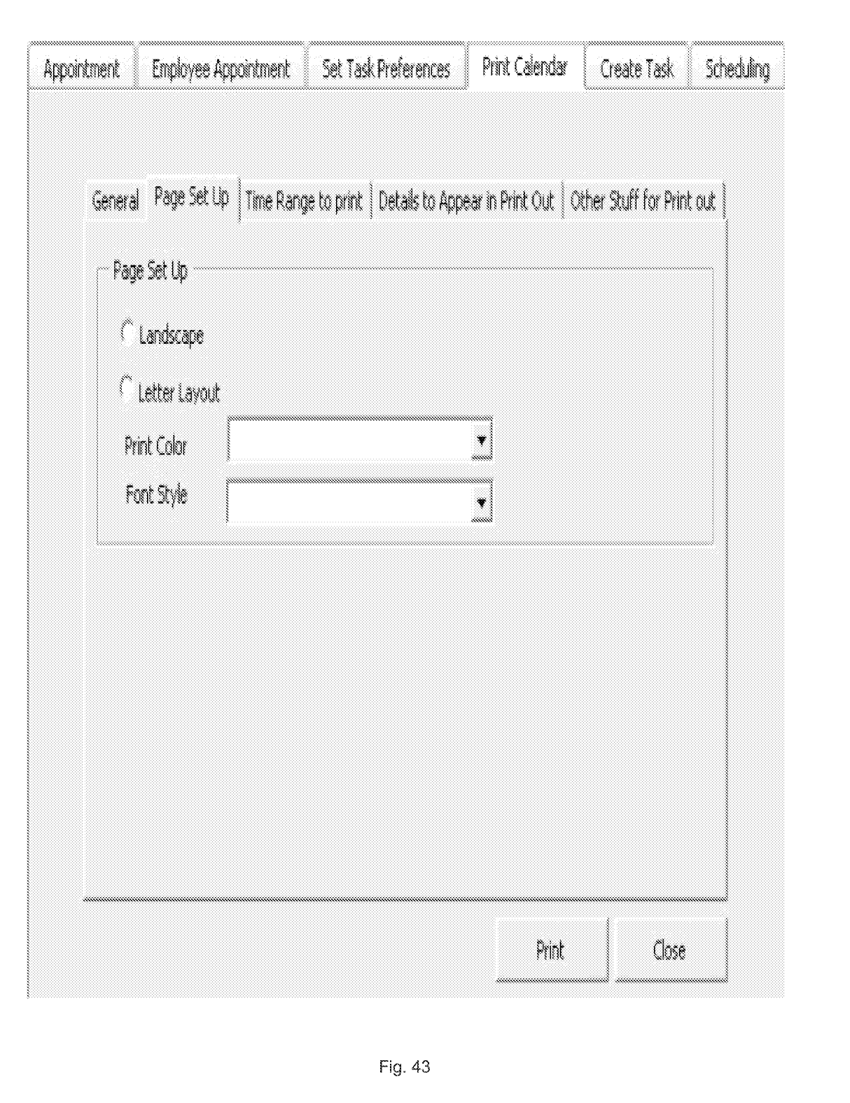

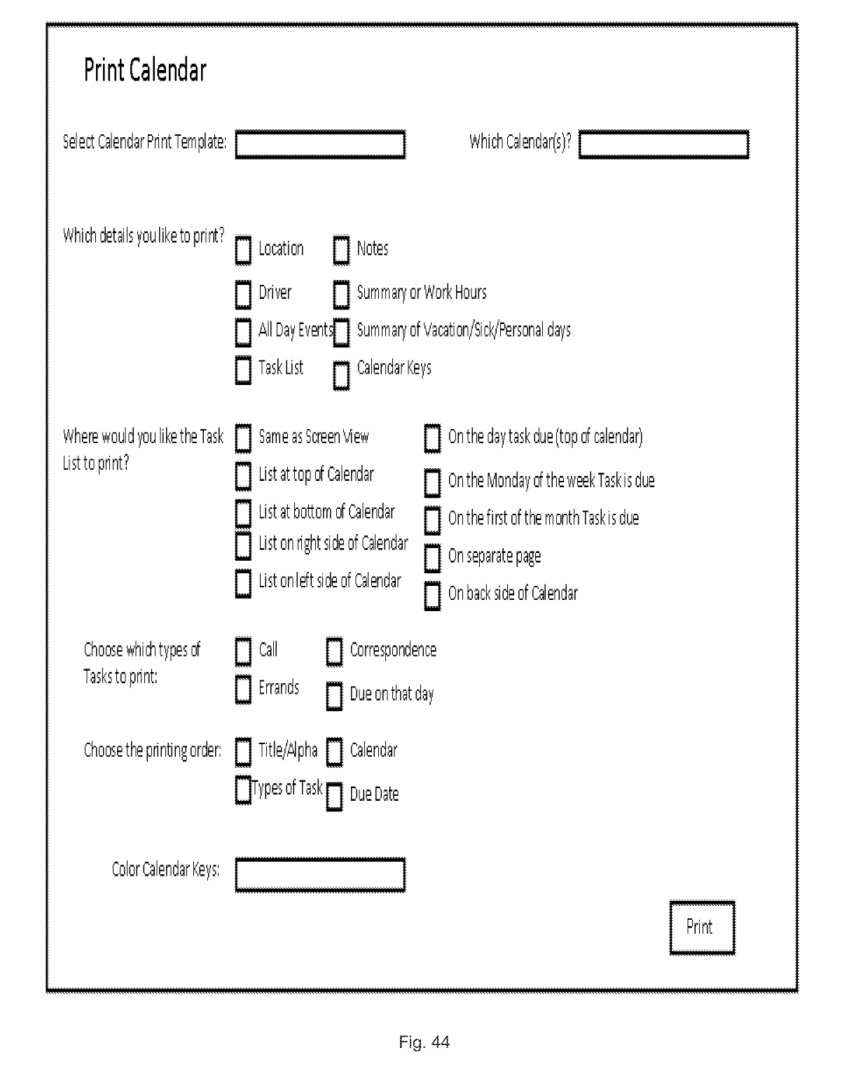

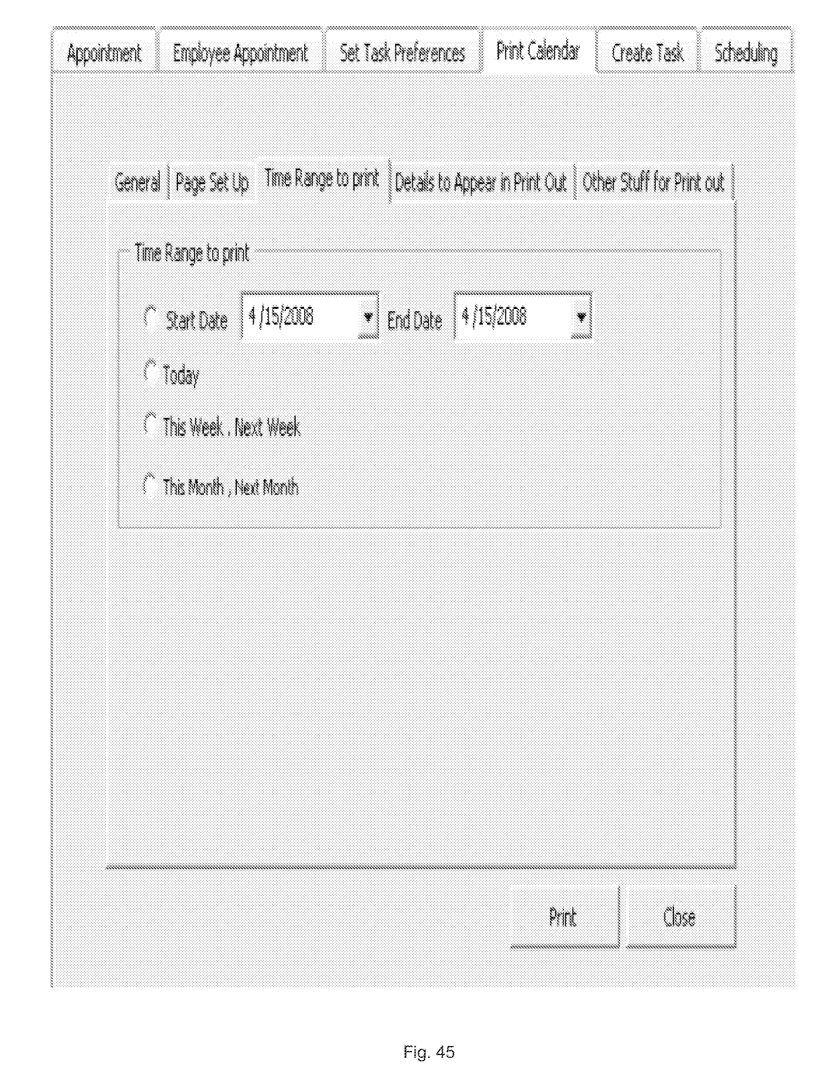

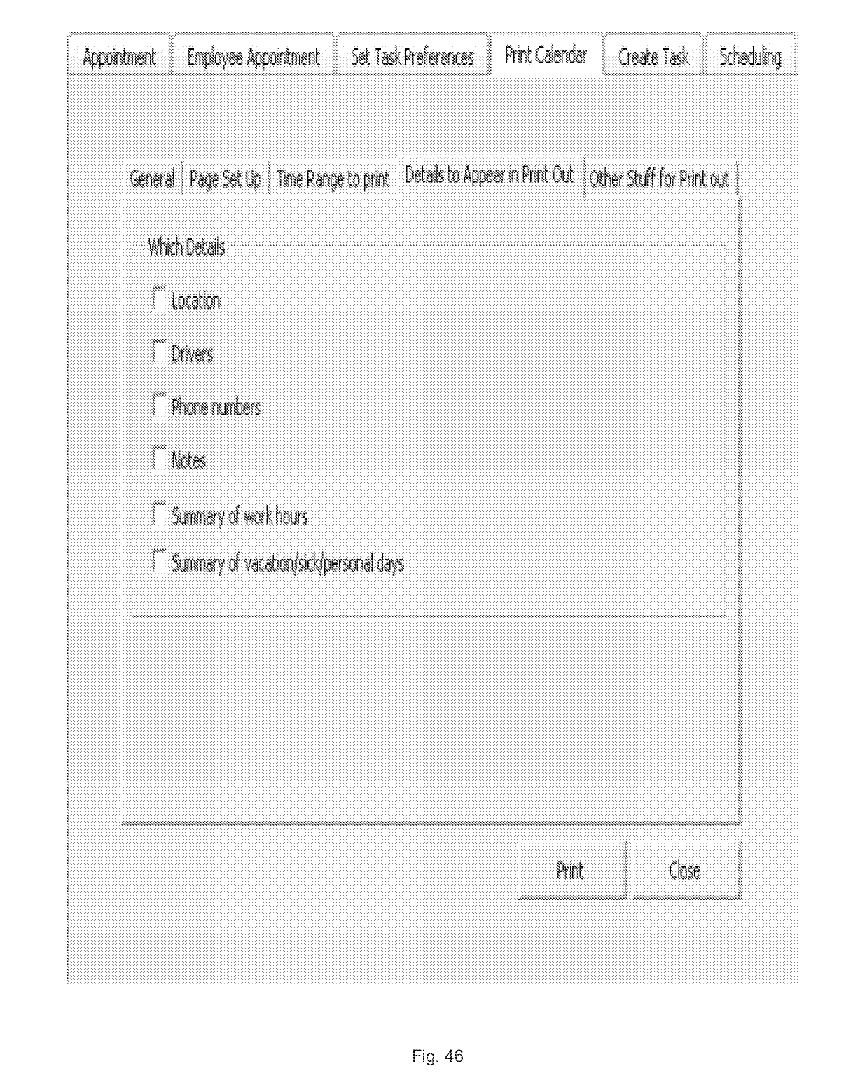

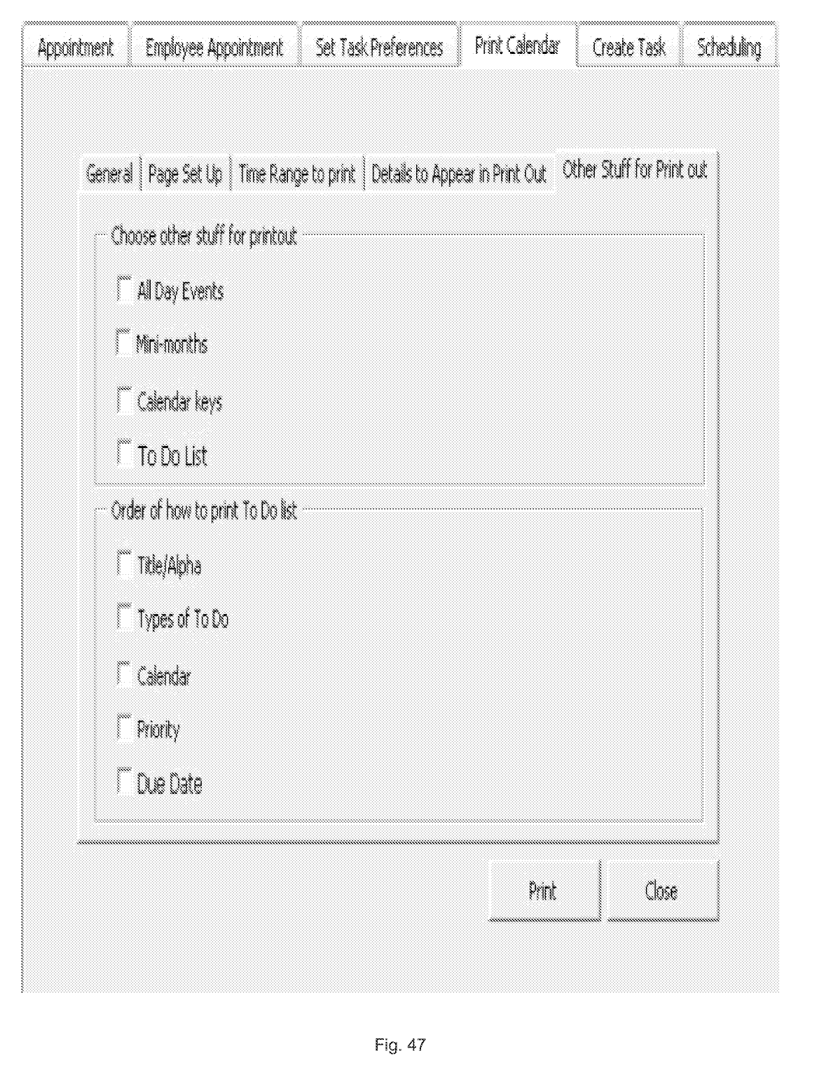

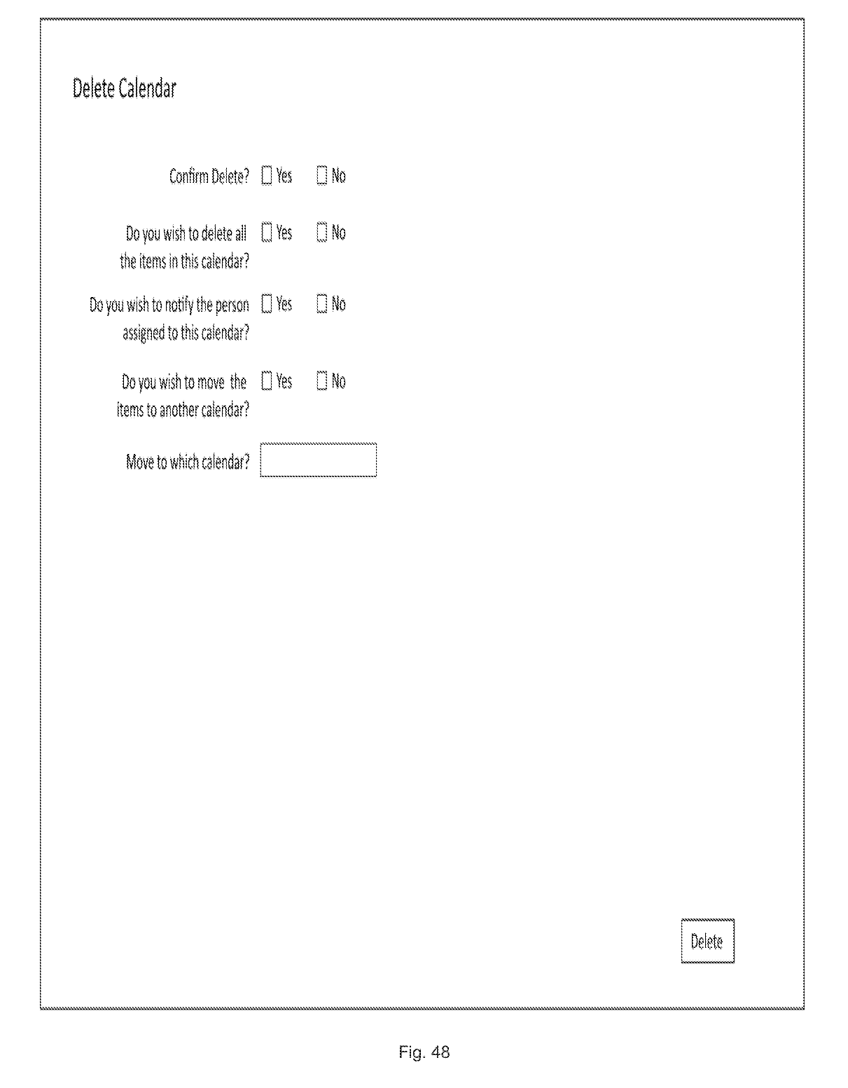

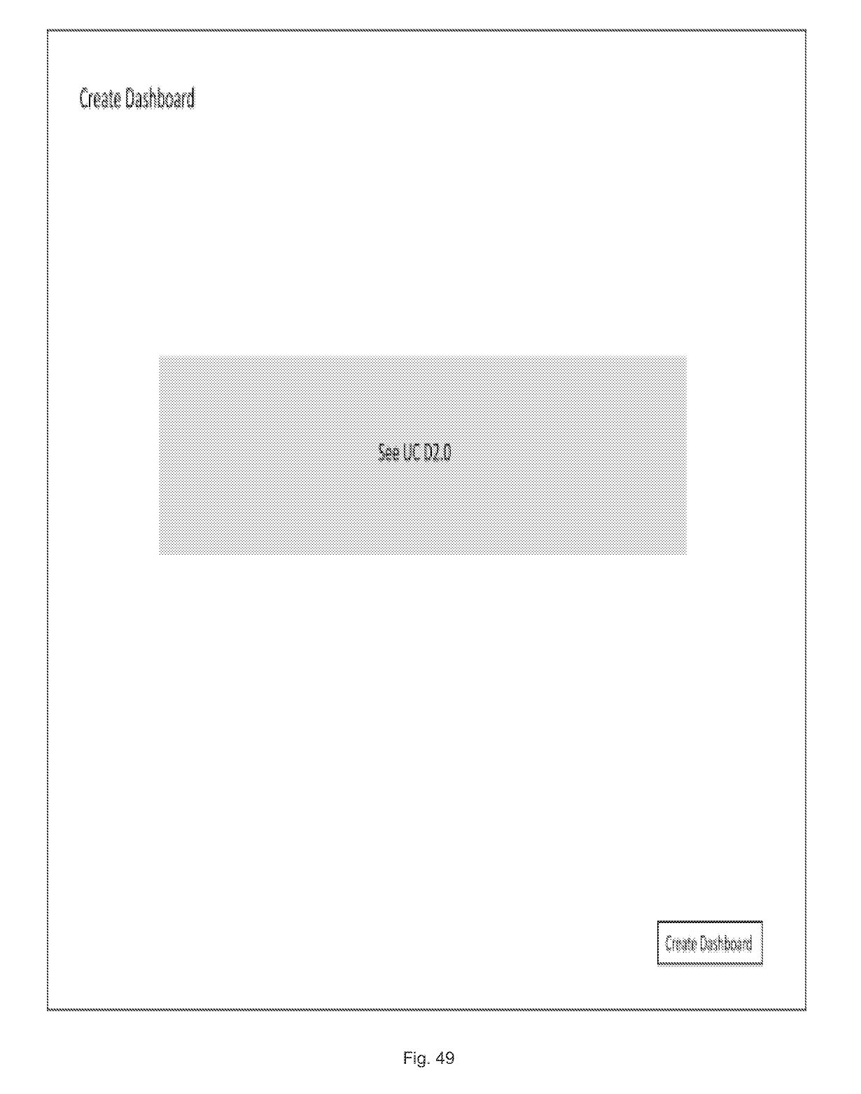

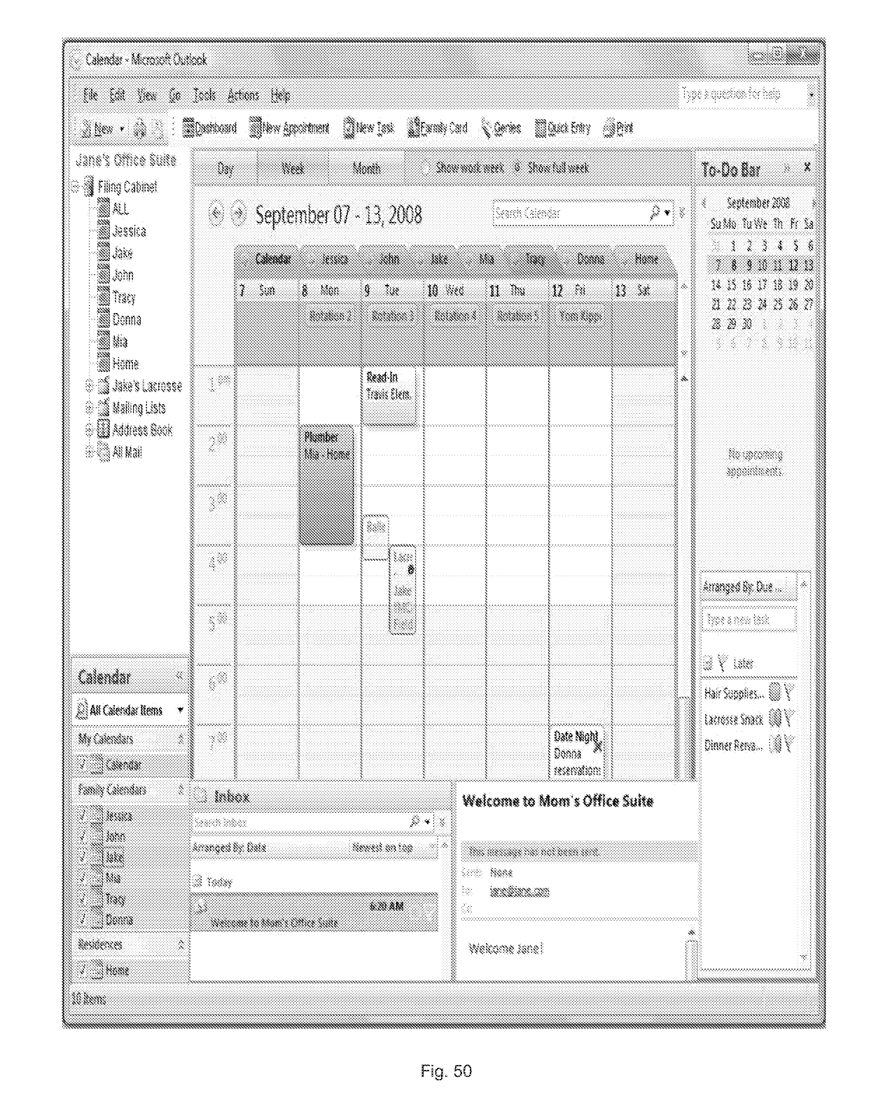

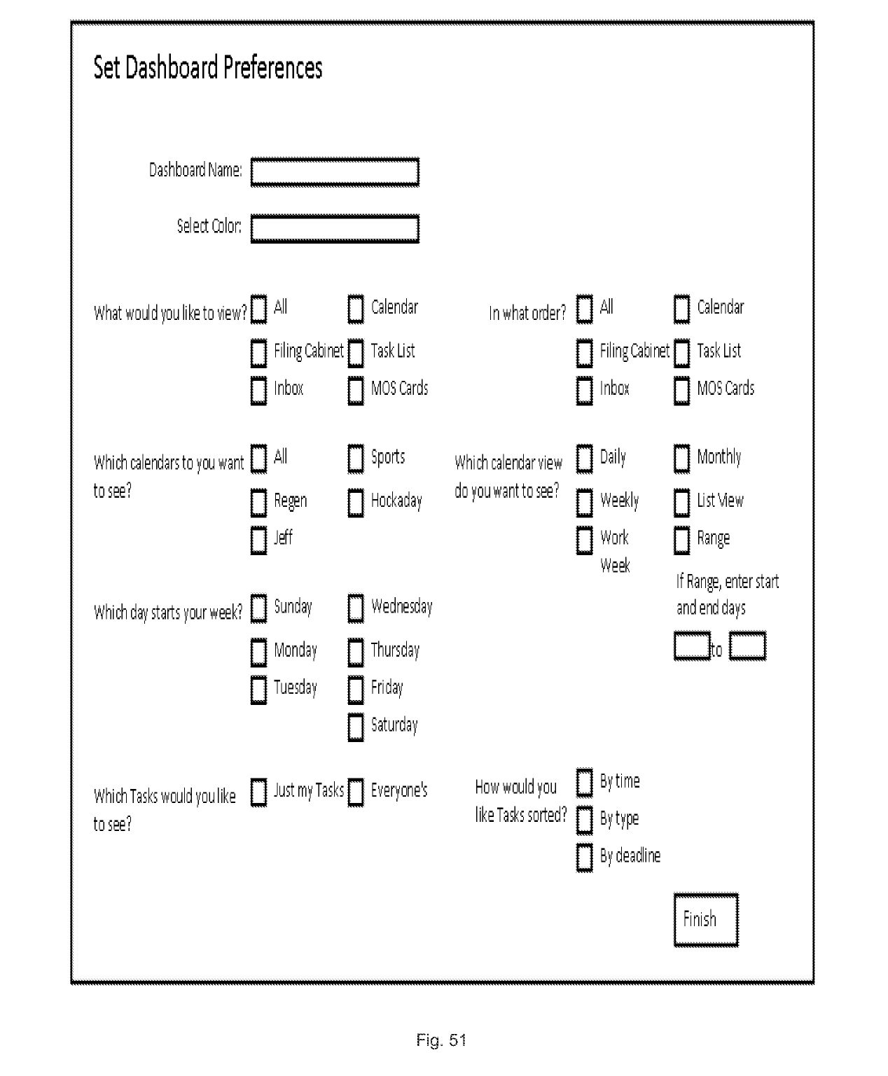

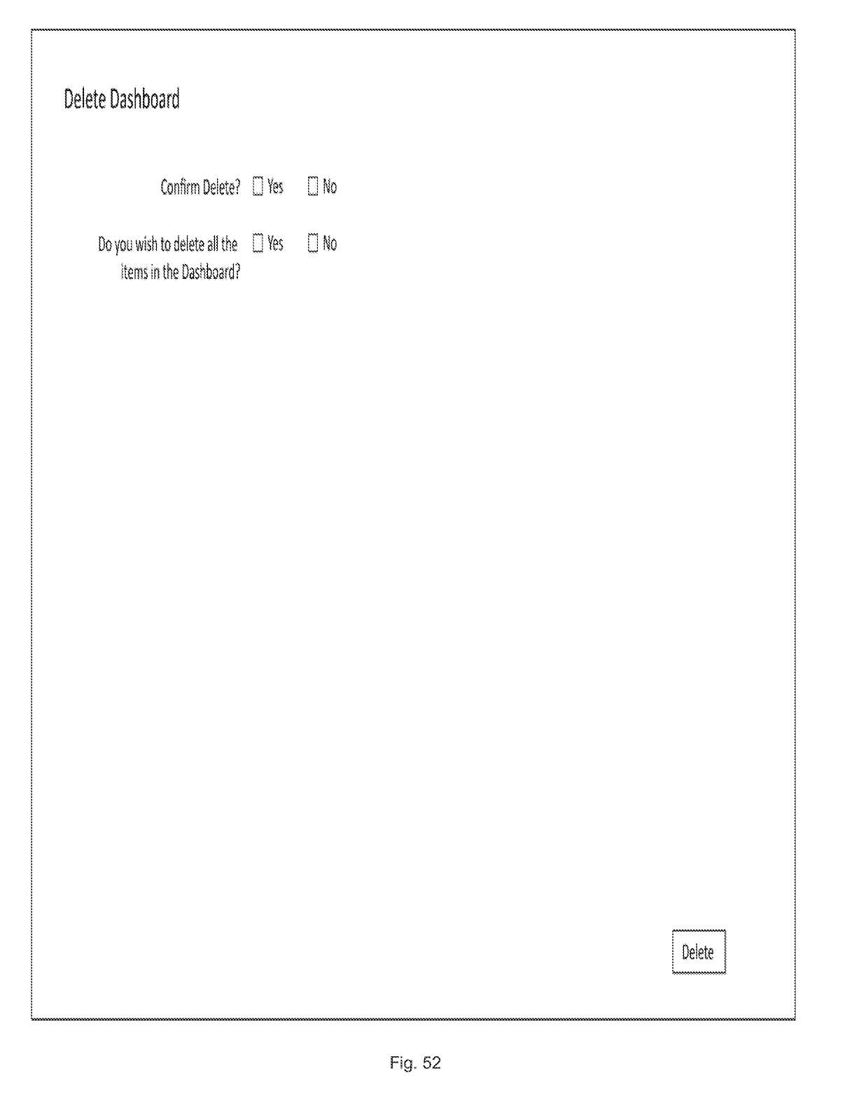

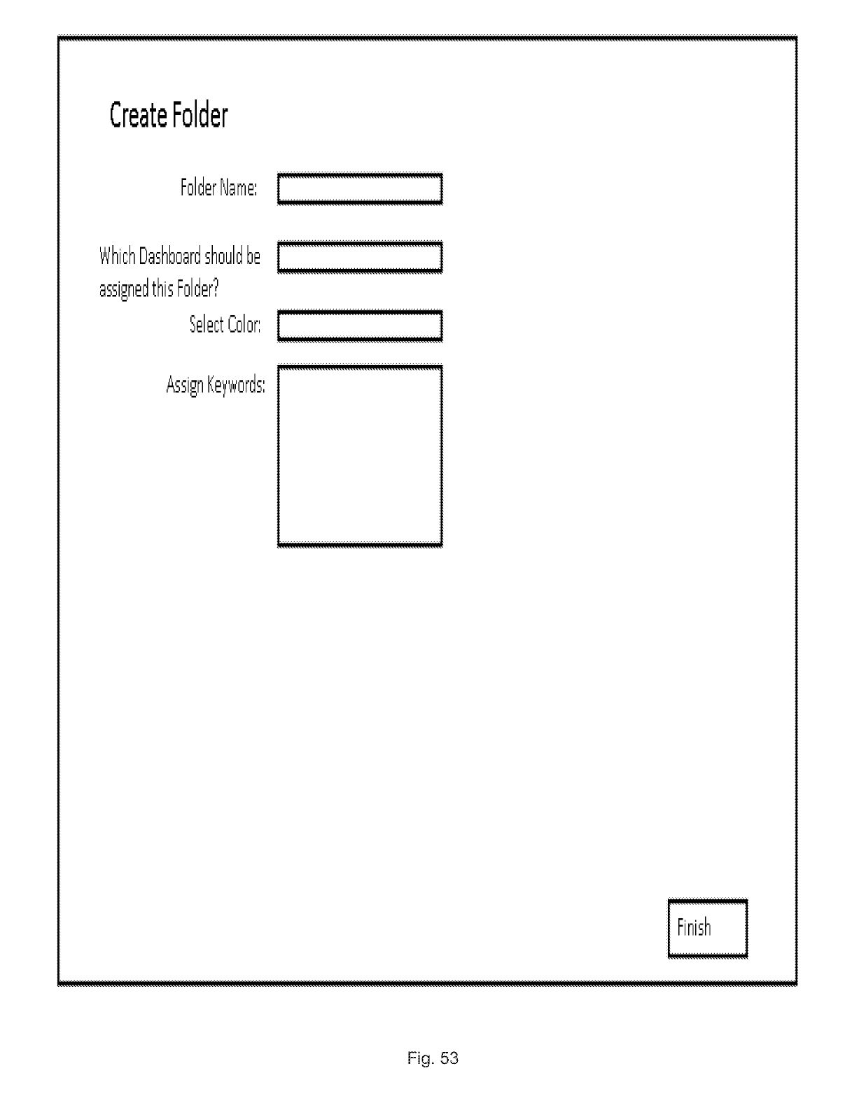

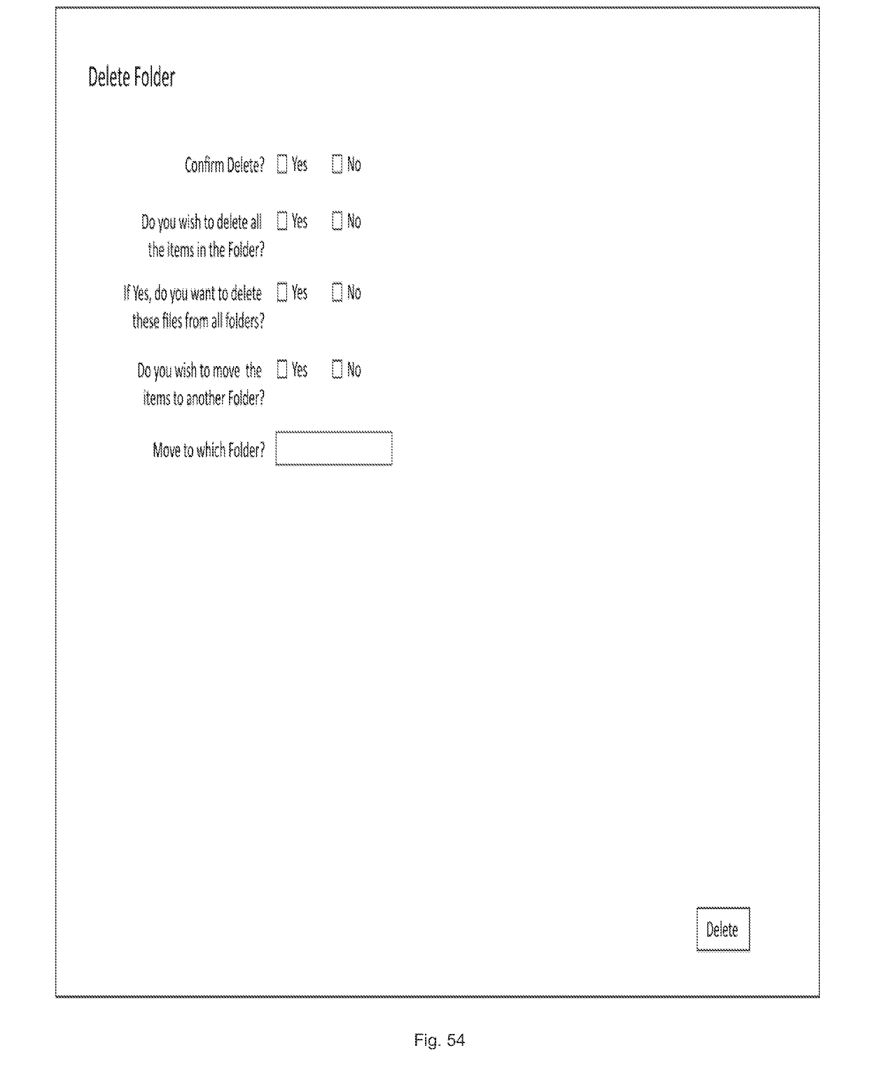

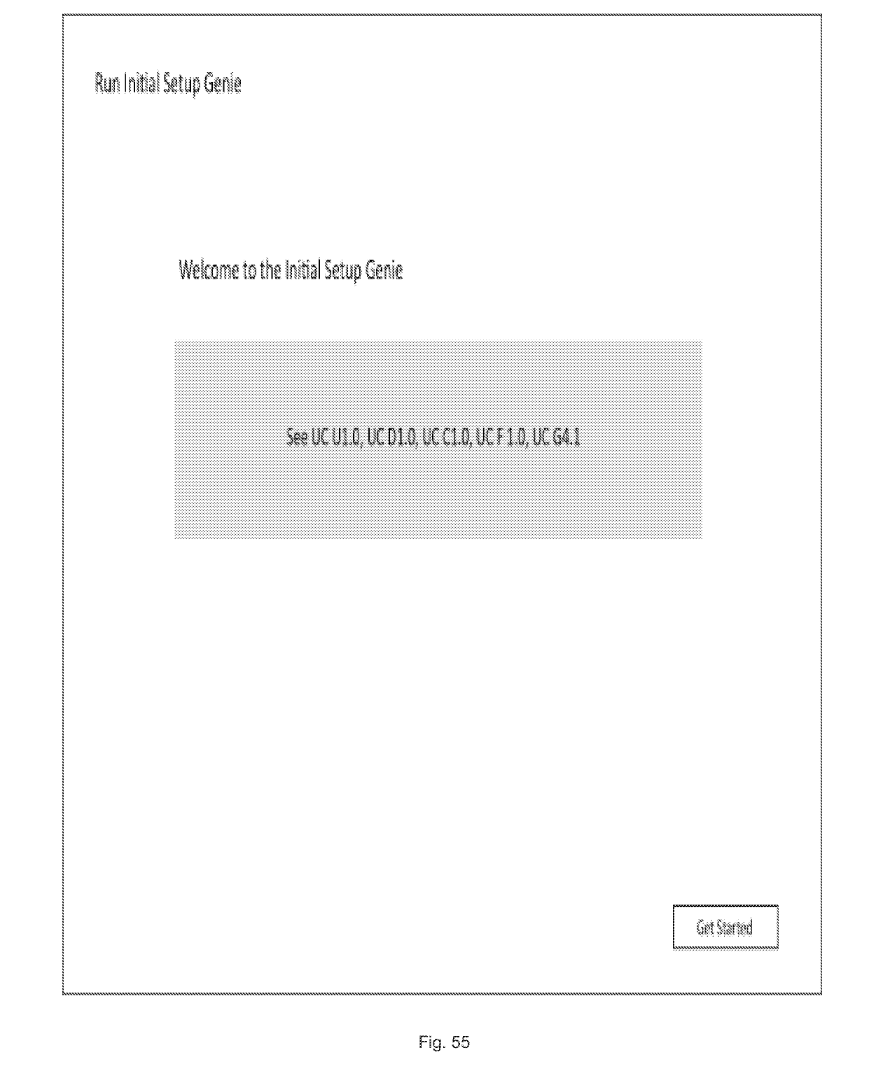

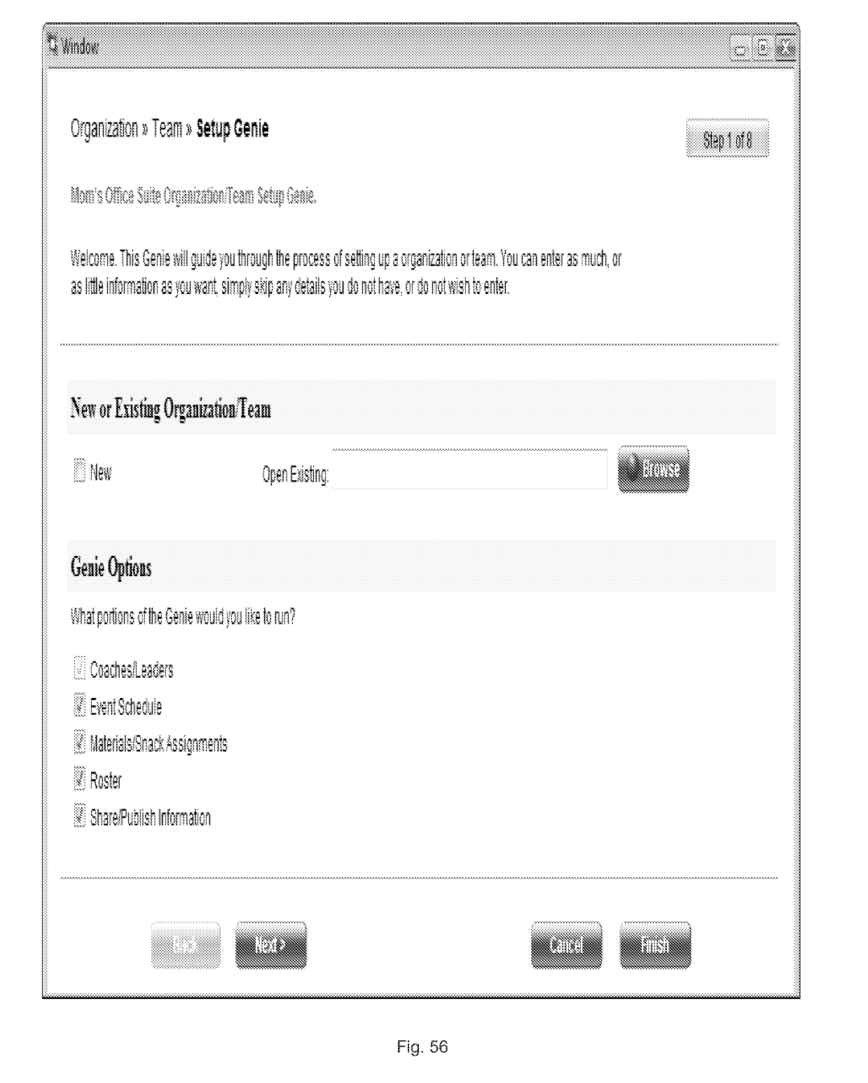

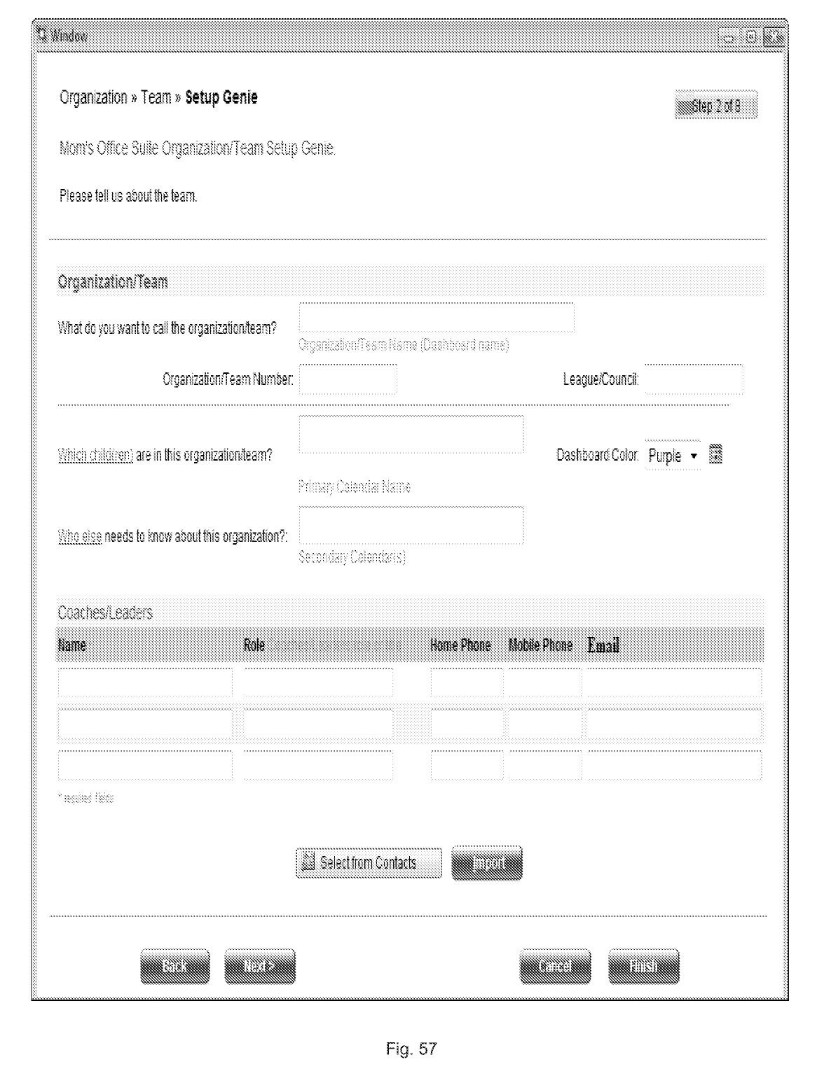

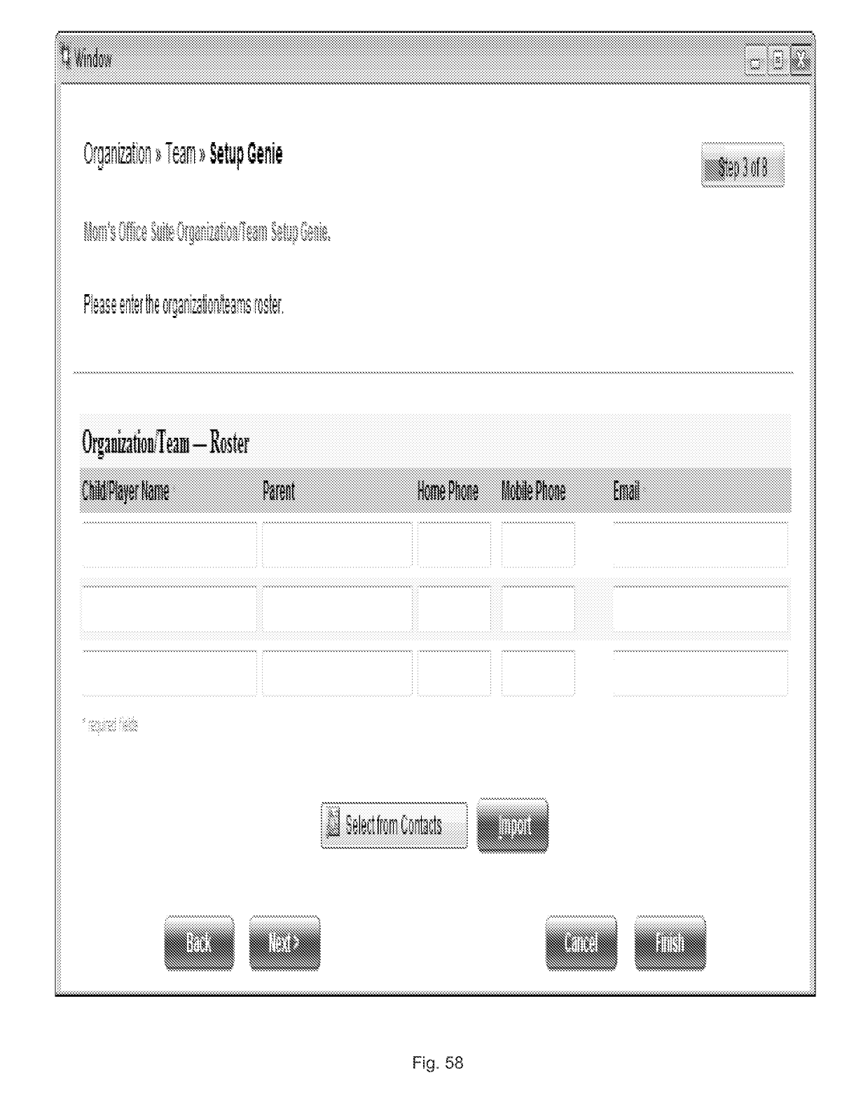

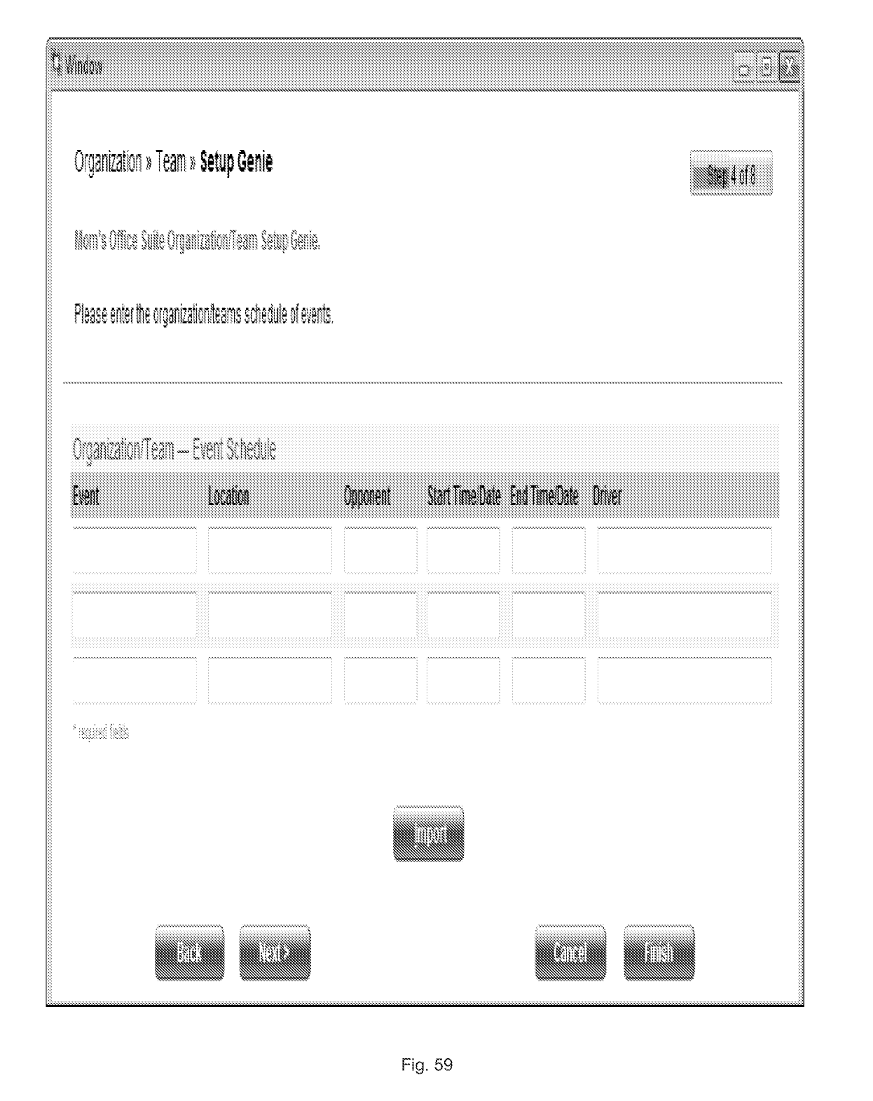

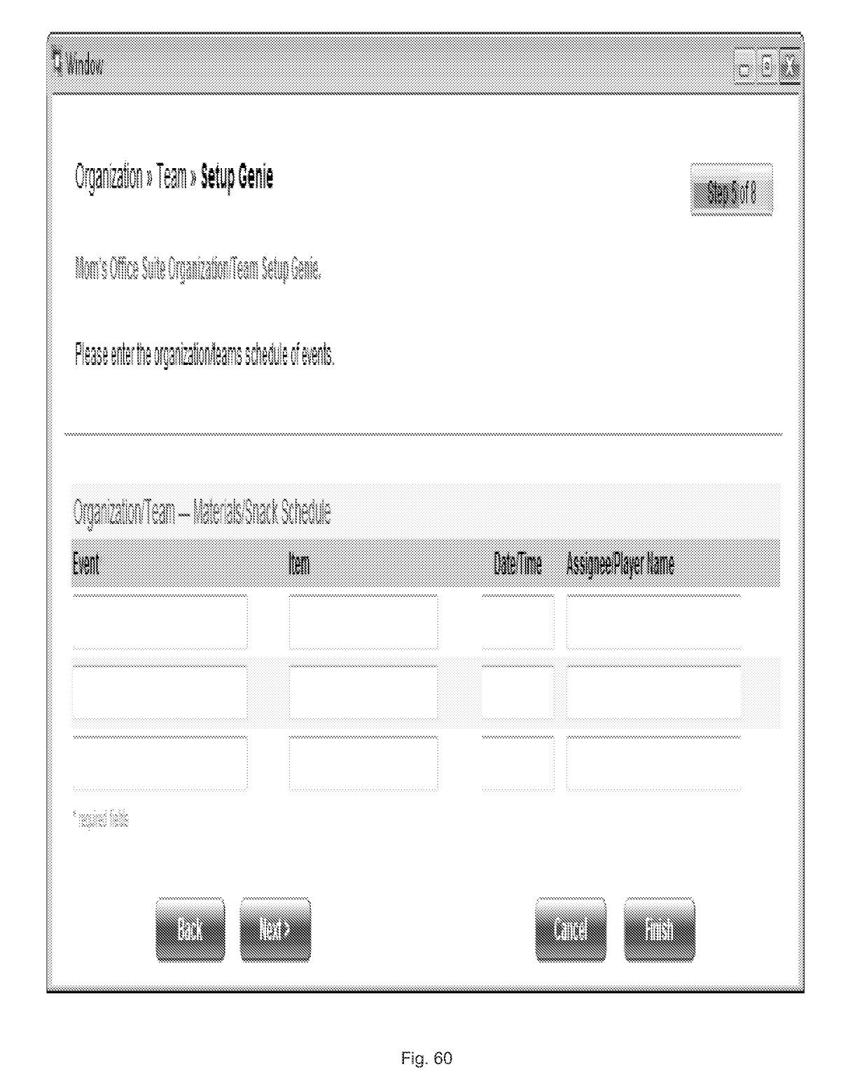

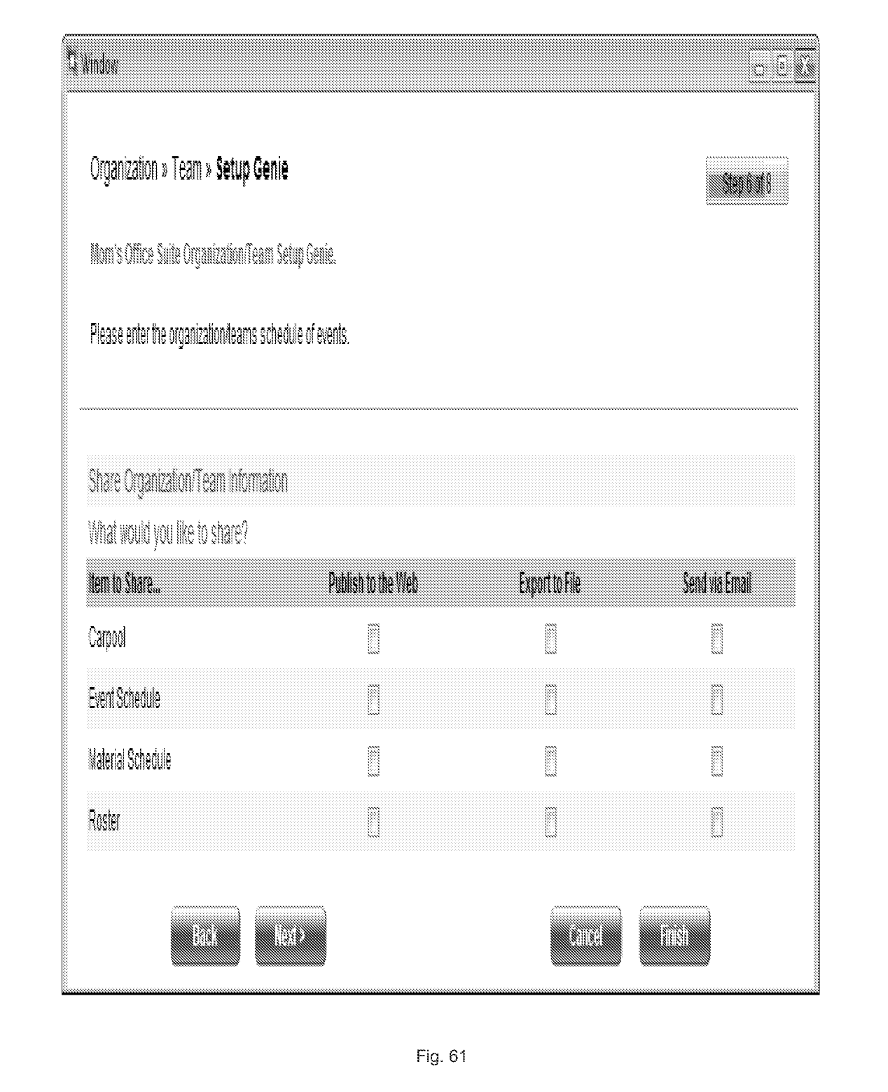

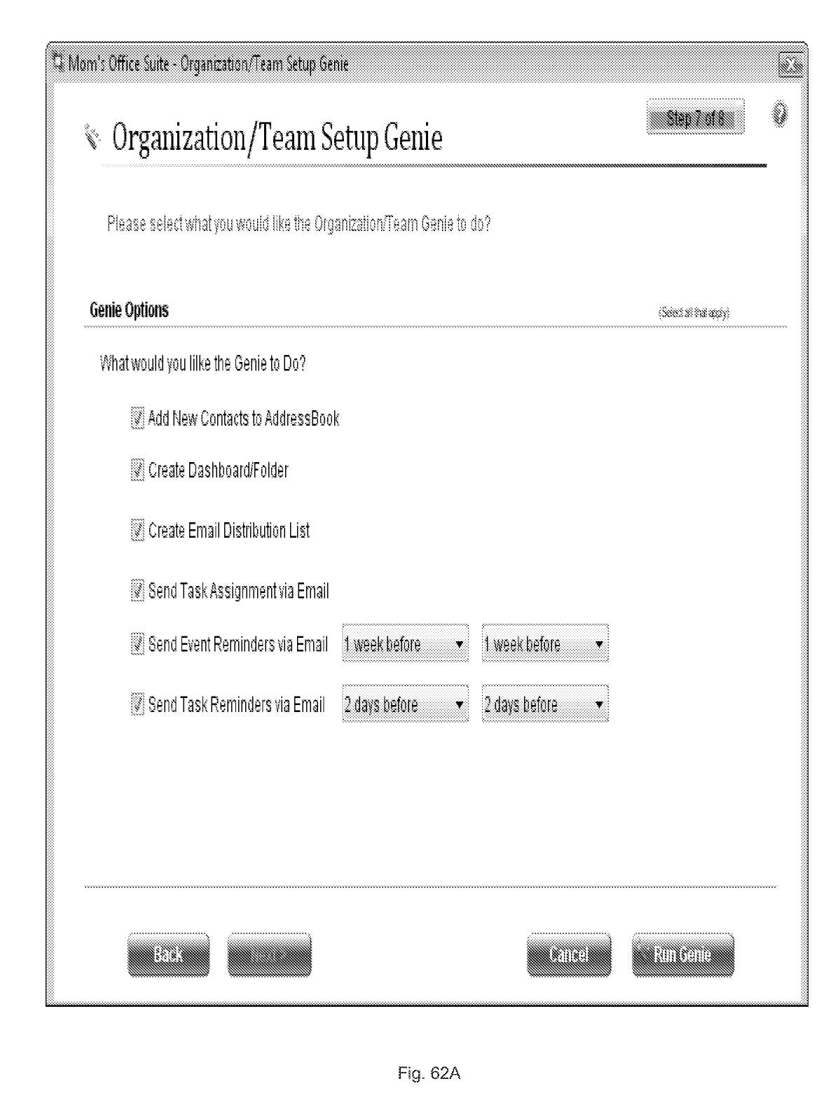

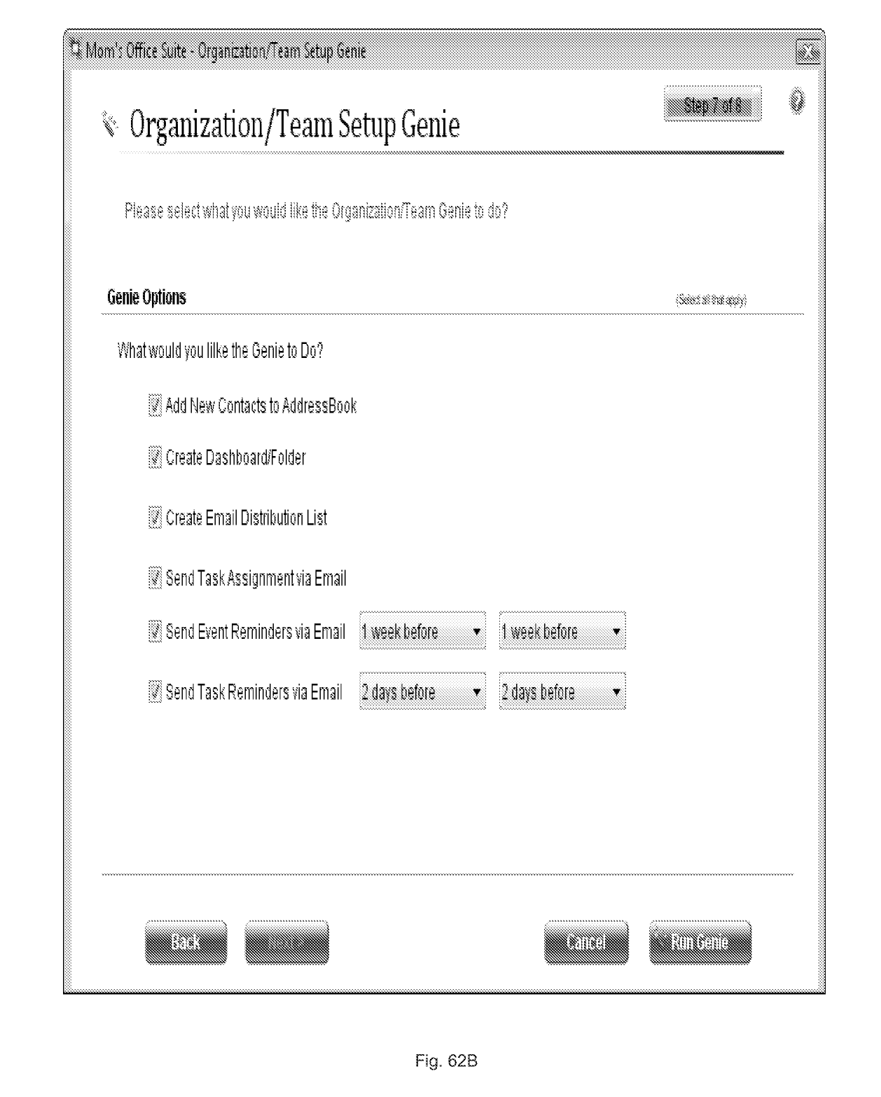

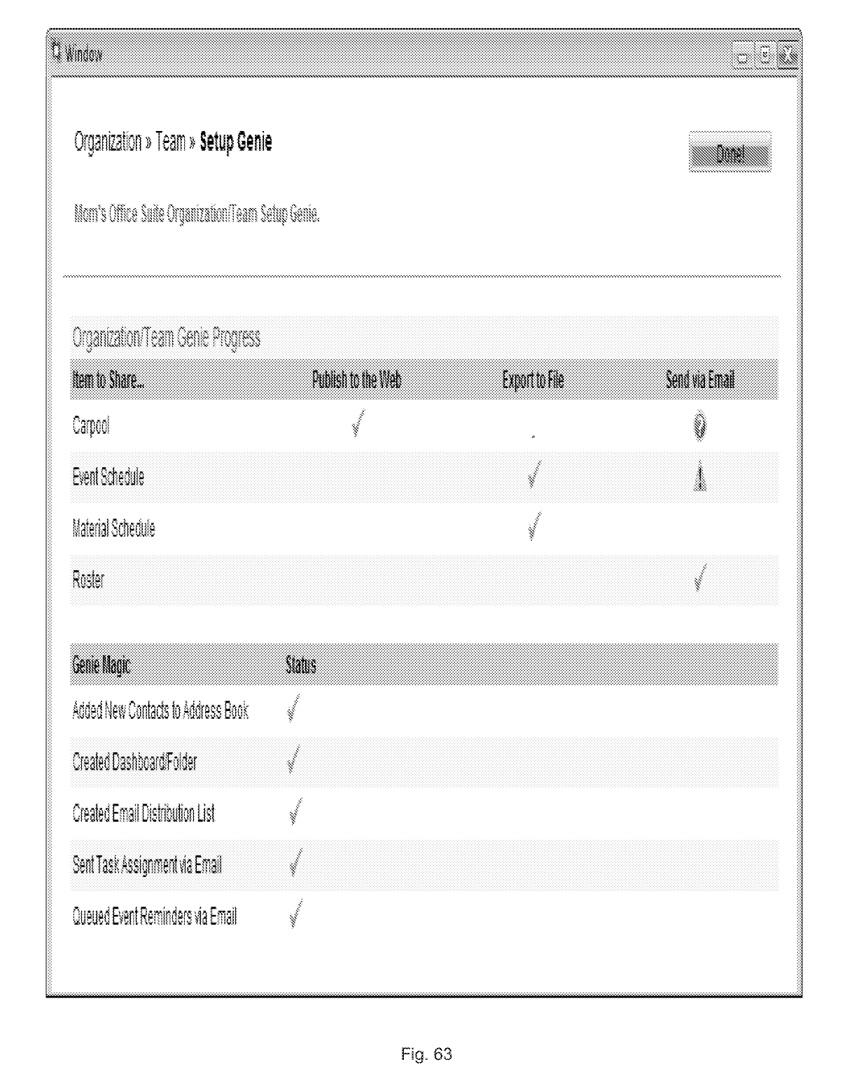

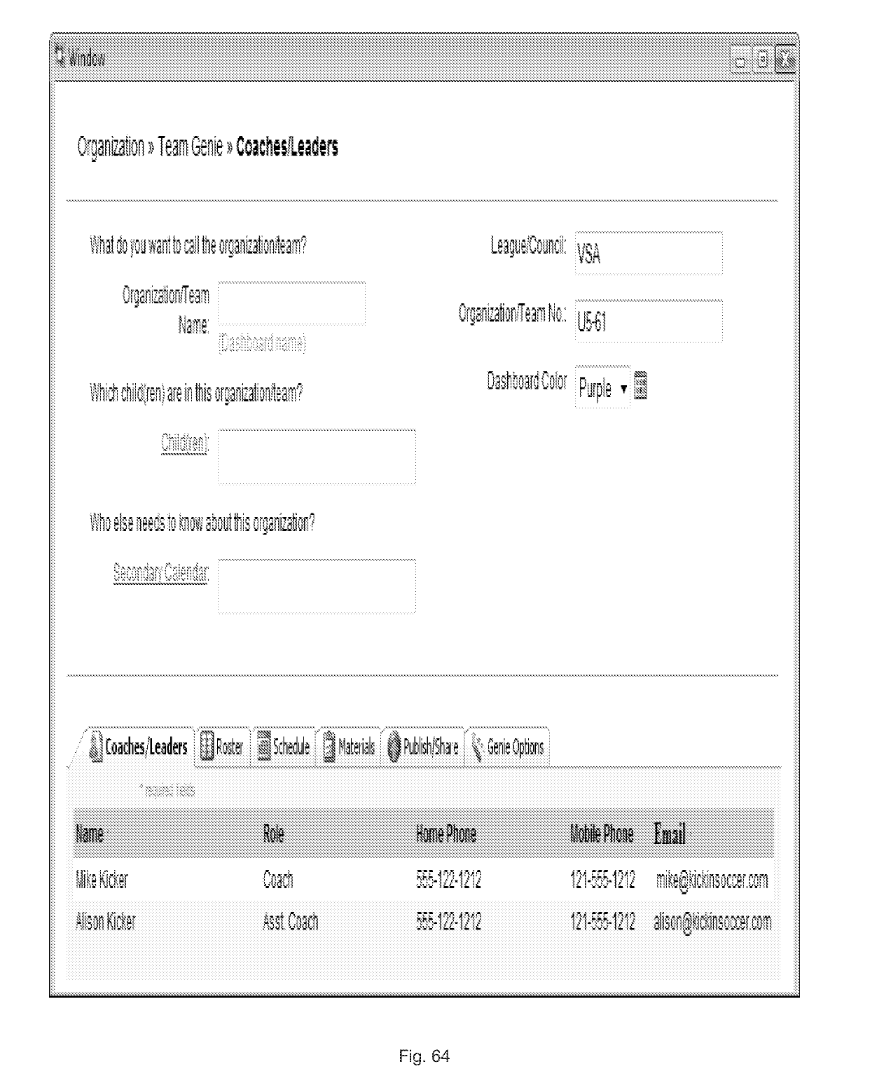

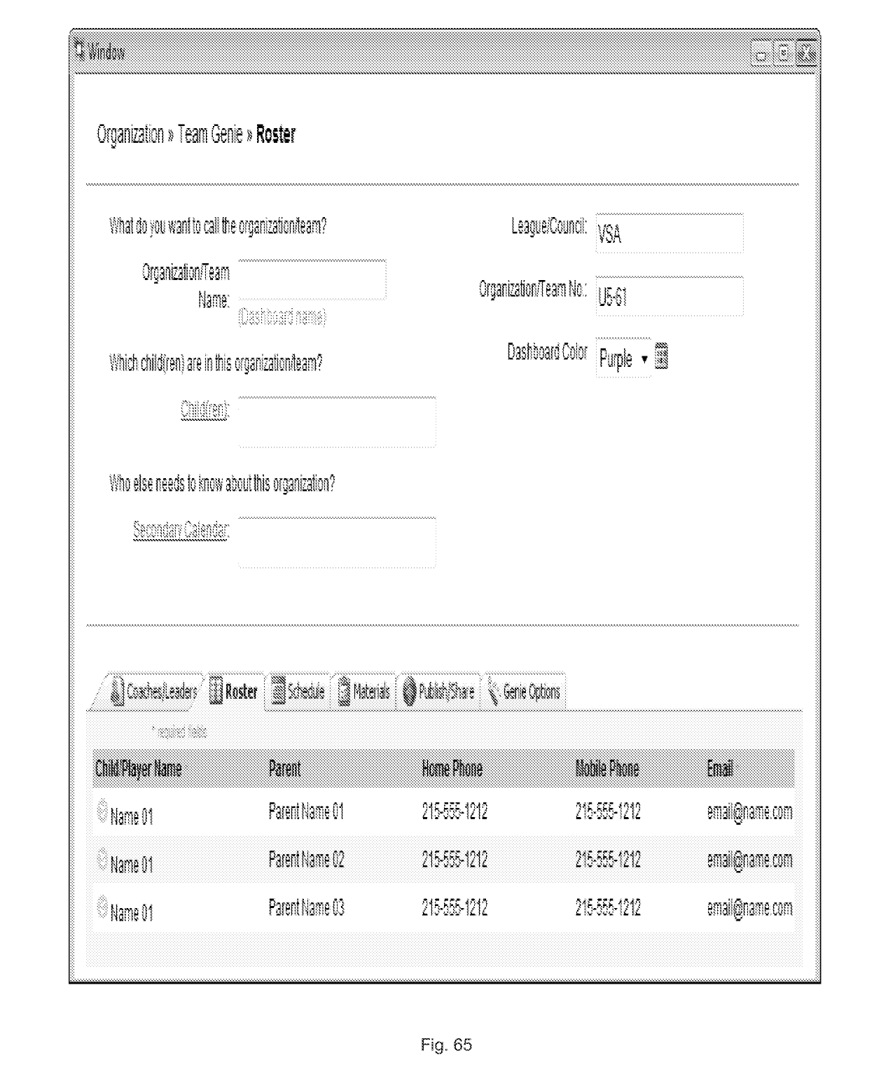

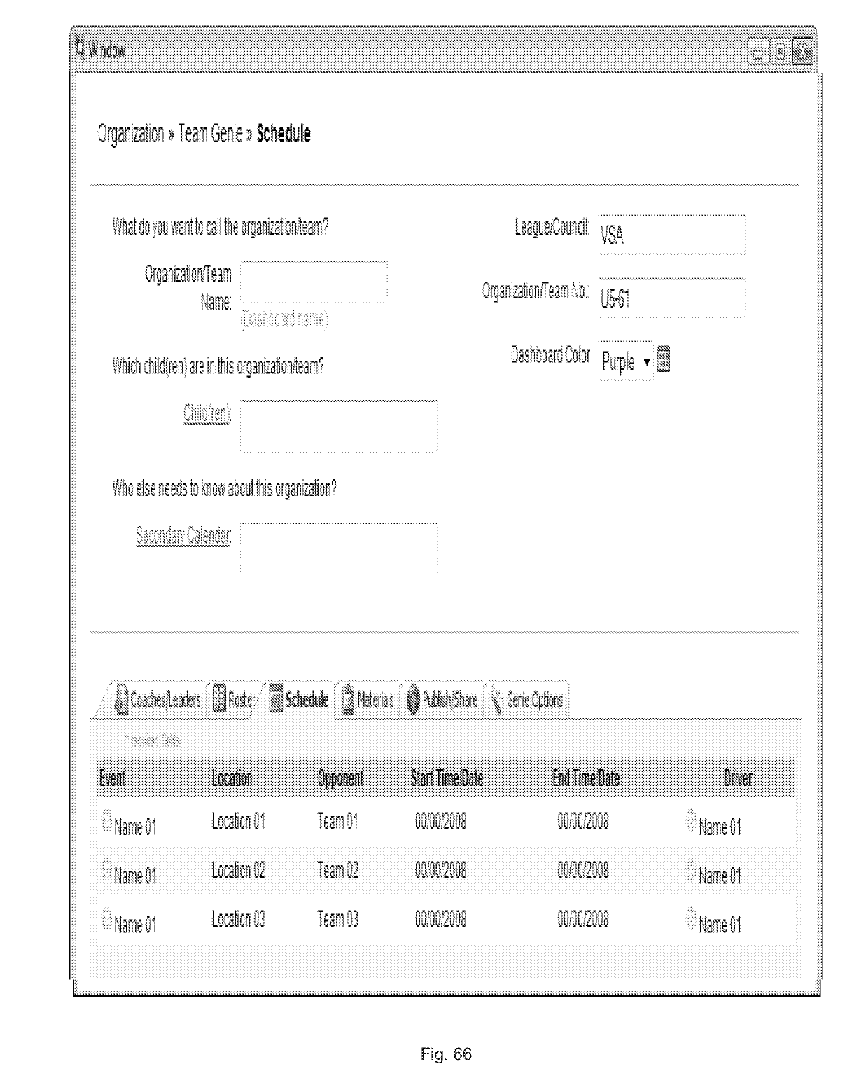

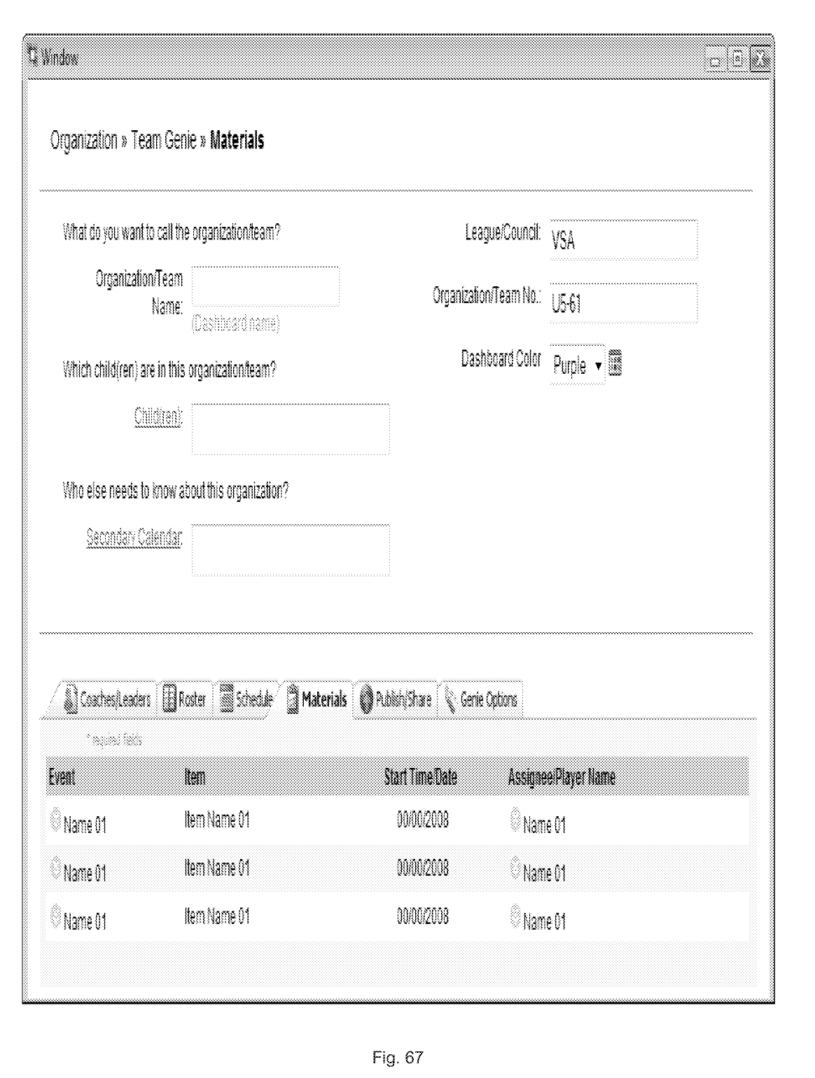

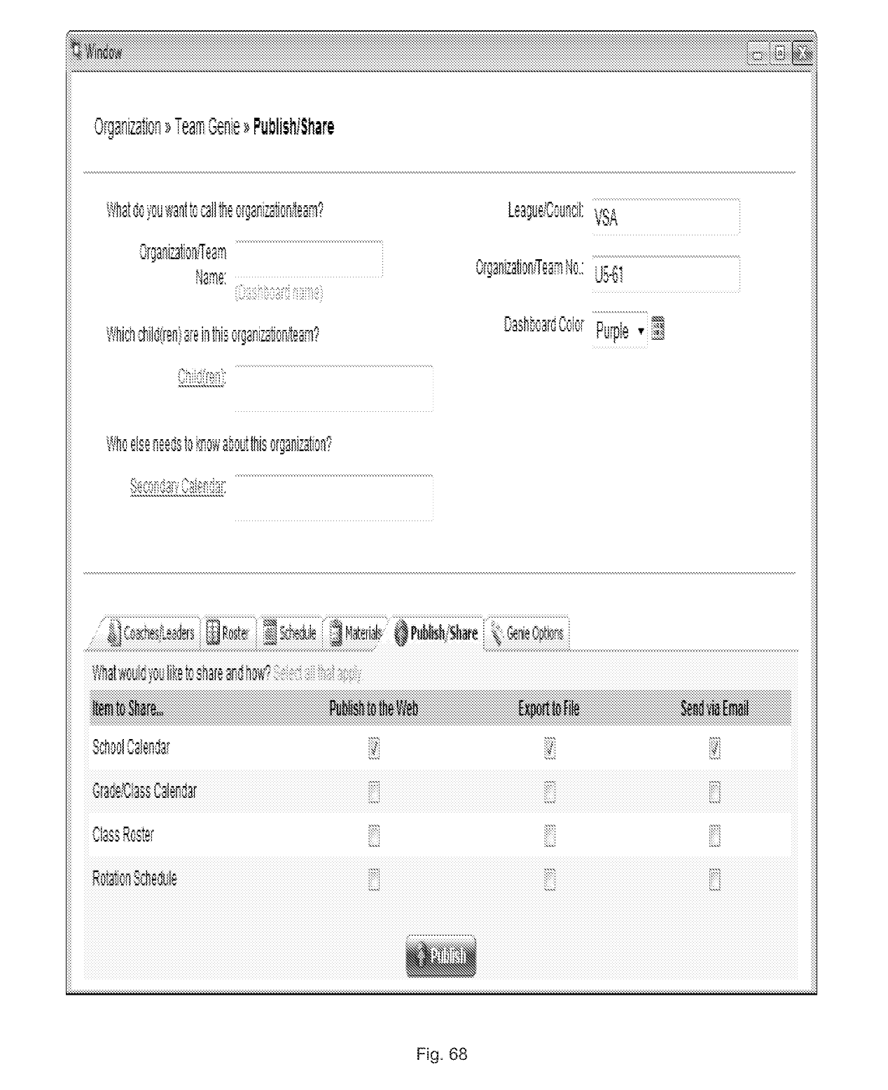

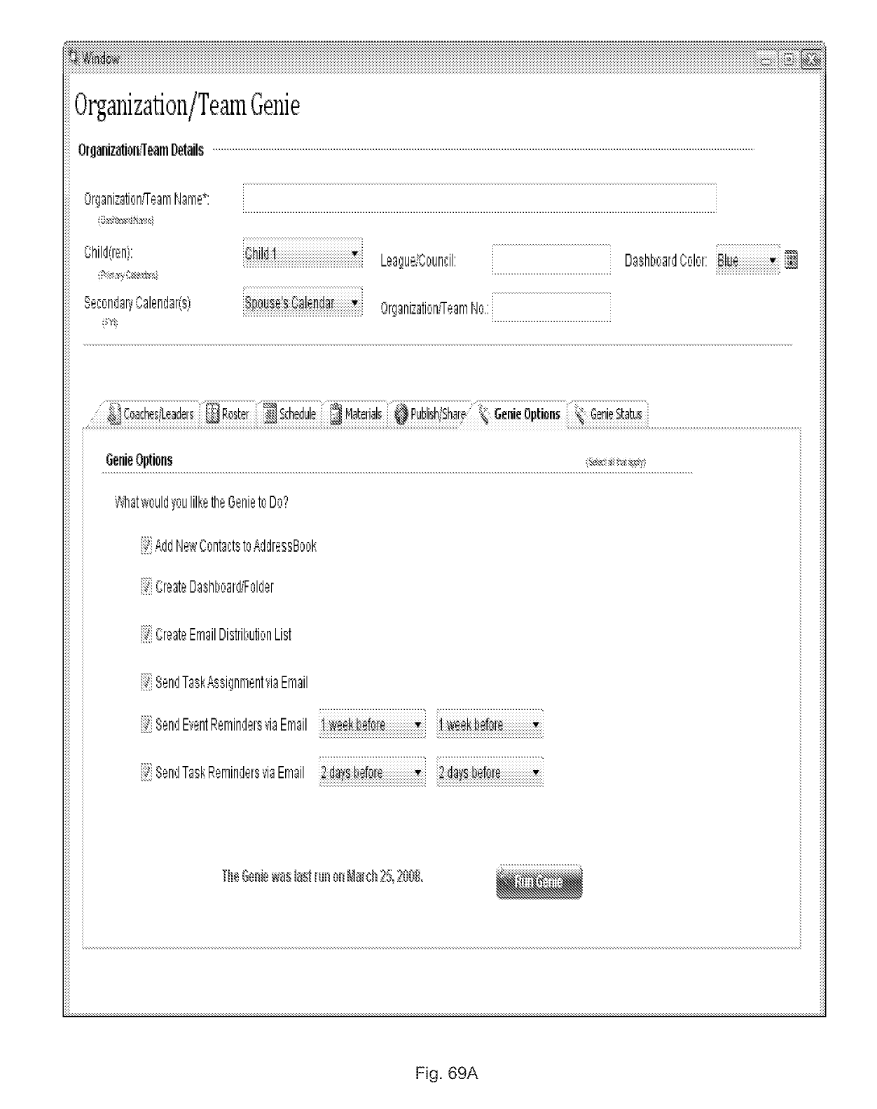

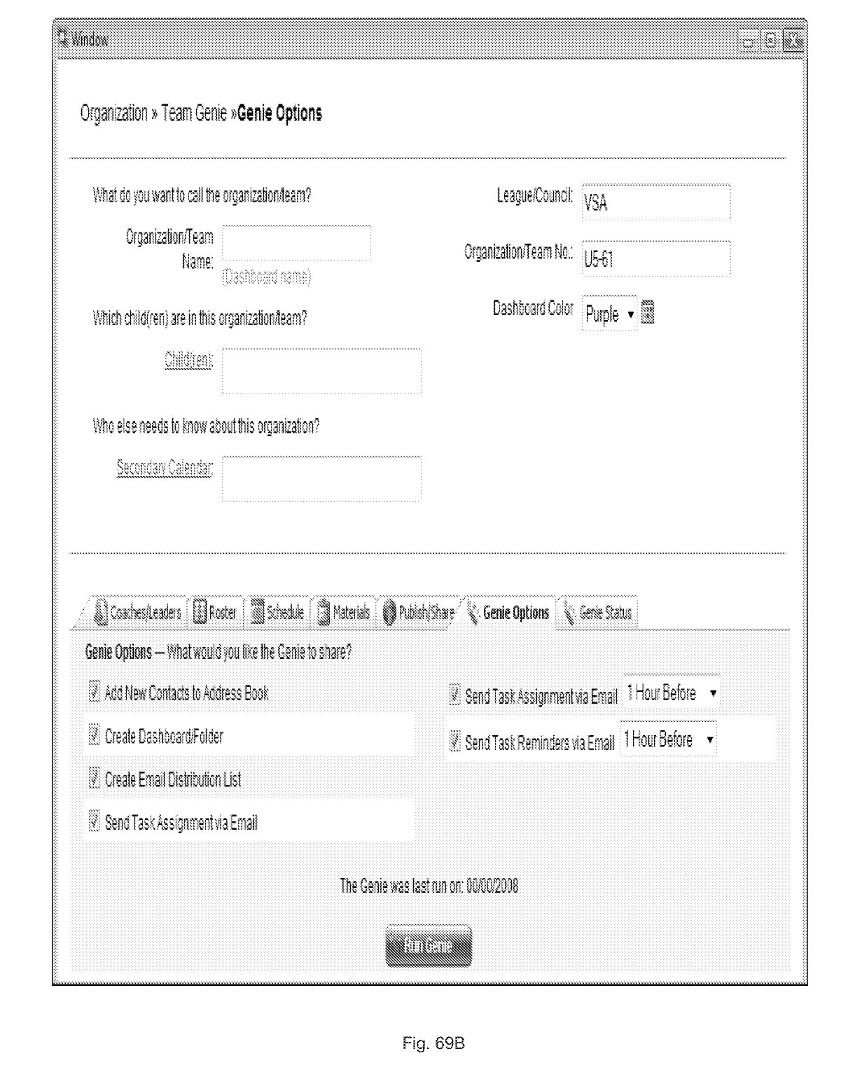

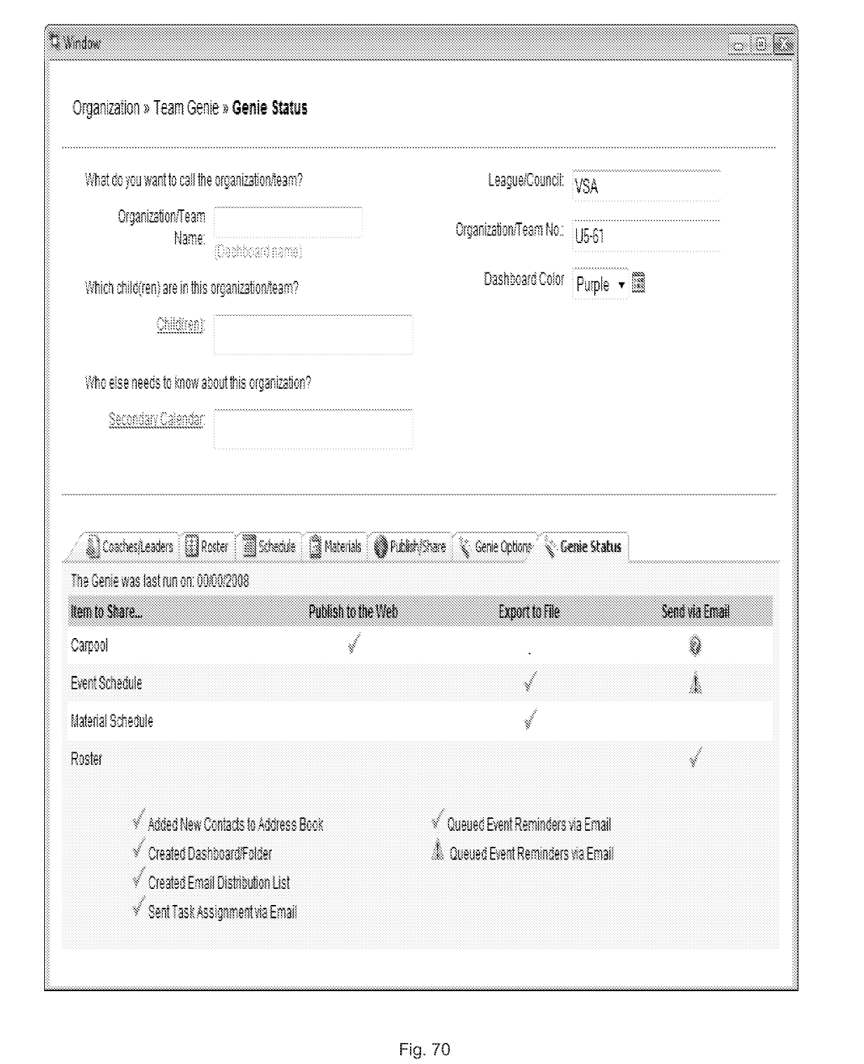

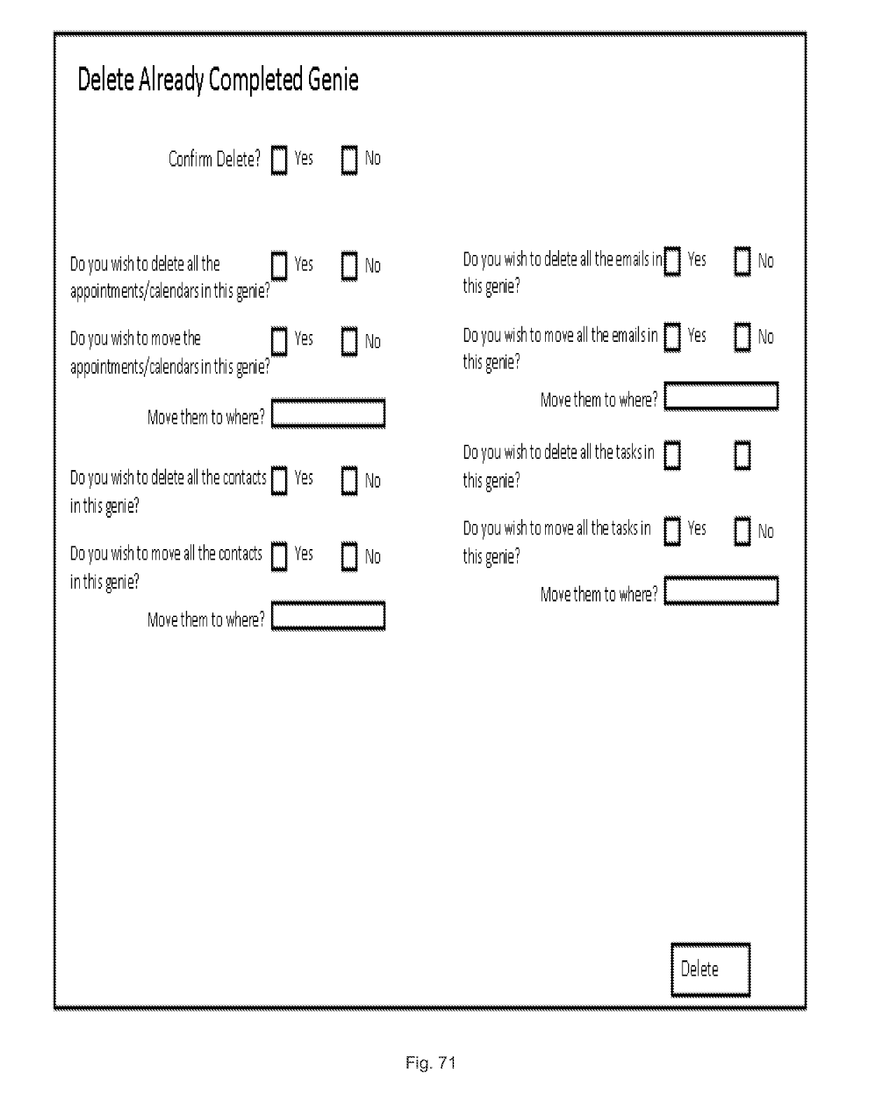

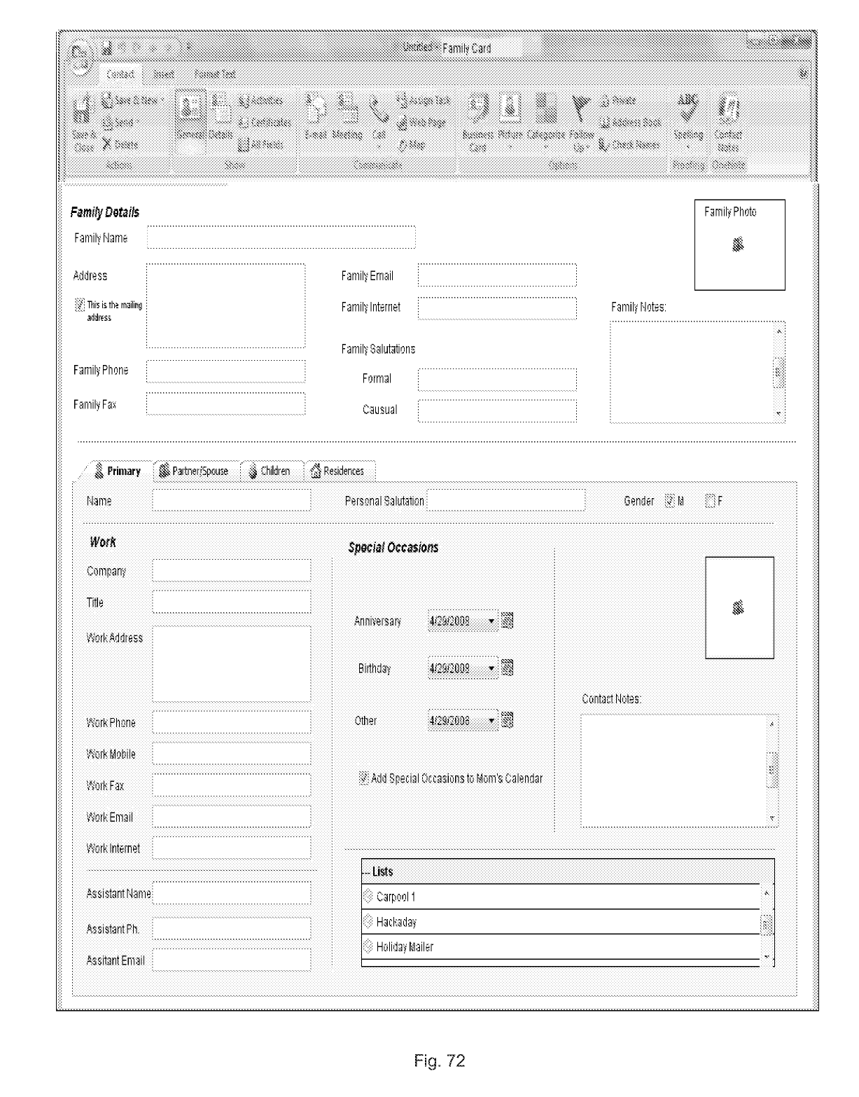

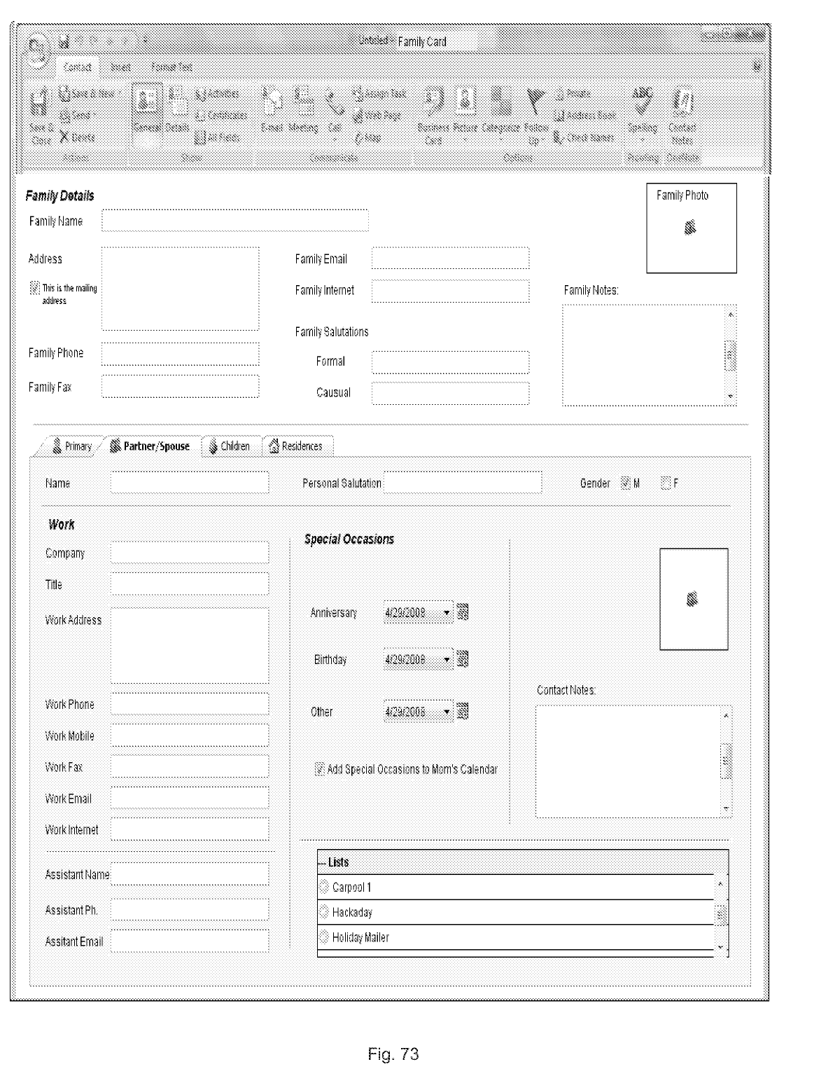

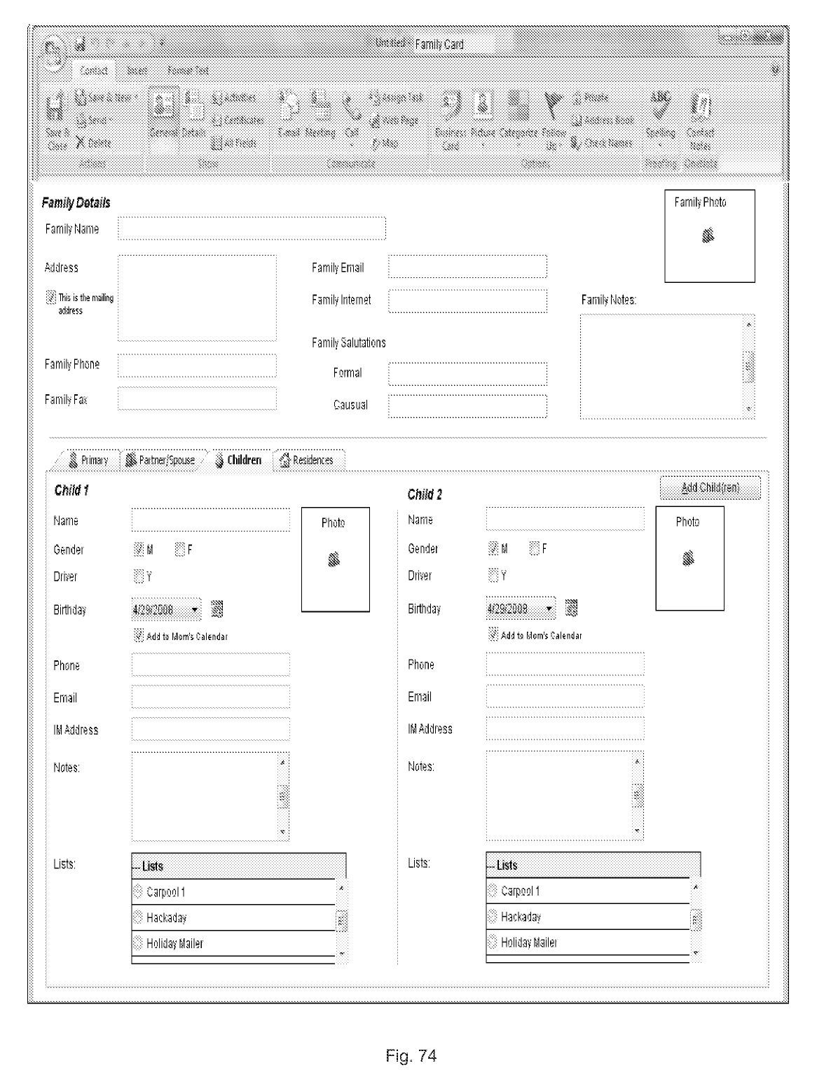

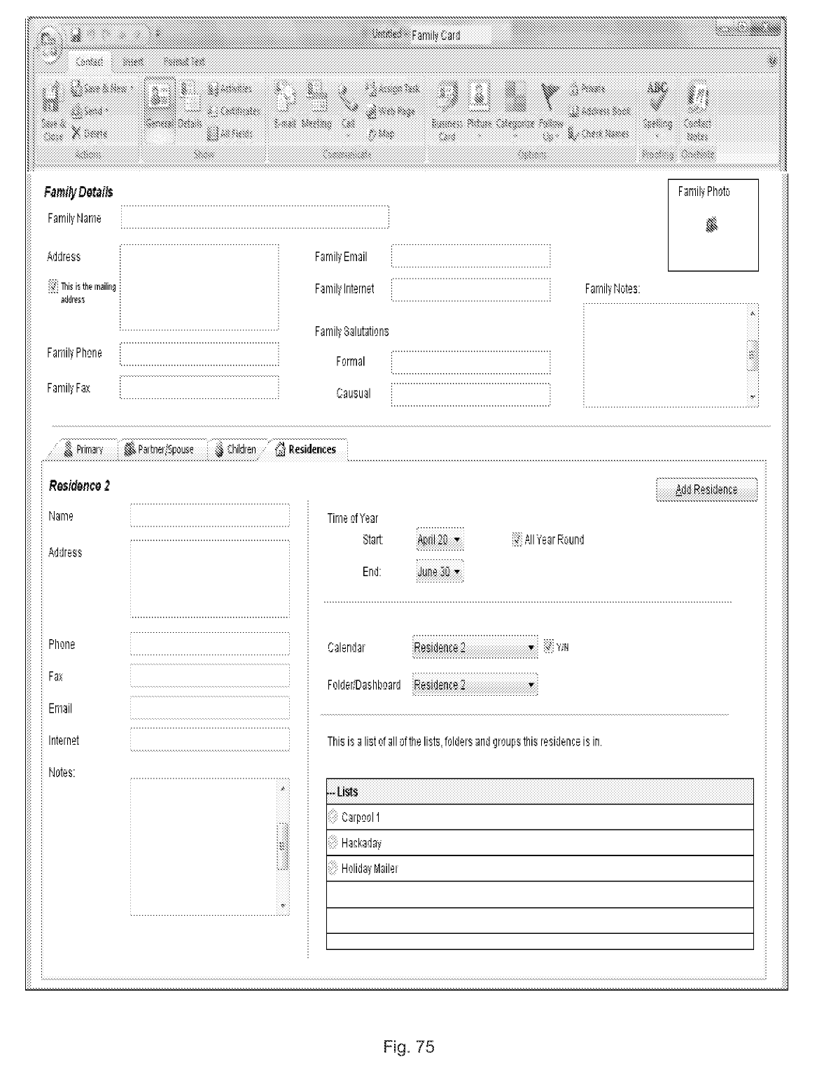

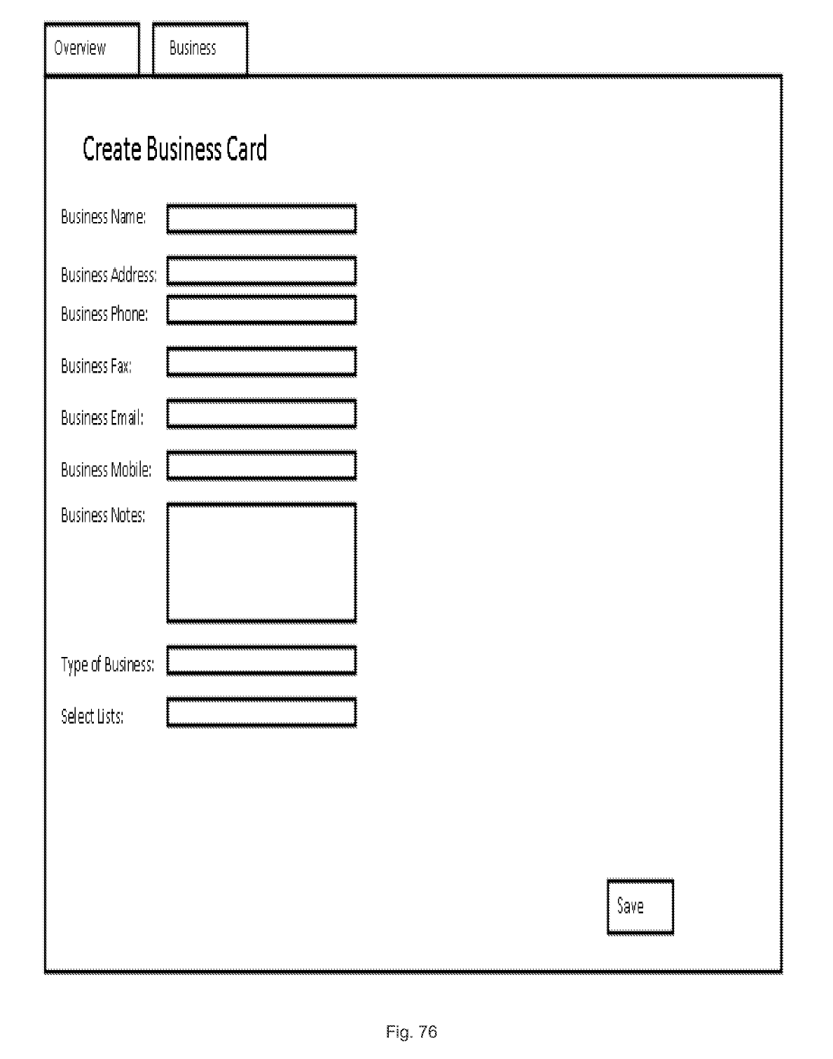

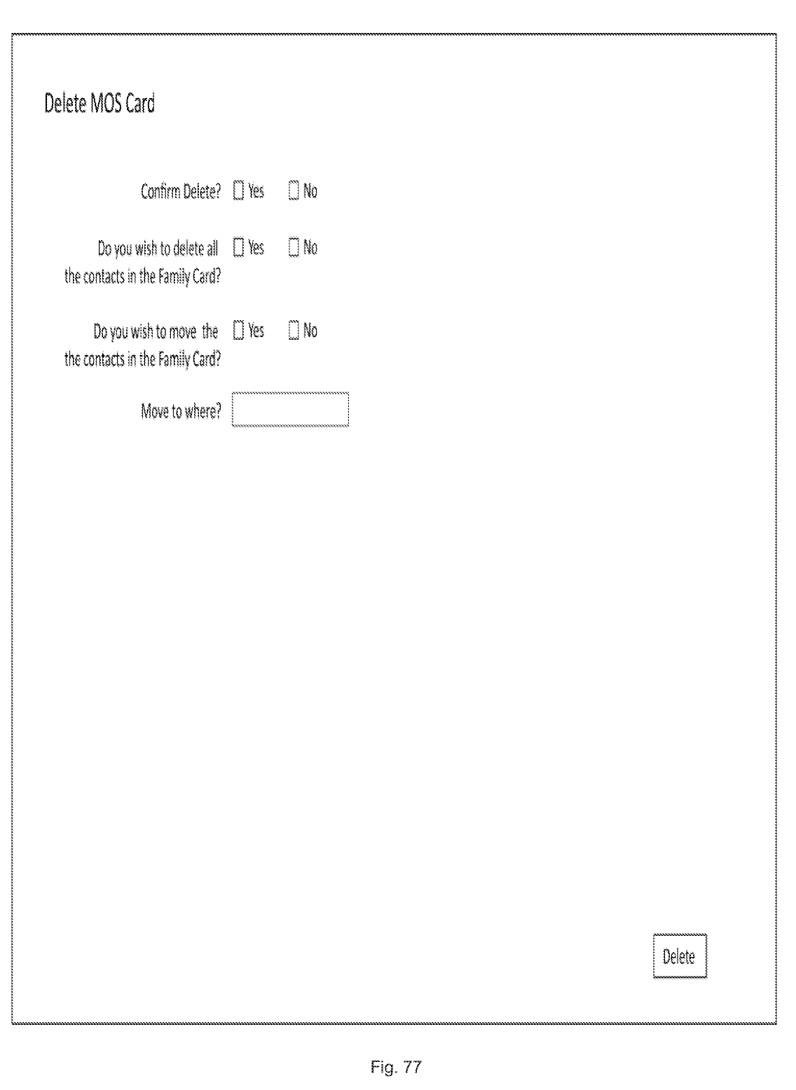

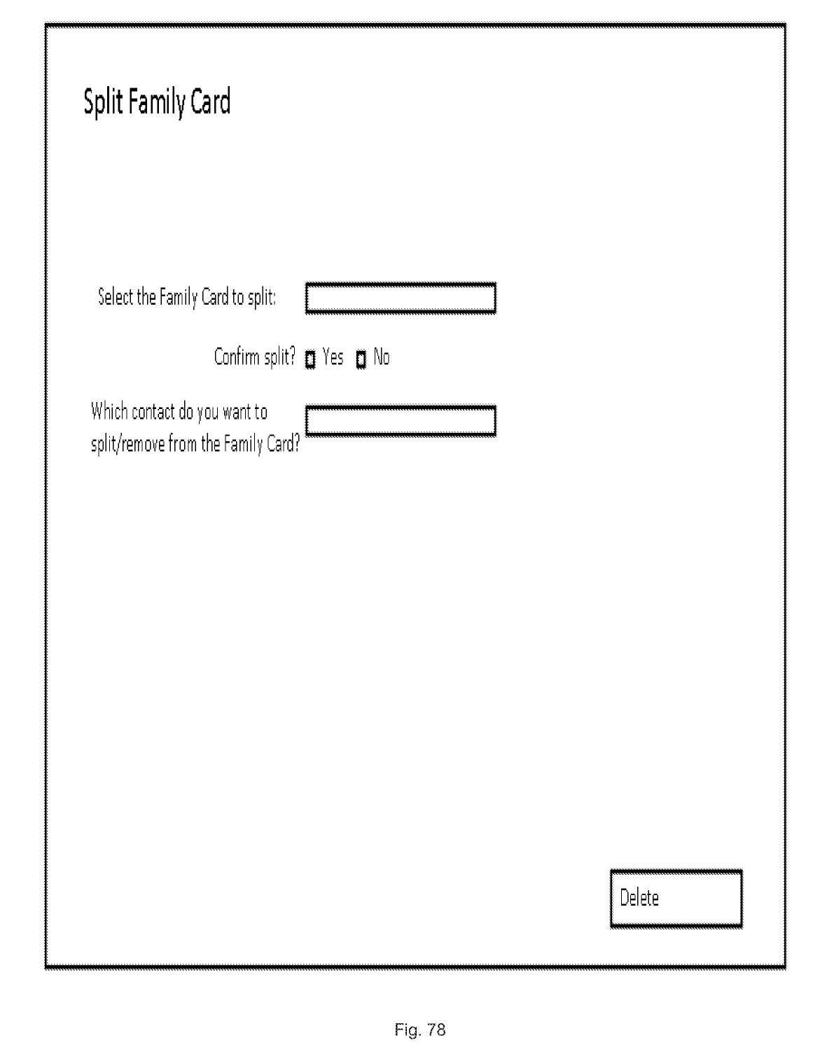

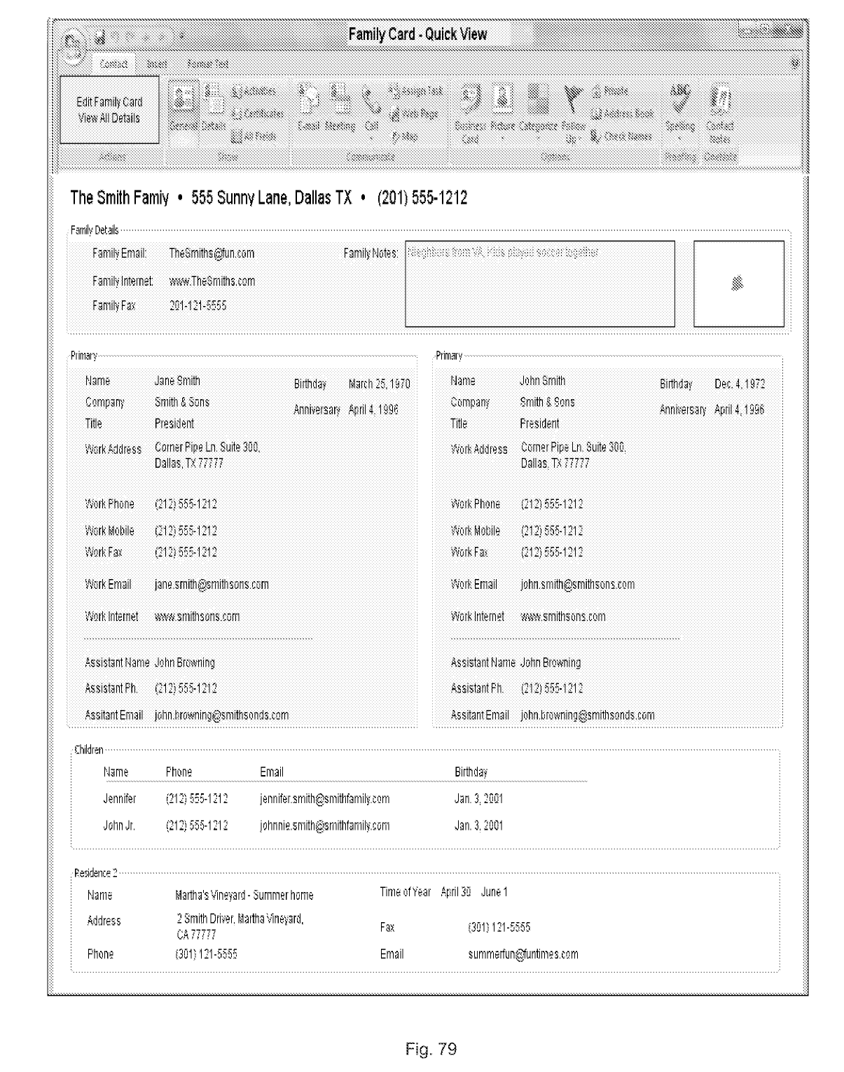

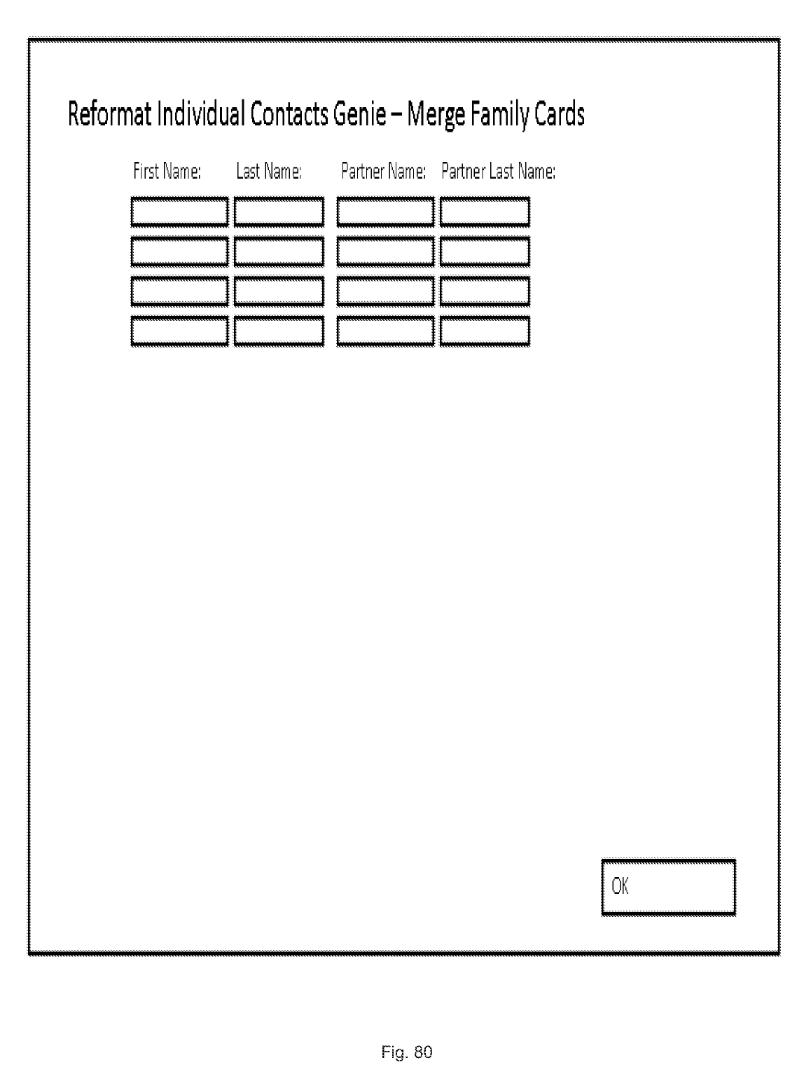

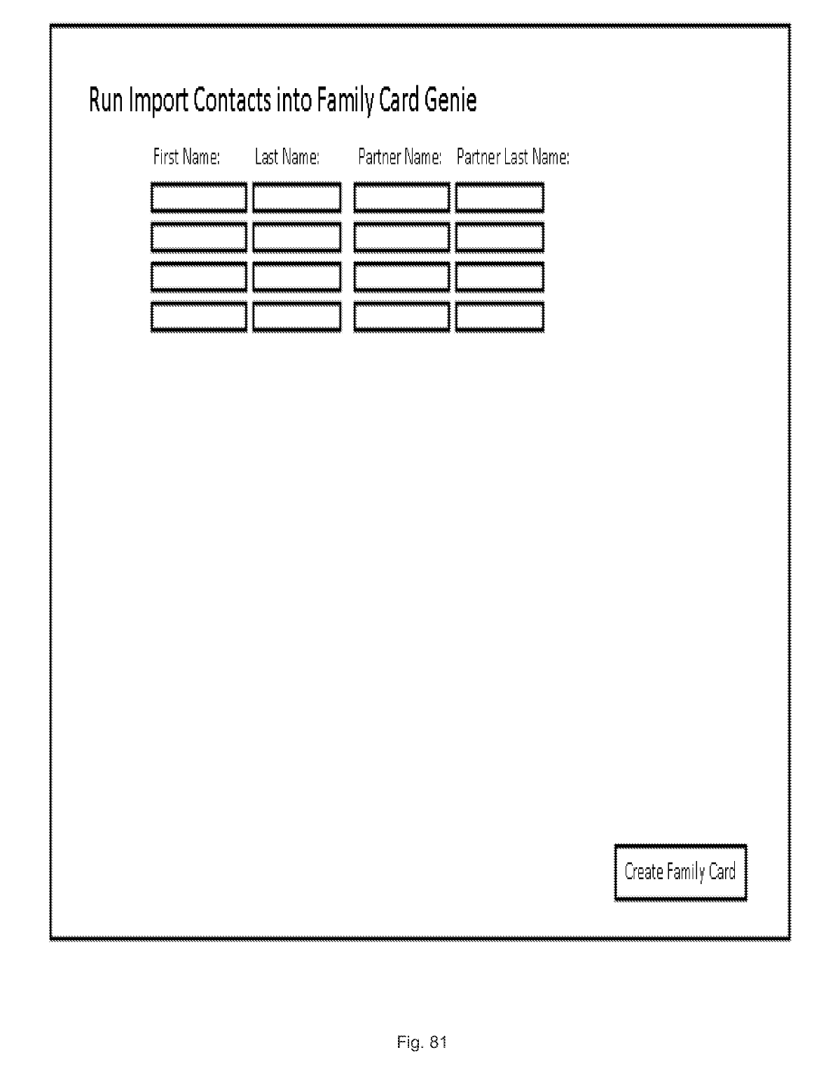

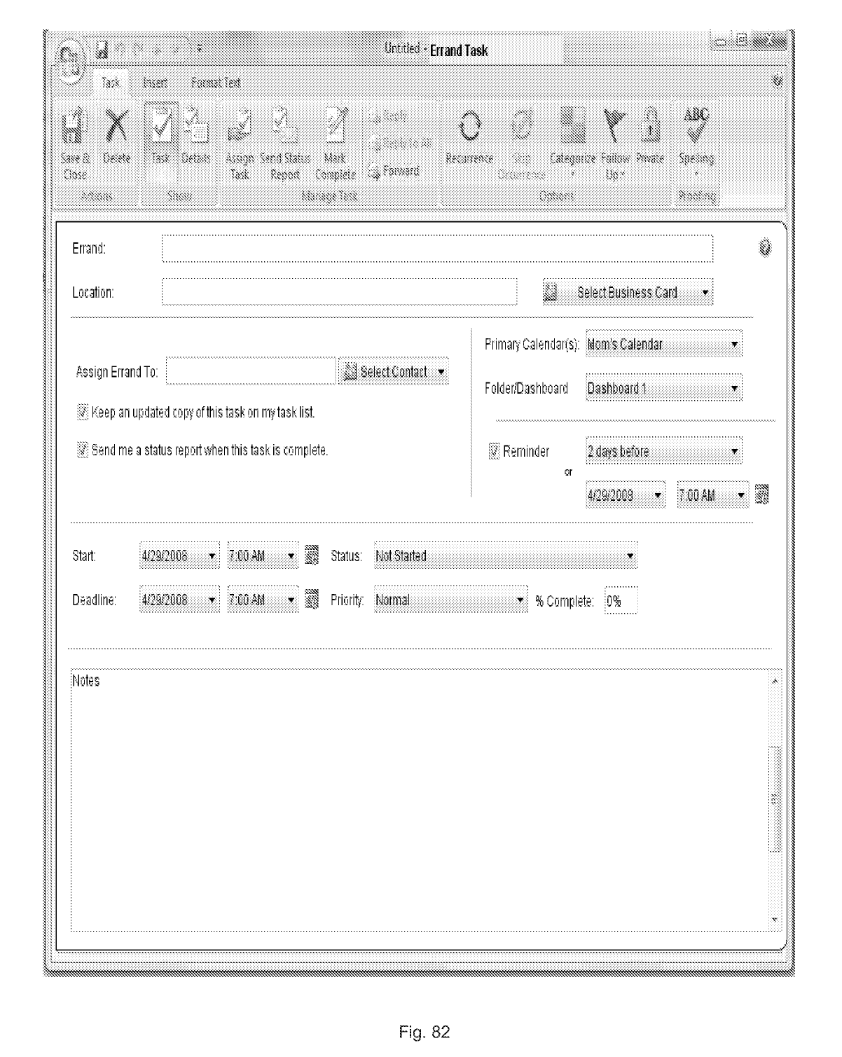

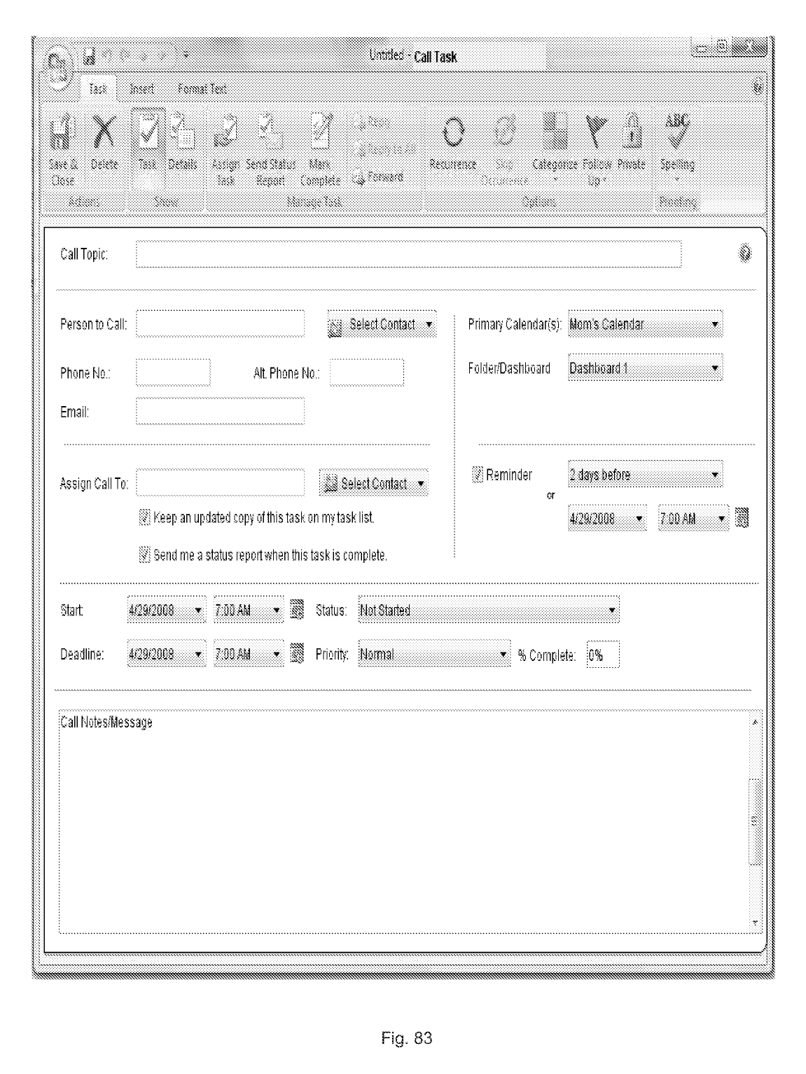

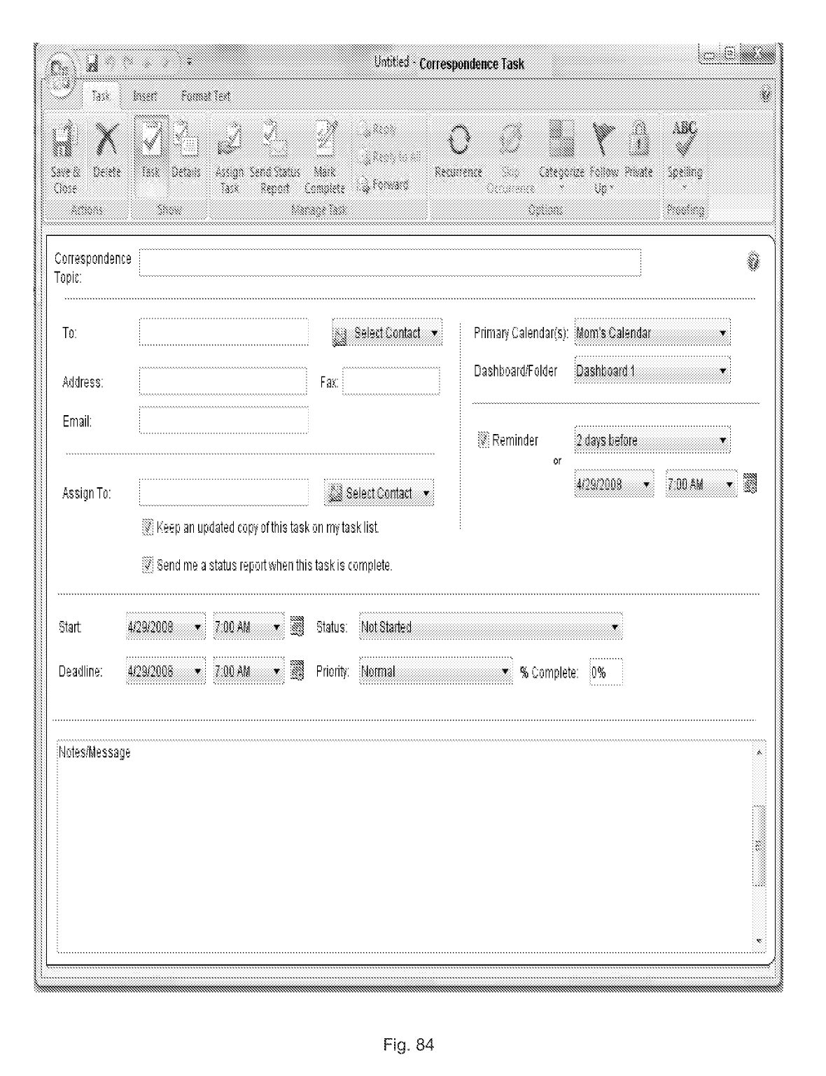

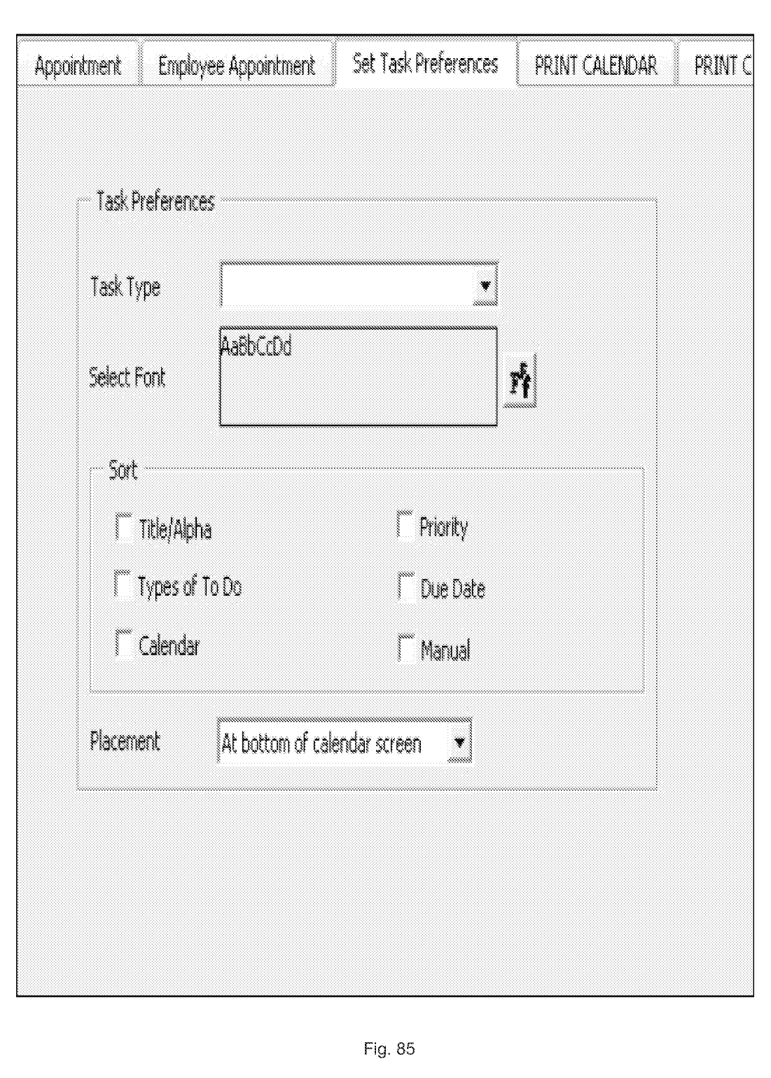

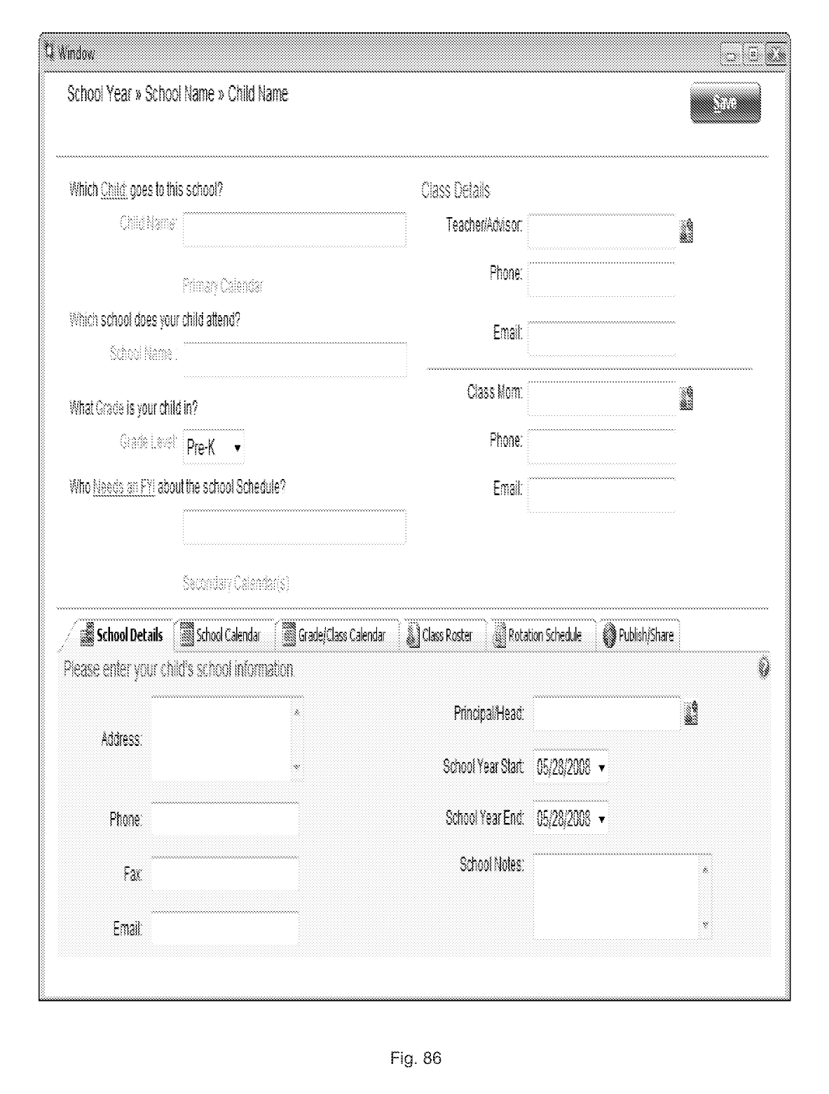

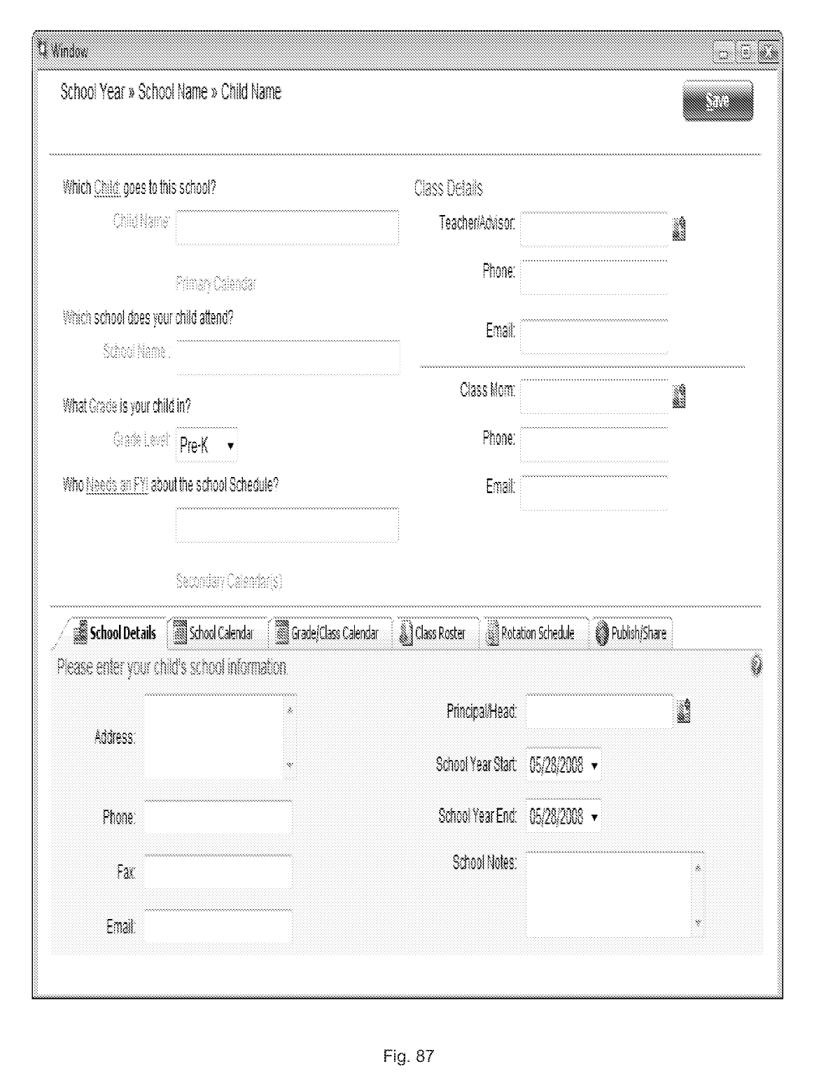

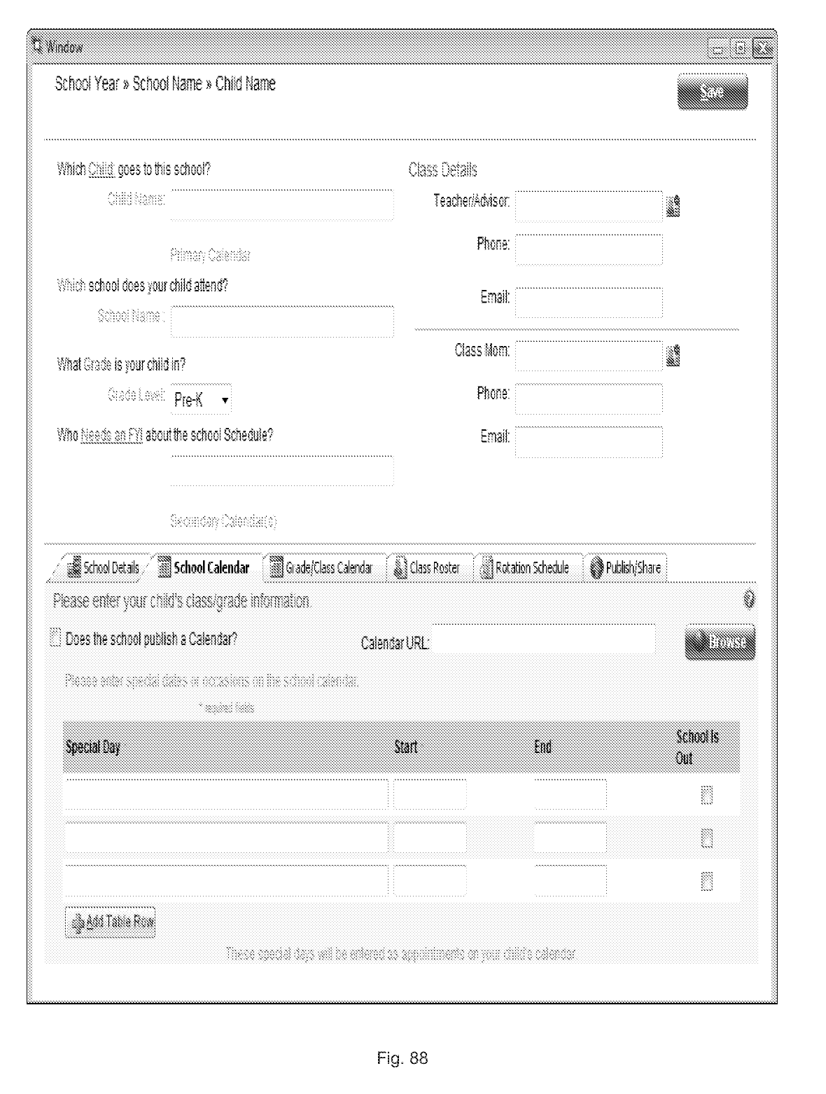

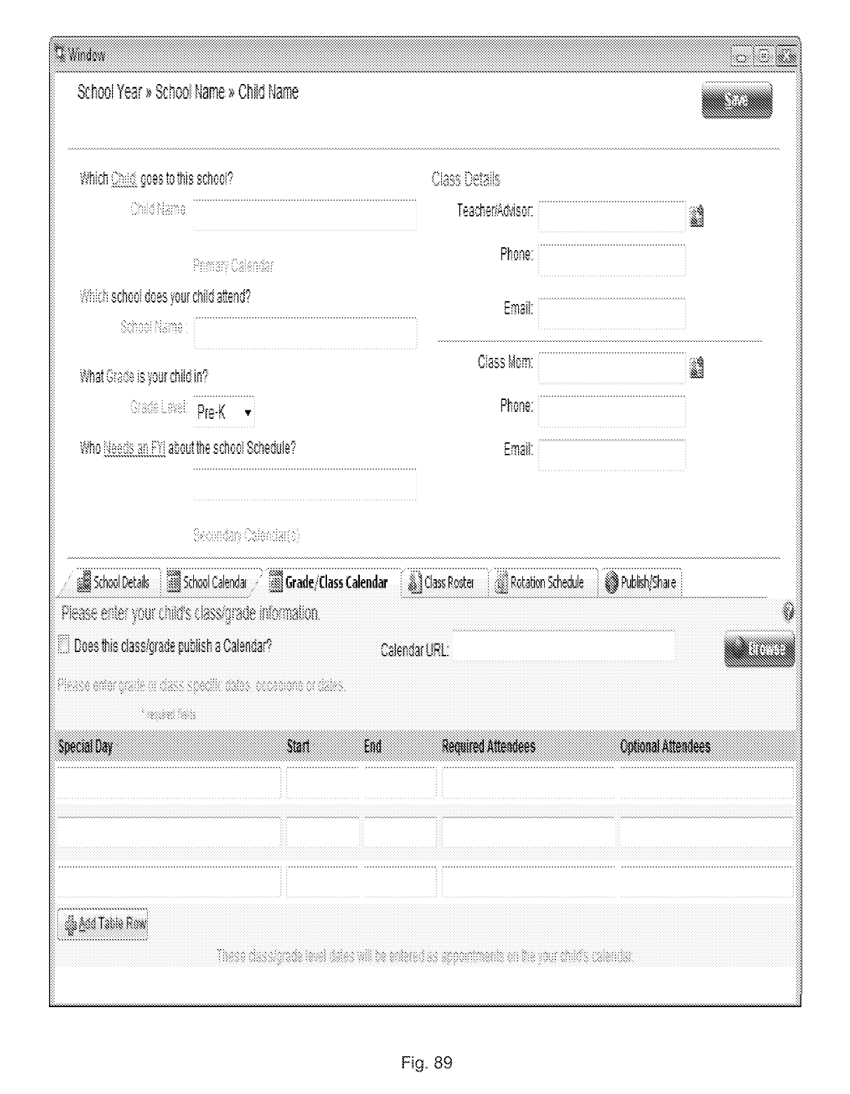

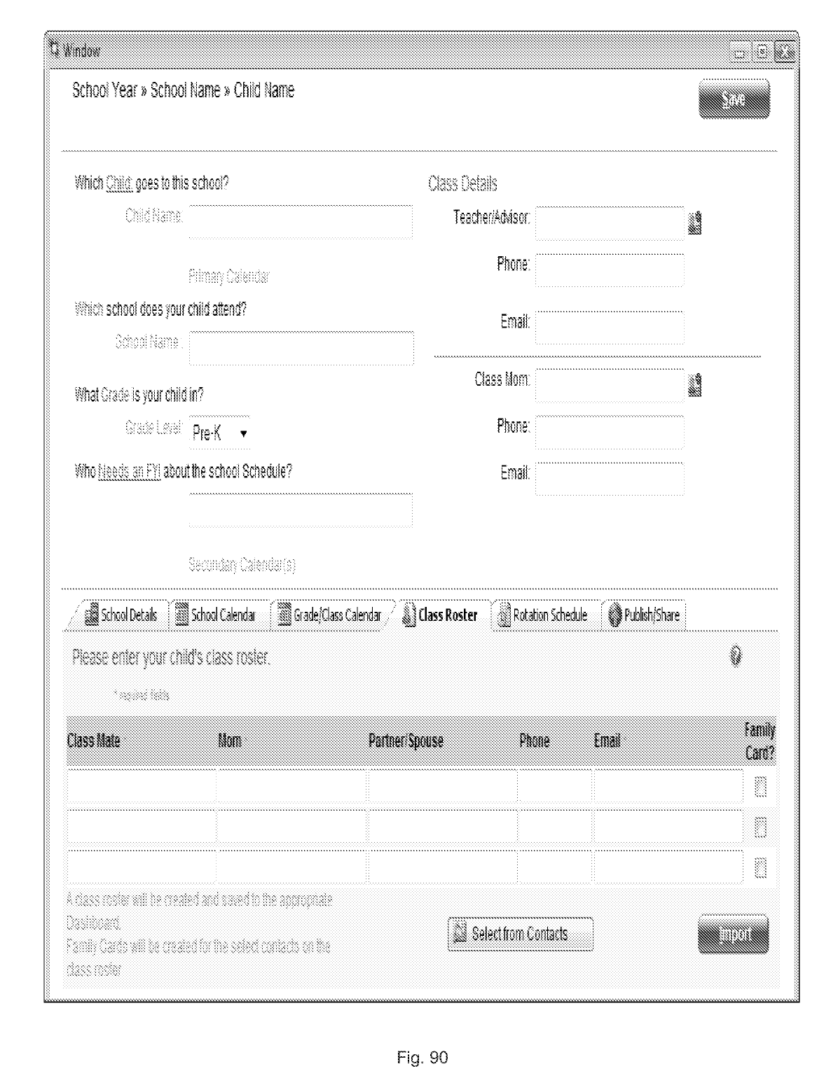

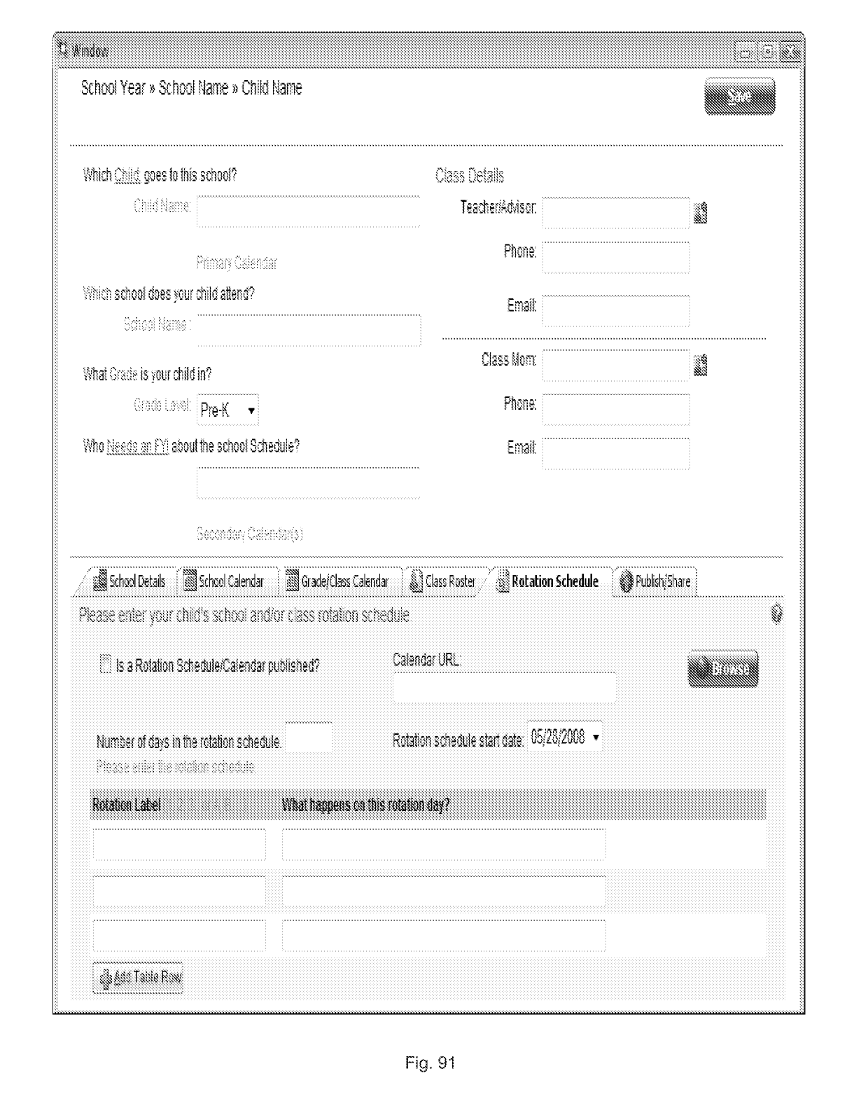

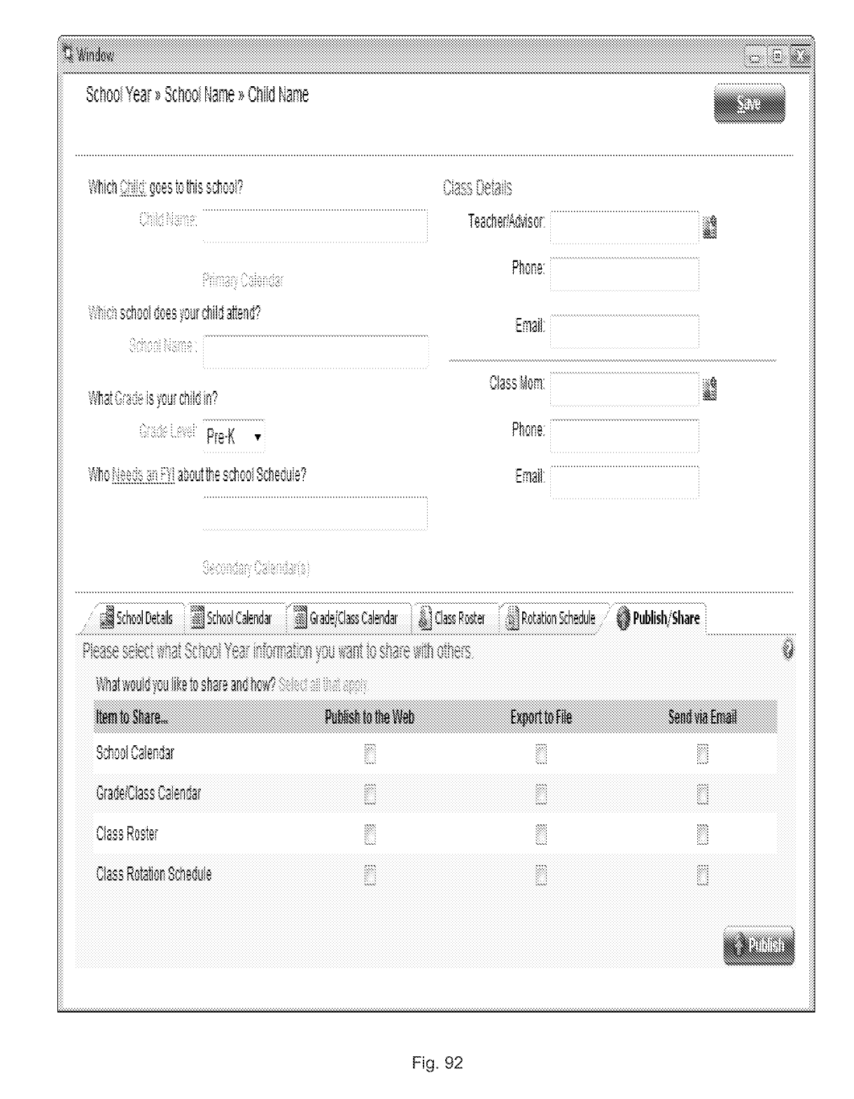

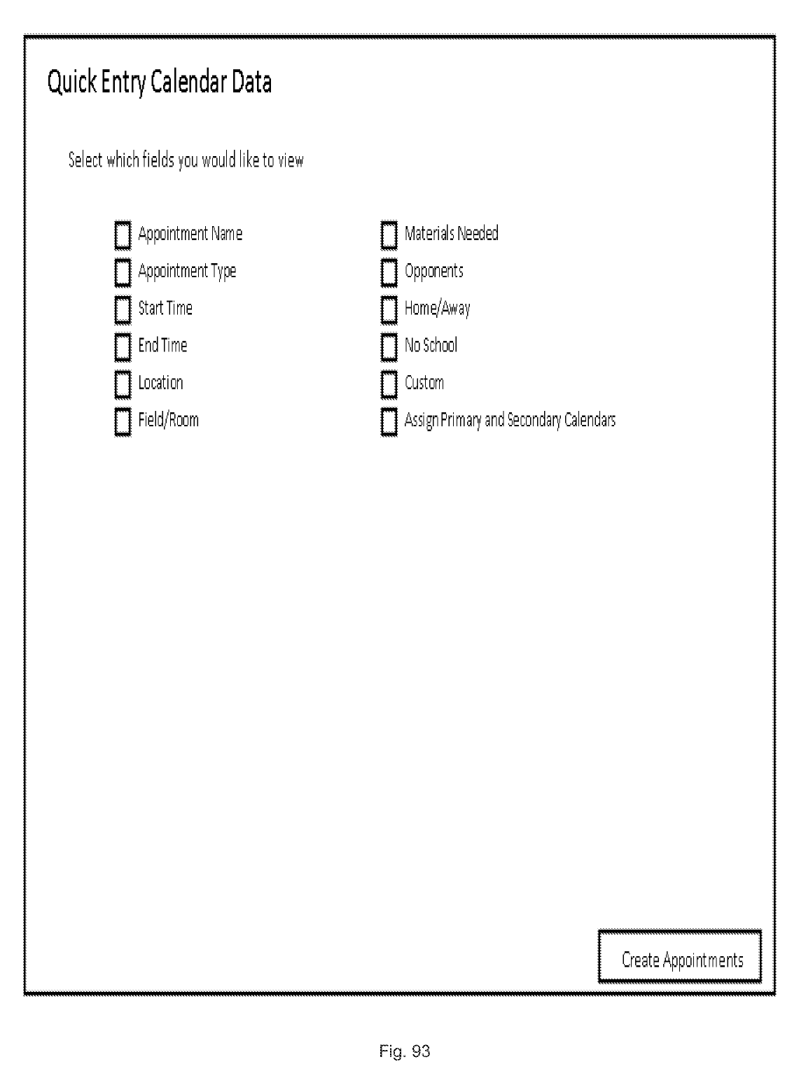

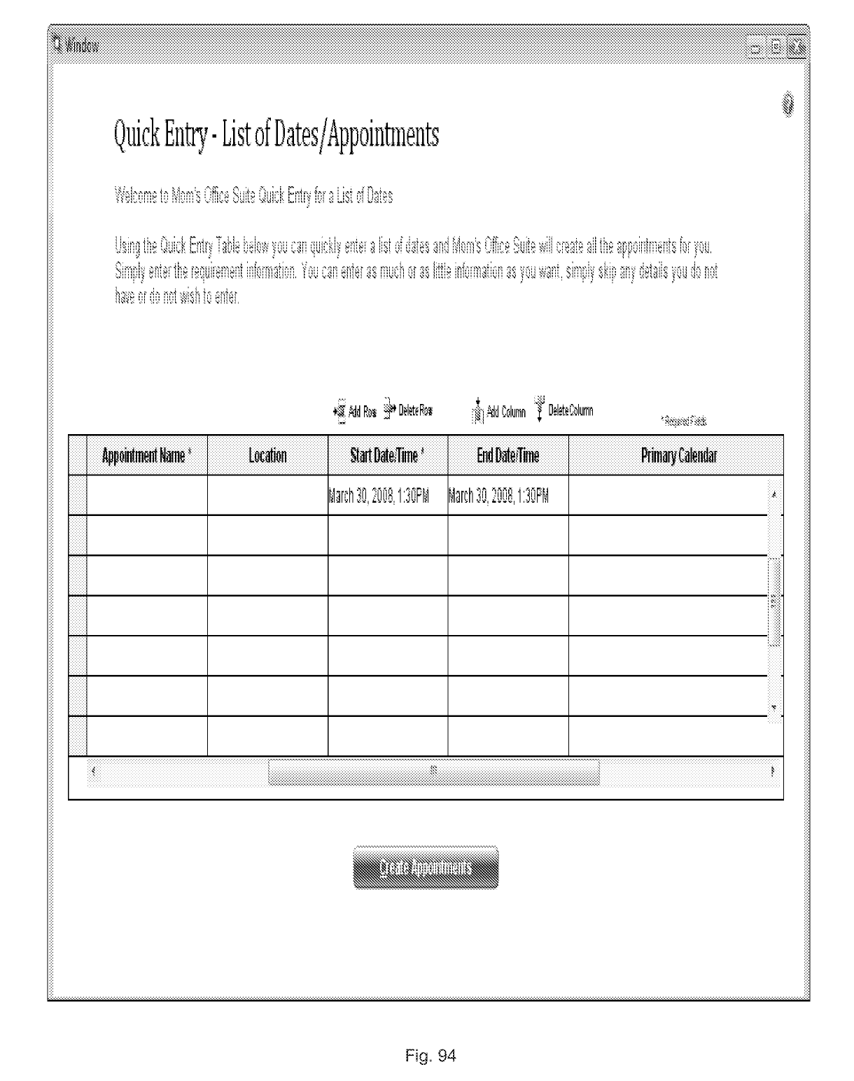

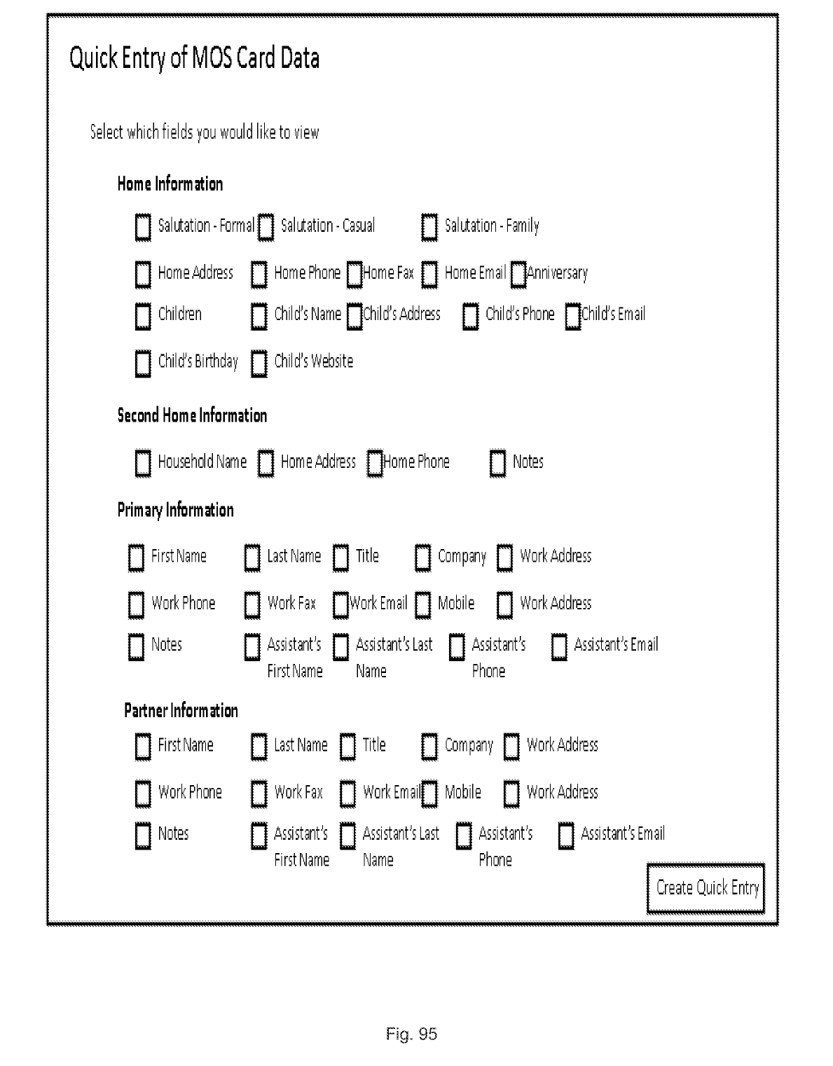

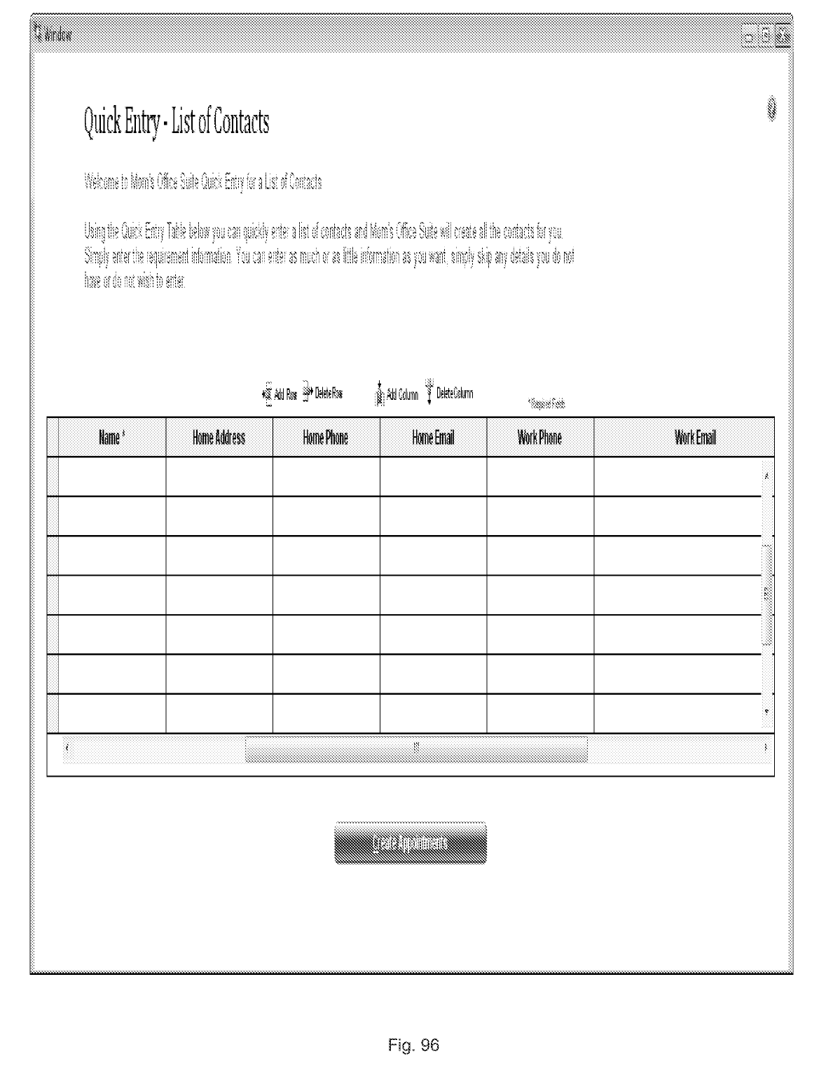

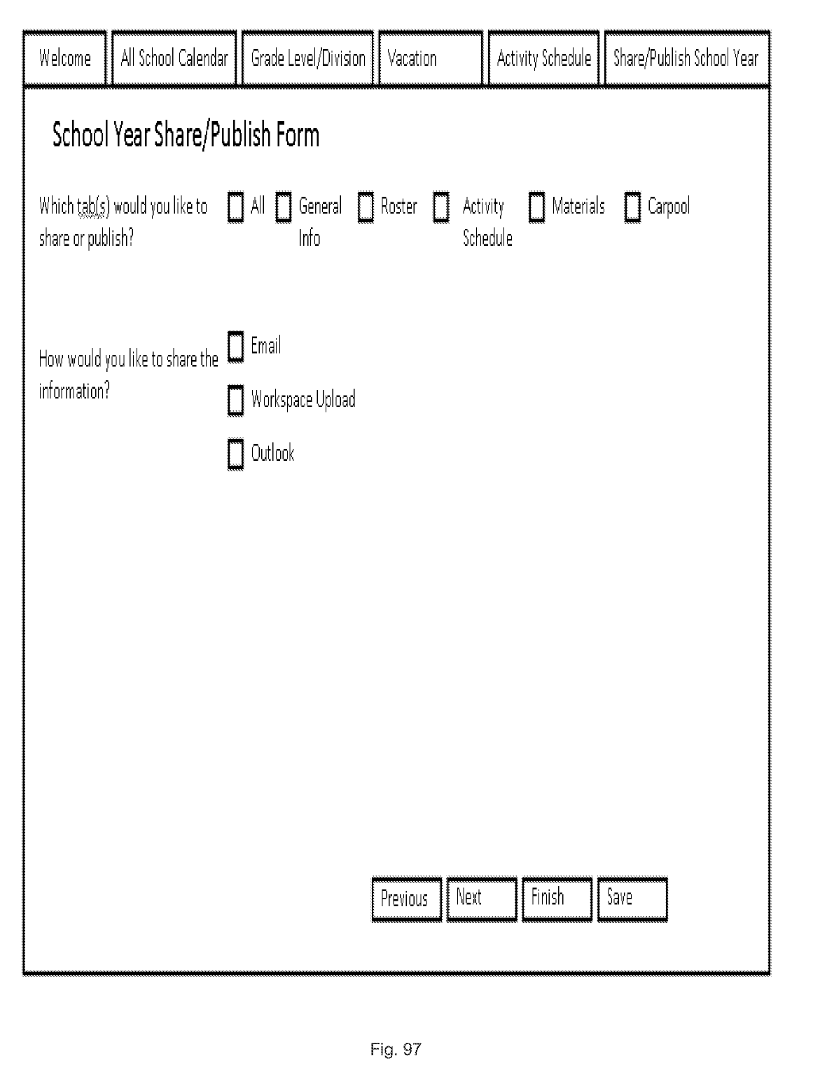

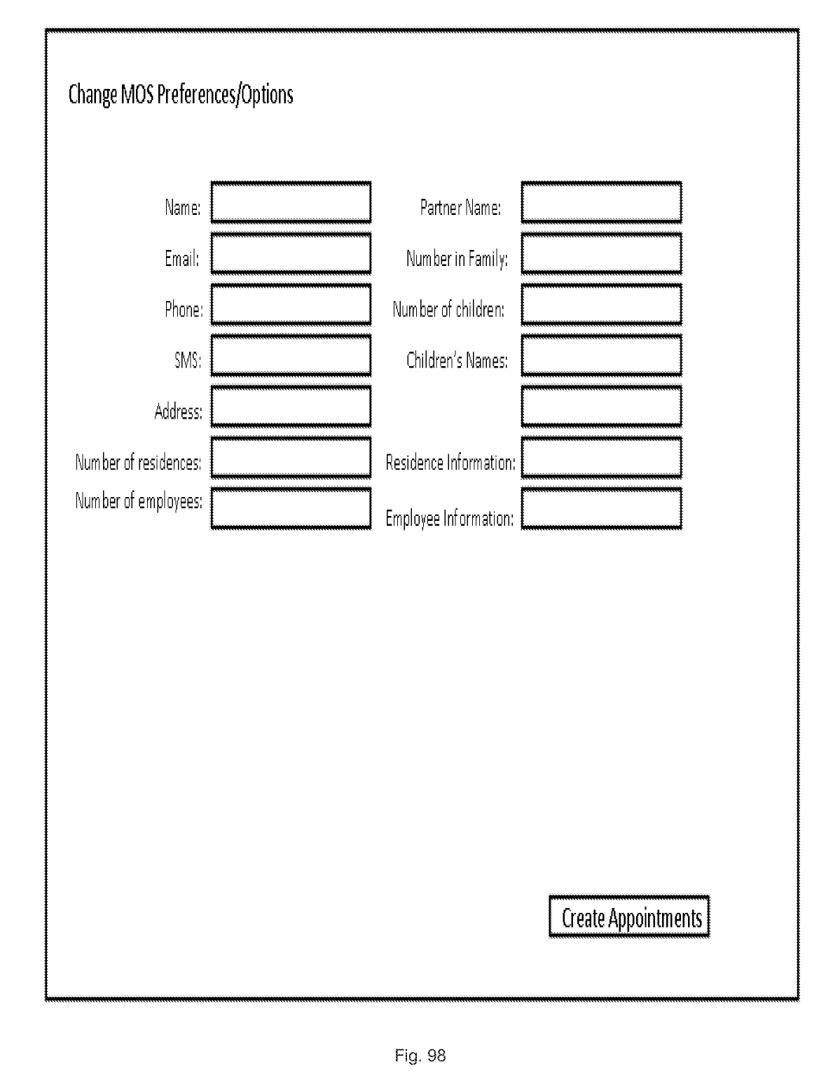

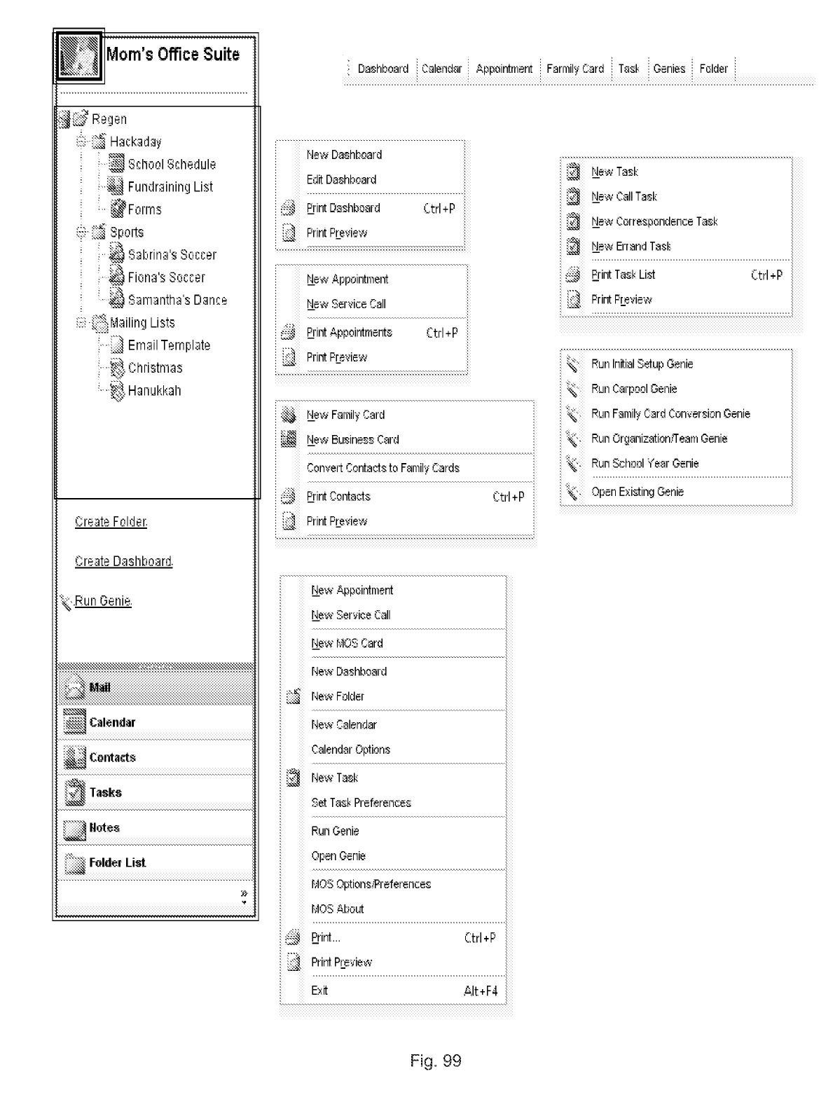

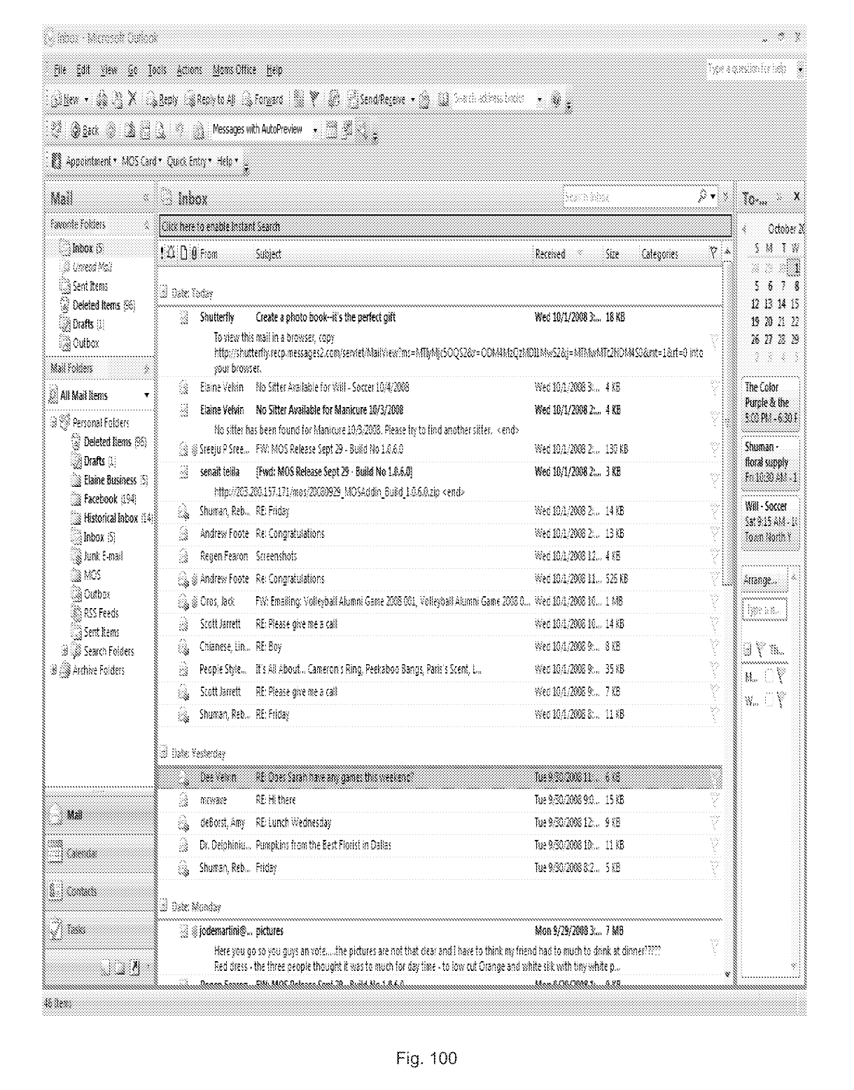

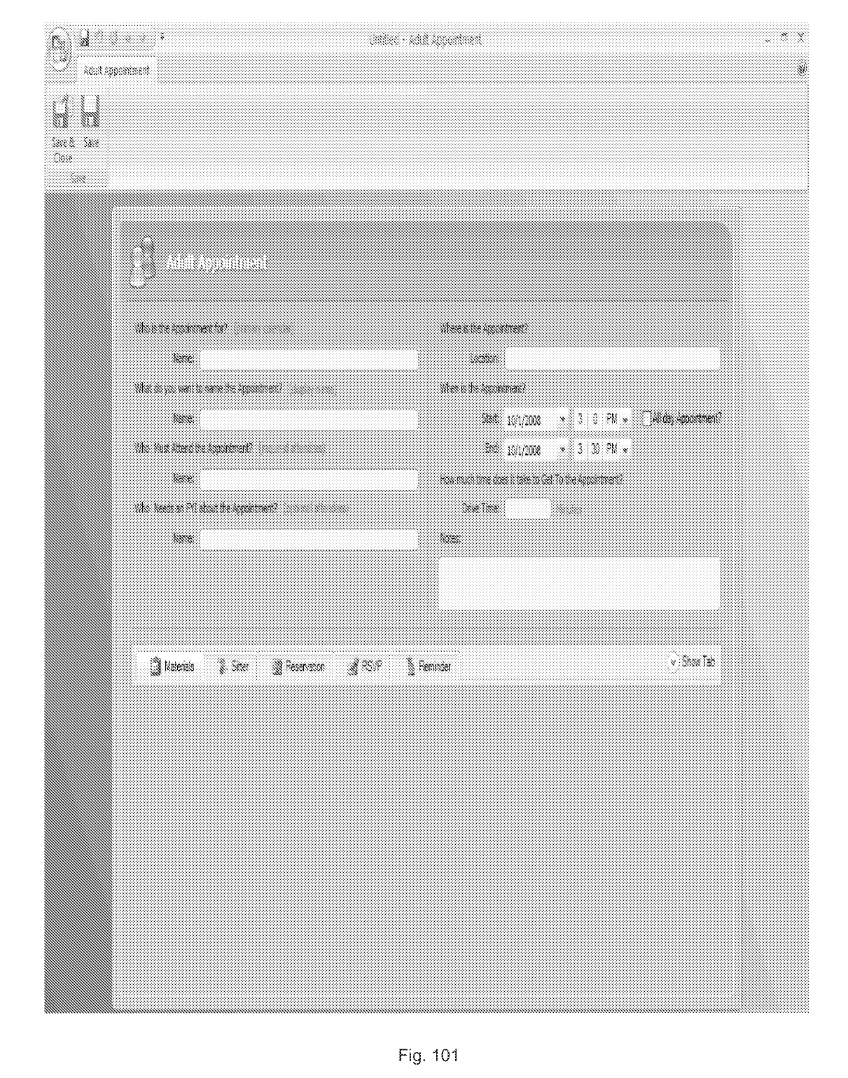

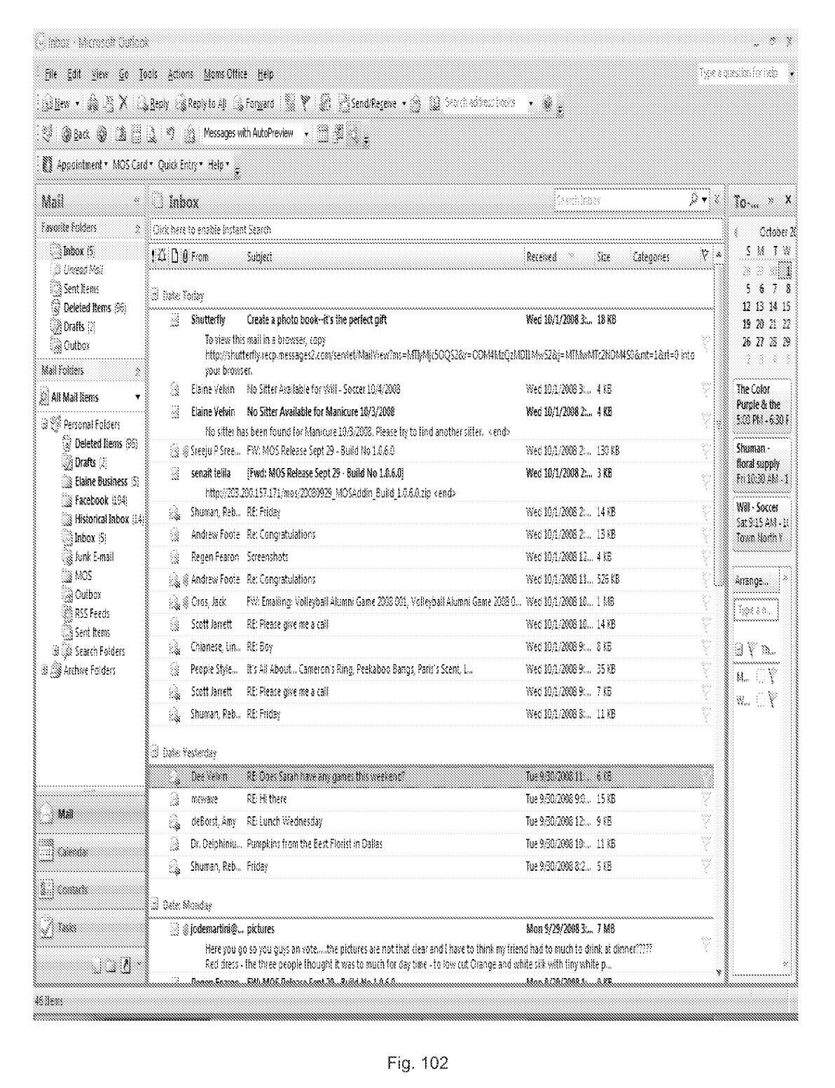

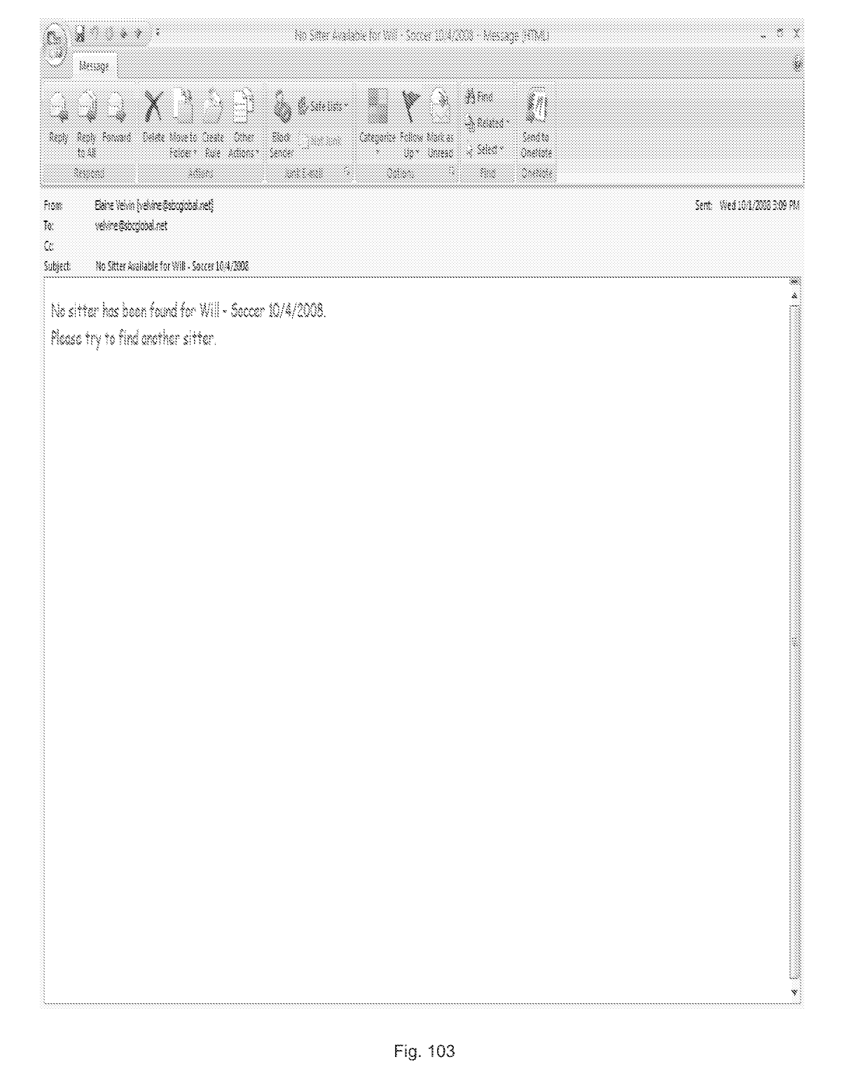

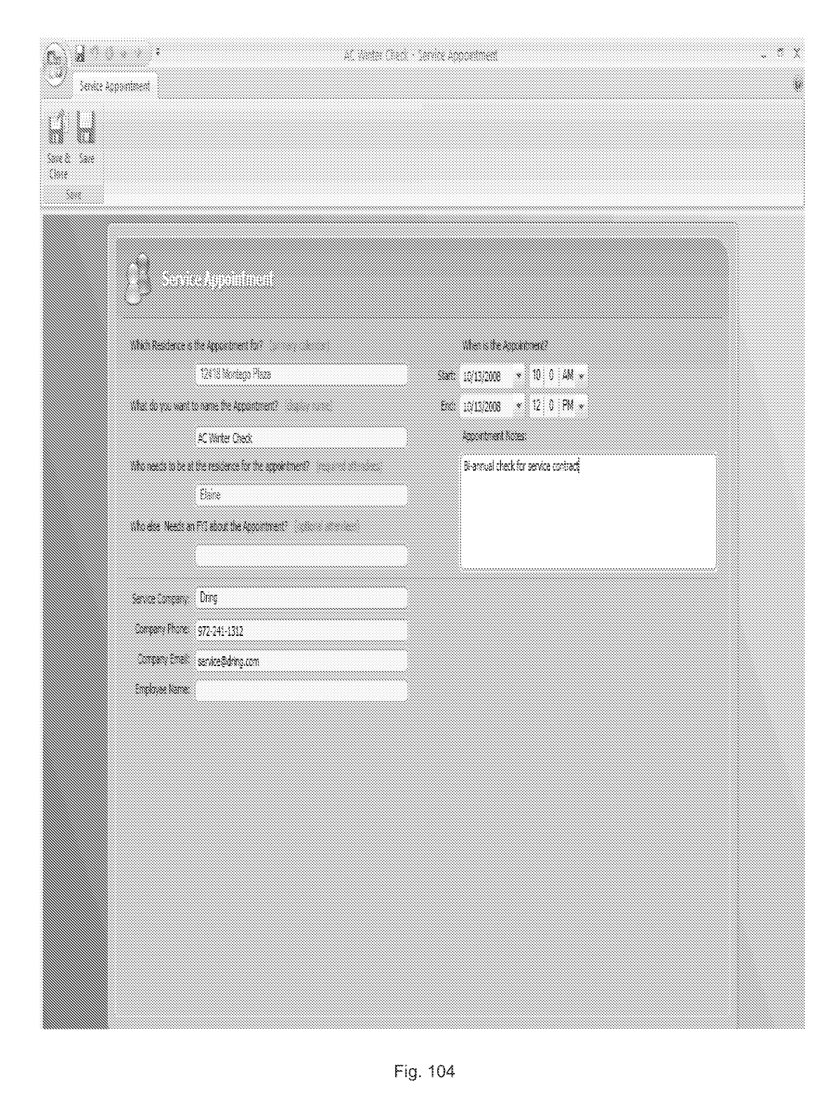

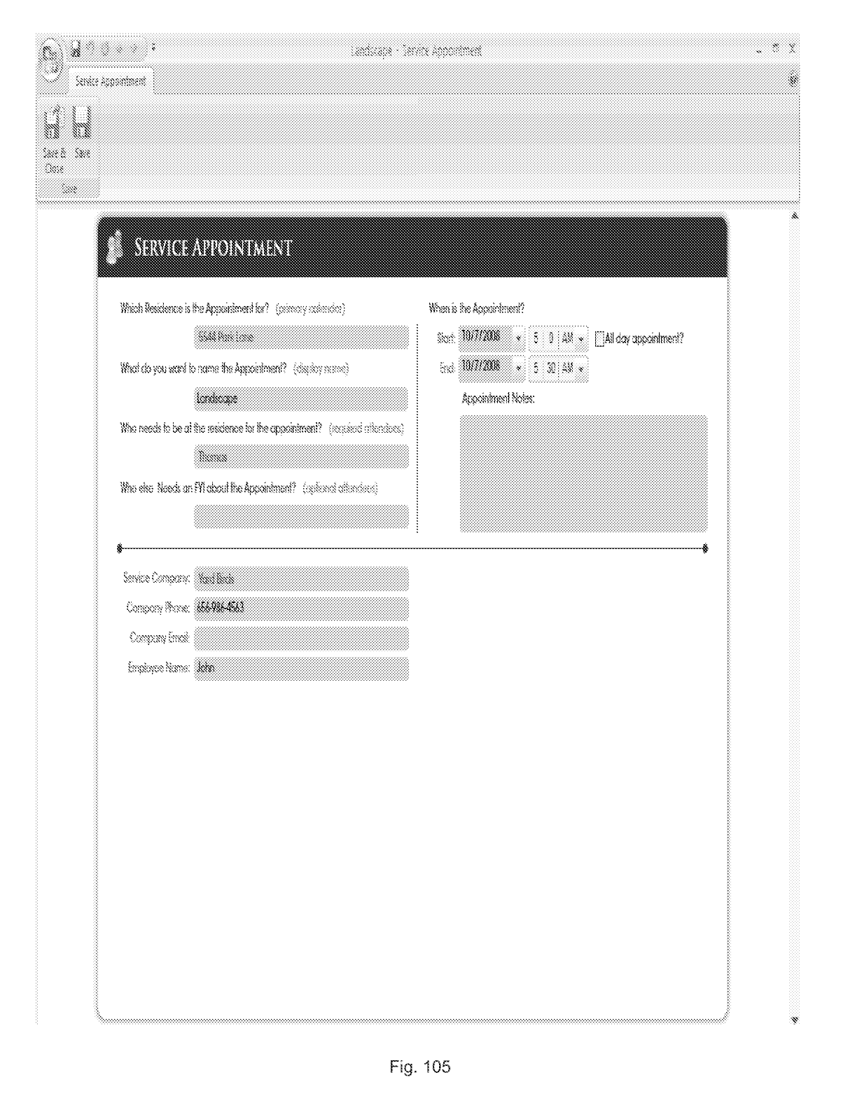

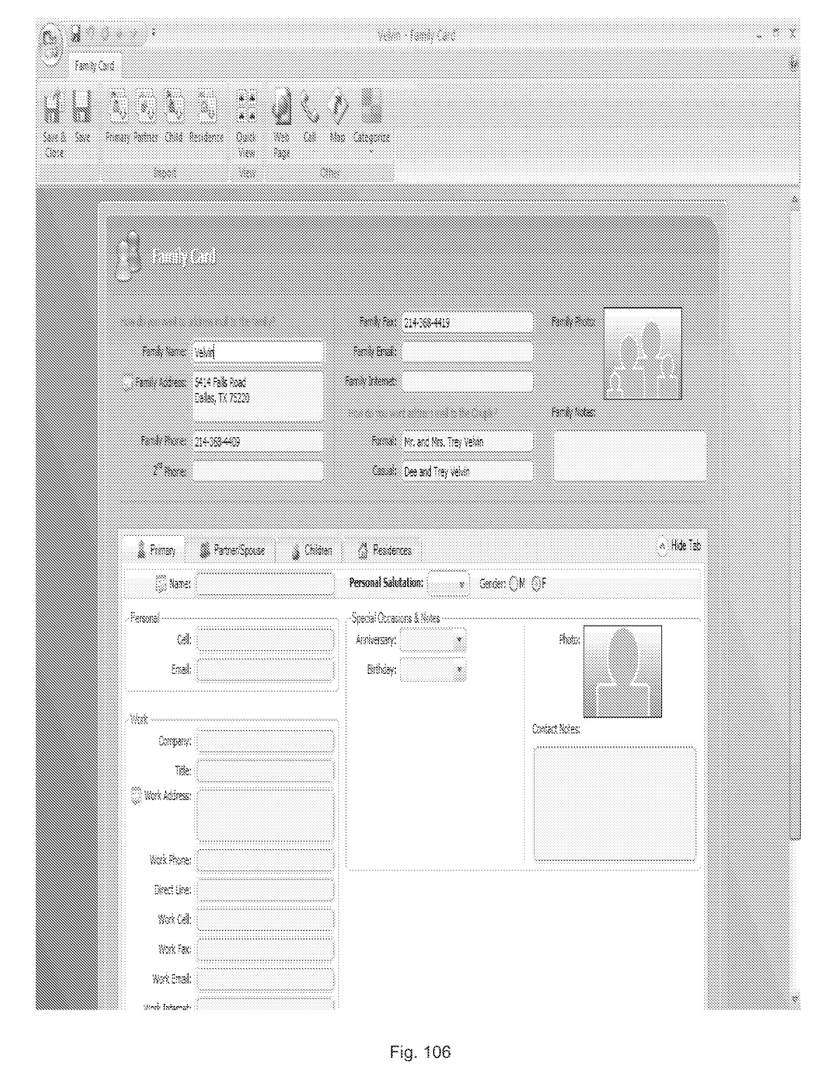

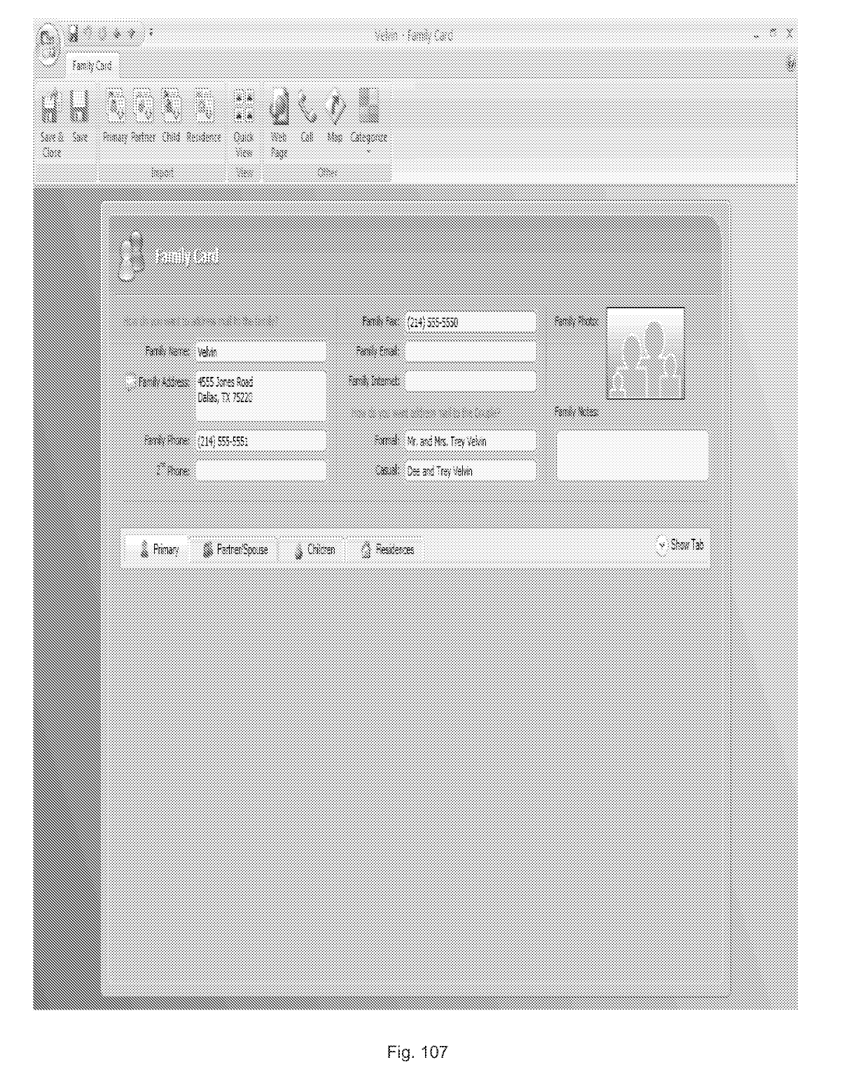

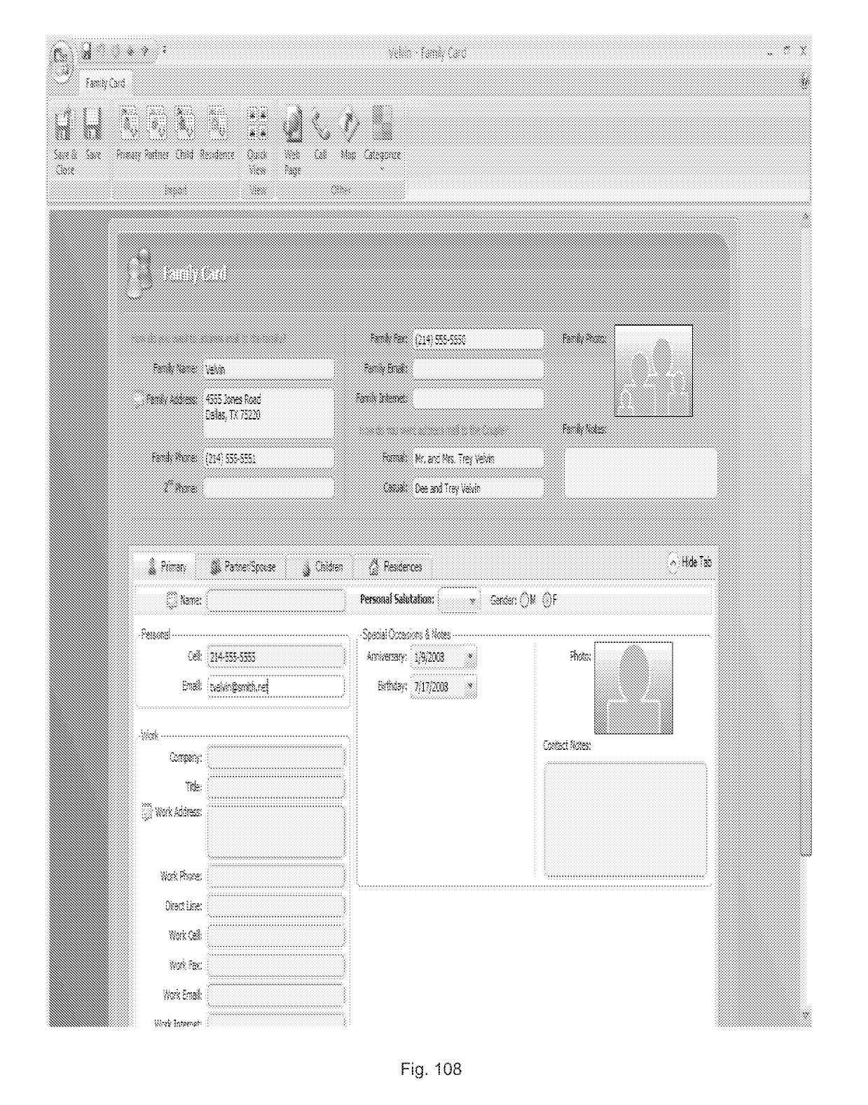

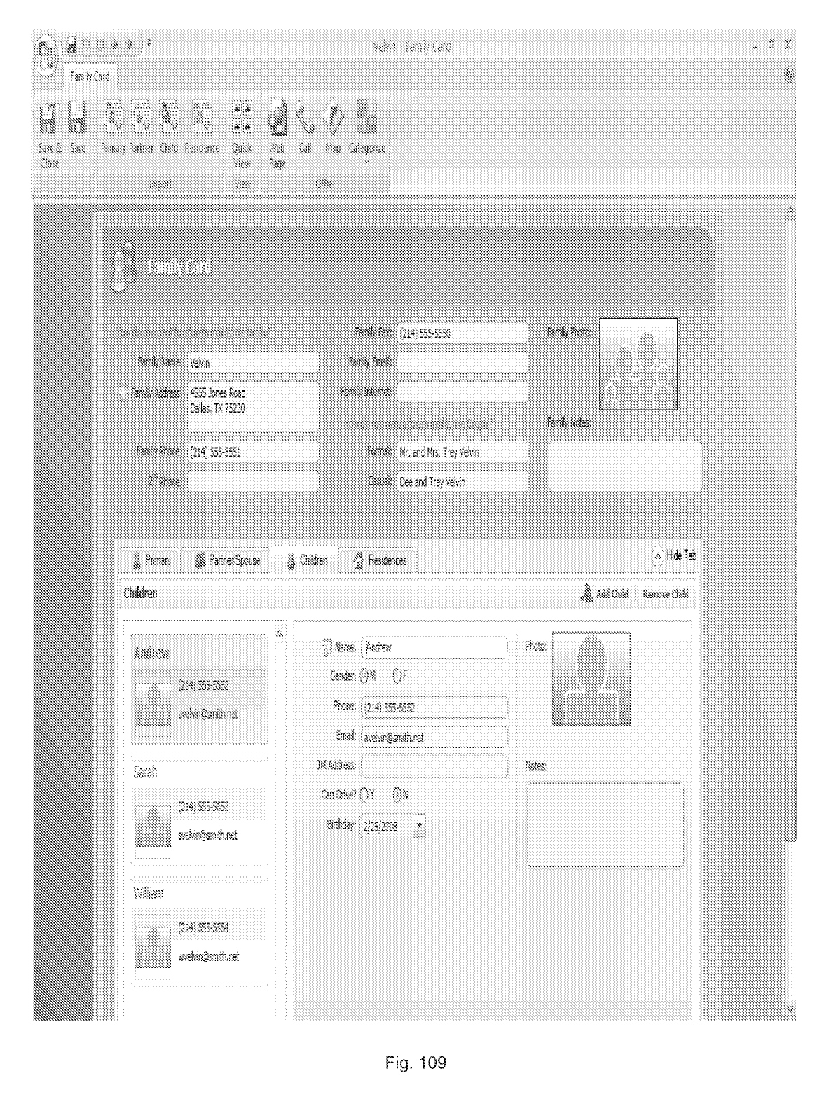

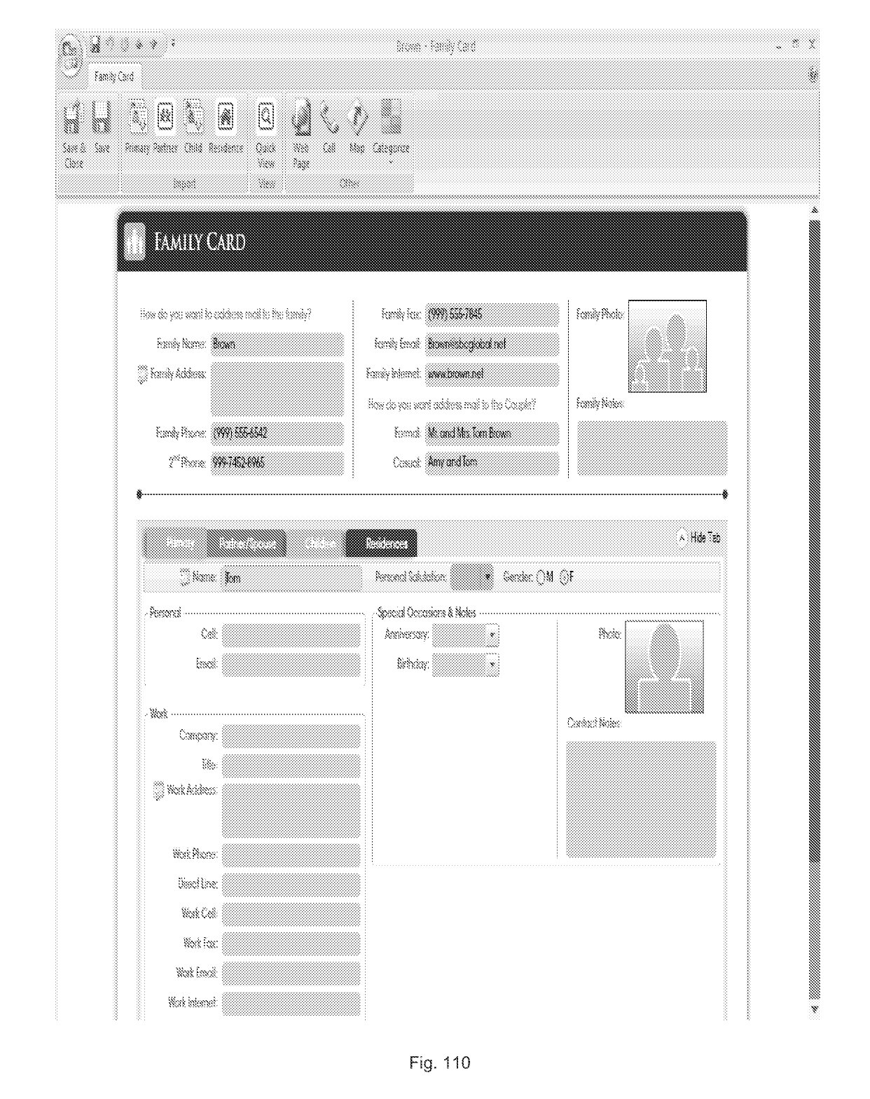

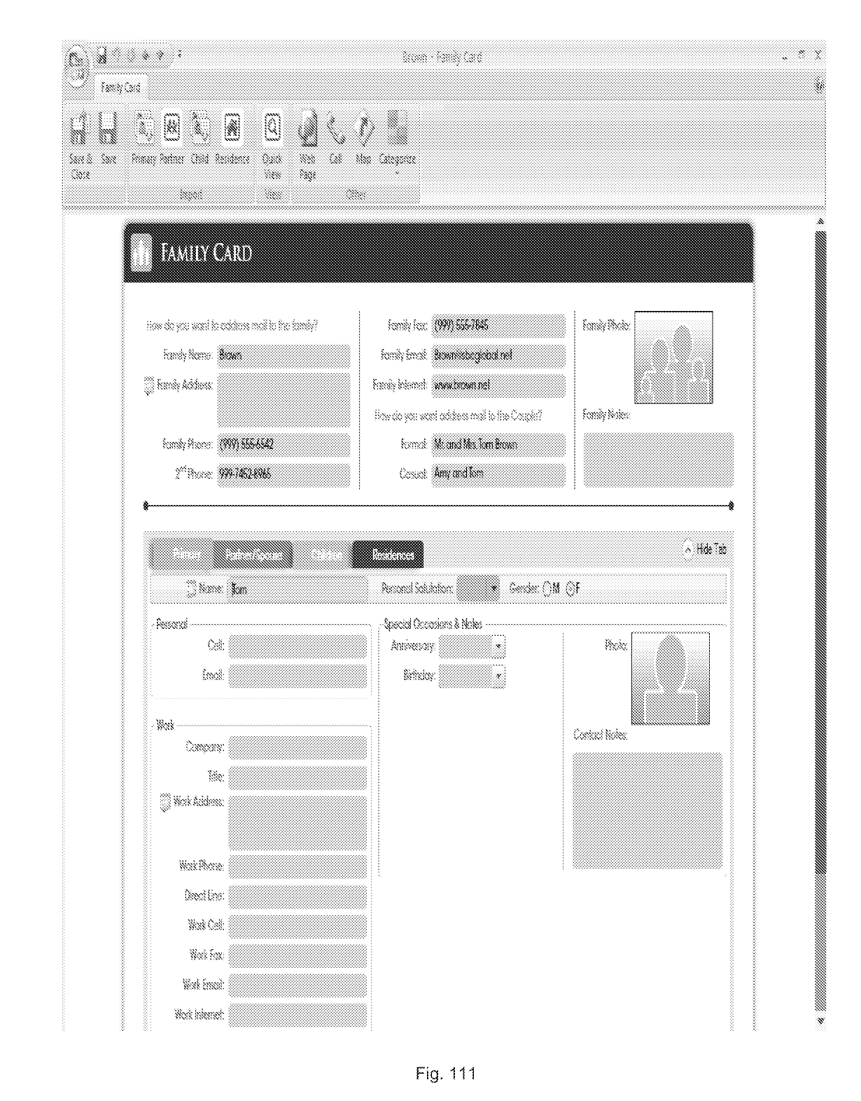

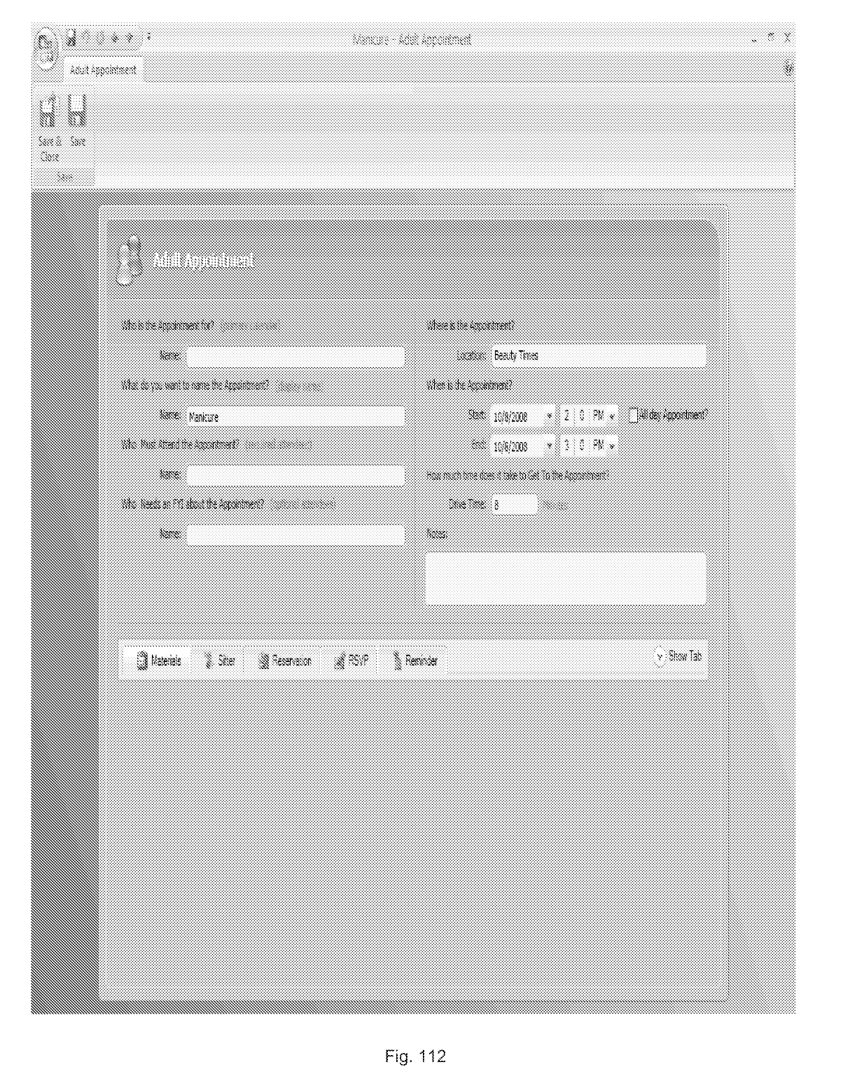

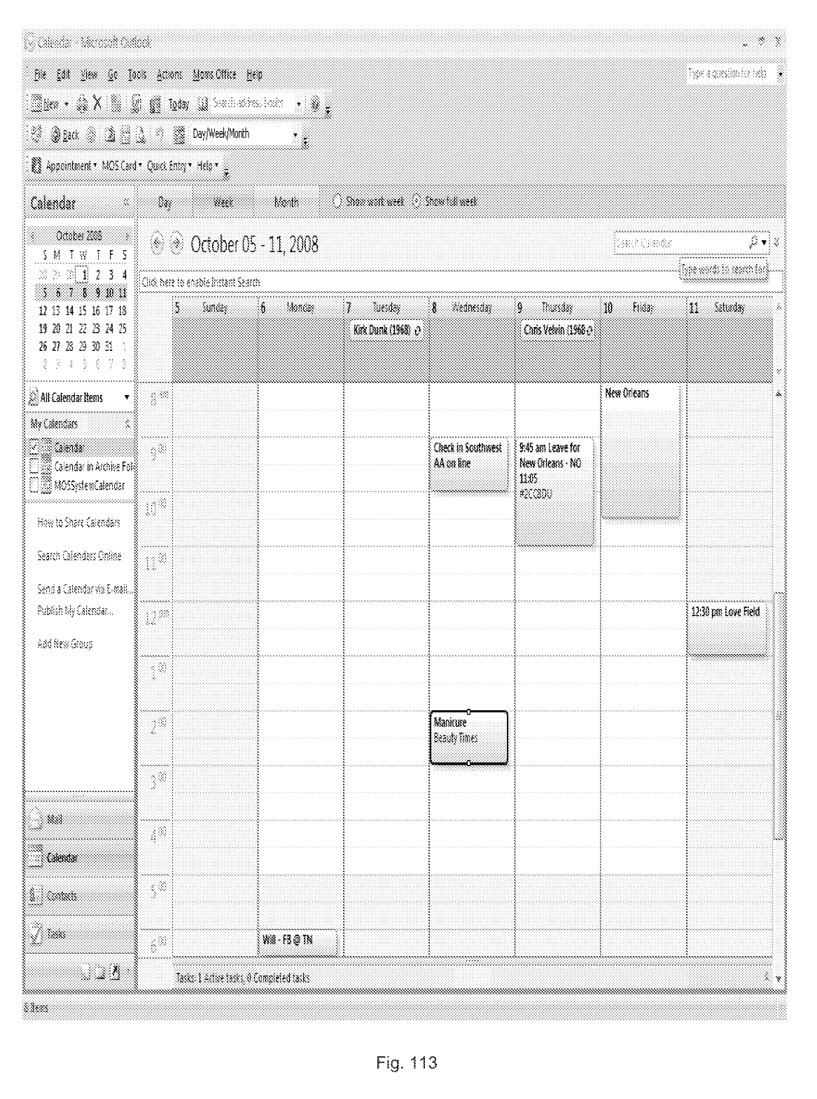

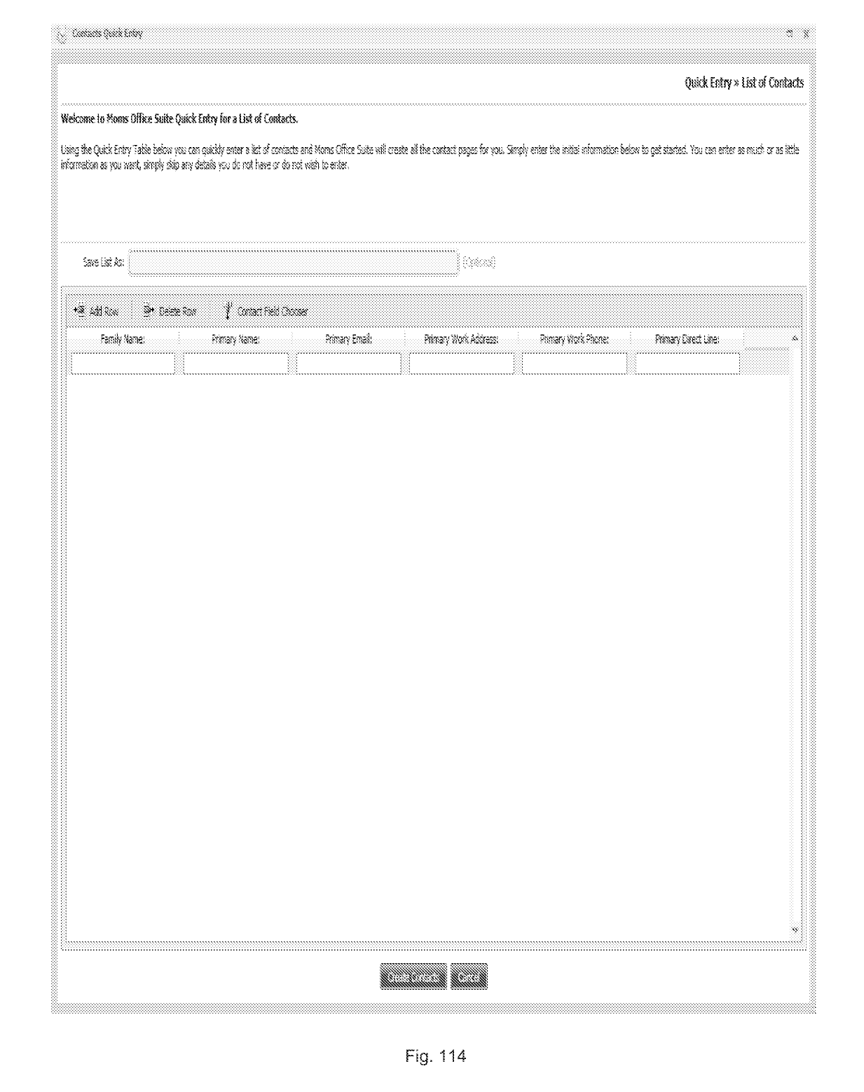

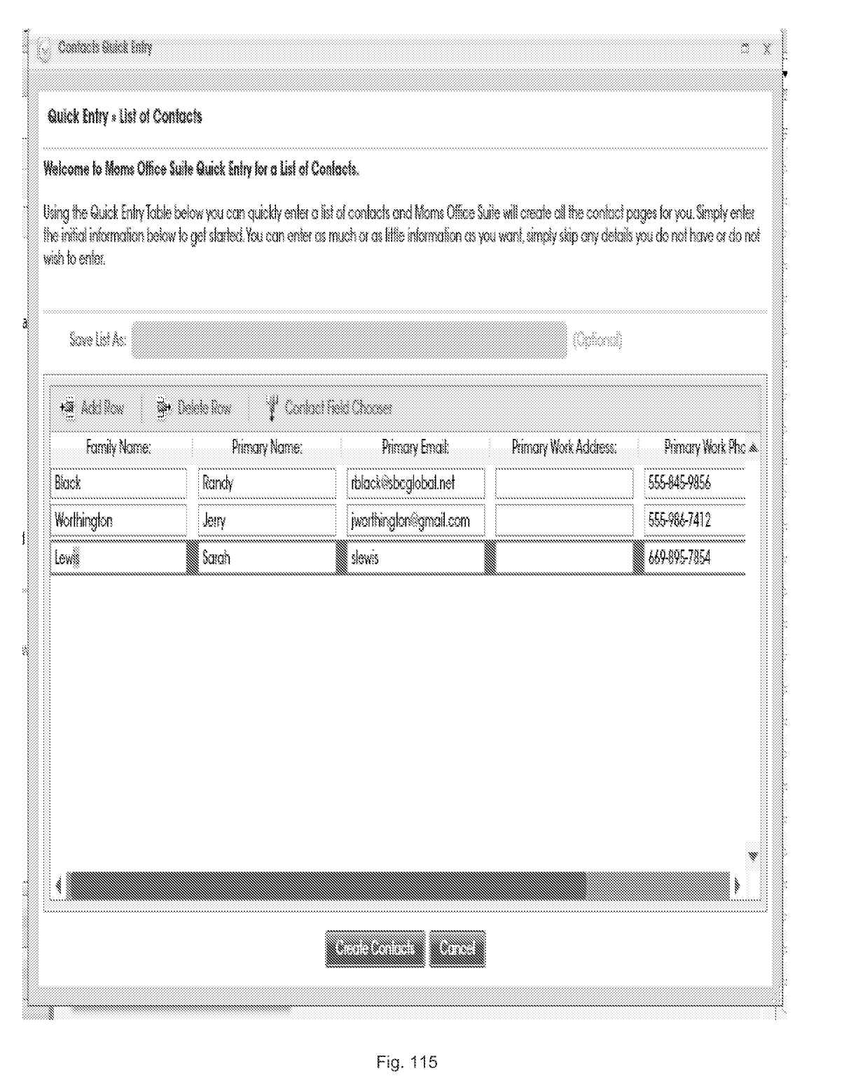

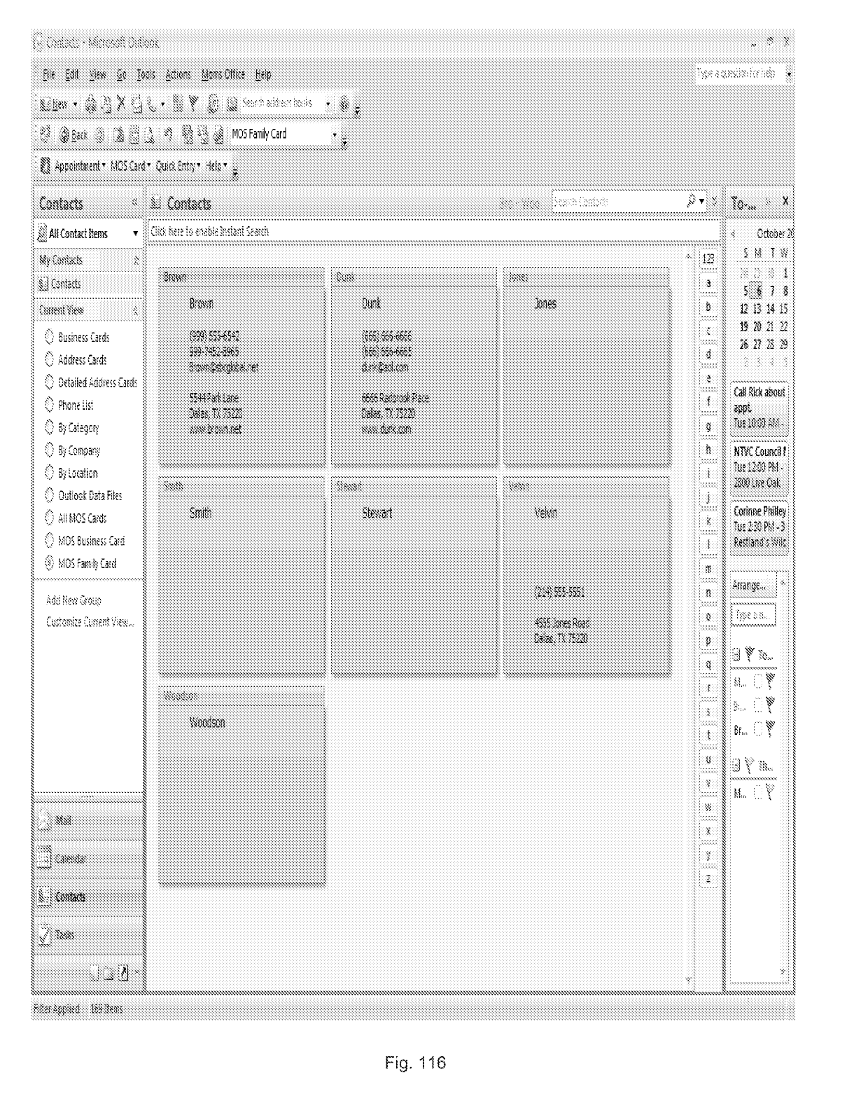

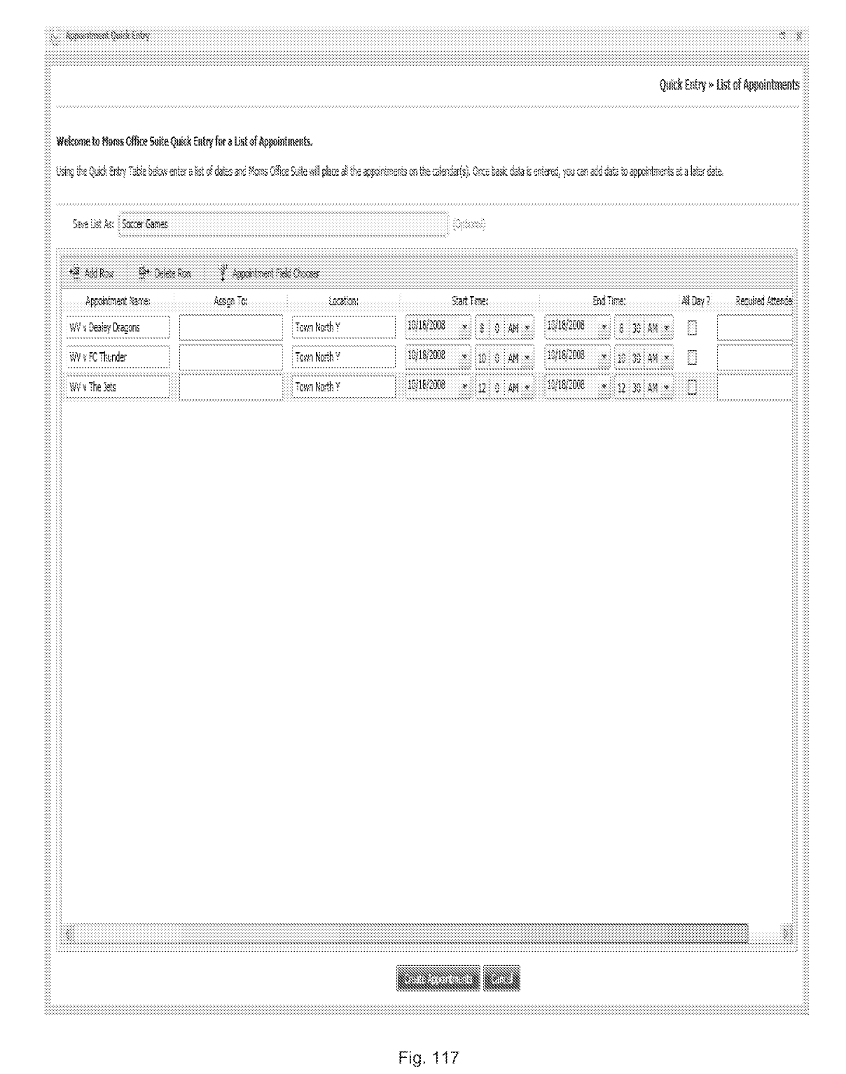

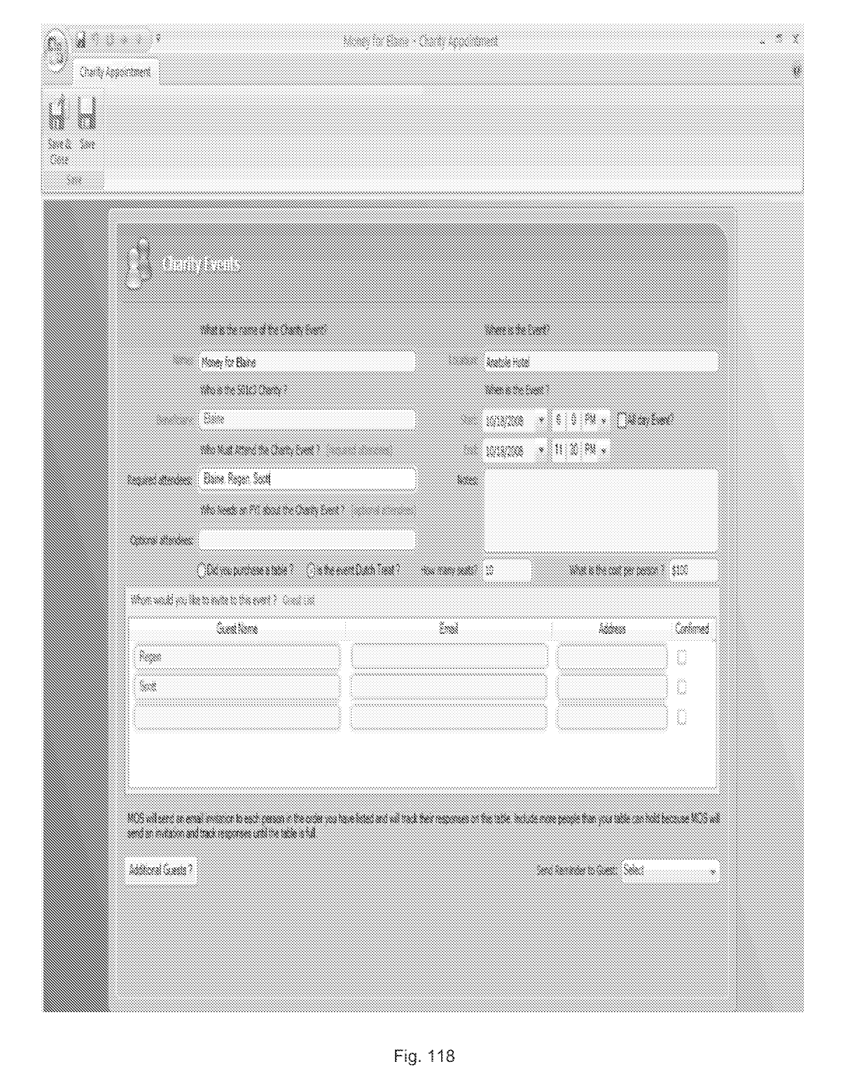

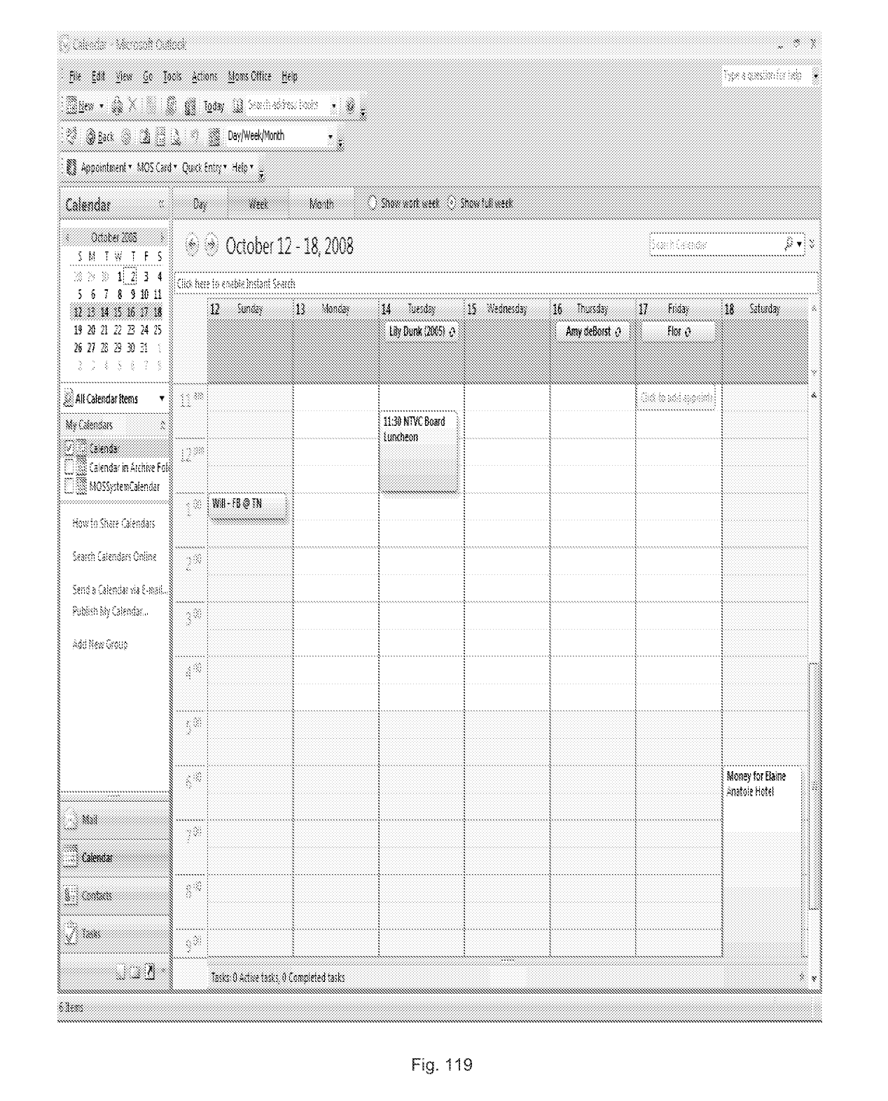

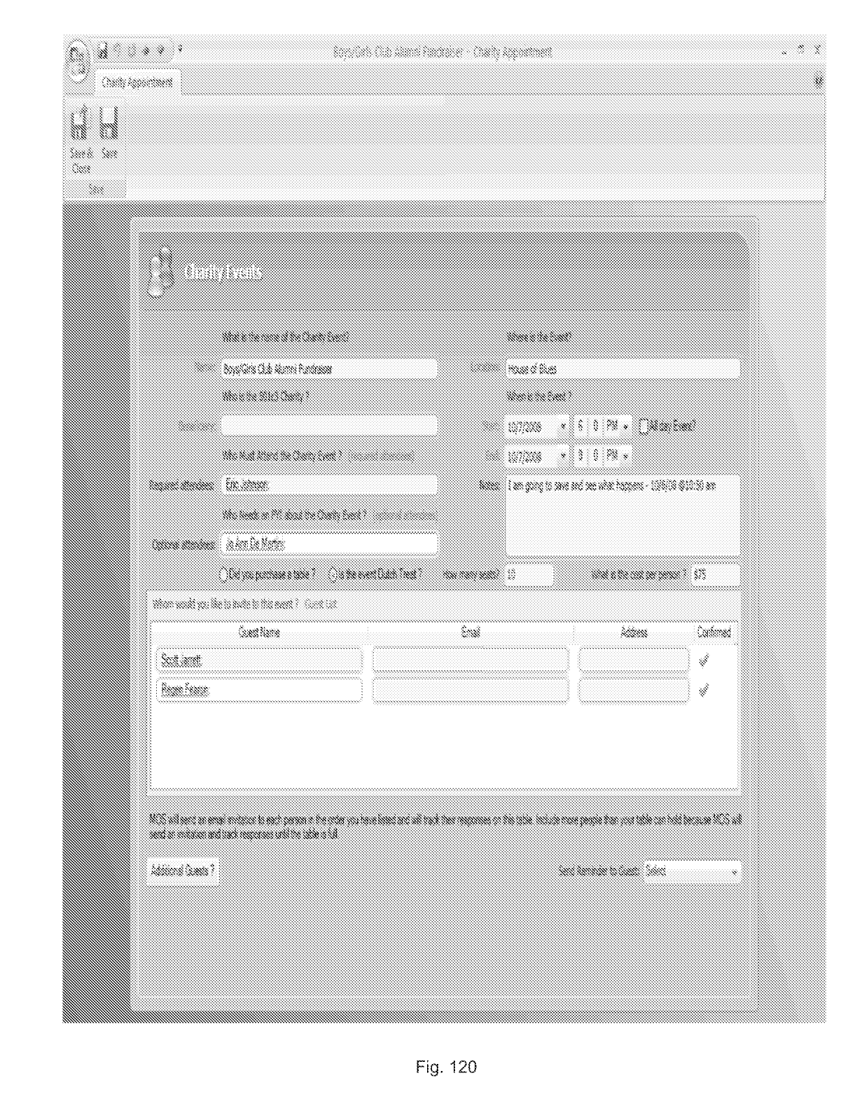

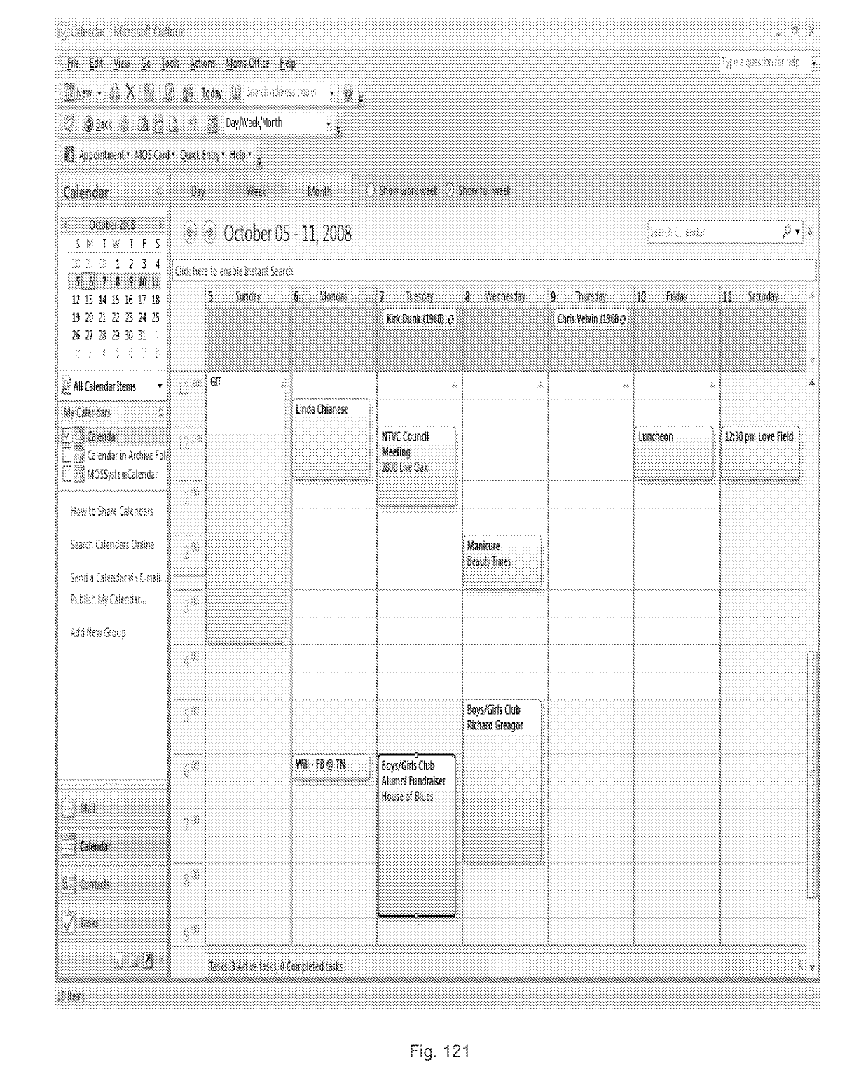

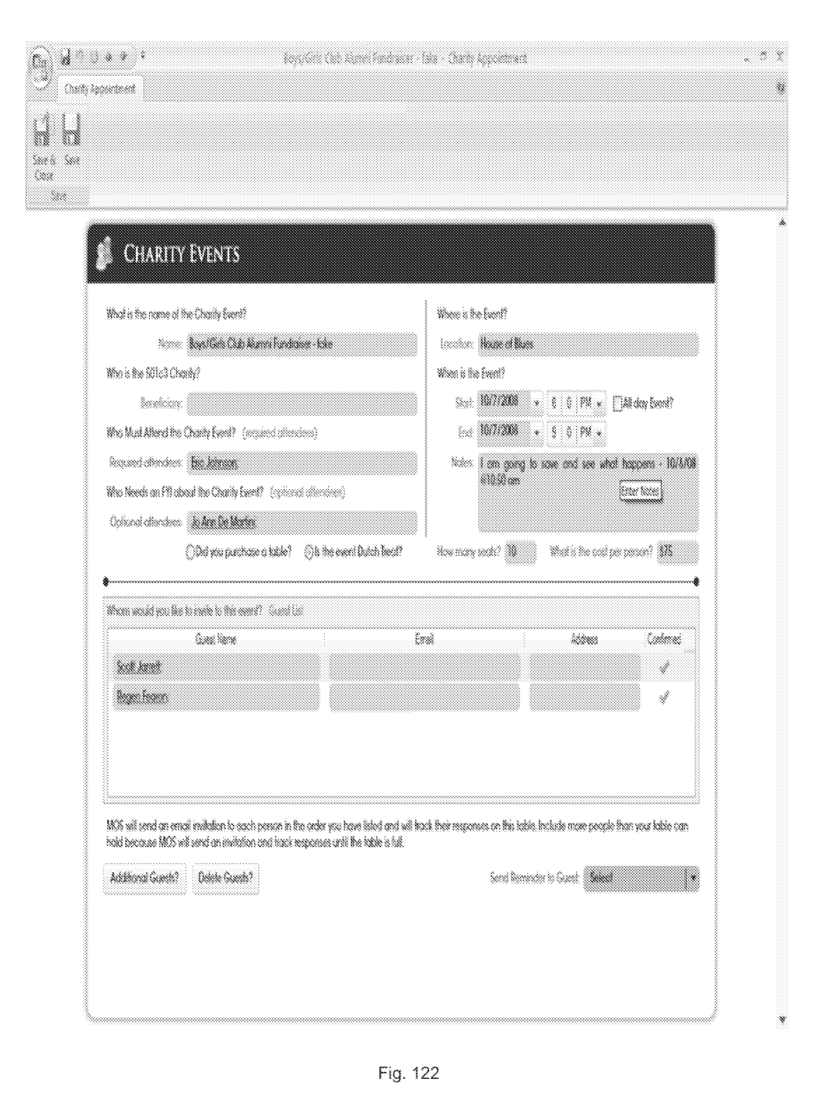

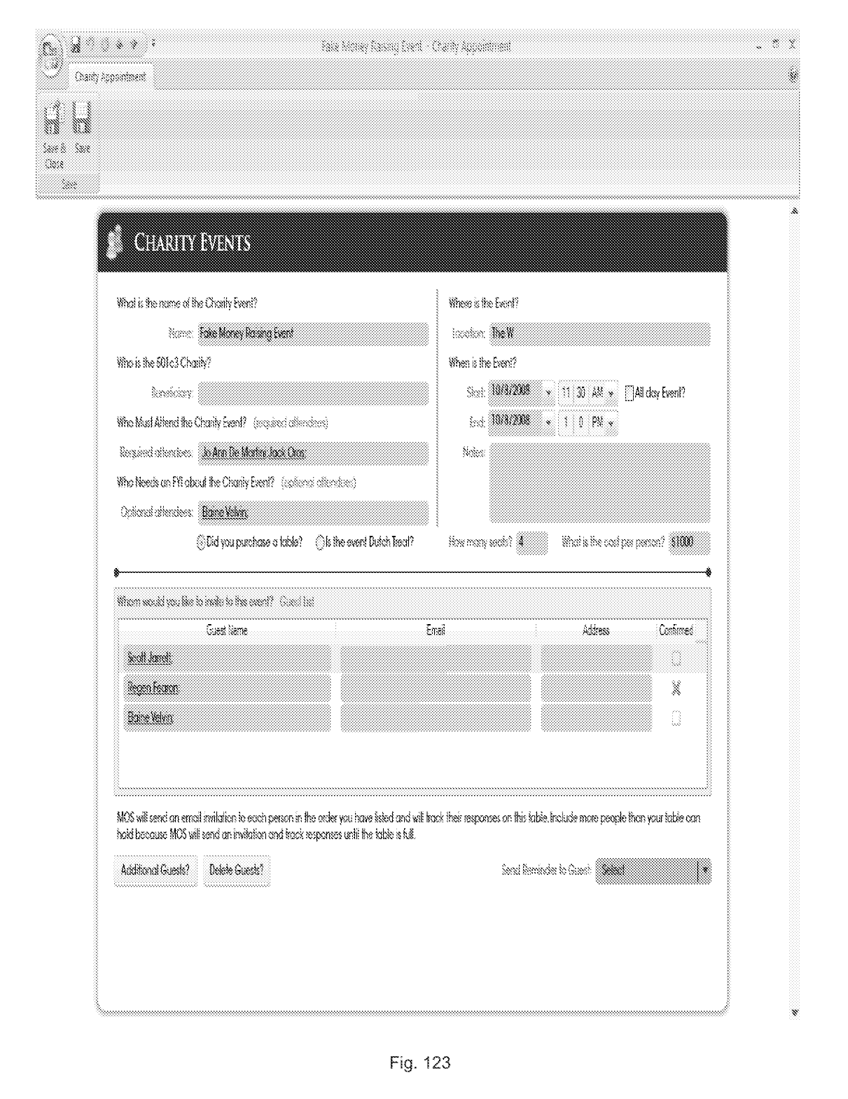

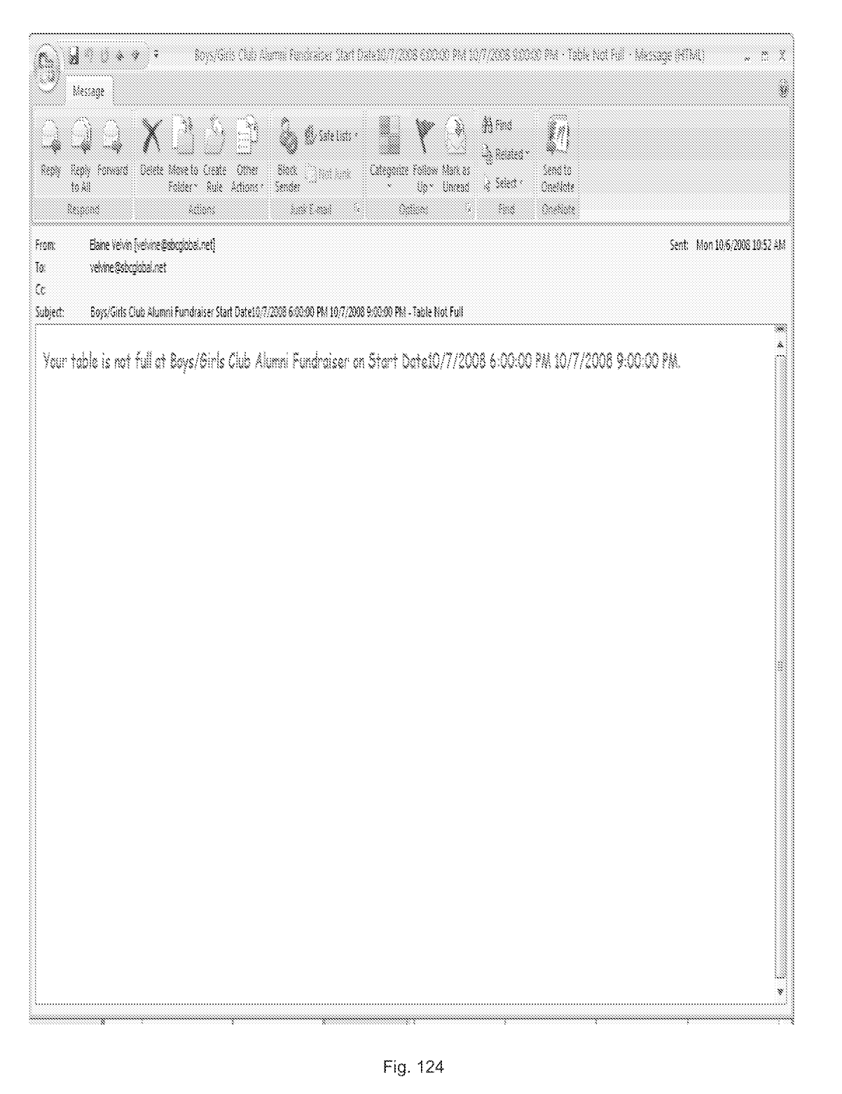

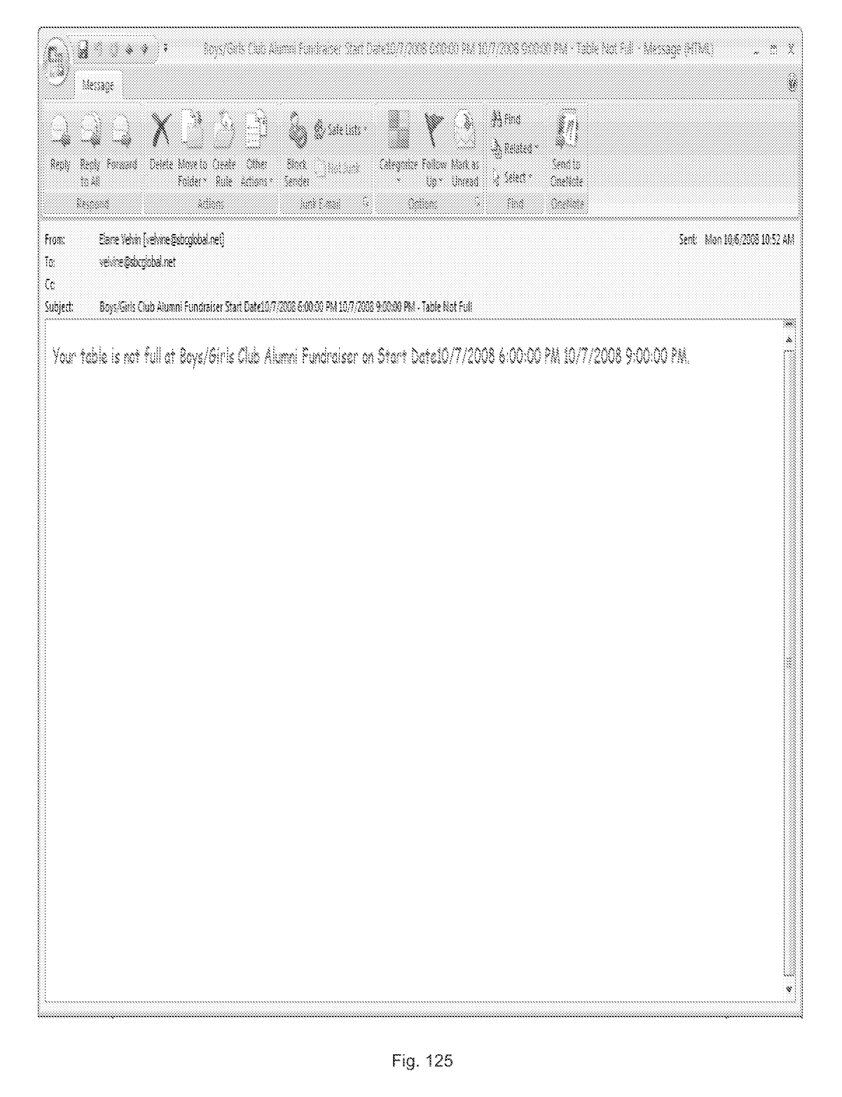

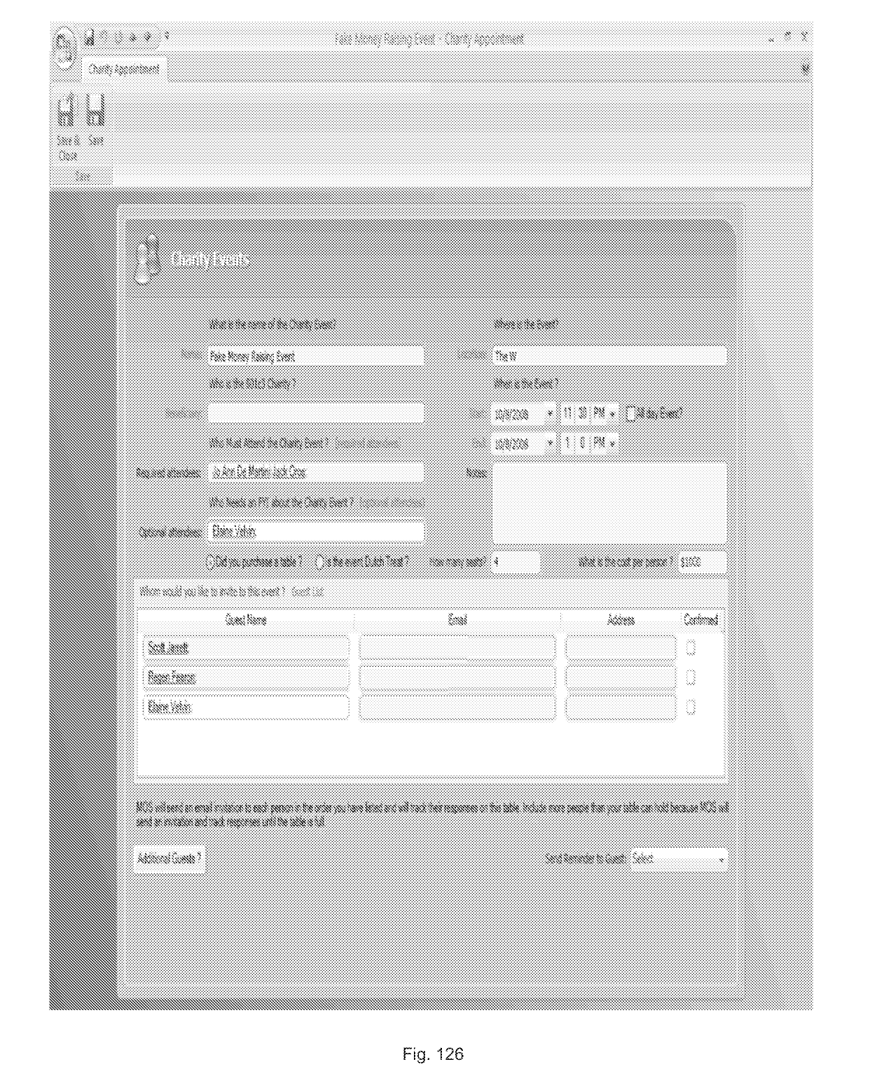

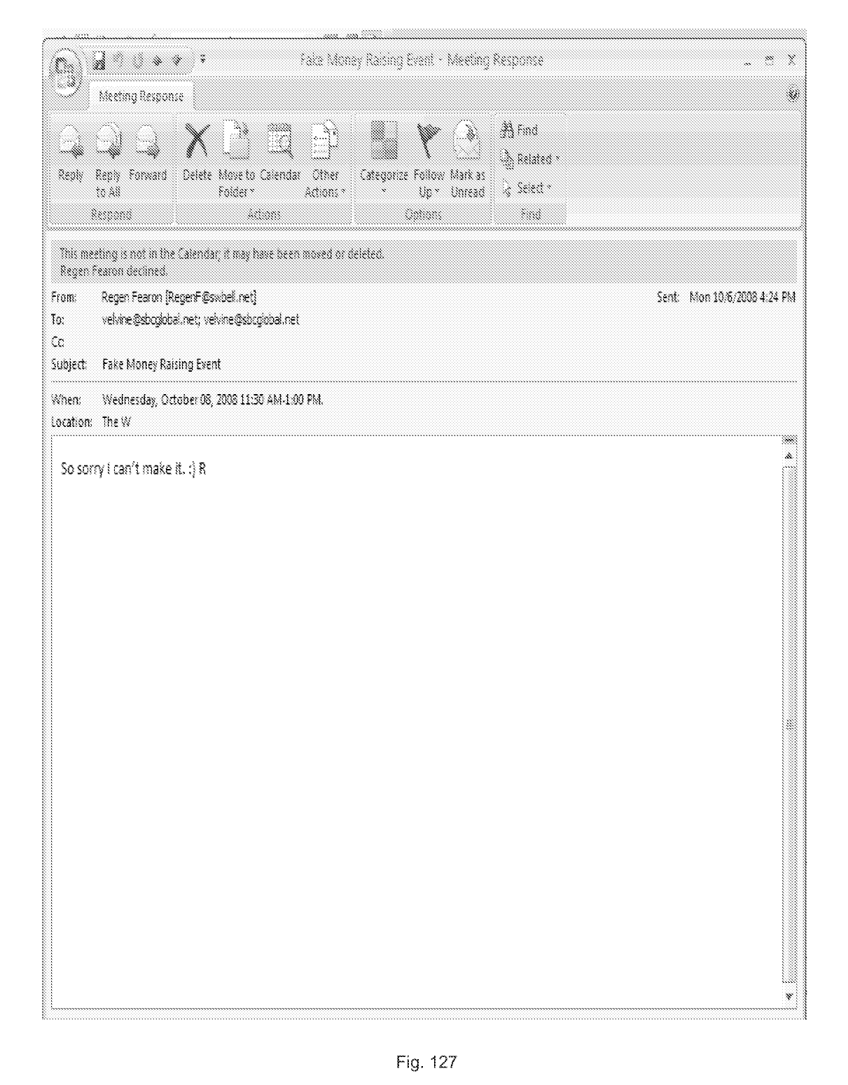

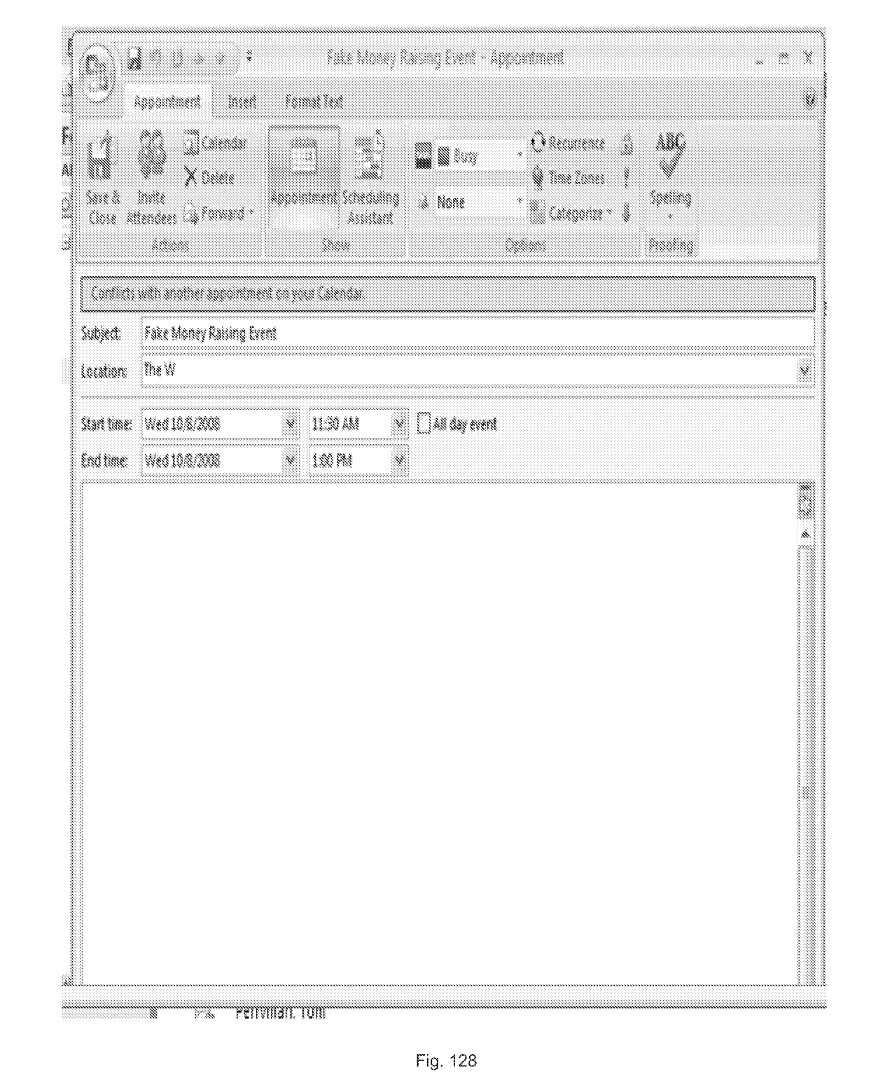

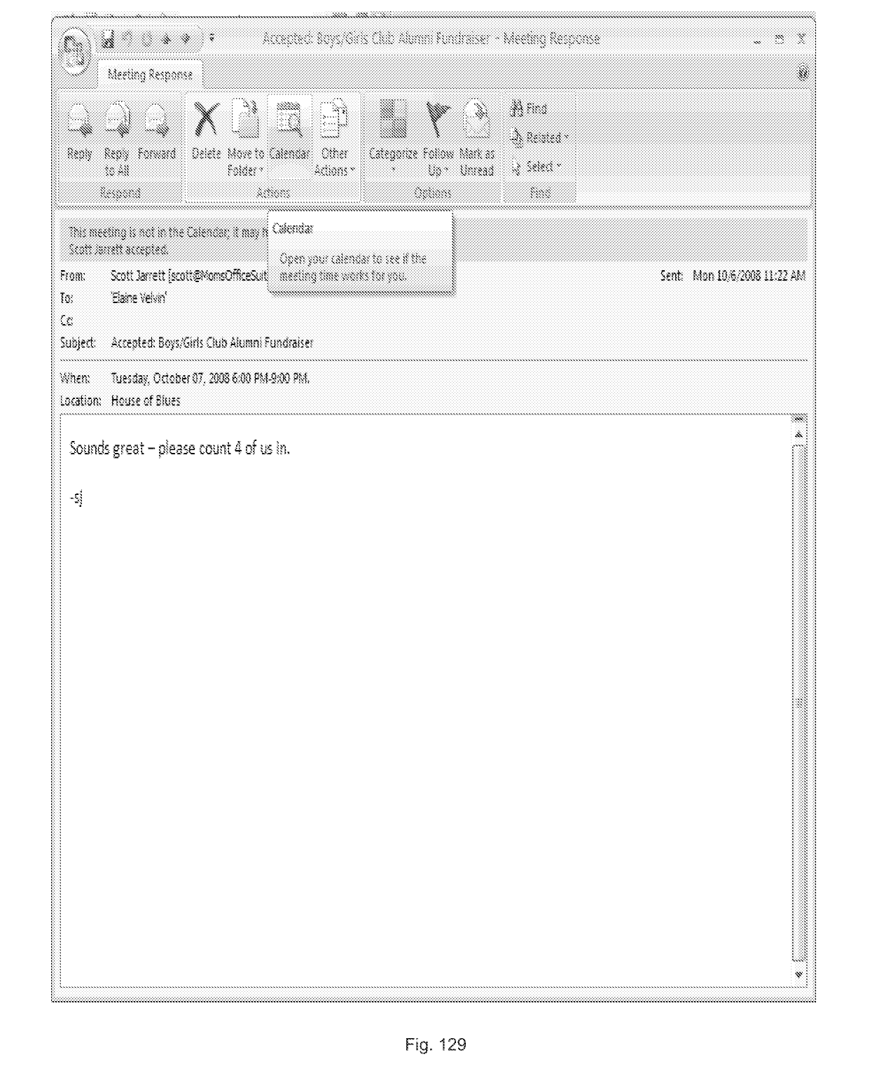

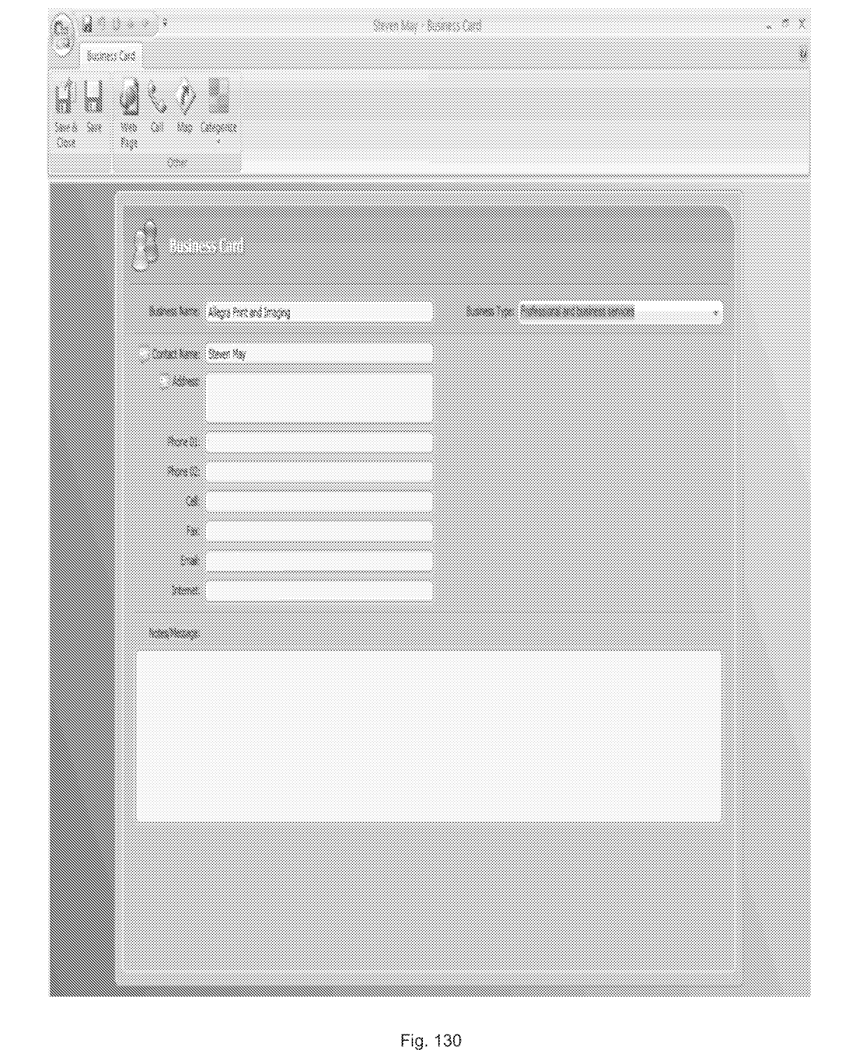

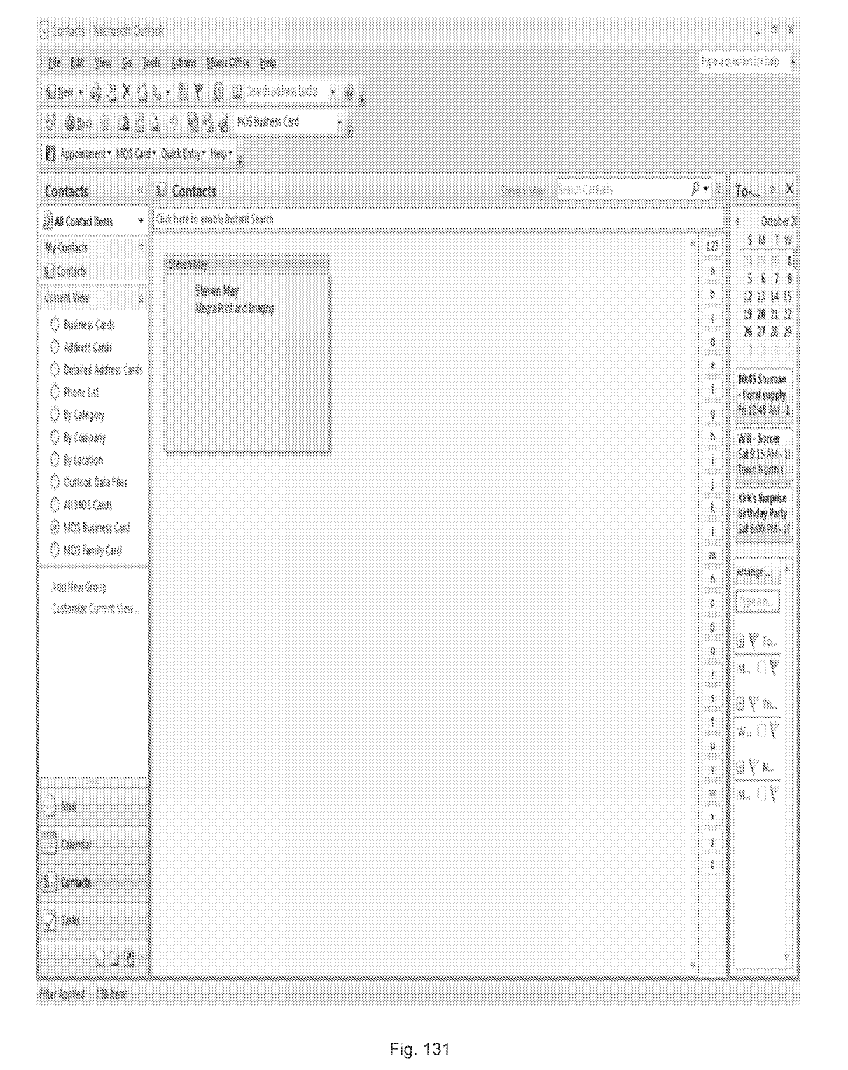

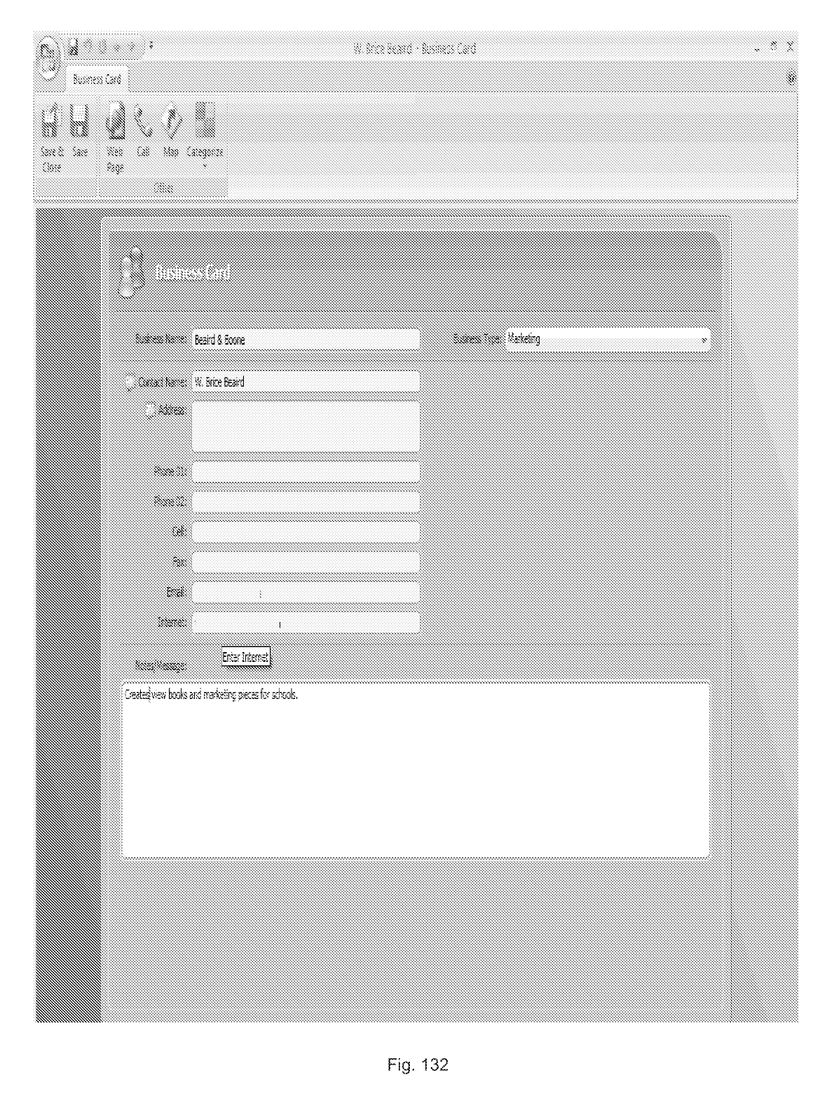

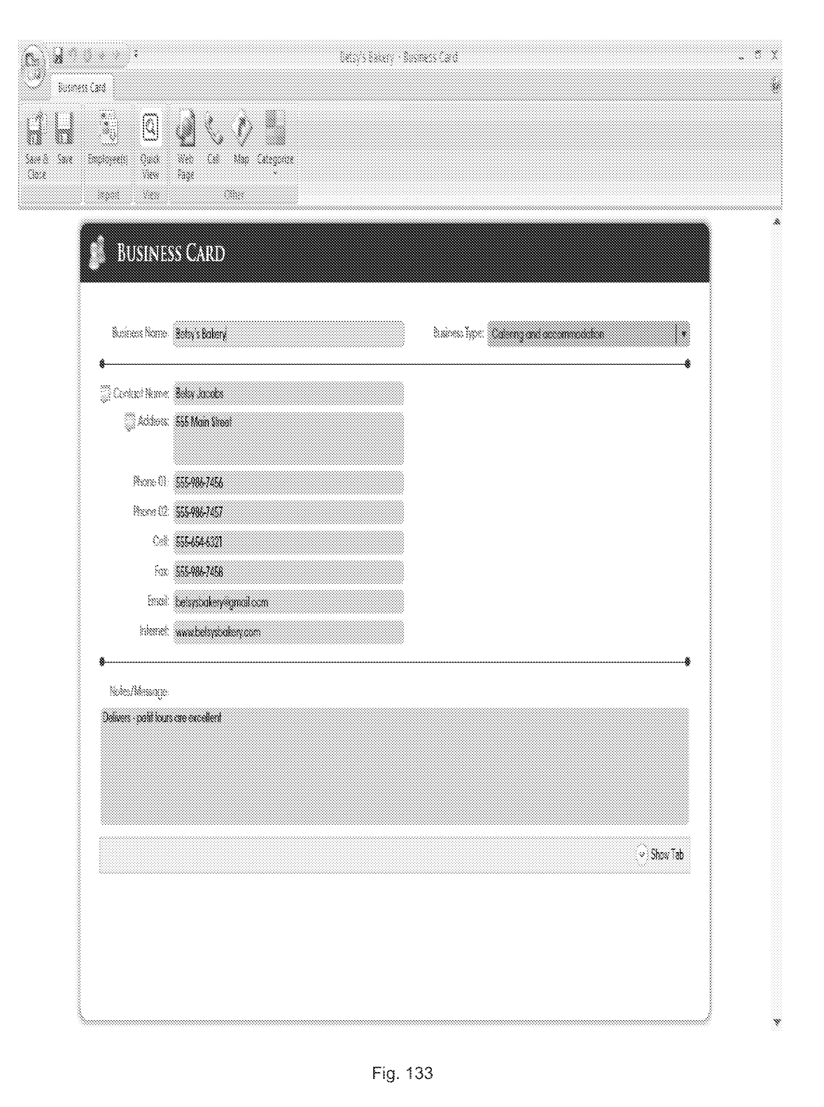

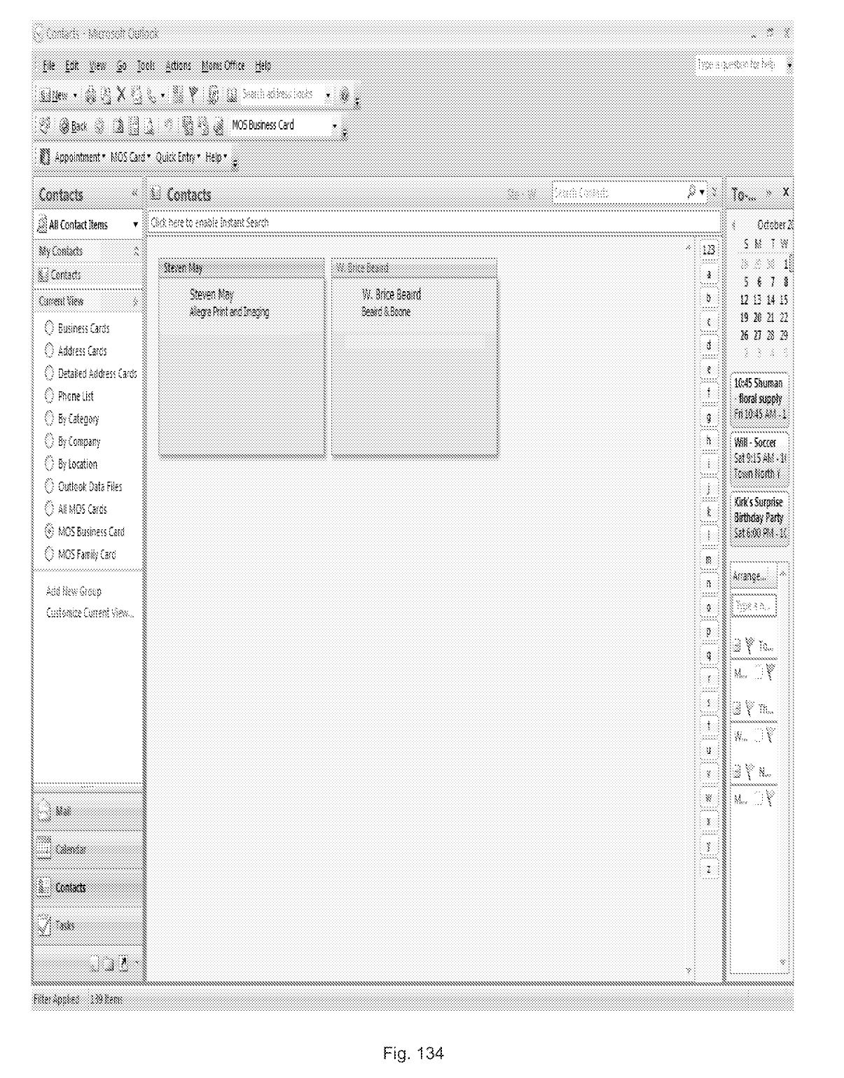

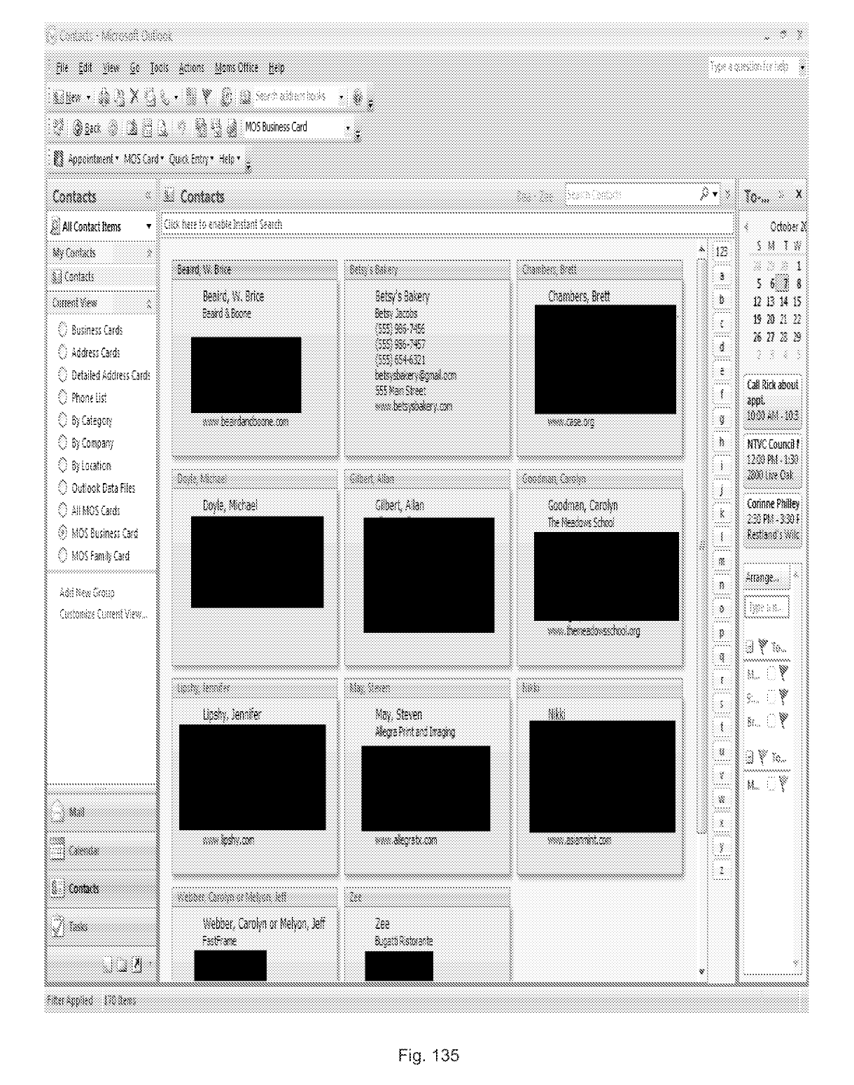

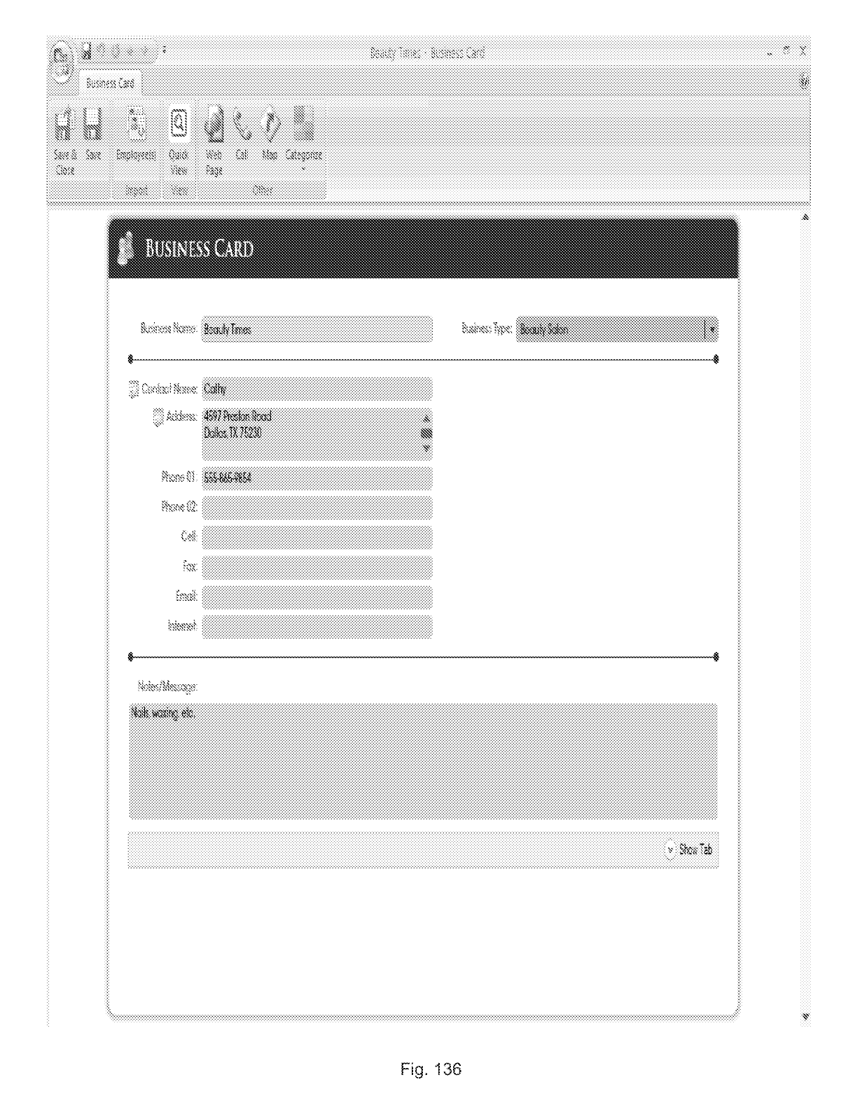

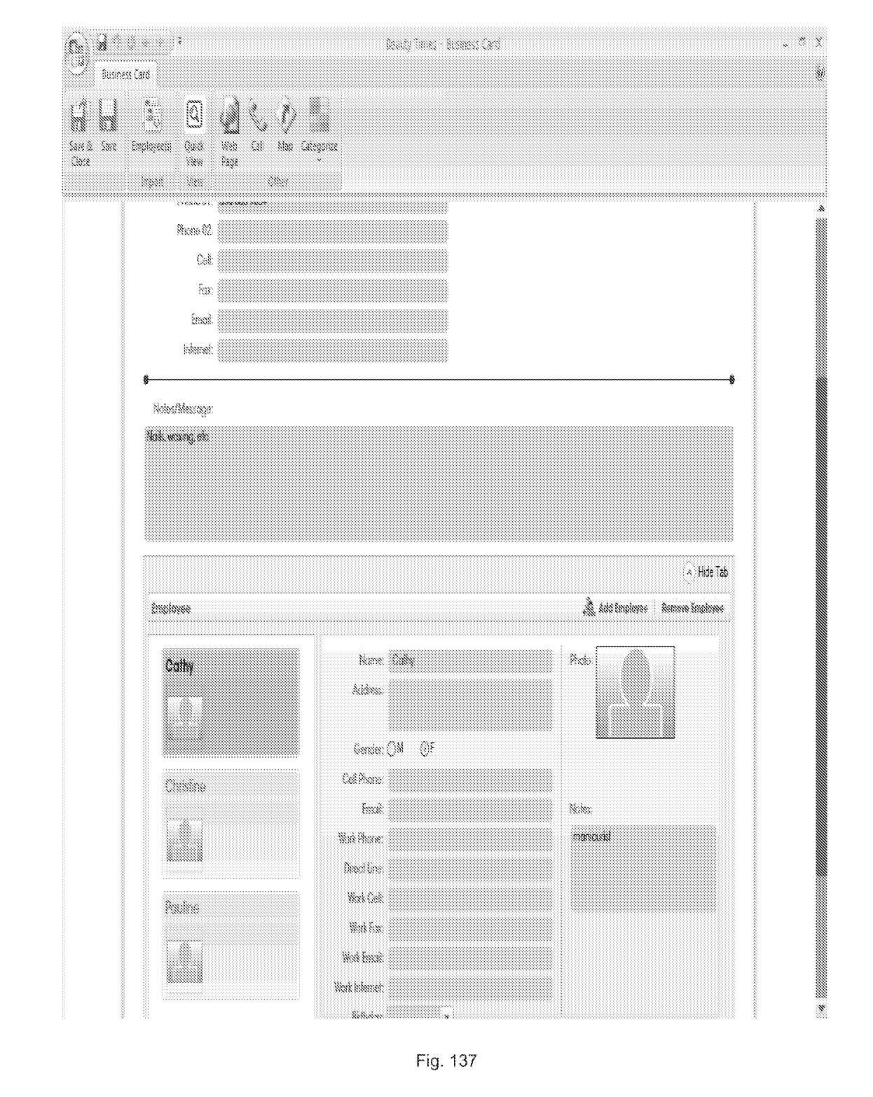

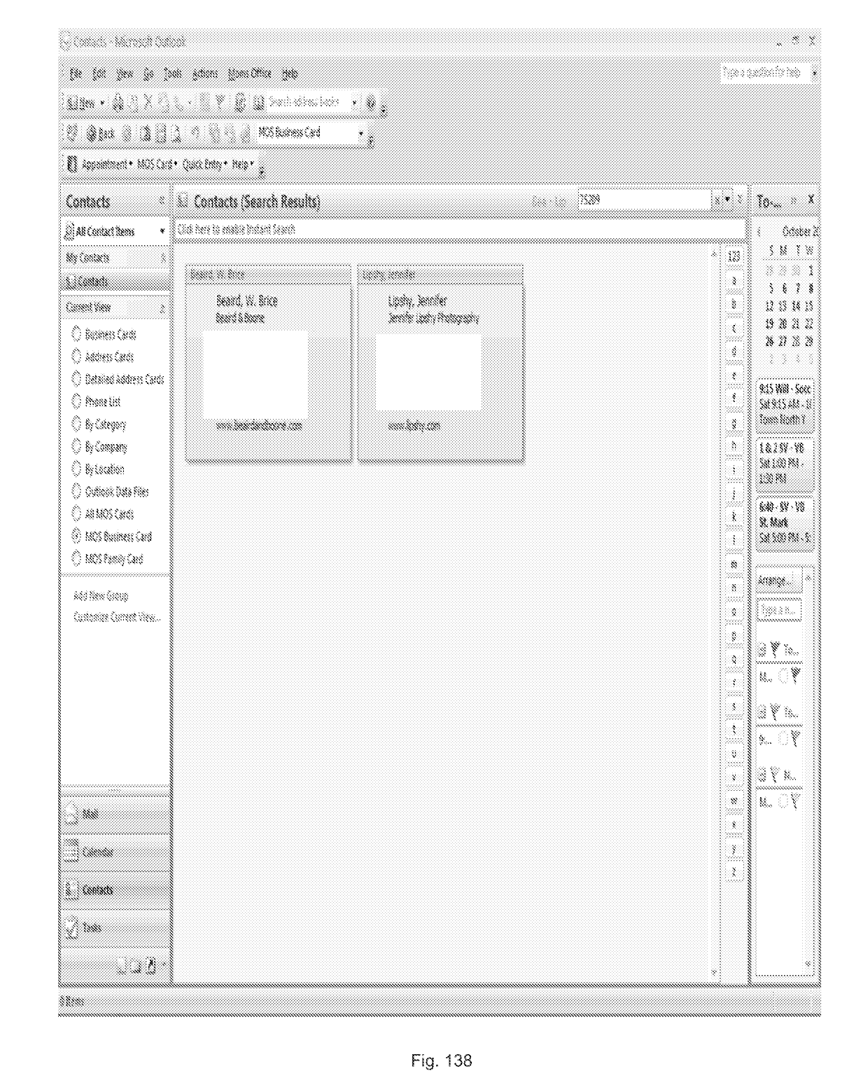

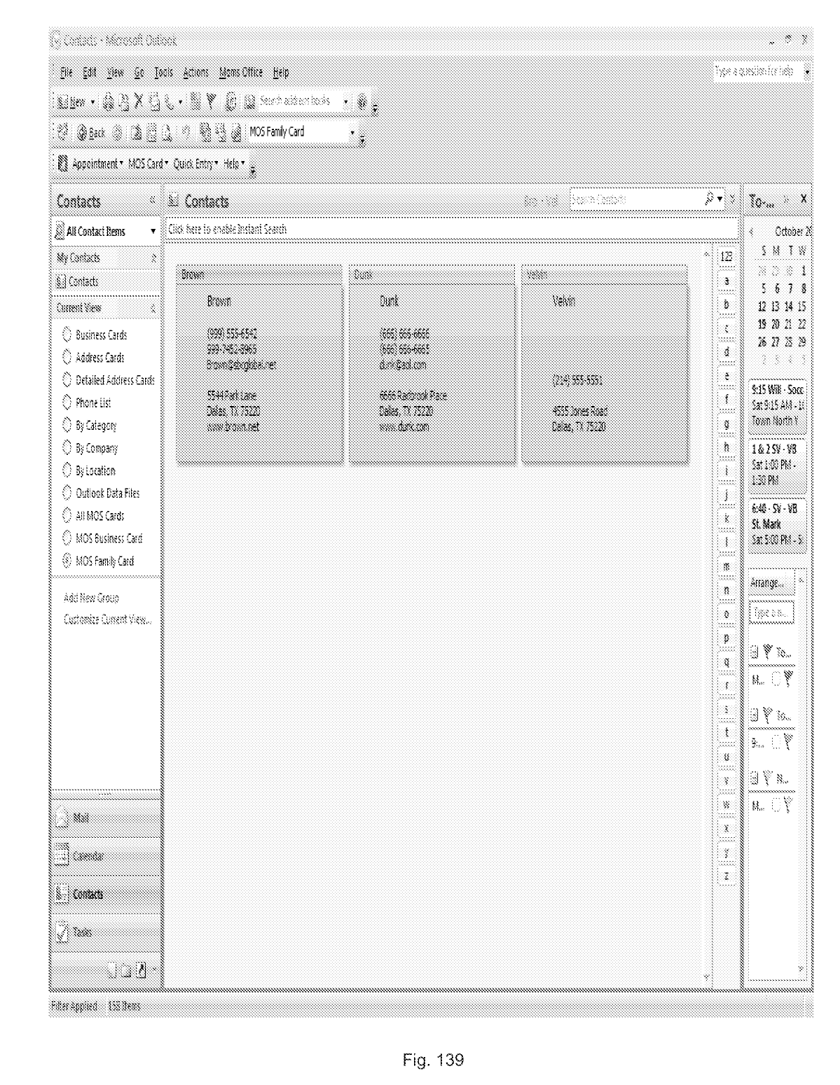

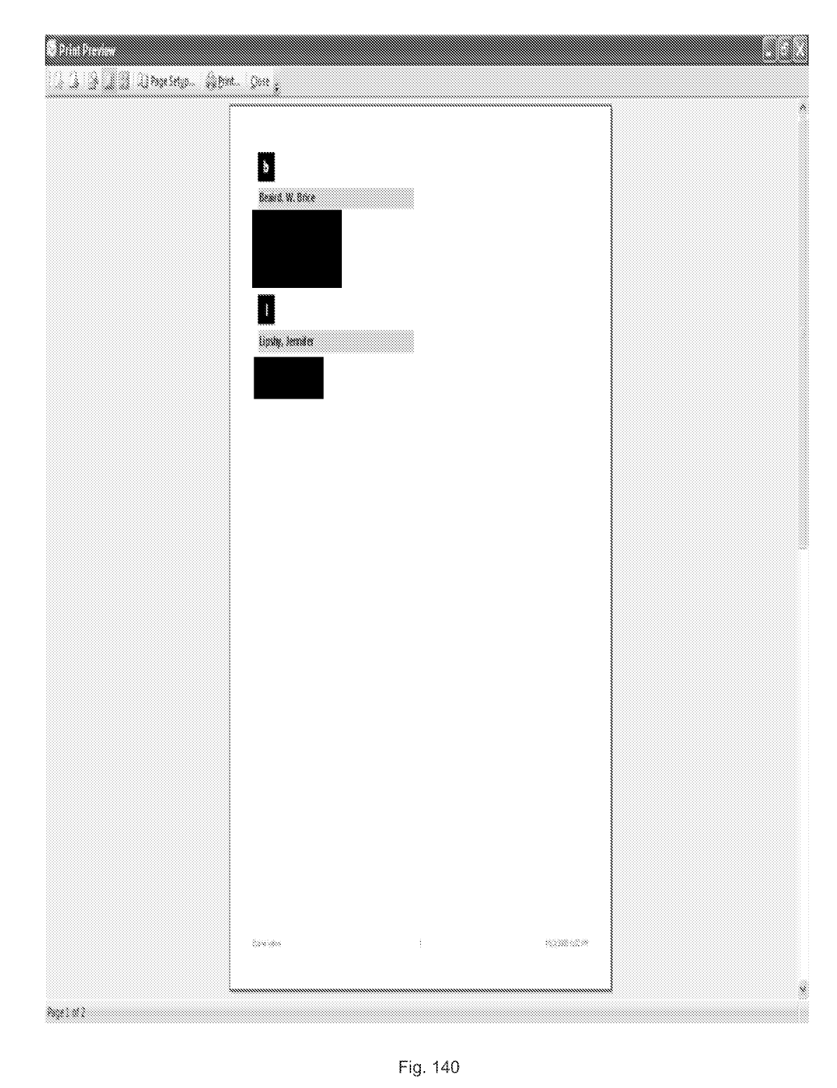

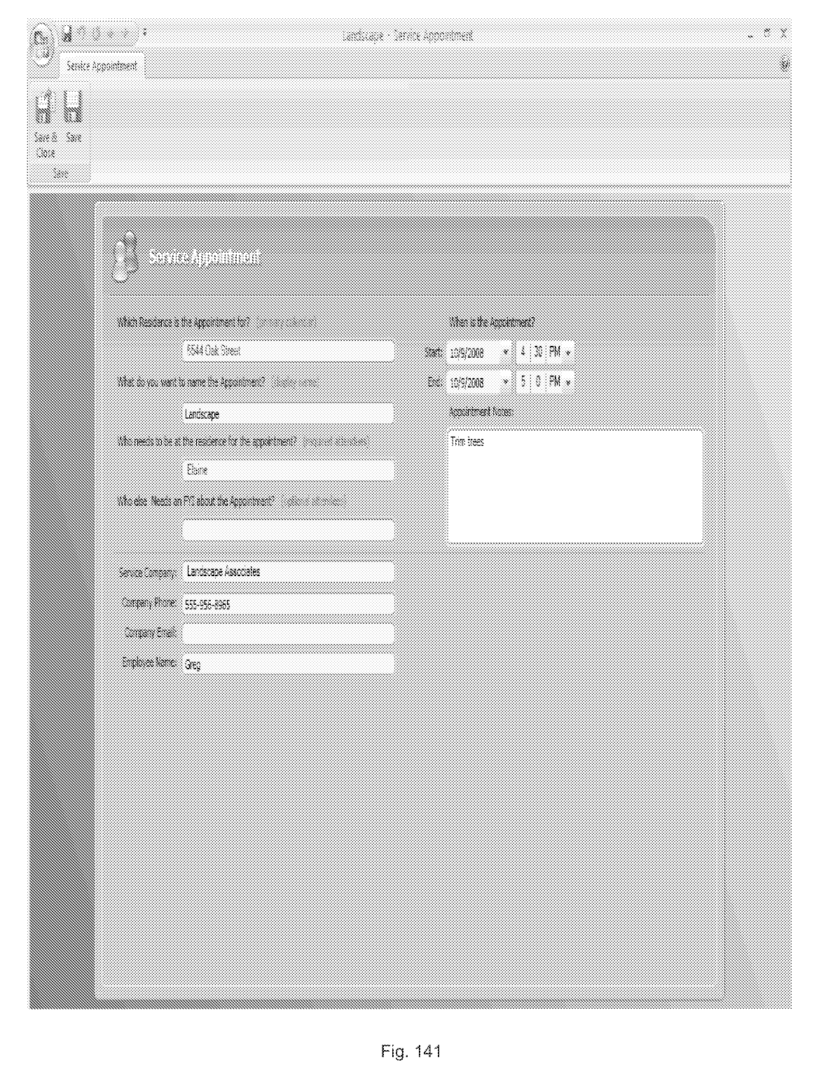

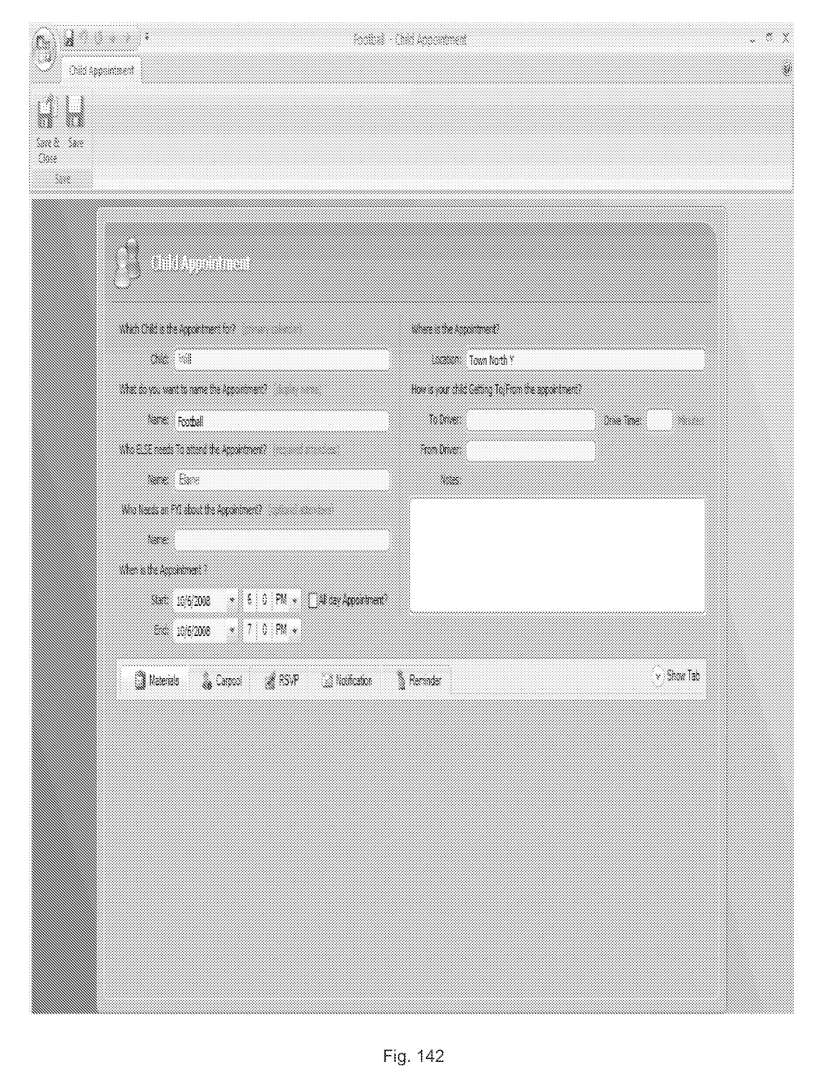

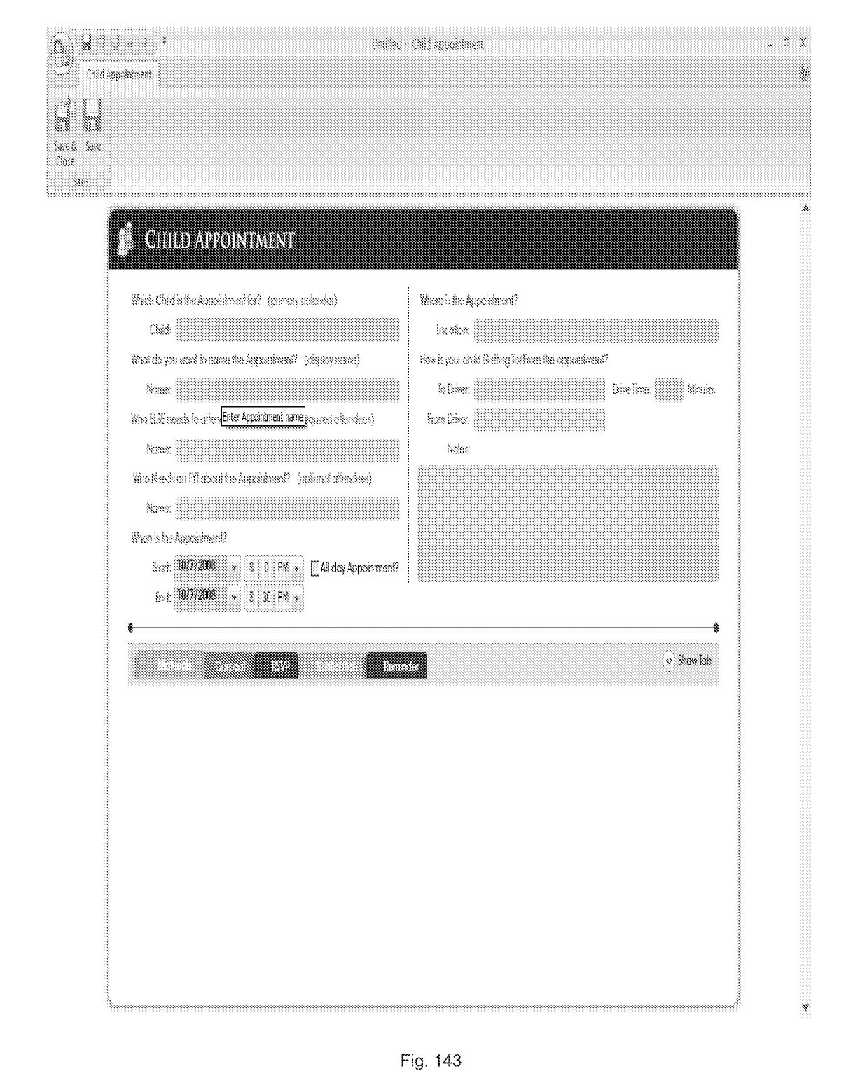

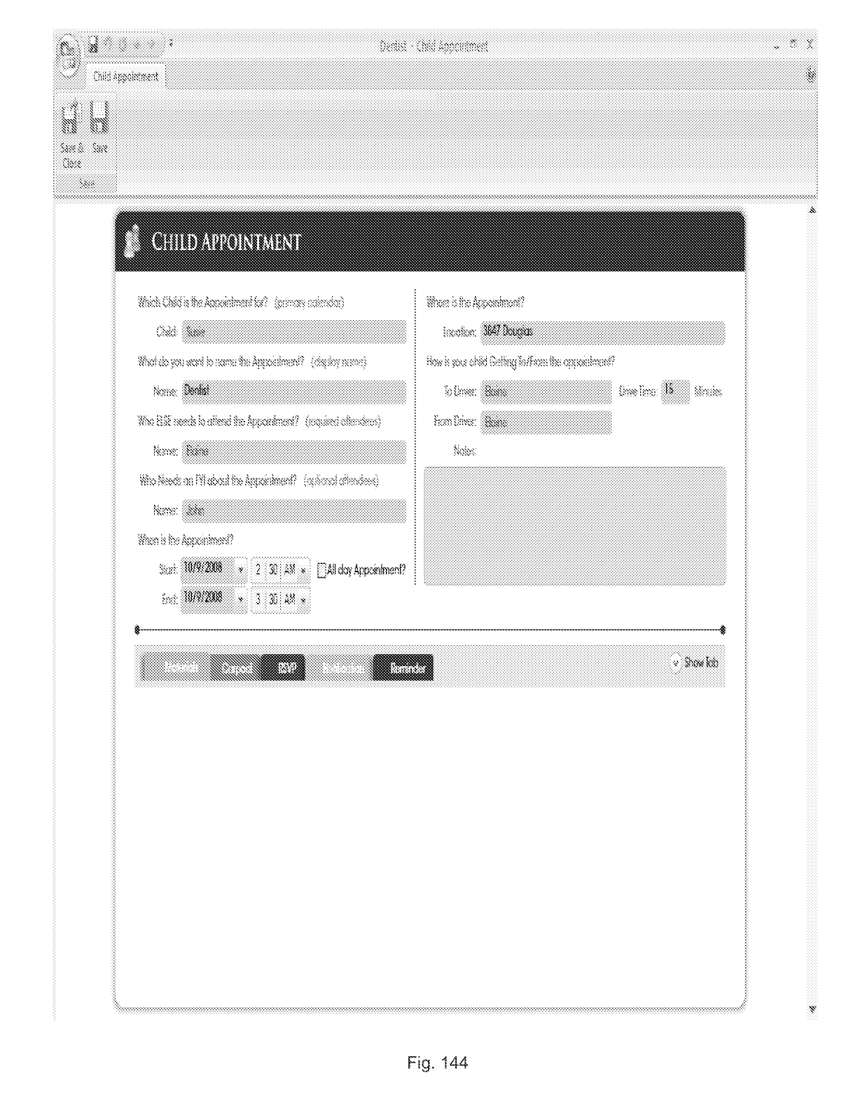

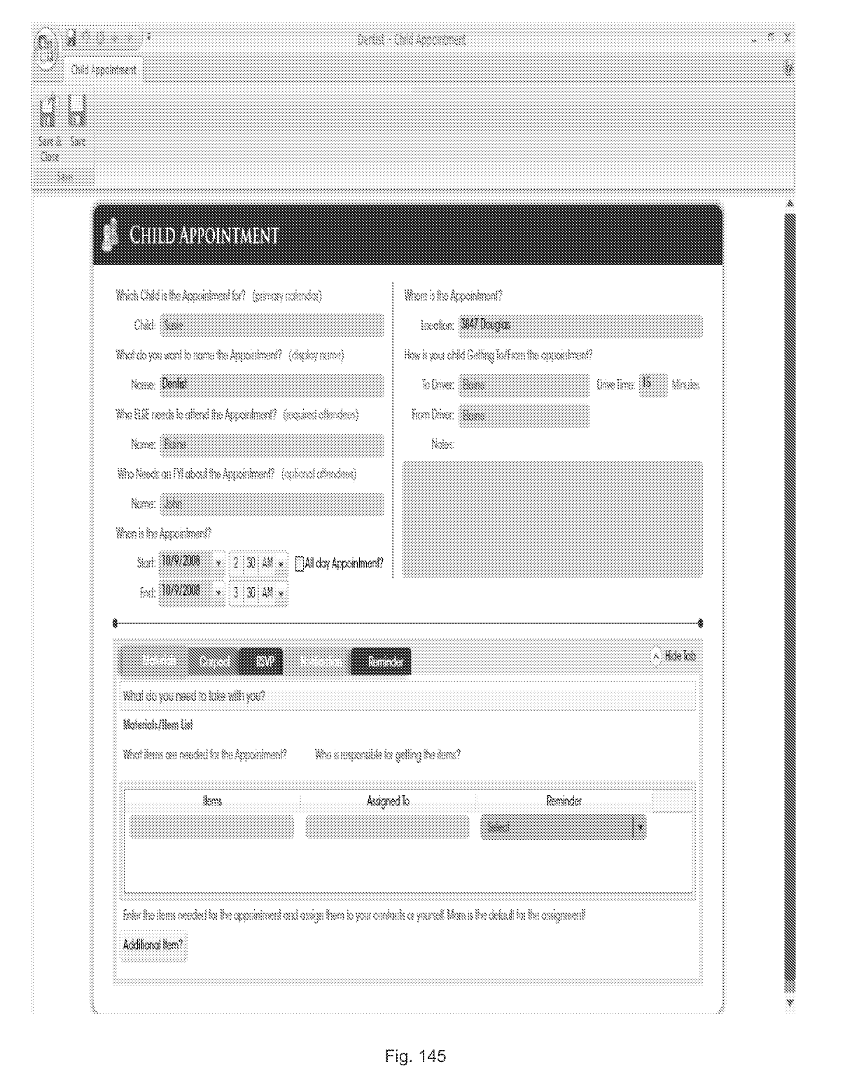

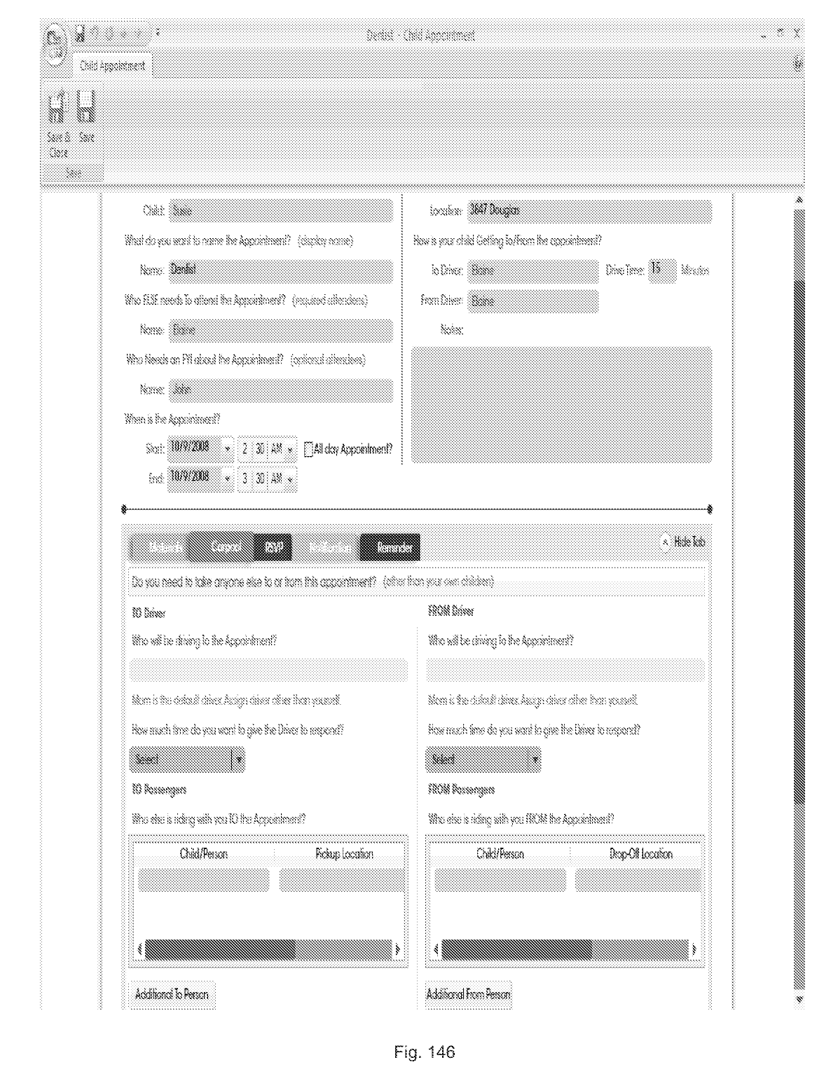

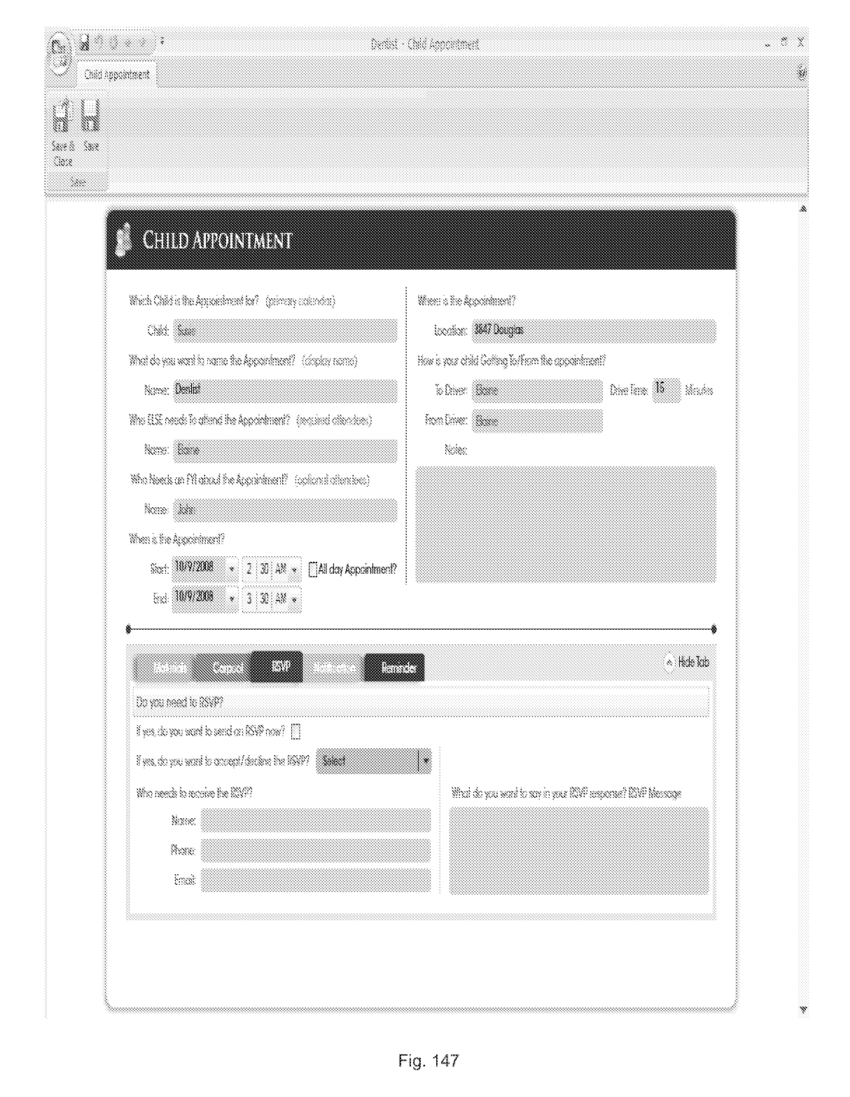

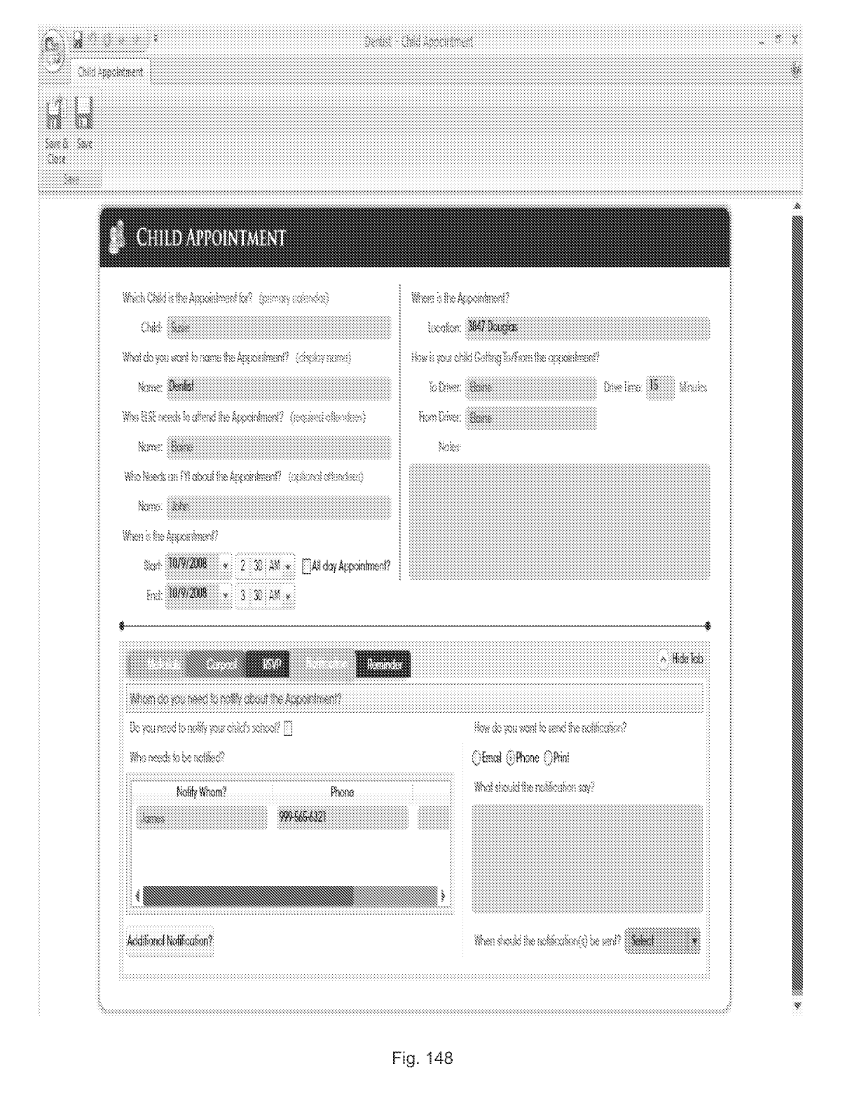

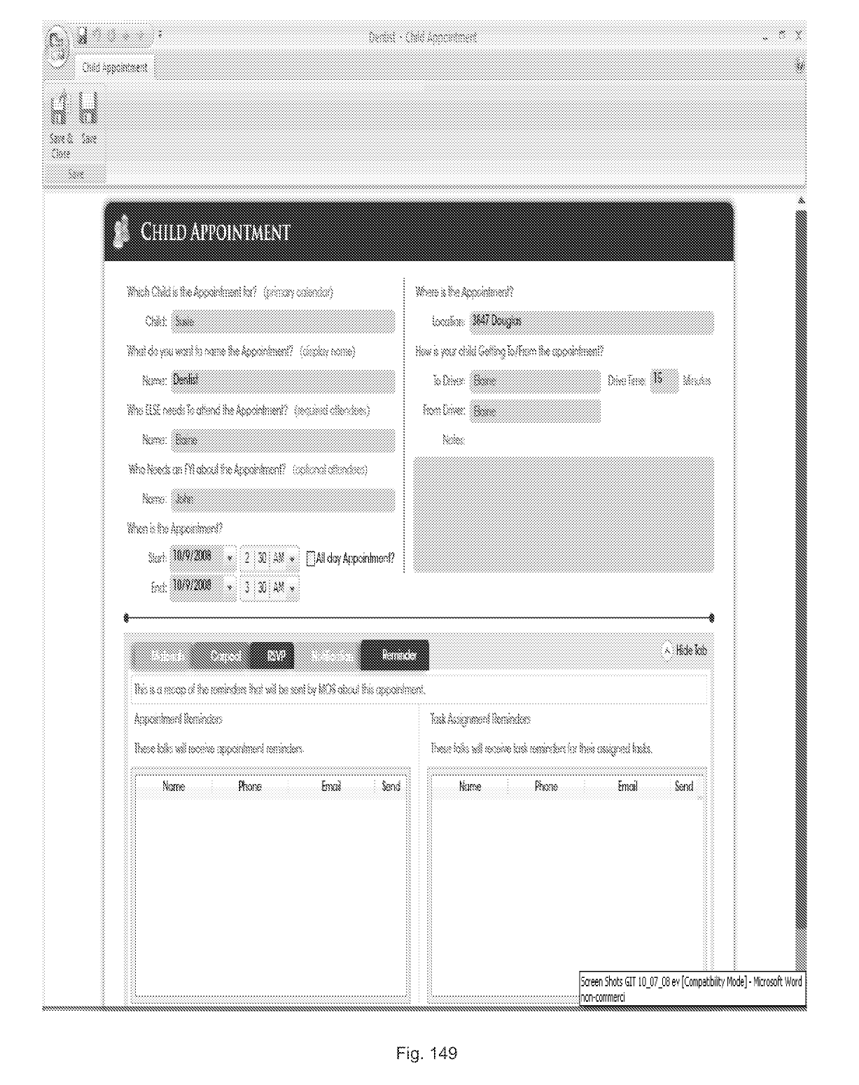

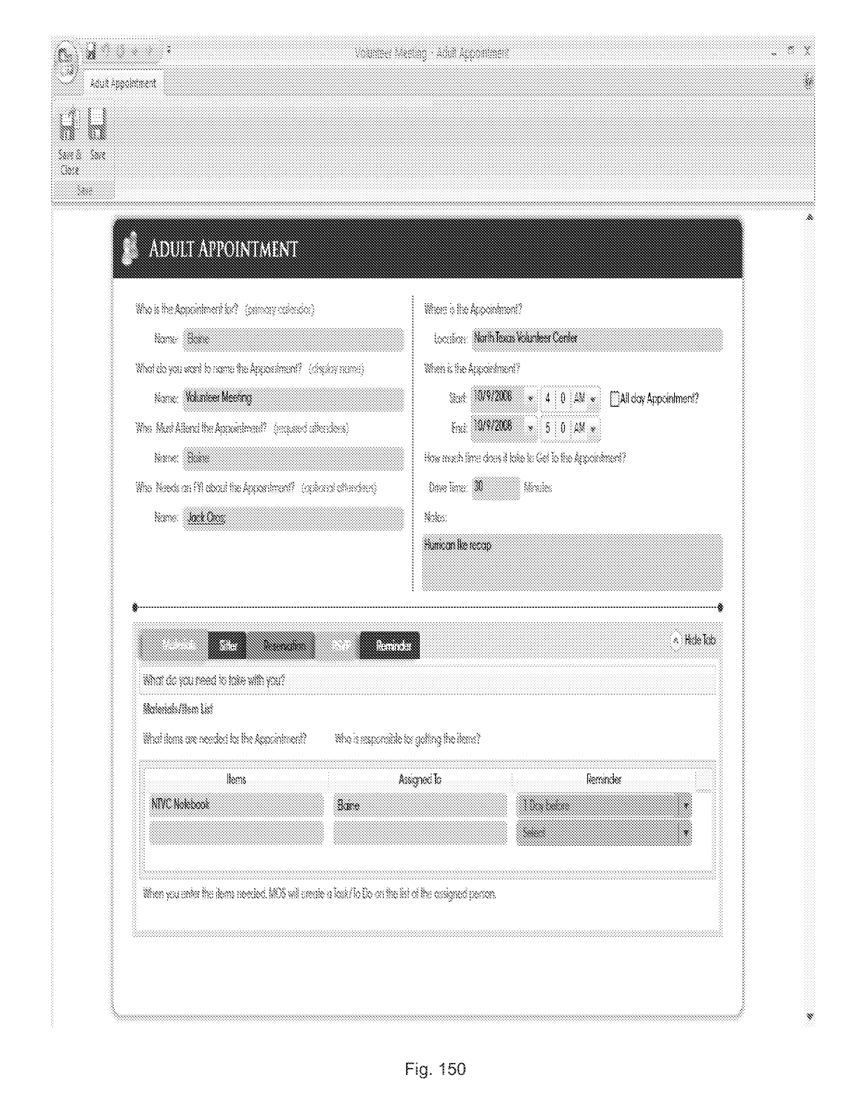

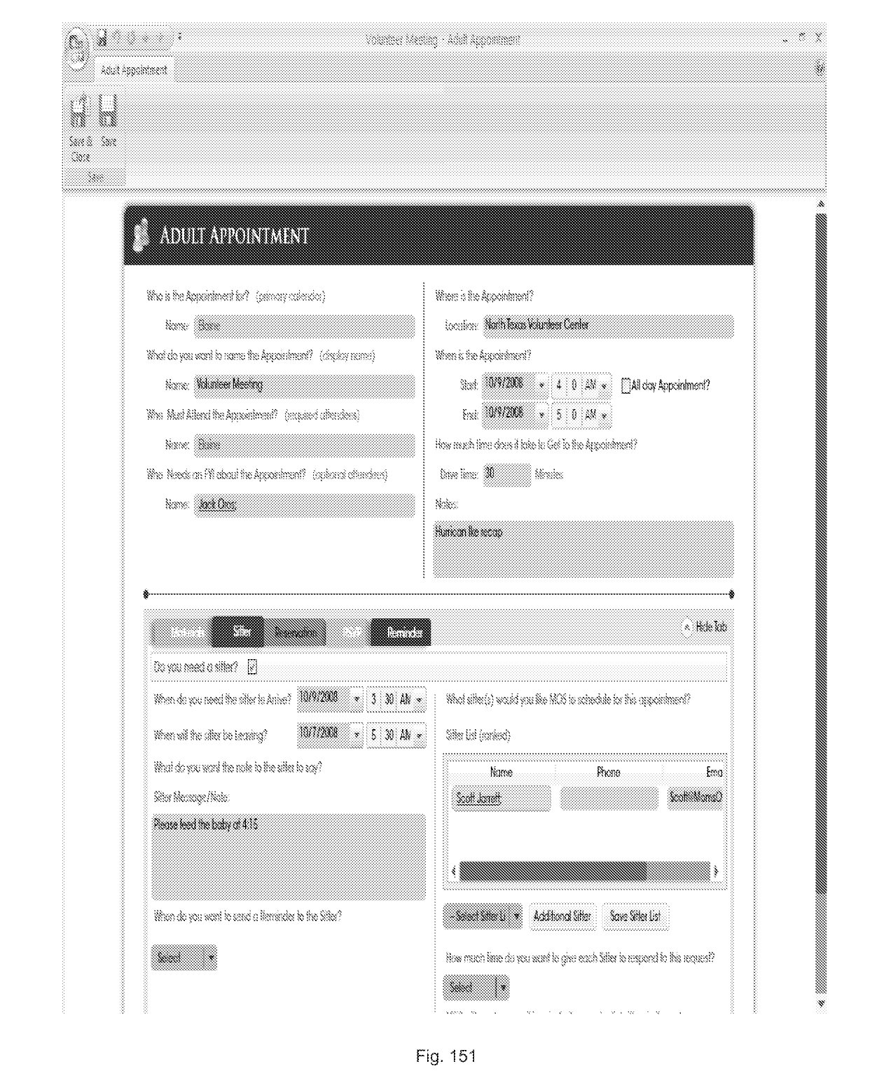

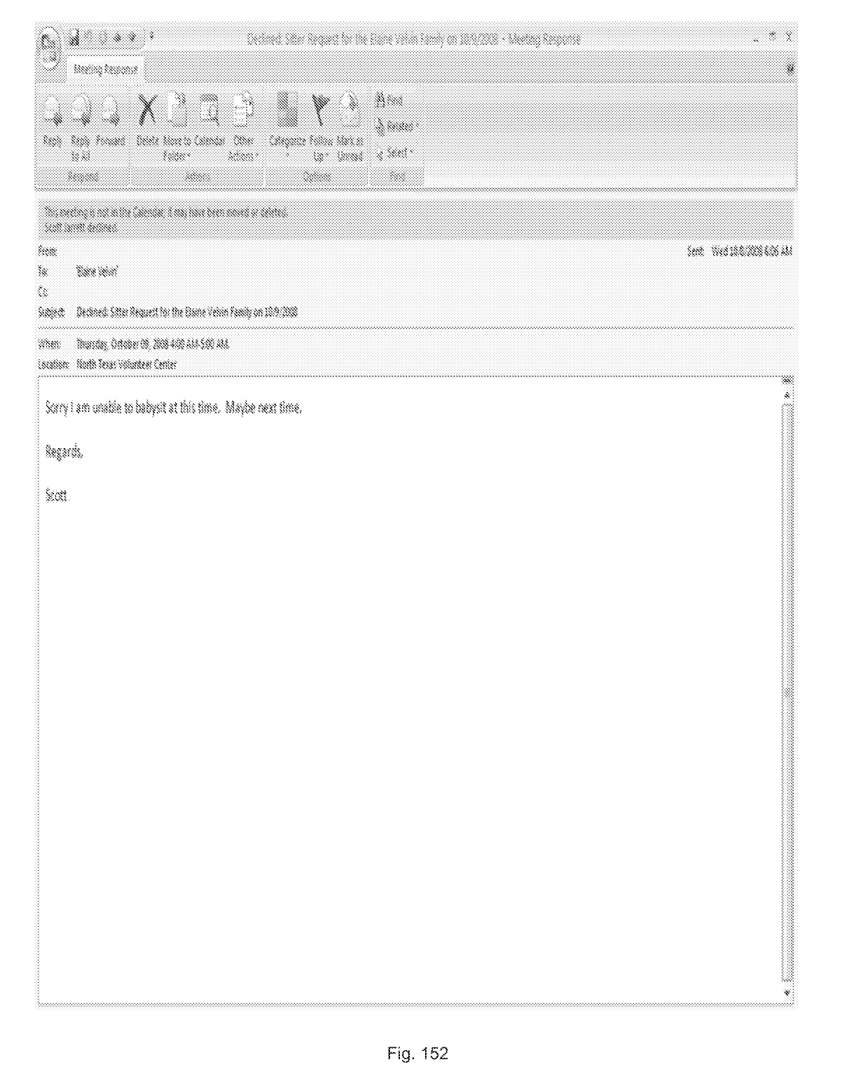

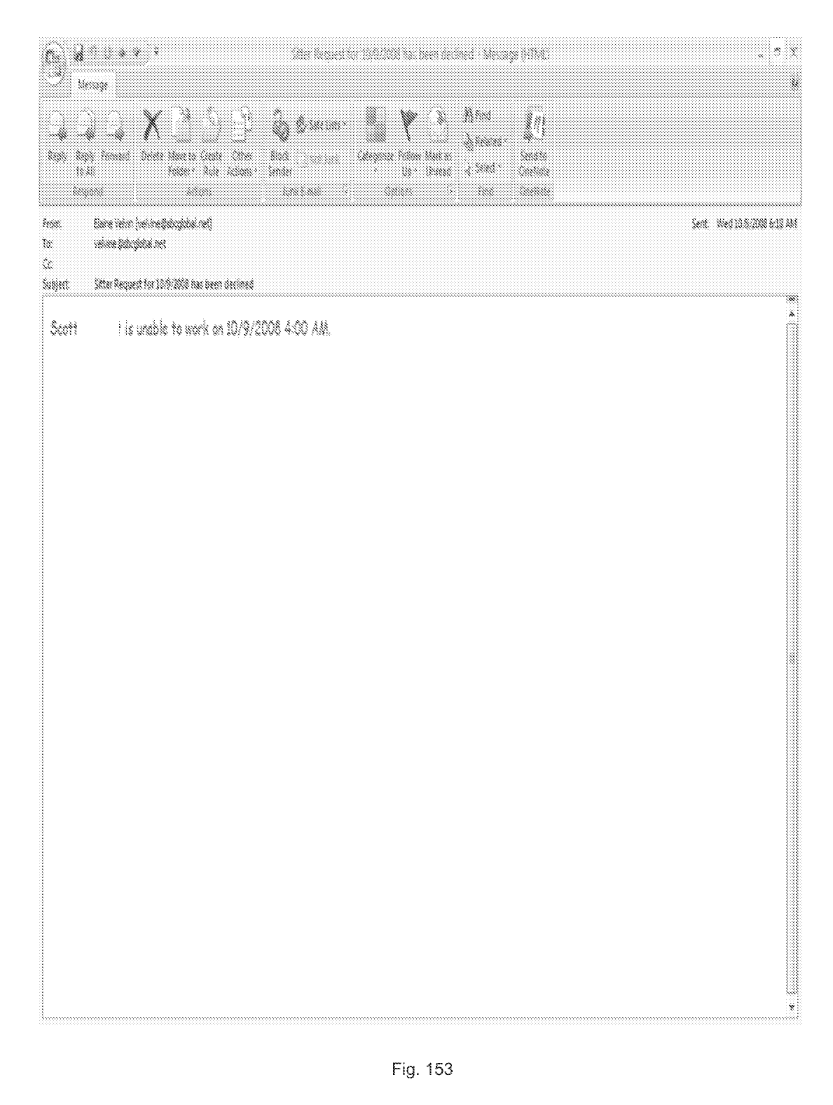

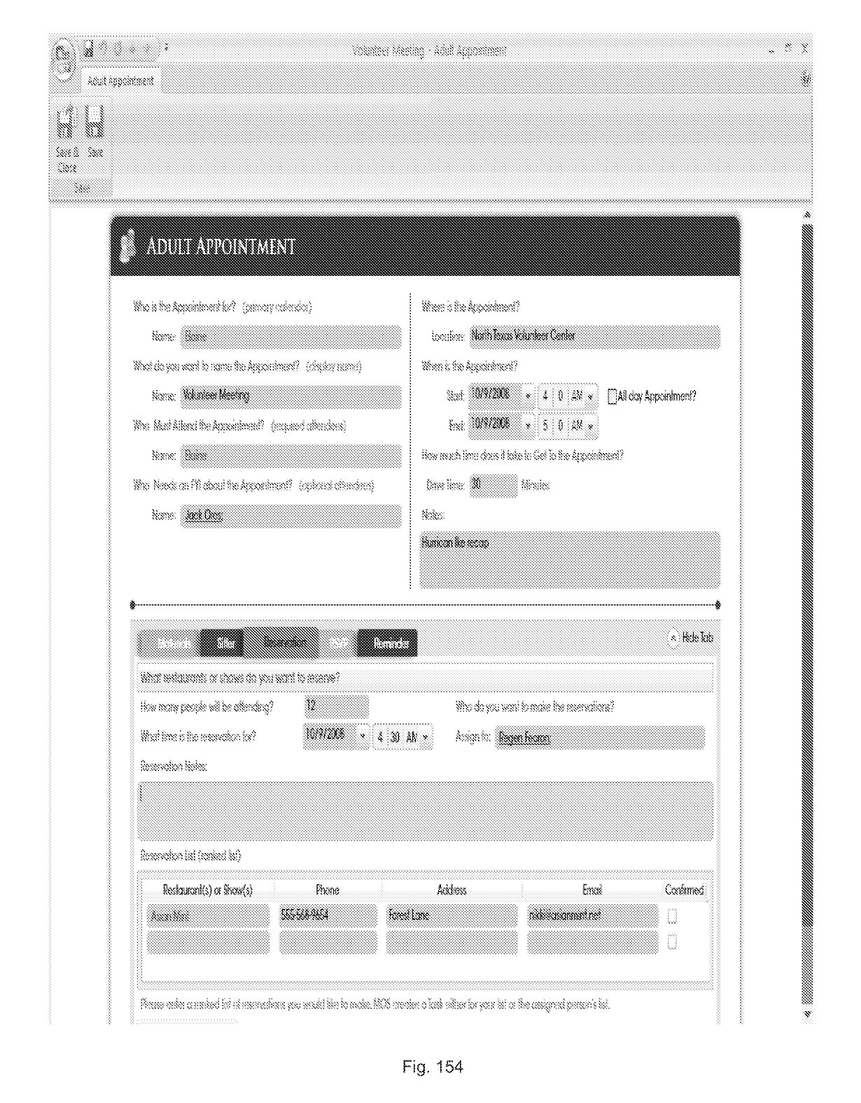

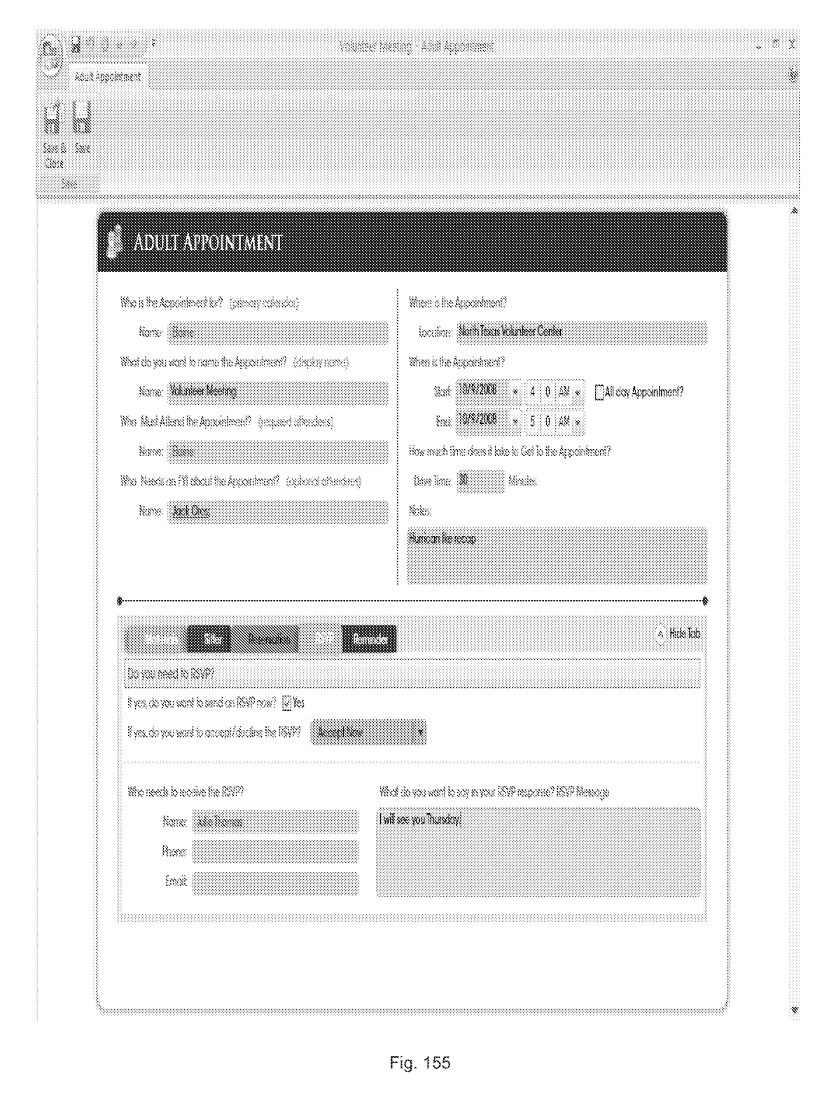

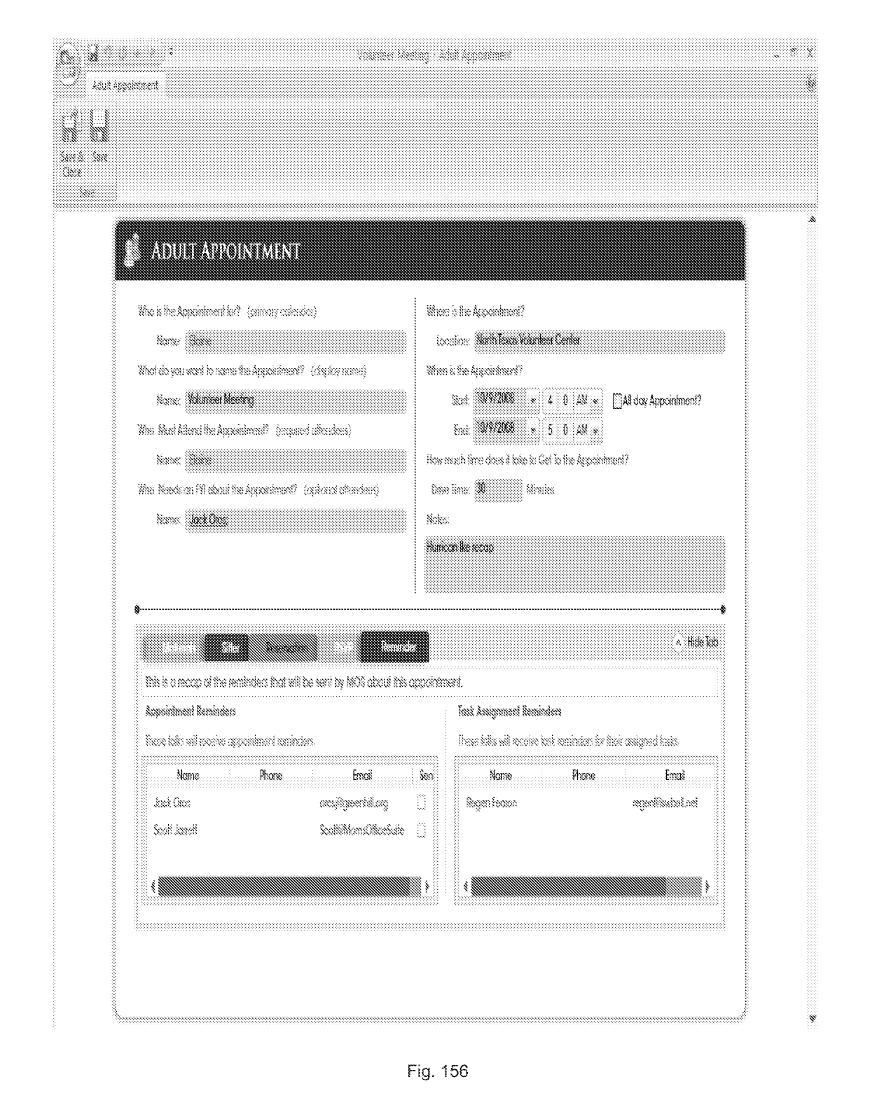

FIGS. 22-156 illustrate various exemplary screen shots disclosed herein.

Appointment Use Cases

UC A1.0: Create Adult Appointment

### Pre-Condition:

MOS & Microsoft Outlook are running

### Normal-Flow:

1. Mom selects Appointment Adult Appointment
2. MOS displays Adult Appointment form.
3. Mom completes Adult Appointment forms/tabs.
   a. Details region (UC A1.1).
   b. Materials tab (UC A1.2).
   c. Sitter tab (UC A1.3).
   d. Reservation tab (UC A1.4).
   e. RSVP tab (UC A1.5).
   f. Reminder tab (UC A1.6).
4. Mom selects the SAVE & CLOSE.
5. MOS populates and processes Action Queue.
6. MOS Displays “Magic Happening” screen

### Post-Condition:

The appointment is created.

### Alternate Flow:

Sitter acceptance/rejection
   When Sitter accepts the request/invite then MOS updates the appointment to reflect that the Sitter is confirmed.
   When Sitter rejects request/invite MOS send email to Mom stating Sitter is not available for <appointment name> on <appointment date> and indicates that the Sitter is not confirmed.
Attendee acceptance/rejection
   When Attendee accepts the request/invite then MOS updates the appointment to reflect that the Attendee is confirmed.
   When Attendee rejects request/invite MOS indicates that the Attendee has rejected.

### Notes:

Need the ability to “enable” and “install” tabs individually. For example Mom may not be interested in tracking reservations or sending out notifications and therefore would like not to have to see/complete those extra fields.
Tab priority (high-to-low): Materials, Driver, Sitter, Charity Event, Notification, Reminder, RSVP, and Reservation.

UC A1.1: Complete Details Region—Adult Appointment

### Pre-Condition:

MOS & Microsoft Outlook are running
Mom views the Appointment form.

### Normal-Flow:

1. MOS displays Appointment form.
2. Mom completes Appointment information.
   a. Appointment Name.
   b. Appointment location.
   c. Appointment All-Day event.
   d. Appointment Start date and time.
   e. Appointment End date and time.
   f. Appointment recurrence and the recurrence pattern.
   g. Appointment primary Calendar (Required Attendee).
   h. Appointment secondary Calendar(s) (Required Attendee).
   i. Optional Attendees (FYI)
      i. Name.
      ii. Phone Number.
      iii. Email.
3. Mom selects CLOSE or SAVE or another tab.
4. MOS saves Appointment information.
   a. MOS performs form validation/verification.
5. MOS populates Action Queue.
   a. MOS adds to the Action Queue appointment(s) to Action Queue for each person's Calendar.

### Alternate-Flow:

The Calendar belongs to a Partner.
   Mom selects whether the appointment should be “Required”, “Optional”, or “Let's discuss”.
If Appoint Primary Calendar is a Child required—Mom required to complete Driver Tab. Warning message is generated if Mom attempts to complete appointment without Driver details.
If School Notification Y—Mom required to complete Notification Tab. Warning message is generated if Mom attempts to complete appointment without notification details.
Mom selects CLOSE—MOS prompts if Mom wishes to Save/Complete appointment.

### Post-Condition: N/A

UC A1.2: Complete Materials Tab—Adult Appointment

### Pre-Condition:

MOS & Microsoft Outlook are running
Mom views the appointment form.
Mom views the Materials tab.

### Normal-Flow:

1. MOS displays Appointment Materials form.
2. Mom completes Appointment Materials information.

a. Material Name.
b. Material Assignment (Person). (default is Mom)
3. Mom selects CLOSE or SAVE or another tab.
4. MOS populates Action Queue.
   a. MOS adds to the Action Queue material assignment tasks to corresponding assigned person's Task List.

### Alternate-Flow:

The person does not have a Task List in MOS.
   MOS adds task assignment as an email to the Action Queue.

### Post-Condition:

Mom has completed the Materials tab of the Appointment.

### Notes:

Mom has the option of adding/removing some Materials fields (columns)—Item and Assigned To fields are required.

UC A1.3: Complete Sitter Tab—Adult Appointment

### Pre-Condition:

MOS & Microsoft Outlook are running
Mom views the Appointment form.
Mom views the Sitter tab.

### Normal-Flow:

1. MOS displays Sitter tab form.
2. Mom completes Sitter tab.
   a. Potential sitters in ranked order/by priority.
      i. Sitter name.
      ii. Sitter phone number.
      iii. Sitter email addresses.
         Save list as Potential Sitter list (template?)
   b. Time for the sitter to arrive.
   c. Notes.
3. Mom selects CLOSE or SAVE or another tab.
4. MOS saves Sitter information.
5. MOS populates Action Queue.
   a. MOS adds to the Action Queue an appointment request for each sitter.
   b. MOS sends the appointment to the first sitter.
      i. Sitter accepts invite/request.
         1. MOS updates appointment to indicate <Sitter Name> has confirmed/accepted.
      ii. Sitter declines request.
         1. MOS sends an email to the next sitter on the list.
         2. MOS updates appointment to indicate sitter is not confirmed.
      iii. MOS sends an email to Mom if all sitters decline (M S1.2).

### Post-Condition:

Mom has completed the Sitter tab of the Appointment.

### Notes:

Add Sitters to a standard list/folder—so that they can be pre-fetched/filled in from centralized list—maybe as art of setup Genie.
If Sitter does not have a calendar in MOS an email invite/meeting request is sent.
Related Message Templates
   Sitter Request (M S1.0).
   Sitter Request Accepted.
   Sitter Request Declined (M S1.1).
   Sitter Request Not Completed (M S1.2)—sent when no sitters are confirmed 1 day prior to the appointment.
   Sitter Request Reminder (M S2.0).
Mom has the option of adding/removing some Sitter fields (columns)—Name and Email or Phone fields are required.

UC A1.4: Complete Reservations Tab—Adult Appointment

### Pre-Condition:

MOS & Microsoft Outlook are running
Mom views the Appointment form.
Mom views the Reservation tab.
   Normal-Flow:

1. MOS displays Reservation tab form.
2. Mom completes Reservation tab,
   a. Names of reservation (restaurants, tickets, etc.) by priority.
   b. Reservation date and time.
   c. Number in the party.
   d. Notes.
   e. Select person to assign the task of making the reservation (default Mom)?
3. Mom selects CLOSE or SAVE or another tab.
4. MOS saves Reservation information.
5. MOS populates Action Queue.
   a. MOS adds to the Action Queue the reservation as a task to the reservation assignee (M RES1.0).
   b. MOS adds to the Action Queue a weekly reminder email to Mom if the task is not completed.
   c. MOS adds to the Action Queue a email when the reservation cannot be completed (M RES2.0).

### Post-Condition:

Mom has completed the Reservation tab of the Appointment.

### Notes:

MOS displays a link to an open table site for the reservation.
Related Message Templates
   Reservation Task Assignment (M RES1.0)
   Reservation Venue Not Available (M RES2.0)
Mom has the option of adding/removing some Reservation fields (columns)—Name field is required.

UC A1.5: Complete RSVP Tab—Adult Appointment

### Pre-Condition:

MOS & Microsoft Outlook are running
Mom views the appointment form.
Mom views the RSVP tab.

### Normal-Flow:

1. MOS displays RSVP form.
2. Mom completes RSVP information.
   a. Have you RSVP'd? (Y/N?).
   b. Did you accept or decline the RSVP?
   c. RSVP details.
      i. RSVP name.
      ii. RSVP phone number.
      iii. RSVP email address.
3. Mom selects CLOSE or SAVE or another tab.
4. MOS populates Action Queue.
   a. If RSVP'd N—MOS adds RSVP task to Mom's Task List.

### Alternate-Flow:

If appointment is declined (2.b.), MOS keeps the appointment on the Primary calendar but hides it from view until/unless the event which is in conflict is deleted.

### Post-Condition:

Mom has completed the RSVP tab of the Appointment.

### Notes:

Related Message Templates
   RSVP Accepted (M R1.0).
   RSVP Declined (MR2.0).

UC A1.6: Complete Reminder Tab—Adult Appointment

### Pre-Condition:

MOS & Microsoft Outlook are running
Mom views the appointment form.
Mom views the Reminder tab.

### Normal-Flow:

1. MOS displays Reminder tab form.
2. Mom completes Reminder information.
   a. Appointment Reminders.
      i. Reviews list of required attendee (primary Calendar) and required attendees (secondary Calendar) that will receive an appointment reminder.
   b. Task Reminders.
      i. Reviews list of people assigned a task that will receive a task reminder.
   c. Enters the date and time for the reminder(s) to be sent.
3. Mom selects CLOSE or SAVE or another tab.
4. MOS saves Reminder information.
5. MOS populates Action Queue.
   a. MOS adds to the Action Queue the reminder for each person.

### Post-Condition:

Mom has completed the Reminder tab of the Appointment.

### Notes:

Mom has the option of adding/removing some Reminder fields (columns)—Name and Email fields are required.

UC A2.0: Create Child Appointment

### Pre-Condition:

MOS & Microsoft Outlook are running

### Normal-Flow:

1. Mom selects Appointment Child Appointment
2. MOS displays Child Appointment form.
3. Mom completes Child Appointment forms/tabs.
   a. Details region (UC A2.1).
   b. Materials tab (UC A2.2).
   c. Carpool tab (UC A2.3).
   d. Reservation tab (UC A2.4).
   e. RSVP tab (UC A2.5).
   f. Notification tab (UC A2.6).
   g. Reminder tab (UC A2.7).
4. Mom selects the SAVE & CLOSE.
5. MOS populates and processes Action Queue.
6. MOS Displays “Magic Happening” screen

### Post-Condition:

MOS creates Service Call Appointment.
Related Messages
   No One Scheduled to be home (M DL1.0)—sent 24 hours before appointment if no one is scheduled/assigned to be home during the appointment and the appointment requires someone to be there.

### Alternate Flow:

Driver acceptance/rejection
   When driver accepts the request/invite then MOS updates the appointment to reflect that the Driver is confirmed.
   When driver rejects request/invite MOS send email to Mom stating Driver is not available for <appointment name> on <appointment date> and indicates that the Driver is not confirmed.
Attendee acceptance/rejection
   When Attendee accepts the request/invite then MOS updates the appointment to reflect that the Attendee is confirmed.
   When Attendee rejects request/invite MOS indicates that the Attendee has rejected.

UC A2.1: Complete Details Region—Child Appointment

### Pre-Condition:

MOS & Microsoft Outlook are running
Mom views the Appointment form.

### Normal-Flow:

1. MOS displays Appointment form.
2. Mom completes Appointment information.
   a. Appointment Name.
   b. Appointment location.
   c. Appointment All-Day event.
   d. Appointment Start date and time.
   e. Appointment End date and time.
   f. Appointment recurrence and the recurrence pattern.
   g. Appointment primary Calendar (Required Attendee).
   h. Appointment secondary Calendar(s) (Required Attendee).
   i. Optional Attendees (FYI)
      i. Name.
      ii. Phone Number.
      iii. Email.
3. Mom selects CLOSE or SAVE or another tab.
4. MOS saves Appointment information.
   a. MOS performs form validation/verification.
5. MOS populates Action Queue.
   a. MOS adds to the Action Queue appointment(s) to Action Queue for each person's Calendar.

### Alternate-Flow:

The Calendar belongs to a Partner.
   Mom selects whether the appointment should be “Required”, “Optional”, or “Let's discuss”.
If Appoint Primary Calendar is a Child required—Mom required to complete Driver Tab. Warning message is generated if Mom attempts to complete appointment without Driver details.
If School Notification Y—Mom required to complete Notification Tab. Warning message is generated if Mom attempts to complete appointment without notification details.
Mom selects CLOSE—MOS prompts if Mom wishes to Save/Complete appointment.

### Post-Condition:

N/A

UC A2.2: Complete Materials Tab—Child Appointment

### Pre-Condition:

MOS & Microsoft Outlook are running
Mom views the appointment form.
Mom views the Materials tab.

### Normal-Flow:

1. MOS displays Appointment Materials form.
2. Mom completes Appointment Materials information.
   a. Material Name.
   b. Material Assignment (Person). (default is Mom)
3. Mom selects CLOSE or SAVE or another tab.
4. MOS populates Action Queue.
   a. MOS adds to the Action Queue material assignment tasks to corresponding assigned person's Task List.

### Alternate-Flow:

The person does not have a Task List in MOS.
   MOS adds task assignment as an email to the Action Queue.

### Post-Condition:

Mom has completed the Materials tab of the Appointment.

### Notes:

Mom has the option of adding/removing some Materials fields (columns)—Item and Assigned To fields are required.

UC A2.3: Complete Carpool Tab—Child Appointment

### Pre-Condition:

MOS & Microsoft Outlook are running
Mom views the Appointment form.
Mom views the Driver tab.

### Normal-Flow:

1. MOS displays Driver form.
2. Mom completes Driver information.
   a. Schedule Driver (Y/Y Later/N?).
   b. Enter pickup information
      i. Pickup “from” location If school notification has been checked in Appointment Details, then defau006Ct location is School. Otherwise, default location is home.
      ii. Pickup date/time
      iii. Pickup children.
      iv. Pickup driver
      v. Pickup notes.
   c. Enter drop-off information
      i. Drop-off “to” location If school notification has been checked in Appointment Details, then default location is School. Otherwise, default location is home.
      ii. Drop-off date/time
      iii. Drop-off children.
      iv. Drop-off driver
      v. Drop-off notes.
3. Mom selects CLOSE or SAVE or another tab.
4. MOS populates Action Queue.
   a. MOS adds to the Action Queue the appointment to each driver's Calendar.
   b. MOS marks appointment to indicate ‘Driver Confirmed’ upon the acceptance/confirmation of the appointment by the Driver.

### Post-Condition:

Mom has completed the Driver tab of the Appointment.

### Alternate Flow:

If Driver ‘Y Later’ then MOS sends reminder to Mom that a Driver has yet to be scheduled for this appointment—24 hours prior to appointment.
If Driver does not have a calendar in MOS an email invite/meeting request is sent.
Related Message Templates
   Driver Request (M D1.0).
   Driver Request—All Declined—Non Available (M D2.0).
   Driver Reminder (M D3.0).

### Notes:

Mom has the option of adding/removing some Driver fields (columns)—Child, Pickup/Drop off Locations are required.

UC A2.4: Complete Reservations Tab—Child Appointment

### Pre-Condition:

MOS & Microsoft Outlook are running
Mom views the Appointment form.
Mom views the Reservation tab.

### Normal-Flow:

1. MOS displays Reservation tab form.
2. Mom completes Reservation tab,
   a. Names of reservation (restaurants, tickets, etc.) by priority.
   b. Reservation date and time.
   c. Number in the party.
   d. Notes.
   e. Select person to assign the task of making the reservation (default Mom)?
3. Mom selects CLOSE or SAVE or another tab.
4. MOS saves Reservation information.
5. MOS populates Action Queue.
   a. MOS adds to the Action Queue the reservation as a task to the reservation assignee (M RES1.0).
   b. MOS adds to the Action Queue a weekly reminder email to Mom if the task is not completed.
   c. MOS adds to the Action Queue a email when the reservation cannot be completed (M RES2.0).

### Post-Condition:

Mom has completed the Reservation tab of the Appointment.

### Notes:

MOS displays a link to an open table site for the reservation.
Related Message Templates
   Reservation Task Assignment (M RES1.0)
   Reservation Venue Not Available (M RES2.0)
Mom has the option of adding/removing some Reservation fields (columns)—Name field is required.

UC A2.5: Complete RSVP Tab—Child Appointment

### Pre-Condition:

MOS & Microsoft Outlook are running
Mom views the appointment form.
Mom views the RSVP tab.

### Normal-Flow:

1. MOS displays RSVP form.
2. Mom completes RSVP information.
   a. Have you RSVP'd? (Y/N?).
   b. Did you accept or decline the RSVP?
   c. RSVP details.
      i. RSVP name.
      ii. RSVP phone number.
      iii. RSVP email address.
3. Mom selects CLOSE or SAVE or another tab.
4. MOS populates Action Queue.
   a. If RSVP'd N—MOS adds RSVP task to Mom's Task List.

### Alternate-Flow:

If appointment is declined (2.b.), MOS keeps the appointment on the Primary calendar but hides it from view until/unless the event which is in conflict is deleted.

### Post-Condition:

Mom has completed the RSVP tab of the Appointment.

### Notes:

Related Message Templates
   RSVP Accepted (M R1.0).
   RSVP Declined (MR2.0).

UC A2.6: Complete Notification Tab—Child Appointment

### Pre-Condition:

MOS & Microsoft Outlook are running
Mom views the appointment form.
Mom views the Notification tab.

### Normal-Flow:

1. MOS displays Notification form.
2. Mom completes Notification form.
   a. Is Notification is needed (Y/N?).
   b. Is the Notification to a School (Y/N?).
   c. Who are you notifying? (table format)
      i. Notify names.
      ii. Notify phone numbers.
      iii. Notify and email addresses.
      iv. Notification method: email, text or print.
   d. When do you want to send/print the notification?

i. Default is 6 AM on day of appointment.
3. Mom selects CLOSE or SAVE or another tab.
4. MOS populates Action Queue.
   a. MOS adds to the Action Queue notification for each notification recipient.
   b. MOS adds to the Action Queue a task for each notification recipient to be printed for the recipient.

### Alternate-Flow:

No recipient is listed and the notification is needed.
   MOS alerts Mom that one or more recipients are needed for the notification.
   Mom provides requested information.

### Post-Condition:

Mom has completed the Notification tab of the Appointment.

### Notes:

Related Message Templates
   Notification of Child Appointment (M N1.0).
Mom has the option of adding/removing some Notification fields (columns)—Name and Email and Phone (if selected) fields are required.

UC A2.7: Complete Reminder Tab—Child Appointment

### Pre-Condition:

MOS & Microsoft Outlook are running
Mom views the Reminder tab.

### Normal-Flow:

1. MOS displays Reminder tab form.
2. Mom completes Reminder information.
   a. Appointment Reminders.
      i. Reviews list of required attendee (primary Calendar) and required attendees (secondary Calendar) that will receive an appointment reminder.
   b. Task Reminders.
      i. Reviews list of people assigned a task that will receive a task reminder.
   c. Enters the date and time for the reminder(s) to be sent.
3. Mom selects CLOSE or SAVE or another tab.
4. MOS saves Reminder information.
5. MOS populates Action Queue.
   a. MOS adds to the Action Queue the reminder for each person.

### Post-Condition:

Mom has completed the Reminder tab of the Appointment.

### Notes:

Mom has the option of adding/removing some Reminder fields (columns)—Name and Email fields are required.

UC A3.0: Create Charity Event Appointment

### Pre-Condition:

MOS & Microsoft Outlook are running
Mom views the Appointment form.
Mom views the Charity Event tab.

### Normal-Flow:

1. MOS display Charity Event form.
2. Mom completes Charity Event form.
   a. Charity Name.
   b. Number of seats.
   c. Selects whether the table is purchased or Dutch treat.
   d. Ticket Price (cost).
   e. Attendee information
      i. Names
      ii. Phone numbers
      iii. Email addresses of potential attendees by priority (rank).
3. Mom selects CLOSE or SAVE.
4. MOS saves Charity Event Data.
   5. MOS populates Action Queue.
   a. MOS adds to the Action Queue the appointment request (M CE1.0) to each recipient for a purchased table (guests are non-paying).
   b. MOS sends the appointment to the first x potential attendees, where x is the number of seats.
      i. If a declination is received, MOS sends an email (M CE1.2) to the declining attendee and sends an email (M CE 1.0) to the next potential attendee on the list.
      ii. If a declination is received and there is no other potential attendee on the list, MOS sends an email to Mom.
      iii. If acceptance is received, MOS sends email (M CE1.1) to attendee and indicates a confirmation of this attendee on appointment.
   c. MOS adds a weekly reminder email for Mom to be sent whenever the number of acceptances is fewer than the number of the seats to the Action Queue.
   d. MOS sends a reminder (M CE 4.0) to Mom and all accepted attendees on the day before the appointment.

### Alternate Flow:

MOS adds to the Action Queue the appointment request (M CE2.0) to each recipient for a Dutch treat table (guests are paying).
   a. MOS sends the appointment to the first x potential attendees, where x is the number of seats.
      i. If a declination is received, MOS sends an email (M CE1.2) to the declining attendee and sends appointment request (M CE2.0) to the next potential attendee on the list.
      ii. If a declination is received and there is no other potential attendee on the list, MOS sends an email to Mom.
      iii. If acceptance is received, MOS sends email (M CE1.1) to attendee and indicates a confirmation of this attendee on appointment.
   b. MOS adds a weekly reminder email (M CE3.0) for Mom to be sent whenever the number of acceptances is fewer than the number of the seats to the Action Queue.
   c. MOS sends a reminder (M CE 4.0) to Mom and all accepted attendees on the day before the appointment.

### Post-Condition:

Mom has completed the Charity Event tab of the Appointment.

### Notes:

Related Message Templates
   Charity Event Invitation Request—Non-Paying Guest (M CE1.0).
   Charity Event Invitation Request Acceptance (M CE1.1).
   Charity Event Invitation Request Declined (M CE1.2).
   Charity Event Invitation Request—Paying Guest (M CE2.0)
   Charity Event Reminder to Fill Table (M CE3.0).
   Charity Event Reminder All Attendees Accepted (M CE4.0).
Mom has the option of adding/removing some Guest List fields (columns)—Name, Phone or Email fields are required.

UC A4.0: Create Service Call Appointment

### Pre-Condition:

MOS & Microsoft Outlook are running

### Normal-Flow:

1. Mom selects Appointment Service Call.
2. MOS displays Service Call form.
3. Mom completes Service Call form.
   a. Service details
      i. Service Call Name.
      ii. Enter start date and time window for the appointment.
      iii. Enter end date and time window for the appointment.
   b. Does someone need to be home for the appointment (Y/N?).
      i. Assign person to be home for the appointment.
   c. What Calendars do you want to assign this appointment to?
      i. Required/Primary. (default is Residence 1)
      ii. Required/Secondary.
      iii. Optional
   d. Service Company information.
      i. Company name.
      ii. Phone number.
      iii. Email address.
      iv. Company employee's name.
   e. Reminder
   f. Notes.
4. Mom selects the CREATE APPOINTMENT.
5. MOS populates and processes Action Queue.
   a. MOS adds to the Action Queue the appointment on the selected residence Calendar.
   b. MOS adds to the Action Queue the appointment on the selected assignee's Calendar if someone needs to be home for the appointment.
6. MOS Displays “Magic Happening” screen
   a. A running list of the Magic/business logic being executed is displayed along with its status (complete, error, etc.)
   b. A progress bar is displayed.

### Post-Condition:

MOS creates Service Call Appointment.
Related Messages
   No One Scheduled to be home (M DL1.0)—sent 24 hours before appointment if no one is scheduled/assigned to be home during the appointment and the appointment requires someone to be there.

Calendar Use Cases

UC C1.0: Create Calendar

### Pre-Condition:

MOS & Microsoft Outlook are running
A Dashboard has been created.

### Normal-Flow:

1. Mom selects the New Calendar.
2. MOS displays Calendar forms.
3. Mom completes Calendar information.
   a. Mom completes the Details tab (UC C1.1).
   b. Mom completes the Employee(s) Hours tab if necessary (UC C1.2).
   c. Mom completes the Compensation tab if necessary (UC C1.3).
4. Mom selects CREATE CALENDAR.
5. MOS populates Action Queue.
   a. MOS processes the Action Queue.
6. MOS Displays “Magic Happening” screen.
   a. A running list of the Magic being executed is displayed along with its status (complete, error, etc.)
   b. A progress bar is displayed.
7. MOS places shortcut to Calendar under the corresponding Dashboard.

### Post-Condition:

Mom has created a Calendar.

UC C1.1: Complete Calendar Details Tab

### Pre-Condition:

MOS & Microsoft Outlook are running
Mom views the Create Calendar form.
Mom views the Details Calendar tab.

### Normal-Flow:

1. MOS displays Calendar Details form.
2. Mom enters Calendar Details information.
   a. Calendar Name.
      i. If Calendar Name is in Contacts link Calendar to the found contact.
      ii. Else Calendar name is just text.
   b. Selects a Dashboard to assign the Calendar to (required, default Mom's Calendar).
   c. Selects Calendar type.
      i. Primary, partner, child or senior, special occasions, employee, residence, or other (project).
   d. Selects a color for the Calendar (default same as selected Dashboard color).
3. Mom selects CLOSE or SAVE or another tab.
4. MOS Saves Calendar Details information.
5. MOS populates Action Queue.
   a. N/A

### Post-Condition:

Mom has completed the Calendar Details tab.

### Notes:

MOS continuously calculates hours worked and timed off accrued if the Calendar is of type employee, completed upon completion of the Calendar (Future Release).
Child or senior and partner Calendar have associated logic/requirements (e.g. child Calendar requires driver information for appointments placed on that Calendar).
Special occasions—specific logic—birthday reminders, links to Blue Mountain, etc.

UC C1.2: Complete Calendar Employee(s) Hours Tab

### Pre-Condition:

MOS & Microsoft Outlook are running
Mom views the Create Calendar form.
The selected Calendar is of Employee type.
Mom views the Employee(s) Hours tab.

### Normal-Flow:

1. MOS displays Employee(s) Hours form.
2. Mom enters Employee(s) Hours information.
   a. Employee schedule.
   b. Schedule recurrence.
3. Mom selects CLOSE or SAVE or another tab.
4. MOS populates Action Queue.
   a. MOS adds to the Action Queue the Employee schedule as appointments.
   b. MOS adds to the Action Queue Employee Schedule Notification message (M N2.0).

### Post-Condition:

Mom has completed the Employee(s) Hours information.

### Notes:

Employee(s) Working hours.
Related Messages
   Employee Schedule (M N2.0).

UC C2.0: Print Calendar

### Pre-Condition:

MOS & Microsoft Outlook are running

### Normal-Flow:

### Normal-Flow:

1. Mom selects Print Calendar.
2. MOS displays Print Calendar form.
3. Mom completes Print Calendar information.
   a. Selects Calendar Print template from template list.
   b. Which Calendars: list all Calendars in MOS with ability to check or uncheck (Outlook does this)
   c. Which details:
      i. Location
      ii. Drivers
      iii. Phone numbers
      iv. Notes
      v. Summary of work hours
      vi. Summary of vacation/sick/personal days
      vii. All Day Events (events that span more than a day, i.e. a trip)
      viii. Mini-months (numeric month before and after)
      ix. Calendar keys (keys to color coding)
      x. Task List
   d. Choose where to print Task
      i. Same as screen view
      ii. As list at top of Calendar
      iii. As list bottom of Calendar
      iv. As list at right side of Calendar
      v. As list at left side of Calendar
      vi. On the day Task is due (print at top in band)
      vii. On the Monday of the week Task is due
      viii. On the 1^{st} of the month Task is due
      ix. On a separate page
      x. On back side of Calendar page
   e. Choose which types of Task to print
      i. Call
      ii. Errands
      iii. Correspondence
      iv. Due on that day
   f. Choose order of how to print Task list
      i. Title/Alpha
      ii. Types of Task (i.e. all calls together, all errands together)
      iii. Calendar (i.e. with all items coded to each Calendar grouped together)
      iv. Due Date
   g. Color Calendar keys
4. Mom selects Print.

### Alternative Flow:

Mom decides to save print preferences as template.
   Create personal printing template (user selects if they want to create a template)
   Name template

### Post-Condition:

Calendar is printed for Mom.

### Alternative Flow:

Mom decides to save print preferences as template
   Create personal printing template (user selects if they want to create a template)
   Name template

UC C3.0: Delete Calendar

### Pre-Condition:

MOS & Microsoft Outlook are running
A Calendar has been created

### Normal-Flow:

1. Mom selects the Calendar Delete.
2. MOS confirms deletion.
   a. Confirm Delete?
   b. Do you wish to Delete all the items in the Calendar?
   c. Notify person assigned to Calendar?
   d. Move Calendar items to another Calendar? Which Calendar?
3. Mom confirms delete.
4. MOS moves Calendar items to another Calendar.
5. MOS deletes Calendar.
6. MOS displays Calendar deleted confirmation.

### Post-Condition:

MOS deletes Calendar.

Dashboard Use Cases

UC D1.0: Create Dashboard

### Pre-Condition:

MOS & Microsoft Outlook are running

### Normal-Flow:

1. Mom selects New Dashboard.
2. MOS displays Create Dashboard form.
3. Mom completes Dashboard information.
   a. Set Dashboard Preferences (UC D2.0).
4. Mom selects CREATE DASHBOARD.
5. MOS creates Dashboard.
6. MOS displays newly created Dashboard.

### Post-Condition:

Mom has created a Dashboard.

### Notes:

Dashboards can not contain other Dashboards (i.e. cannot be nested).

UC D2.0: Set Dashboard Preferences

### Pre-Condition:

MOS & Microsoft Outlook are running

### Normal-Flow:

1. Mom selects Dashboard Customize
2. MOS prompts Mom to identify which Dashboard she wants to customize.
3. Mom completed Dashboard preferences information.
   a. Dashboard Name.
   b. Dashboard Color.
   c. Mom selects whether and in which order to view the Dashboard, from selecting from File Cabinet, family contacts, inbox, Calendar, task list, or all.
   d. Mom selects which Calendars he or she wishes to see.
   e. Mom selects the default Calendar view from day, week, workweek, month, list view, or range (start and end days).
   f. Mom selects which day the week starts.
   g. Mom selects whether to view all tasks, or only his or her tasks.
   h. Mom selects whether to sort tasks by title, type, or deadline.
4. Mom selects the SAVE.
5. MOS updates Dashboard.

### Alternate-Flow:

Mom selected to view all tasks.
   Mom can additionally select to sort tasks by Calendar.

### Post-Condition:

Mom has updated a Dashboard.

UC D3.0: Delete a Dashboard

### Pre-Condition:

MOS & Microsoft Outlook are running

### Normal-Flow:

1. Mom selects Dashboard Delete
2. MOS confirms deletion.
   a. Confirm Delete?
   b. Do you wish to Delete all the items in the Dashboard?
3. Mom confirms delete.
4. MOS deletes Dashboard.
5. MOS displays Dashboard deleted confirmation.

### Post-Condition:

Dashboard is deleted.
Contents of the Dashboard are not deleted—they are categorized somewhere else.

Folder Use Cases

UC F1.0: Create Folder

### Pre-Condition:

MOS & Microsoft Outlook are running

### Normal-Flow:

1. Mom selects the New Folder.
2. MOS displays Create Folder form.
3. Mom completes Create Folder information.
   a. Name the Folder
   b. Select a Dashboard to assign the Folder to.
   c. Select a color for the Folder. (default is Dashboard color)
   d. Enter zero or more tag keywords for auto-tagging of email.
4. Mom selects the CREATE FOLDER.
5. MOS creates folder.
6. MOS places shortcut to folder under the corresponding Dashboard.

### Extensions:

Create Task List (a folder with only Tasks in it).
Create Contact List (a folder with only Contacts in it, like a mailing list or distribution list).

### Post-Condition:

Mom has created a folder.

### Extensions:

Create Task List (a folder with only Tasks in it)
Create Contact List (a folder with only Contacts in it; e.g. mailing list, distribution list, etc.).

### Notes:

View Folder→Generic Folders—contains filters/views, automatically groups—emails, tasks, files, etc.

UC F2.0: Move Folder

### Pre-Condition:

MOS & Microsoft Outlook are running

### Normal-Flow:

1. Mom selects the folder to move.
2. Mom moves the folder to the Dashboard or other folder desired.
3. MOS changes the color of the folder to the parent's color if no color was selected.

### Post-Condition:

Mom has moved a folder.

UC F3.0: Delete a Folder

### Pre-Condition:

MOS & Microsoft Outlook are running

### Normal-Flow:

1. Mom selects Folder to Delete.
2. MOS prompts
   a. Confirm Delete?
   b. Do you wish to Delete all the items in the Folder? (Y/N)
   c. If Y—do you want to delete these files from all folders?
   d. If N you wish to Move the items in this Folder to another Folder? (Y/N); which folder?
3. Mom confirms delete.
4. MOS moves items to miscellaneous folder.
5. MOS deletes folder.

### Post-Condition:

Folder is deleted.
Folder items are moved to miscellaneous folder unless Mom selects to delete all items in folder.
Items are not deleted from MOS if they are in other folders.

UC F4.0: Move Item to Folder

### Pre-Condition:

MOS & Microsoft Outlook are running

### Normal-Flow:

1. Mom selects the item to move.
2. Mom selects the Folder to which the item will be moved.
3. MOS moves Folder.

### Post-Condition:

Mom has moved an item to a folder.

Genie Use Cases

UC G1.0: Run Initial Setup Genie

### Pre-Condition:

MOS & Microsoft Outlook are running
The Mom's Office Suite add-in is run for the first time or Setup Genie is selected.

### Normal-Flow:

1. MOS displays series of Initial Setup screens
2. Mom completes or skips Initial setup screens
   a. Welcome screen.
   b. What do you want to Setup Genie to do? (select all that apply)
   c. MOS settings/preferences (UC U1.0)—required.
   d. Create Dashboard (UC D1.0)—required.
   e. Create Calendar (UC C1.0)—required.
   f. Create Folder (UC F1.0).
   g. Create Family Cards (UC FC 1.0).
   h. Create Family Card by Merging Contacts (UC G4.1).
3. Mom selects GET STARTED (“Let the Magic begin!”).
4. MOS performs MAGIC.
5. MOS Displays “Magic Happening” screen.
   a. A running list of the Magic/business logic being executed is displayed along with its status (complete, error, etc.)
   b. A progress bar is displayed.

### Post-Condition:

Mom has run the setup genie.
Initial Setup Genie can only be executed once—subsequent executions require Mom to use Mom's Office Suite Options/Preferences (UC U1.0).

UC G2.0: Run Organization/Team Setup Genie

### Pre-Condition:

MOS & Microsoft Outlook are running

### Normal-Flow:

1. Mom selects Genie Setup Organization/Team.
2. MOS displays Setup Organization/Team screens
3. Mom completes
   a. Setup Options form (UC G2.1)
   b. Details form (UC G2.2).
   c. Roster form (UC G2.3).
   d. Schedule form (UC G2.4).
   e. Snack/Materials form (UC G2.5).
   f. Share/Publish form (UC G2.6).
4. MOS displays preview/review screen.
5. Mom makes any necessary edits to the enter data.
6. MOS displays Genie Options form (UC G2.7).
7. Mom selects Team Genie Options.
8. Mom selects RUN ORGANIZATION/TEAM GENIE.
9. MOS creates Organization/Team.
10. MOS executes selected MAGIC—processes Action Queue.
   a. Activity Calendar/schedule is added to selected Calendars
   b. MOS places all dates on the indicated Adult Calendars with <child name><activity>or on a Child Calendar with just <activity> and places all other data into appropriate fields for that event.
   c. Group/Cluster Contact is created—email distribution list; e.g. Sabrina's Fall Soccer Team
   d. Roster is added to Contacts—new contacts created if they did not already exist
   e. Calendar and roster and emailed to participating children/families
   f. Reminders are sent prior to each activity and to each person assigned to either snack or drink or group Leader at the indicated date and time. Just a reminder that we have a <type of event> scheduled for <date> at <start time> at <location><field/room>.
      <assigned person> is assigned to bring the <materials needed>.
   g. Snack schedule is placed on assigned user's tasks lists
   h. MOS creates <Organization/Team Name> Genie file.
      i. MOS places shortcut to <Organization/Team Name> Genie file under the corresponding Dashboard.
11. MOS displays Genie Complete screen (UC G2.8)
   a. A running list of the Magic/business logic being executed is displayed along with its status (complete, error, etc.)
   b. A progress bar is displayed.

### Post Condition:

Once Mom has input all data (that she wants to), MOS creates the master document with all data.
MOS created a <Team Name> Genie file.

UC G2.1: Complete Setup Options Form—Organization/Team Setup Genie

### Pre-Condition:

MOS & Microsoft Outlook are running
Mom views Organization/Team Setup Options form.

### Normal-Flow:

1. MOS displays Organization/Team Setup Options form.
2. Mom completes Organization/Team Setup Options information.
   a. New or Existing Organization/Team?
   b. Genie Options (Mom selects which forms/tabs she wants to complete)
3. Mom selects SAVE or NEXT.
4. MOS creates Organization/Team file (Organization team Name
5. MOS saves Organization/Team detail information.
6. MOS populates Action Queue.
   a. MOS adds the creation of a folder for the team/organization to the Action Queue, completed upon completion of the Team/Organization Setup Genie.
7. MOS displays next form (Organization/Team Coaches/Leaders UC G2.2).

### Post-Condition:

Organization/Team file created and information saved.

### Notes:

Mom has the option of adding/removing some Coach/Leader fields (columns)—Name and email fields are required.

UC G2.2: Complete Coaches/Leaders Form—Organization/Team Setup

### Pre-Condition:

MOS & Microsoft Outlook are running
Mom views Organization/Team Coaches/Leaders form.

### Normal-Flow:

1. MOS displays Coaches/Leaders form.
2. Mom completes Coaches/Leaders information.
   a. Mom selects which child (primary calendar) is involved.
   b. Name of activity.
   c. Organization/Team name.
   d. Organization/Team web site.
   e. Mom selects which child (primary Calendar) goes to this school.
   f. Coach/leader, assistant coach/leader information (phone, email, address).
   g. League.
   h. Dashboard and color to assign the team to.
   i. Who else needs to know (secondary Calendars) about the team/organization.
   j. Would you like to create a Calendar for the team/organization? Select color.
   k. Dashboard to assign the team to.
   l. Coach/leader, assistant coach/leader information (phone, email, address).
3. Mom Selects NEXT or FINISH
4. MOS populates Action Queue.
5. MOS displays next form (Organization/Team Form UC G2.3).

### Post-Condition:

MOS saves Roster information.

### Notes:

Mom has the option of adding/removing some Roster fields (columns)—Name, Parent and email fields are required.

UC G2.3: Complete Roster Form—Organization/Team Setup

### Pre-Condition:

MOS & Microsoft Outlook are running
Mom views Organization/Team Roster form.

### Normal-Flow:

1. MOS displays Roster form.
2. Mom completes Roster information.
   a. Number of children on team/organization.
   b. Using Family Card Quick Entry table. Enter in individual names of children participating in the organization/team.
      i. Child name.
      ii. Parent Name, email, phone
3. MOS populates Action Queue.
4. MOS displays next form (Organization/Team Schedule Form UC G2.4).

### Post-Condition:

MOS saves Roster information.

### Notes:

Mom has the option of adding/removing some Roster fields (columns)—Name, Parent and email fields are required.

UC G2.4: Complete Schedule Form—Organization/Team Setup Genie

### Pre-Condition:

MOS & Microsoft Outlook are running
Mom views Organization/Team Schedule form.

### Normal-Flow:

1. MOS displays Schedule form.
2. Mom completes Organization/Team schedule information.
   a. Does the Organization/Team publish schedule information.
      i. If yes, import information (file location), subscribe to ______ (URL/iCal).
   b. Mom enters the schedule of the activity (see Calendar Appointment Quick Entry table UC G2.0)
      i. Activity name, type (game, performance, practice, or meeting) and entering the start date and time, end date and time, location and field/room, opponents, notes, and recurrence pattern of the activity using the.
   c. Recurring Schedule
      i. What days does activity meet: M T W Th F Sa Su (user selects all appropriate days)
      ii. Frequency: every ______ weeks
      iii. Starting on: month/day/year at ______ am/pm until : am/pm
      iv. Ending on: month/day/year at ______ am/pm until ______ am/pm
      v. Activity dates (meetings, practices, game, etc.)—repeat for each activity date
         1. date, begin time, end time, location
         2. Practice or Game *
         a. If game, other team*
         b. Home team?<team name> or <other team>
         c. Field
         d. If game, wear color*
   d. List of Dates (Custom Schedule):
      i. month/day/year at ______ am/pm until at ______ am/pm (user types+to add another line of data)
      ii. +month/day/year at ______ am/pm until at ______ am/pm
      iii. Practice or Game *
         1. If game, other team*
         2. Home team?<team name> or <other team>
         3. Field
         4. If game, wear color*
3. Mom selects SAVE or NEXT.
4. MOS Saves Schedule information.
5. MOS populates Action Queue.
   a. MOS adds to the Action Queue the appointment to each primary Calendar (and each secondary Calendar as tentative).
6. MOS displays next form (Snack/Materials Form UC G2.5).

### Post-Condition:

MOS saves Event Schedule information.

### Notes:

Mom has the option of adding/removing some Schedule fields (columns)—Event and Start Time/Date fields are required.

UC G2.5: Complete Snack/Materials Schedule Tab—Organization/Team Setup Genie

### Pre-Condition:

MOS & Microsoft Outlook are running
Mom views the Organization/Team Setup form.
Mom views the Materials tab.

### Normal-Flow:

1. MOS displays Organization/Team Materials form.
2. Mom completes Organization/Team Materials information.
   a. Mom enters the materials needed for the activity by selecting the type, start and end type, location (all pre-populated from the activity schedule), assignee (pre-populated from roster), and materials to bring.
   b. Mom selects whether to send a reminder, and if so, how many days prior to send the email reminder.
3. Mom clicks to SAVE or NEXT.
4. MOS populates Action Queue.
   a. MOS adds to the Action Queue the email reminder to be delivered.
5. MOS displays Organization/Team Reminder form (UC G7.6).

### Post-Condition:

Mom has completed the Materials tab of the Team/Organization Setup Genie. Notes:
Mom has the option of adding/removing some Materials/Snack Schedule fields (columns)—Item, Date/Time and Player fields are required.

UC G2.6: Complete Share/Publish Form—Organization/Team Setup Genie

### Pre-Condition:

Microsoft Outlook is running
Mom views the Organization/Team Share/Publish tab.

### Normal-Flow:

1. MOS displays Organization/Team Publish/Share form.
2. Mom Completes Organization/Team Publish/Share form.
   a. Mom selects which tab to share/publish, from all (default), general info, roster, activity schedule, materials, or carpool).
   b. Mom selects whether to share the information as an email attachment or workspace upload or using Outlook 2007 sharing/publishing capabilities.
3. Mom clicks to NEXT (Run Genie, Finish).
4. MOS saves Organization/Team Publish/Share information.
5. MOS populates Action Queue.
   a. MOS adds to the Action Queue file save to the folder.
   b. MOS adds to the Action Queue the email delivery of the file to the roster if email was selected.
   c. MOS displays the upload link to the workspace if workspace was selected.

### Post-Condition:

Mom has completed the Share/Publish tab of the Team/Organization Setup Genie.

UC G2.7: Complete Genie Options Form—Organization/Team Setup Genie

### Pre-Condition:

MOS & Microsoft Outlook are running
Mom views the Organization/Team Genie Options form.

### Normal-Flow:

1. MOS displays Organization/Team Reminder form.
2. Mom completes Organization/Team Reminder information.
   a. Set alarm/send reminder for snack and drink duty and Group Leader
      i. To whom?<snack duty name> or <drink duty name> or <group leader name>
      ii. Where? Email, phone/text or other
      iii. When? Date and time(default is one week ahead of date at 5 pm)
         1. Morning of at ______ am
         2. Night before at ______ Pm
         3. Week before at ______ am/pm
         4. Two weeks before at ______ am/pm
3. Mom selects RUN GENIE.
4. MOS saves Organization/Team Genie Options information.
5. MOS populates Action Queue.

UC G2.8: Genie Complete—Organization/Team Setup Genie

### Pre-Condition:

Microsoft Outlook is running
Mom views the Organization/Team Share/Publish tab.

### Normal-Flow:

1. MOS displays Organization/Team Genie Complete screen.
   a. Screen dynamically builds, showing each step of the setup process (i.e. as Action Queue is processed) as it is complete.
2. Mom Closes Organization/Team Genie.

### Post-Condition:

Mom has completed the Team/Organization Setup Genie.

UC G3.0: Edit Existing Organization/Team Genie

### Pre-Condition:

MOS & Microsoft Outlook are running
An Organization/Team Genie (or other Genie) was previously created.

### Normal-Flow:

1. Mom selects Genie Open Existing Organization/Team Genie.
2. MOS displays Organization/Team Genie Form for selected Organization/Team.
3. Mom completes/edits Organization/Team tabs/forms
   a. Coaches/Leaders
   b. Roster
   c. Schedule
   d. Materials
   e. Publish/Share
   f. Genie Options
   g. Genie Status
4. MOS selects SAVE or RUN GENIE
   a. MOS populates and processes Action Queue.
5. MOS Displays “Magic Happening” screen
   a. A running list of the Magic/business logic being executed is displayed along with its status (“complete”, “error”, or others).
   b. A progress bar is displayed.

UC G4.0: Delete Already Completed Genie

### Pre-Condition:

MOS & Microsoft Outlook are running
Mom previously ran one of the Genies are created a Genie file named <Genie Name>

### Normal-Flow:

1. Mom selects Genie Delete or Mom selects <Genie Name>
2. MOS prompts
   a. Confirm Delete (Y/N?).
   b. Do you wish to delete all the appointments/calendars in <Genie Name>?
   c. Do you wish to Move the appointments/calendars in <Genie Name> (Y/N); where?
   d. Do you wish to delete all the contacts in <Genie Name>? (Y/N)
   e. Do you wish to Move the contacts in <Genie Name> (Y/N); where?
   f. Do you wish to delete all the emails in <Genie Name>?
   g. Do you wish to Move the emails in <Genie Name> (Y/N); where?
   h. Do you wish to delete all the Tasks in <Genie Name>?
   i. Do you wish to Move the Tasks in <Genie Name> (Y/N); where?
3. Mom confirms delete.
4. MOS moves items to miscellaneous contacts.
5. MOS deletes <Genie Name> file.

### Post-Condition:

<Genie Name> deleted.
<Genie Name> appointments, tasks, emails,

MOS Card Use Cases

UC FC1.0: Create MOS Card

### Pre-Condition:

MOS & Microsoft Outlook are running

### Normal-Flow:

1. Mom selects the New- MOS Card (Contact).
2. Mom selects whether the contact is a family or business contact.
   a. Create Family Card (UC FC1.1).
   b. Create Business Card (UC FC1.2).
3. Mom selects CREATE CARD (contact).
4. MOS creates MOS Card.

UC FC1.1: Create Family Card

### Pre-Condition:

MOS & Microsoft Outlook are running

### Normal-Flow:

1. Mom selects the New- Family Card.
2. MOS displays the Family Card form.
3. Mom completes Family Card information.
   a. Family Details
      i. Enter family's formal, casual, and family salutation for home mail.
      ii. Enter the family's home address.
      iii. Enter the family's home phone number, fax number, and email address.
      iv. Enter the couple's anniversary.
      v. Selects the family's List(s) to place family on (Holiday, etc.).
      vi. Selects the family's picture.
      vii. Enter the home information notes.
   b. Primary Contact Details
      i. MOS custom fields
         1. Gender.
         2. Family role.
         3. Birthday, special occasions.
         4. Selects folder(s)/List(s).
         5. Assistant's name, phone number, and email address.
      ii. Standard Outlook fields
         1. Salutation
         2. Name. (fn, mn, ln)
         3. Title, company and work address.
         4. Work Main phone number, Direct Phone Number, fax number, and email address.
         5. Home mobile phone number.
         6. Select person's picture and signature.
         7. Notes.
   c. Add Partner Information for Family Card (UC FC1.1.1).
   d. Add Children Information for Family Card (UC FC1.1.2).
   e. Add Residence Information to Family Card (UC FC1.1.3).
4. Mom selects the SAVE.
5. MOS creates Family Card.

### Post-Condition:

Mom has created Family Card.
MOS has added the person's birthday to the Special Occasions Calendar.

### Notes:

MOS Card includes a list of all the folders that the card is “in”—this way Mom knows all of the “places” this card is referenced/included.

UC FC1.1.1: Add Partner to Family Card

### Pre-Condition:

MOS & Microsoft Outlook are running
MOS displays the Family Card screen.

### Normal-Flow:

1. Mom selects Partner tab.
2. MOS displays Partner form.
3. Mom completes Partner information
   a. Select gender.
   b. Salutation
   c. Enter name.
   d. Enter title, company and work address.
   e. Enter work Main phone number, Direct Phone, fax number, and email address.
   f. Enter mobile phone number.
   g. Enter birthday.
   h. Select List(s) to place contact on (Holiday, etc.).
   i. Enter assistant's name, phone number, and email address.
   j. Select picture and signature.
   k. Enter notes about the partner.
4. Mom selects the SAVE or another tab.
5. MOS saves Partner Information.
6. MOS displays next tab.

### Post-Condition:

Mom has added the partner to the Family Card.
MOS has added the partner's birthday to the Special Occasions Calendar.

UC FC1.1.2: Add Children to Family Card

### Pre-Condition:

MOS & Microsoft Outlook are running
MOS displays the Family Card screen.
Mom views the family card the child is to be added to.

### Normal-Flow:

1. Mom selects Child tab.
2. MOS displays Child form.
3. Mom completes Child information.
   a. Enters the Child's name.
   b. Enter physical address (default is home address).
   c. Enter Child's phone number (default is home phone number).
   d. Enter Child's email address.
   e. Enter Child's SMS address
   f. Enter Child's IM name.
   g. Enter Child's website.
   h. Select Child's birthday.
   i. Selects the Folders/Lists in which this child should be listed.
   j. Enter Child's notes.
4. Mom selects the SAVE or another tab.

### Post-Condition:

Mom has added the child information added to the Family Card.
MOS has added the child's birthday to the Special Occasions Calendar

UC FC1.1.3: Add Residence Information to Family Card

### Pre-Condition:

MOS & Microsoft Outlook are running
MOS displays the Family Card screen.
Mom views the family card the Residences information is to be added to.

### Normal-Flow:

1. Mom selects Residences tab.
2. MOS displays Residences form.
3. Mom completes Residences information.
   a. Enter Residences name
   b. Enter address.
   c. Enter phone number.
   d. Enter fax number.
   e. Select folder.
   f. Enter notes.
   g. Enter dates/time of year family at second home.
4. Mom selects the SAVE or another tab.

### Post-Condition:

Mom has added the Residences information to the Family Card.

UC FC1.2: Create Business Card

### Pre-Condition:

MOS & Microsoft Outlook are running

### Normal-Flow:

1. Mom selects the New- Business Card.
2. MOS displays the Business Card form.
3. Mom completes Business Card information.
   a. Standard Outlook fields
      i. Business Name.
      ii. Business address.
      iii. Business phone number
      iv. Business fax number,
      v. Business email address.
      vi. Business mobile phone number.
      vii. Notes.
   b. Type of business
   c. List(s) to place Business on (e.g. home repair, etc.).
4. Mom selects the SAVE.
5. MOS creates Business Card.

### Post-Condition:

Mom has created the Business Card.

### Notes:

MOS Card includes a list of all the folders that the card is “in” —this way Mom knows all of the “places” this card is referenced/included.

UC FC2.0: Print MOS Card

### Pre-Condition:

MOS & Microsoft Outlook are running

### Normal-Flow:

1. Mom selects MOS Card to print.
2. Mom selects PRINT.
3. MOS displays print preview/preferences.
4. Mom selects printing preferences.
5. MOS prints MOS Card.

### Post-Condition:

MOS Card is printed.

UC FC3.0: Delete MOS Card

### Pre-Condition:

MOS & Microsoft Outlook are running

### Normal-Flow:

1. Mom selects MOS Card to Delete.
2. MOS prompts
   a. Confirm Delete?
   b. Do you wish to Delete all the contacts in the Family Card? (Y/N)
   c. Do you wish to Move the contacts in this Family Card? (Y/N); where?
3. Mom confirms delete.
4. MOS moves items to miscellaneous contacts.
5. MOS deletes MOS Card.

### Post-Condition:

MOS Card deleted.

UC FC4.0: Split Family Card

### Pre-Condition:

MOS & Microsoft Outlook are running
An MOS card has been previously created.

### Normal-Flow:

1. Mom selects MOS Card to Split.
2. MOS prompts
   a. Confirm Split?
   b. Which Contact (partner, child, etc.) do you want to split/remove from the Family Card
3. Mom confirms Split.
4. MOS un-associates the selected Contact from the selected Family Card.

### Post-Condition:

MOS Card split.

UC FC5.0: View Family Card—Quick View

### Pre-Condition:

MOS & Microsoft Outlook are running
An MOS card has been previously created.

### Normal-Flow:

1. Mom selects MOS Family Card to view
2. MOS displays MOS Family Card

### Post-Condition:

N/A

UC FC 6.0: Create Family Cards by Merging Contacts

### Pre-Condition:

Microsoft Outlook is running
Mom views the Reformat Individual Contacts Genie form.

### Normal-Flow:

1. Mom selects Genie Create Family Card Using Existing Contacts.
2. MOS displays Create Family Card Using Existing forms.
3. Mom completes Create Family Card Using Existing information.
   a. Mom views a Quick Entry table with the first and last name of each family member as primary and their partner's first and last name blank.
   b. Mom enters the partner's first and last name into the partner's first and last name columns.
4. MOS merges the partner's family card into the primary family card and removes the partner from the primary family card list if the primary contact is found.
5. Mom selects CREATE FAMILY CARDs.
6. MOS displays Family Card Created.

### Alternate-Flow:

The partner is not found in the primary family card list.
   MOS adds the partner to the family card as a new member.

### Post-Condition:

Mom has merged family cards.

UC FC7.0: Import Contacts into Family Card Format

### Pre-Condition:

MOS & Microsoft Outlook are running
Mom has contacts in Microsoft Outlook.

### Normal-Flow:

1. Mom selects Genie Convert/Reformat Individual Contacts.
2. MOS displays Convert/Reformat Individual Contacts forms.
3. Mom completes Convert/Reformat Individual Contacts information.
   a. Select contacts to Reformat or
   b. Auto Identify/Select families.
4. Mom selects REFORMAT CONTACTS.
5. MOS performs Magic.
   a. Auto identifies families.
      i. MOS highlights contacts with the same last name
      ii. MOS prompts Mom if the identified contacts are to be in the same Family Card
      iii. MOS iterates through contacts
      iv. MOS attempts to assign gender by name.
   b. Self selected Family Contacts
      i. Mom highlights two or more contacts—identifying them as a family
      ii. Mom selects CREATE FAMILY CARD.
      iii. MOS attempts to assign gender by name.
      iv. MOS prompts Mom to “label” the selected contacts (primary, partner, children, etc.)
6. MOS displays “Magic Happening” screen
   a. A running list of the Magic/business logic being executed is displayed along with its status (complete, error, etc.)
   b. A progress bar is displayed.
7. MOS displays Magic Complete.

### Post-Condition:

Mom has reformatted individual contacts into Family Cards.

### Notes:

Determining gender of contact is probably a future release capability, if necessary at all.
Consider renaming—Reformat?—Convert perhaps.

Task Use Cases

UC T1.0: Create Errand Task

### Pre-Condition:

MOS & Microsoft Outlook are running

### Normal-Flow:

1. Mom selects the Tasks New Errand.
2. MOS displays Errand Task form.
3. Mom completes Errand Task information.
   a. Errand's name.
   b. Errand's location.
   c. Errand's deadline (default is none).
   d. Name of the person to whom the errand is assigned (default is Mom).
   e. Date and time of the errand's reminder (default is none).
      i. Set the daily, weekly, or monthly recurrence of the reminder.
   f. Enter any notes for the errand.
4. Mom selects CREATE ERRAND.
5. MOS creates errand.
6. MOS places the errand in the assignee's task list.
7. MOS enters the reminder email into its queue, to deliver at the recurrence rate.

### Post-Condition:

The errand task is created.

UC T2.0: Create Call Task

### Pre-Condition:

MOS & Microsoft Outlook are running

### Normal-Flow:

1. Mom selects Task New Call Task.
2. MOS displays Call Task form.
3. Mom completes Call Task information.
   a. Name of the person to call.
   b. Phone number of the person to call.
   c. Alternate phone number of the person to call.
   d. Call's topic.
   e. Task Name (default is Call <Person to call name>).
   f. Task deadline.
   g. Name of the person to whom the task is assigned.
   h. Task Reminder date and time.
   i. Task Priority level.
   j. Task Public/private (sensitivity).
   k. Task Category, Calendar, Folder, Dashboard.
   l. Task Recurrence pattern (default is none).
   m. Task Reminder sets the daily, weekly, or monthly recurrence of the task's reminder.
   n. Task Notes.
4. Mom selects the CREATE TASK.
5. MOS creates Call Task.
6. MOS places the call in the assignee's task list.
7. MOS populates Action Queue.
   a. MOS enters the reminder email into its queue, to deliver at the recurrence rate.

### Post-Condition:

The Call Task is created.

UC T3.0: Create Correspondence Task

### Pre-Condition:

MOS & Microsoft Outlook are running

### Normal-Flow:

1. Mom selects New Correspondence.
2. MOS displays Correspondence Task form.
3. Mom completes Correspondence Task information.
   a. Name of correspondence.
   b. Correspondence's topic.
   c. Task deadline.
   d. Name of the person to whom the task is assigned (default Mom).
   e. Task Reminder date and time (default is none).
   f. Task Priority level.
   g. Task Public/private (sensitivity).
   h. Task Category, Calendar, Folder, Dashboard.
   i. Task Recurrence pattern (default is non).
   j. Task Reminder sets the daily, weekly, or monthly recurrence of the task's reminder.
   k. Task Notes.
4. Mom selects the CREATE TASK.
5. MOS places the correspondence in the assignee's task list.
6. MOS populates Action Queue.
   a. MOS enters the reminder email into its queue, to deliver at the recurrence rate.

### Post-Condition:

The correspondence task is created.

UC T4.0: Set Task Preferences

### Pre-Condition:

MOS & Microsoft Outlook are running

### Normal-Flow:

1. Mom selects Task Preferences.
2. MOS displays Task Preferences form.
3. Mom enters Tasks Preferences information.
   a. STYLE (how would you like to see To Dos?)
      i. Errand font type font size font style
      ii. Call font type font size font style
      iii. Correspondence font type font size font style
4. Mom selects SAVE.
5. MOS saves Task Preferences.

### Post-Condition:

Task preferences set.

Template Use Cases

UC TP1.0: Start New School Year

### Pre-Condition:

MOS & Microsoft Outlook are running
Microsoft Outlook is running
Mom views the School Year Setup Template

### Normal-Flow:

1. MOS displays School Year Setup Template.
2. Mom completes School Year Setup forms/tabs.
   a. School Details region.
      i. School Mom selects which child goes to this school. (Primary calendar)
      ii. Mom selects or enters the name of the school.
      iii. School location, phone number, fax number, principal, and school year for the school.
      iv. Mom selects who else needs to know (secondary Calendars) about the school year.
      v. Mom enters the name, phone number, and email address of the teacher or advisor.
   b. School Details tab (UC TP1.1).
   c. School Calendar tab (UC TP1.2).
   d. Grade/Class Calendar tab (UC TP1.3).
   e. Class Roster tab (UC TP1.4).
   f. Rotation Schedule tab (UC TP1.5).
   g. Publish/Share tab (UC TP1.6).
3. Mom selects the SAVE & CLOSE.
4. MOS populates and processes Action Queue.
5. MOS Displays “Magic Happening” screen

UC TP1.1: School Details Form—School Year Template

### Pre-Condition:

MOS & Microsoft Outlook are running
Microsoft Outlook is running
Mom views the All School Calendar form.

### Normal-Flow:

1. MOS displays School Details form.
2. Mom completes All School Calendar information.
   a. School location, phone number, fax number, email.
   b. Principal/School Head contact information.
   c. School year starts/ends (date).
3. Mom selects SAVE.
4. MOS Saves School information.
5. MOS populates Action Queue.
   a. Creation or edit of the business card for the school.
6. MOS displays next tab (School Calendar).

### Post-Condition:

Mom has completed the School Details tab.

UC TP1.2: School Calendar Form—School Year Template

### Pre-Condition:

MOS & Microsoft Outlook are running
Microsoft Outlook is running
Mom views the All School Calendar tab.

### Normal-Flow:

1. MOS displays School Calendar tab.
2. Mom completes School Calendar information.
   a. Does school publish Calendar (iCal, Web etc.)
      i. if yes—subscribe to Calendar Mom enters URL to find calendar.
      ii. if not MOS displays a table pre-populated with typical school holidays and events.
   b. Mom adds dates where missing and can add new appointments.
      i. Name of the special day (some pre-populated from a list of well-known days),
      ii. Start date, end date,
      iii. Whether the school is in session or not,
      iv. Whether to display the day as an all-day event in the Calendar or not.
      v. Holidays & Breaks: Labor Day Holiday, Yom Kippur Holiday, Fall Break, Thanksgiving Break, Holiday Break, MLK Holiday, Presidents' Day Holiday, Winter Break, Spring Break, Easter Break, Memorial Day, Classes End, Graduation, No Classes, Other.
3. Mom selects SAVE.
4. MOS Saves School Calendar information.
5. MOS populates Action Queue.
   a. MOS adds to the Action Queue the appointment to each Calendar.
6. MOS displays next form (Complete Grade Level/Child Specific Calendar).

### Post-Condition:

Mom has completed the All School Year tab of the School Year Setup Form.

UC TP1.3: Grade Level/Child Specific Calendar Form—School Year Template

### Pre-Condition:

MOS & Microsoft Outlook are running
Mom views the Grade Level/Division Form.

### Normal-Flow:

1. MOS displays Grade Level/Child Specific form.
2. Mom completes Grade Level/Child Specific information.
   a. Mom enters the Child's Name (primary calendar)
   b. Mom enters the grade level of the child.
   c. Does school publish Calendar (iCal, Web etc.)
      i. if yes—subscribe to Calendar Mom enters url to find Calendar
      ii. if not enter data manually of via import (see quick entry calendar data UC G2.0)
   d. Mom enters important dates using the Calendar Appointment Quick Entry table.
   e. Mom selects who else needs to know (Secondary/Required and Secondary/Optional)
3. Mom selects SAVE.
   a. MOS saves Grade Level/Child Specific calendar information as <child's name><grade level> calendar.
   b. MOS saves Grade Level/Child Specific MOS Card information as <child's name><grade level> roster
4. MOS populates Action Queue.
   a. MOS adds to the Action Queue the teacher, room Mom, class mates, and their parents as family cards, if requested.
   b. MOS adds to the Action Queue the appointment to each primary Calendar (and each secondary Calendar as tentative) to the Action Queue.
   c. MOS creates child specific roster/distribution list (folder).
   d. MOS places each appointment (entry) onto the designated Calendar for the using <Grade Level><Field Name> as the label (e.g. 2^{nd} Grade Spring Play.)

### Post-Condition:

Mom has completed the Grade Level/Child Specific tab of the School Year Form.

UC TP1.4: Class Roster Form—School Year Template

### Pre-Condition:

MOS & Microsoft Outlook are running
Mom views the Class Roster tab.

### Normal-Flow:

1. Mom selects Class Roster tab.
2. MOS displays Class Roster form.
3. Mom completes Class Roster information.
4. Mom selects SAVE.
5. MOS saves Class Roster.
   a. Mom enters the classmates and parents' contact information using the Family Contact Quick Entry table.
   b. Mom indicates whether she wants Family Cards created for these people.
6. MOS populates Action Queue.
   a. MOS adds to the Action Queue the rotation ID to each Calendar in the child's color, completed upon completion of the School Year Setup Genie.
7. MOS places the rotation days (either number or letter) on appropriate dates on designated Calendars.

### Post-Condition:

Mom has completed the Class Roster Form.

### Notes:

Genie knows to skip weekends and any dates marked with a holiday when school is out. (User must have entered holidays using either the template or Genie for list of dates.)

UC TP1.5: Rotation Schedule Form—School Year Template

### Pre-Condition:

MOS & Microsoft Outlook are running
Mom views the Rotation tab.

### Normal-Flow:

1. Mom selects School Rotation Schedule tab.
2. MOS displays School Rotation Schedule form.
3. Mom completes School Rotation Schedule information.
   a. Mom enters the number of days in the rotation, and whether they are numbered or lettered.
      i. Numbers starting with
      ii. Letters starting with
   b. Mom enters the start and end date of school, pre-populated with the first and last day of class.
   c. Mom enters whether the rotation ID display should appear to the left or right of the day in the Calendar.
4. Mom selects SAVE.
5. MOS saves School Rotation information as <child's name><school year>rotation
6. MOS populates Action Queue.
   a. MOS adds to the Action Queue the rotation ID to each Calendar in the child's color, completed upon completion of the School Year Setup Genie.
7. MOS places the rotation days (either number or letter) on appropriate dates on designated Calendars.

### Post-Condition:

Mom has completed the Rotation Schedule Form. ps Notes:
Genie knows to skip weekends and any dates marked with a holiday when school is out. (User must have entered holidays using either the template or Genie for list of dates.)

UC TP1.6: School Year Share/Publish Form—School Year Template

### Pre-Condition:

Microsoft Outlook is running
Mom views the Share/Publish tab.

### Normal-Flow:

1. MOS displays School Year Publish/Share tab.
2. Mom Completes School Year Publish/Share form.
   a. Mom selects which information to share/publish.
   b. Mom selects whether to share the information as an email attachment or workspace upload or using Outlook 2007 sharing/publishing capabilities.
3. Mom clicks to PUBLISH.
   a. MOS sends the email of the files if email was selected.
   b. MOS displays the upload link to the workspace if workspace was selected.

### Post-Condition:

Mom has completed the School Year Share/Publish Form.

UC TP2.0: Enter a List of Appointments—Quick Entry

### Pre-Condition:

Microsoft Outlook is running
Mom views the Quick Entry Appointment form (New Enter a list of dates).

### Normal-Flow:

1. MOS displays Quick Entry Appointment form.
2. Mom completes Quick Entry Appointment form.
3. Mom selects the Appointment fields that correspond to the information she plans to enter.
   a. Appointment name.
   b. Appointment type.
   c. Appointment start time and end time.
   d. Appointment location.
   e. Appointment field/room.
   f. Materials needed.
   g. Opponents
   h. Home/Away
   i. No School
   j. Custom.
      k. Assign Calendar(s) primary Calendar(s), and secondary Calendars(s). MOS displays a table with Mom's selected fields as column headings for Mom to populate. Mom selects SAVE, renames this list of appointments and tells which Dashboard to save the information in/on.
4. Mom selects CREATE APPOINTMENTS.
5. MOS creates appointments.

### Post-Condition:

Mom has completes a Calendar Appointment Quick Entry form.
MOS has created an appointment for each entry row, and assigns it to the primary and secondary Calendars.

UC TP3.0: Enter a List of Contacts—Quick Entry

### Pre-Condition:

Microsoft Outlook is running
Mom views the Quick Entry screen.

### Normal-Flow:

1. Mom selects Genie Enter a List of Contacts.
2. MOS displays Quick Entry form for MOS Contacts.
3. MOS displays a table with Mom's selected fields as column headings for Mom to populate.
   a. Mom enters the data. First name, last name required.
3. Mom selects SAVE, renames this list of names (roster) and tells which Dashboard to put the information in/on
4. Mom selects CREATE MOS CARDS.
5. MOS creates Family card for each contact on the list.

### Post-Condition:

Mom has completed the Family Contact Quick Entry form.
MOS has created a family contact for each entry row.

Utility Use Cases

UC U1.0: Change Mom's Office Suite Preferences/Options

### Pre-Condition:

MOS & Microsoft Outlook are running

### Normal-Flow:

1. Mom selects Mom's Office Suite Options/Preferences.
2. MOS displays Options/Preferences form.
3. Mom completes Options/Preferences form.
   a. Mom's information.
      i. Name
      ii. Email
      iii. Phone
      iv. SMS
      v. Address
   b. Mom's partner's name.
   c. Number of people in family,
   d. Number of children.
   e. Children names.
   f. Number of residences.
   g. Residence information.
   h. Number of Employee(s).
   i. Employee(s) information.
4. Mom selects SAVE PREFERENCES.
5. MOS saves and implements preferences.

### Post-Condition:

MOS Options/Preferences Updated.

UC U2.0: Uninstall Mom's Office Suite

### Pre-Condition:

MOS & Microsoft Outlook are installed.

### Normal-Flow:

1. Mom selects Windows Control Panel Add/Remove Programs Mom's Office Suite.
2. MOS runs uninstall process.
   a. Splits Family Cards into individual contacts.
   b. MOS specific ‘data fields’ in contact, Calendar and tasks are placed into the notes section of standard Microsoft Outlook contacts, Calendars and tasks.
3. MOS displays message Un-installation complete.
4. MOS opens Mom's browser to MOS feedback page.
5. Mom completes and submits feedback regarding MOS.

### Post-Condition:

MOS removed from system.
None of Mom's contact, Calendar, email, task or other data is lost.

System Use Cases

The following is a brief listing of the MOS system-level use cases identified.

System Use Case Parking Lot
Populate Action Queue.
Process Action Queue.
   Process messages (email, SMS, etc.)
   Process tasks
   Process reminders
Send reminders using message templates
Send and assign tasks
Send messages utilizing message template
Genie Magic

UC S?: Run Auto Tag Email

### Pre-Condition:

MOS & Microsoft Outlook are running

### Normal-Flow:

1. MOS executes MAGIC—Auto Tag Rules.
   a. MOS receives an incoming email.
   b. MOS reads the “from” address and “subject” text and matches those keywords against all known tags.
   c. MOS tags the email with a folder color for each keyword that matches a folder's list of tags.

### Extension:

No keyword matches any folder's tags.
   Mom selects whether the appointment should be “Required”, “Optional”, or “Let's discuss”.

### Post-Condition:

MOS email in InBox has been auto tagged.

UC S?: Consolidate User Communications

### Pre-Condition:

Two or more communication (email, text message, etc.) have been added to the Action Queue for the same recipient (user)

### Normal-Flow:

1. MOS will bundle/consolidate notifications to employees of tasks assigned and driver/sitter assignments so that they don't get a million different emails?
   s

### Post-Condition:

N/A

MOS Message Templates

These templates are to be used when creating and sending the various messages from MOS to the various users.

Message Template Master List
Task Assignment
Task Reminder
Sitter Needed
Sitter Regret
Sitter Reminder
RSVP Accept
RSVP Decline
Restaurant Reservation Task Assignment
Ticket Purchase Task Assignment
Charity Event Invitation for Non-paying guest
Charity Event Invitation for Dutch treat/paying guest
Charity Event Accepted
Charity Event Declined
Charity Event Reminder to Fill table
Charity Event Reminder
Driver Needed for both directions
Driver Needed for driving to appointment
Driver Needed for driving from appointment
Notification (to school) of child appointment
Notification (to employee) of weekly schedule
Delivery to home (please be home) task assignment

M T1.0: Task Assignment and Reminder

### Use Case:

To: <Task Owner>
From: MOS/Mom
Subject: <Task Name> for <Appointment Name> is Due <Task Deadline>
Message Body:
Task Assignment Email:Task assignment <assigned item> for <appointment name> on <appointment date>. <note> Please confirm when this task is completed.
Task Reminder Email: You have an incomplete task <assigned item> for <appointment name> on <appointment date>. Please confirm when this task is completed.
Best Regards,
<Mom Name>

M D1.0: Driver Request

### Use Case: UC A1.3

To: <Driver>
From: Mom
Subject: Are you available to drive <Calendar Name> on <Appointment Date>?
Message Body:

M D1.1: Driver Request—Driver Need for Both Directions

“Are you available to drive <Calendar name> on <date> to <appointment name><location> which begins at<time> and ends at <time>?” <note>

M D1.2: Driver Request—Driver Need To Appointment

“Are you available to drive <Calendar name> on <date> to <appointment name><location>which begins at<time>?” <note>”

M D1.3: Driver Request—Driver Needed From Appointment

“Are you available to drive <Calendar name> on <date> from <appointment name><location>which ends at<time>?” <note>”

M D2.0: Driver Request—No Drivers Available

### Use Case: UC A1.3

To: <Mom>
From:
Subject: No Driver Confirmed for <Appointment Name><Appointment Date>
Message Body:
No Driver Confirmed for <Appointment Name><Appointment Date>.
Please find another driver.

M D3.0: Driver Reminder

Use Case: UC A1.3
To:
From:
Subject:
Message Body:
???

M N1.0: Notification of Child Appointment

Use Case: UC A1.5
To:
From:
Subject:
Message Body:
Notification email for child appointment “<Calendar name> has an appointment on <date> at <time>.Please excuse <Calendar name> at <time>. <assigned driver for to appointment> will be picking <Calendar name> up.Thank you, <Mom first name><Mom last name>.”
Best Regards,
<Mom Name>

M N2.0: Notification of Employee(s) Schedule

### Use Case: UC

### Message Template:

To:
From:
Subject:
Message Body:
Notification email for Employee schedule: “Your schedule for next week is as follows. Please let me know if you see any problems.
<date><start time><end time>
<date><start time><end time>
<date><start time><end time>
<date><start time><end time>
Best Regards,
<Mom Name>

M S1.0 Sitter Request

### Use Case: UC A1.7

### Message Template:

To: <Sitter email>
From: <Mom>
Subject: Sitter Request for the <Mom Last Name> Family on <Appointment Date>
Message Body:
Are you available to babysit on <start time> until <end time> at our home, <home street address>?You would need to arrive at <sitter arrival time>.Please respond as soon as possible via email or by calling <home phone>.<note>
Best Regards,
<Mom Name>

M S1.1 Sitter Request Declined

### Use Case: UC A1.7

### Message Template:

To: <Mom>
From: <MOS>
Subject: Sitter Request for <Appointment Date> has been declined
Message Body:
<potential sitter #1> is unable to work on <start time>.

M S1.2 Sitter Request Not Completed

### Use Case: UC A1.7

### Message Template:

To: <Mom>
From: <MOS>
Subject: No Sitter Available for <Appointment Name><Appointment Date>
Message Body:
No sitter has been found for <Appointment Name><Appointment Date>.
Please try find another sitter.

M S2.0 Sitter Reminder

### Use Case:UC A1.7

### Message Template:

To: <Mom>
From: <MOS>
Subject: Sitter Request for the <Mom Last Name> Family on <Appointment Date>
Message Body:
We are looking forward to you babysitting at our home, <home street address> on <start time> until <end time>.Please arrive at <sitter arrival time>.
Best Regards,
<Mom Name>

M R1.0 RSVP Acceptance

Use Case: UC A.14

### Message Template:

To: <RSVP Owner>
From: <Calendar Name>
Subject: RSVP <Event Name>
Message Body:
“<Calendar name> is looking forward to your event on <date>.Thank you for the invitation.”

M R2.0: RSVP Decline

### Use Case: UC A.14

### Message Template:

To: <RSVP Owner>
From: <Calendar Name> Mom?
Subject: <Calendar Name/Mom Name> Is Unable to Attend <Event Name>
Message Body:

“<Calendar name> regrets your kind invitation for the event on <date>.

M RES1.0: Reservation Task Assignment

### Use Case:UC A1.8

### Message Template:

To:
From:
Subject:
Message Body:
Make a restaurant reservation task assignment email: “Please make a reservation at <restaurant name #1>,<restaurant name #2> or <restaurant name #3> for <table for #<>______ am/pm> on <event date>.<note>

M RES2.0: Reservation Venue Not Available

### Use Case:UC A1.8

### Message Template:

To:
From:
Subject:
Message Body:
“None of the restaurants you requested are available on <event date>.Would you like me to try another?”
Mom's response to restaurant not available (positive): “Yes, please try <restaurant #4> or <restaurant #5>.”
Mom's response to restaurant not available (Negative): “No, thanks, I'll handle this.”
Ticket purchase task assignment email: “Please try to get <# of tickets> to <event name> on <date> at <time>, or <date> and <time> or <date and <time>.” <note>

M CE1.0: Charity Event Invitation Request Non-Paying Guest

### Use Case: UC A1.9

### Message Template:

To:
From:
Subject:
Message Body:
“Will you be my guest at <event name> on <event date/time> at <event location>? <Mom's name>”

M CE1.1 Charity Event Invitation Request Acceptance

### Use Case: UC A1.9

### Message Template:

To:
From:
Subject:
Message Body:
“I'm so glad you can join me at <event name><Mom's name>.”

M CE1.2: Charity Event Invitation Request Declined

### Use Case: UC A1.9

### Message Template:

To:
From:
Subject:
Message Body:
Charity Event Invitation is regretted email:
“I'm sorry you can't join me at <event name>. Thanks for letting me know. <Mom's name>”

M CE2.0: Charity Event Invitation Request Paying Guest

### Use Case: UC A1.9

### Message Template:

To:
From:
Subject:
Message Body:
<?????>

M CE3.0: Charity Event Reminder to Fill Table

### Use Case: UC A1.9

### Message Template:

To: <Mom>
From: MOS
Subject: <Appointment Name><Charity Name> <Appointment Date/Time>—Table Not Full
Message Body:

“Your table is not full at <event name> on <event date>.”

M DL1.0: Delivery No One Home

### Use Case:

### Message Template:

To: <Mom>
From: MOS
Subject: <Appointment Name> on <Appointment Date> Requires Someone to be home Message Body:
“No one is scheduled to be at <residence street address> for <delivery or service call name> on <date> from <start time> to <end time>.”
Please be home for delivery email:“Please plan to be at <home address> between <start time> and <end time> on <date> for <delivery or service call>.”

Miscellaneous Things Not Sure Where to Capture

Other Requirements

User Interface
Toggle filing cabinet folder display.
Dashboard dockability.

Questions
How are we going to relate the ‘physical structure’ of MOS suite to the virtual folder structure?

Graphical/UI Elements
Add-in Ribbon
File Cabinet (left bar)
File Menus/Command Bar
Dashboard
   1. <list of current Dashboards, folders?>
   2. New
   3. Print
   4. Rename
   5. Delete
Genie
   1. <list of Genies>
   2. Appointment
   3. New→Adult, Child, Employee(s)/Employee
   4. Print
Family Card
   1. New
   2. Print
   3. Search/Find
   4. Task
   5. New→Call, Correspondence, Errand, Other
   6. Print
Print
   1. <list of print templates>
Help
About

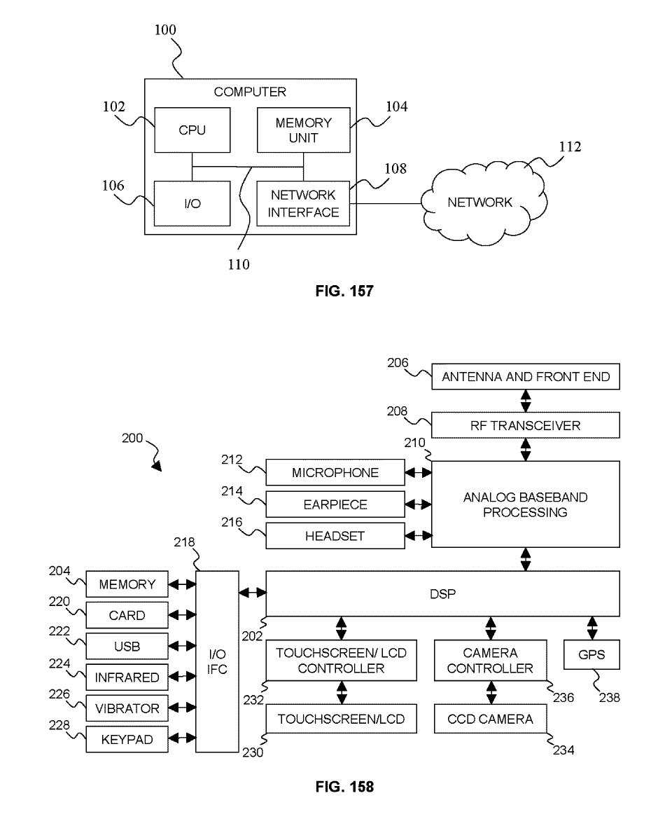

As described previously, various systems may be used to implement aspects of the present disclosure. Two such systems are illustrated in FIGS. 157 and 158. However, it is understood that these systems are for purposes of example only and that many different systems and system configurations may be used.

Referring to FIG. 157, in one embodiment, a computer system 100 illustrates an environment within which various aspects of the present disclosure may be implemented. As an illustration of an exemplary computer, the computer system 100 may include a central processing unit (“CPU”) 102, a memory unit 104, an input/output (“I/O”) device 106, and a network interface 108. The components 102, 104, 106, and 108 are interconnected by one or more communications channels (e.g., a bus system) 110. It is understood that the computer 100 may be differently configured and that each of the listed components may actually represent several different components. For example, the CPU 102 may actually represent a multi-processor or a distributed processing system; the memory unit 104 may include different levels of cache memory, main memory, hard disks, and remote storage locations; and the I/O device 106 may include monitors, mice, keyboards, and the like.

In some embodiments, the computer 100 may be connected to a network 112 via the network interface 108, which may be wired and/or wireless. The network 112 may be representative of several networks, such as a local area network, a company wide intranet, and/or the Internet. Because the computer 100 may be connected to the network 112, certain components may, at times, be shared with other computers (not shown). Therefore, a wide range of flexibility is anticipated in the configuration of the computer 100. It is understood that, although a conventional computer is illustrated in FIG. 2, the terms “computer” and “computing device” in the present disclosure may refer to any device that includes a memory capable of storing data and instructions and a processor for processing such instructions. The computer 100 may be using any operating system, including various versions of operating systems provided by Microsoft (such as WINDOWS), Apple (such as OS X), UNIX, and LINUX.

The computer 100 is operable to store data and instructions in the memory unit 104 and to execute the instructions using the CPU 102. Input may be received from a user via the I/O device 106 and/or the network interface 108 (i.e., remotely via the network 112). Such data and instructions may include data and instructions for implementing various aspects of the disclosure as described above.

Referring to FIG. 158, a block diagram illustrates one embodiment of a mobile device (e.g., a computing device) 200 that may be used to implement various aspects of the present disclosure. The mobile device 200 includes a digital signal processor (DSP) 202 and a memory 204. As shown, the mobile device 200 may further include an antenna and front end unit 206, a radio frequency (RF) transceiver 208, an analog baseband processing unit 210, a microphone 212, an earpiece speaker 214, a headset port 216, an input/output interface 218, a removable memory card 220, a universal serial bus (USB) port 222, an infrared port 224, a vibrator 226, a keypad 228, a touch screen liquid crystal display (LCD) with a touch sensitive surface 230, a touch screen/LCD controller 232, a charge-coupled device (CCD) camera 234, a camera controller 236, and a global positioning system (GPS) sensor 238. It is understood that not all of these components may be present.

The DSP 202 or some other form of controller or central processing unit operates to control the various components of the mobile device 200 in accordance with embedded software or firmware stored in memory 204. In addition to the embedded software or firmware, the DSP 202 may execute other applications stored in the memory 204 or made available via information carrier media such as portable data storage media like the removable memory card 220 or via wired or wireless network communications. The application software may comprise a compiled set of machine-readable instructions that configure the DSP 202 to provide the desired functionality, or the application software may be high-level software instructions to be processed by an interpreter or compiler to indirectly configure the DSP 202.

The antenna and front end unit 206 may be provided to convert between wireless signals and electrical signals, enabling the mobile device 200 to send and receive information from a cellular network or some other available wireless communications network. The RF transceiver 208 provides frequency shifting, converting received RF signals to baseband and converting baseband transmit signals to RF. The analog baseband processing unit 210 may provide channel equalization and signal demodulation to extract information from received signals, may modulate information to create transmit signals, and may provide analog filtering for audio signals. To that end, the analog baseband processing unit 210 may have ports for connecting to the built-in microphone 212 and the earpiece speaker 214 that enable the mobile device 200 to be used as a cell phone. The analog baseband processing unit 210 may further include a port for connecting to a headset or other hands-free microphone and speaker configuration.

The DSP 202 may send and receive digital communications with a wireless network via the analog baseband processing unit 210. In some embodiments, these digital communications may provide Internet connectivity, enabling a user to gain access to content on the Internet and to send and receive e-mail or text messages. The input/output interface 218 interconnects the DSP 202 and various memories and interfaces. The memory 204 and the removable memory card 220 may provide software and data to configure the operation of the DSP 202. Among the interfaces may be the USB interface 222 and the infrared port 224. The USB interface 222 may enable the mobile device 200 to function as a peripheral device to exchange information with a personal computer or other computer system. The infrared port 224 and other optional ports such as a Bluetooth interface or an IEEE 802.11 compliant wireless interface may enable the mobile device 200 to communicate wirelessly with other nearby mobile devices and/or wireless base stations.

The input/output interface 218 may further connect the DSP 202 to the vibrator 226 that, when triggered, causes the mobile device 200 to vibrate. The vibrator 226 may serve as a mechanism for silently alerting the user to any of various events such as an incoming call, a new text message, and an appointment reminder.

The keypad 228 couples to the DSP 202 via the interface 218 to provide one mechanism for the user to make selections, enter information, and otherwise provide input to the mobile device 200. Another input mechanism may be the touch screen LCD 230, which may also display text and/or graphics to the user. The touch screen LCD controller 232 couples the DSP 202 to the touch screen LCD 230.

The CCD camera 234 enables the mobile device 200 to take digital pictures. The DSP 202 communicates with the CCD camera 234 via the camera controller 236. The GPS sensor 238 is coupled to the DSP 202 to decode global positioning system signals, thereby enabling the mobile device 200 to determine its position. Various other peripherals may also be included to provide additional functions, e.g., radio and television reception.

The mobile device 200 is operable to store data and instructions in the memory 204 and/or memory card 220 and to execute the instructions using the DSP202. Input may be received from a user via various input devices and/or the antenna 206. Such data and instructions may include data and instructions for implementing various aspects of the disclosure as described above.

It will be appreciated by those skilled in the art having the benefit of this disclosure that this system and method for managing events in a multiple schedule environment. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for managing events in a multiple schedule environment comprising:
receiving, by a computing device, a user selection identifying an event that is to be scheduled, wherein the user selection identifies the event from a plurality of pre-defined event types;
opening, by the computing device, the event as an entry in a schedule;
receiving, by the computing device, user data identifying at least a date and a time corresponding to the event;
creating, by the computing device, a message for a recipient, wherein the message includes the time and date inserted into pre-defined text corresponding to the event type;
sending, by the computing device, the message to the recipient;
determining, by the computing device, whether a reply has been received from the recipient;
determining, by the computing device, whether the reply is affirmative or negative if the reply has been received;
updating, by the computing device, a status of the event based on the steps of determining; and
notifying, by the computing device, a designated individual of the status.

2. The method of claim 1 wherein the event type is a baby sitting appointment.

3. The method of claim 2 further comprising selecting the recipient from a list of recipients associated with the event type.

4. The method of claim 3 further comprising:
if the reply is received and determined to be negative, selecting a next recipient from the list of recipients;
creating a second message for the next recipient, wherein the second message includes the time and date inserted into pre-defined text corresponding to the event type; and
sending the second message to the next recipient.

5. The method of claim 4 further comprising repeating the steps of selecting, creating, and sending until either an affirmative reply is received or all recipients on the list of recipients have been sent a message without an affirmative reply being received.

6. The method of claim 2 further comprising:
selecting the recipient from a list of recipients;
if no reply is received after a pre-defined period of time, selecting a next recipient from the list of recipients;
creating a second message for the next recipient, wherein the second message includes the time and date inserted into pre-defined text corresponding to the event type; and
sending the second message to the next recipient.

7. The method of claim 1 wherein the event type is a charity event.

8. The method of claim 7 further comprising receiving user data identifying the recipient and a plurality of other recipients corresponding to the event, wherein the steps of creating, sending, and determining are performed for each of the plurality of other recipients.

9. The method of claim 8 wherein a certain number of spaces are available for the recipients, and wherein notifying the designated individual of the status includes notifying the designated individual if a certain portion of the spaces are still available.

10. The method of claim 1 further comprising:
retrieving contact information corresponding to the recipient from a database; and
applying the contract information to the message prior to sending the message to the recipient.

11. The method of claim 1 wherein notifying the designated individual of the status includes:
creating a message for the designated individual, wherein the message includes information corresponding to the recipient, the event, and whether the reply was affirmative or negative; and
sending the message to the designated individual.

12. The method of claim 1 further comprising, if the reply is received and determined to be affirmative, updating the event with information corresponding to the recipient.

13. A computing device comprising:
a network interface;
a processor coupled to the network interface;
a memory coupled to the processor; and
a plurality of instructions stored in the memory for execution by the processor, the instructions including instructions for:
receiving user data identifying at least a date and a time corresponding to an event;
retrieving a preformatted message from the memory, wherein the message is retrieved from a plurality of preformatted messages based on an event type of the event;
retrieving an address of a recipient for the message from the memory, wherein the recipient is selected based on one of a user selection and a recipient list associated with the event type;
inserting the time, date, and address into the message;
sending the message to the recipient via the network interface;
determining whether a reply has been received from the recipient;
updating a status of the event based on the step of determining; and
notifying, by the computing device, a designated individual of the status.

14. The computing device of claim 13 further comprising instructions for determining whether the reply is affirmative or negative if the reply has been received.

15. The computing device of claim 14 further comprising instructions for sending a message to a second recipient if the reply is negative.

16. The computing device of claim 13 further comprising instructions for:
determining whether a predefined period of time has elapsed if the reply has not been received; and
sending a message to a second recipient if the predefined period of time has elapsed.

17. The computing device of claim 13 further comprising instructions for receiving user input to customize the preformatted message.

18. The computing device of claim 13 further comprising instructions for sending a plurality of messages to a plurality of recipients.

19. The computing device of claim 13 further comprising instructions for presenting a customizable dashboard to a user.

20. A computing device for managing events in a multiple schedule environment comprising:
means for receiving a user selection identifying an event that is to be scheduled, wherein the user selection identifies the event from a plurality of pre-defined event types;
means for opening the event as an entry in a schedule;
means for receiving user data identifying at least a date and a time corresponding to the event;
means for creating a message for a recipient, wherein the message includes the time and date inserted into pre-defined text corresponding to the event type;
means for sending the message to the recipient;
means for determining whether a reply has been received from the recipient;
means for determining whether the reply is affirmative or negative if the reply has been received;
means for updating a status of the event based on the steps of determining; and
means for notifying a designated individual of the status.
